(19) United States
(12) Patent Application Publication
(10) Pub. No.: US 2012/0282580 A1
(43) Pub. Date: Nov. 8, 2012

(54) ISO9001 IMPLEMENTATION WORKSHOP

(76) Inventor: William J. Metzcar, New Madison, OH (US)

(21) Appl. No.: 13/464,394

(22) Filed: May 4, 2012

Related U.S. Application Data
(60) Provisional application No. 61/482,235, filed on May 4, 2011.

(51) Int. Cl. G09B 19/00

(52) U.S. Cl. 434/219

(57) ABSTRACT

The present disclosure relates to an ISO9001 implementation workshop which combines ISO9001 implementation instruction with a hands-on workshop. The course provides the history and foundation of ISO9001, a complete overview of the ISO9001 standard and review of the key steps to consider for all hospitals with regard to implementing ISO9001 within their organization. The course includes: on-site instruction at a preferred location or site; a two to four day course with full access to a highly trained, knowledgeable ISO accredited consultant; an additional fully trained facilitator to help support the participants during the workshop portion of the course; and, utilizing the healthcare organizations own documentation, coupled with health care's best practices, the actual development of the key documents required for the ISO implementation.

### CROSS-REFERENCE TO RELATED APPLICATIONS

This application claims the benefit of U.S. Provisional Application Ser. No. 61/482,235, filed May 4, 2011.

### BACKGROUND OF THE INVENTION

The present invention relates to implementation of ISO9001 quality management standards. ISO9001 is an international standard by which organizations manage the quality, business, and compliance of the organization. The ISO9001 standard focuses on customer requirements and improving processes based on control points designed to ensure standardized healthcare policies, procedures, management, and infrastructure.

### BRIEF DESCRIPTION OF THE SEVERAL VIEWS OF THE DRAWINGS

The following detailed description of specific embodiments of the present invention can be best understood when read in conjunction with the following drawings in which:

FIGS. 1-468 are views of the materials for ISO9001 implementation workshops for Phases One through Three.

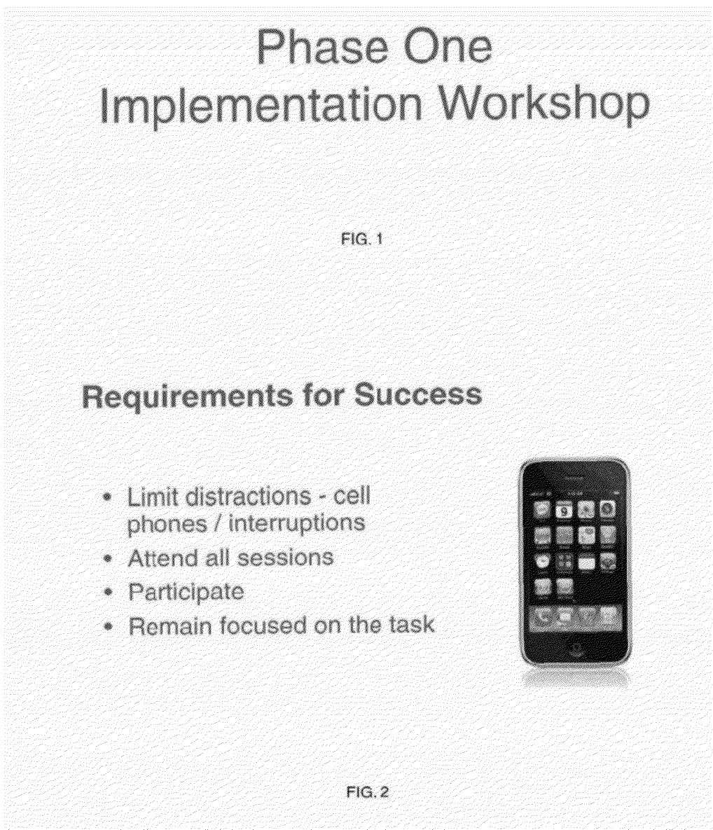

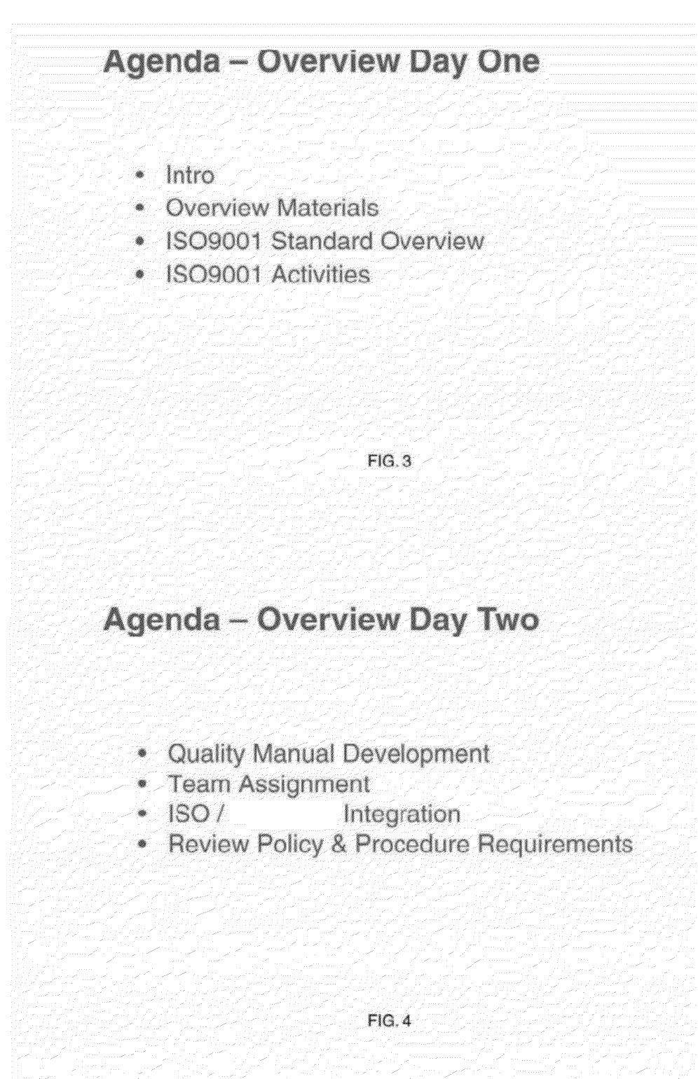

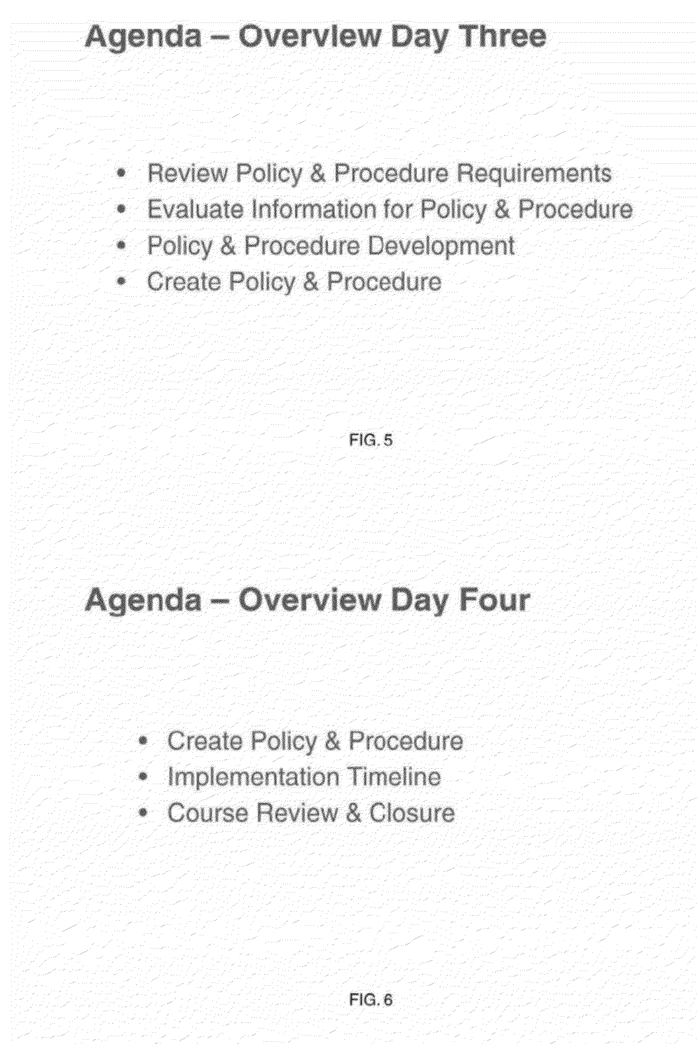

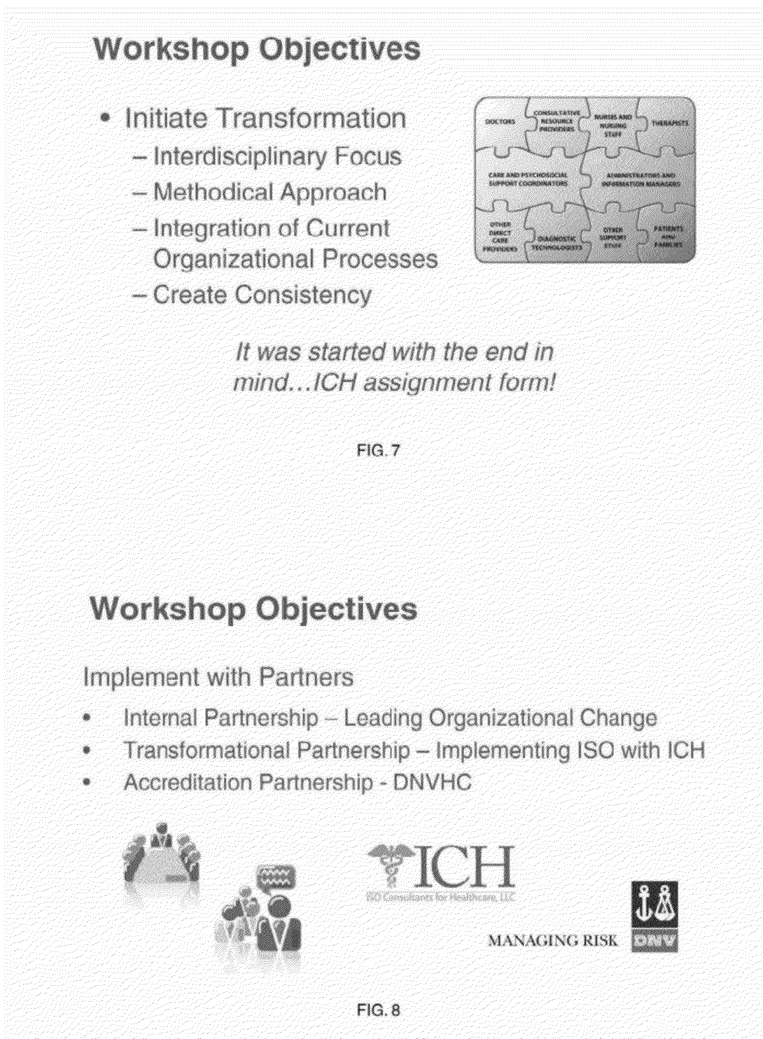

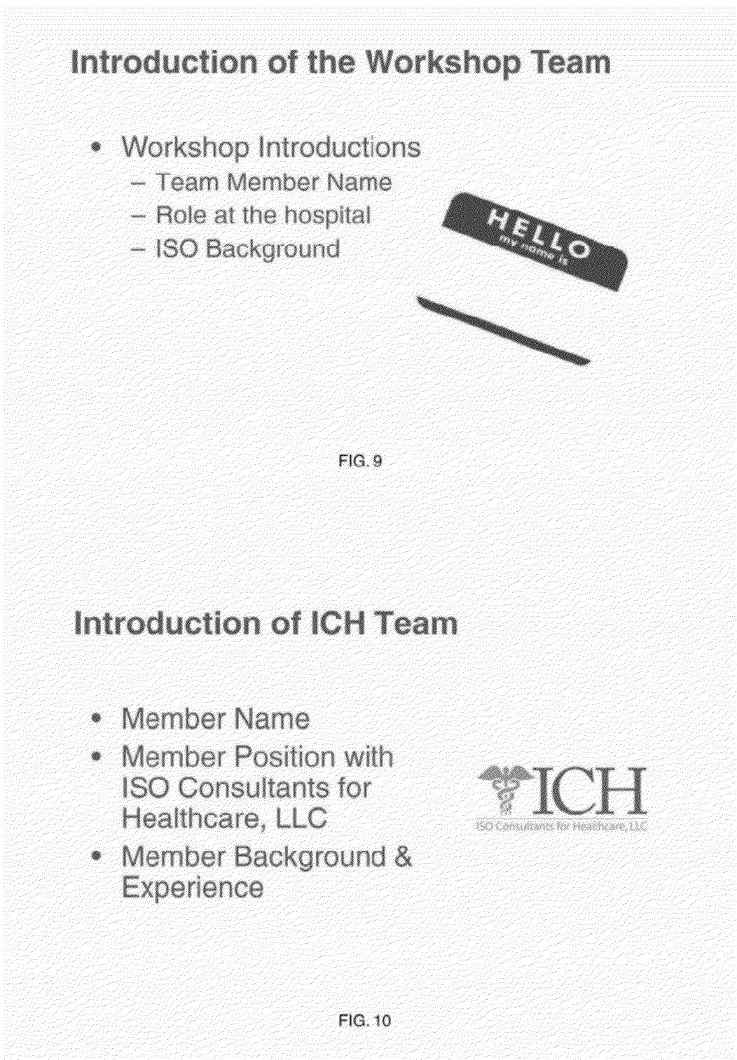

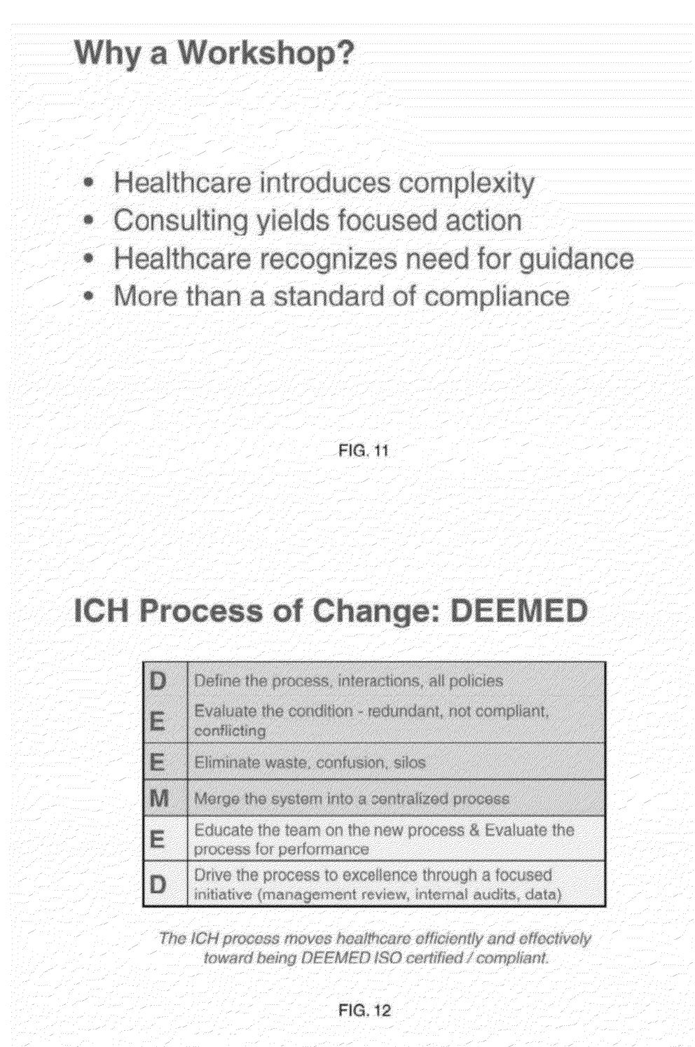

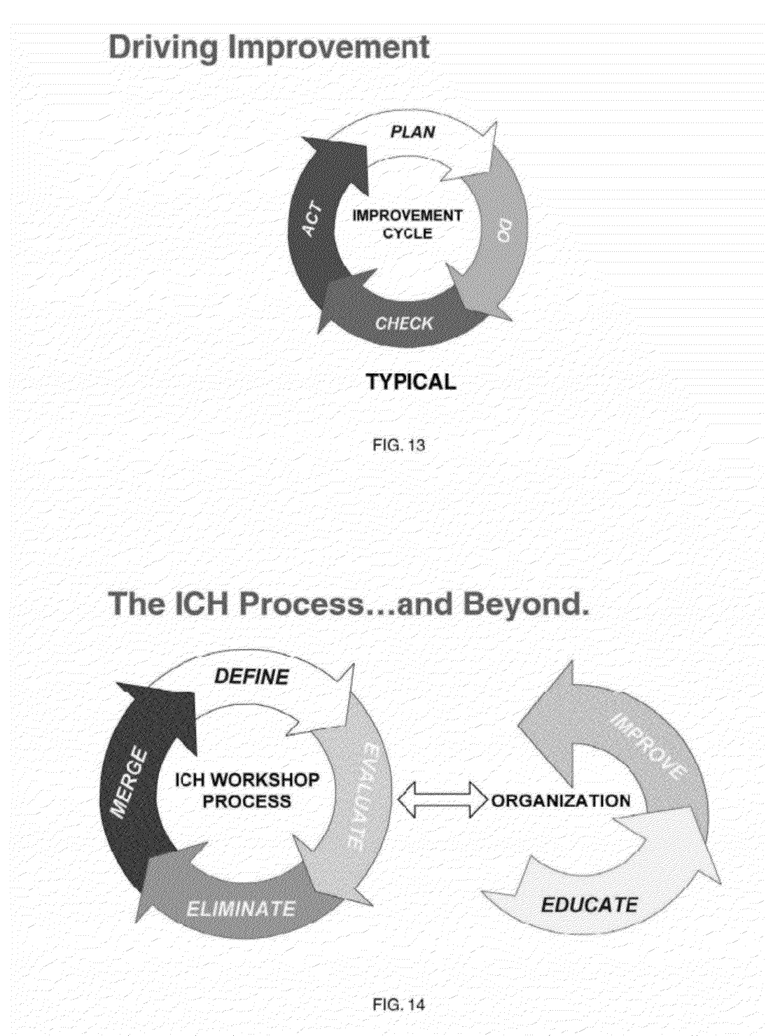

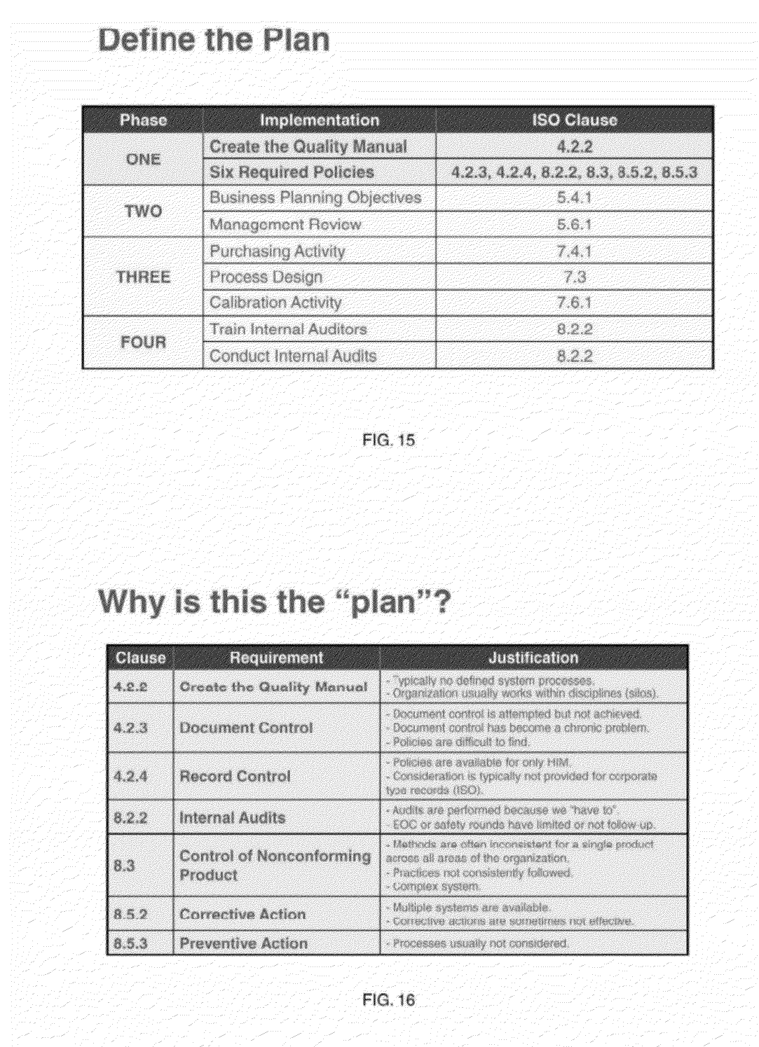

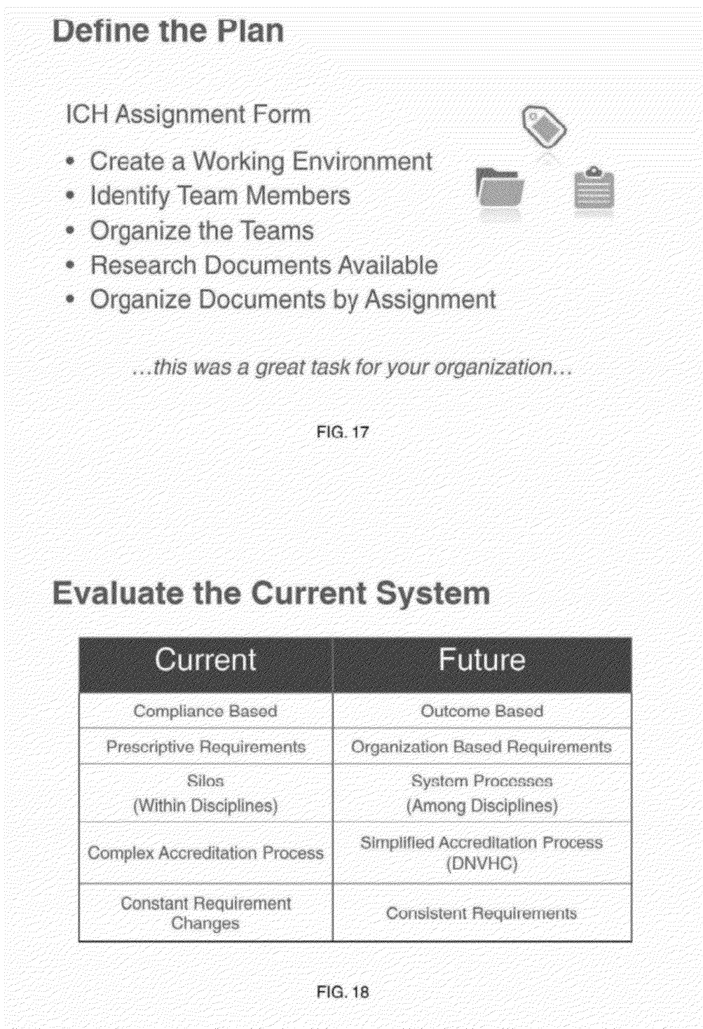

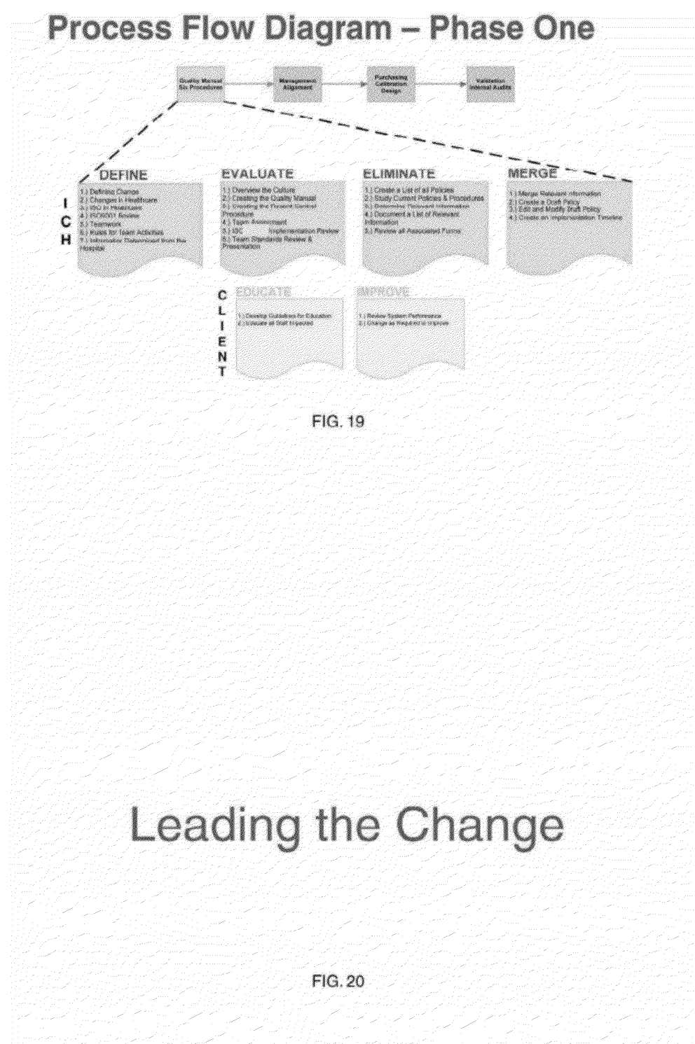

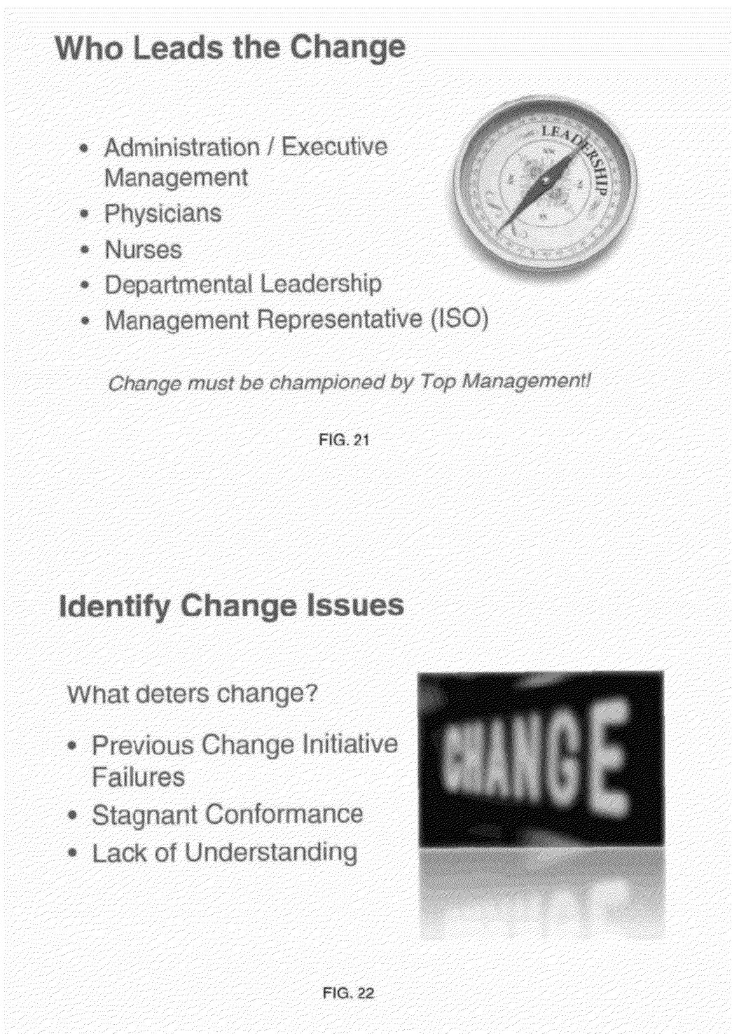

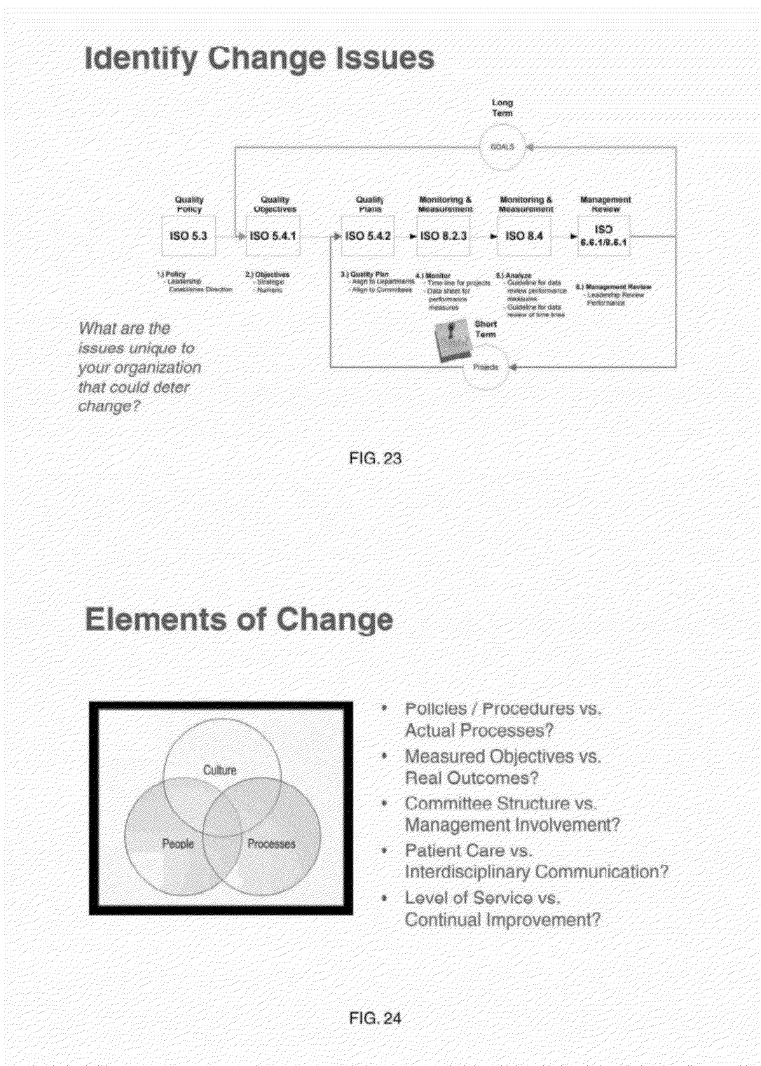

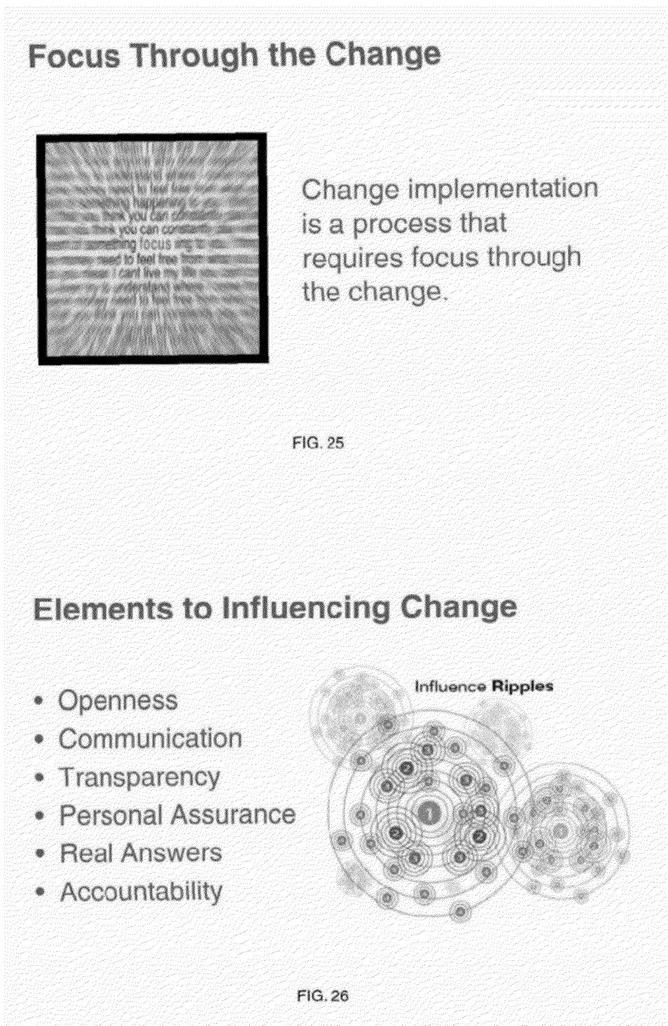

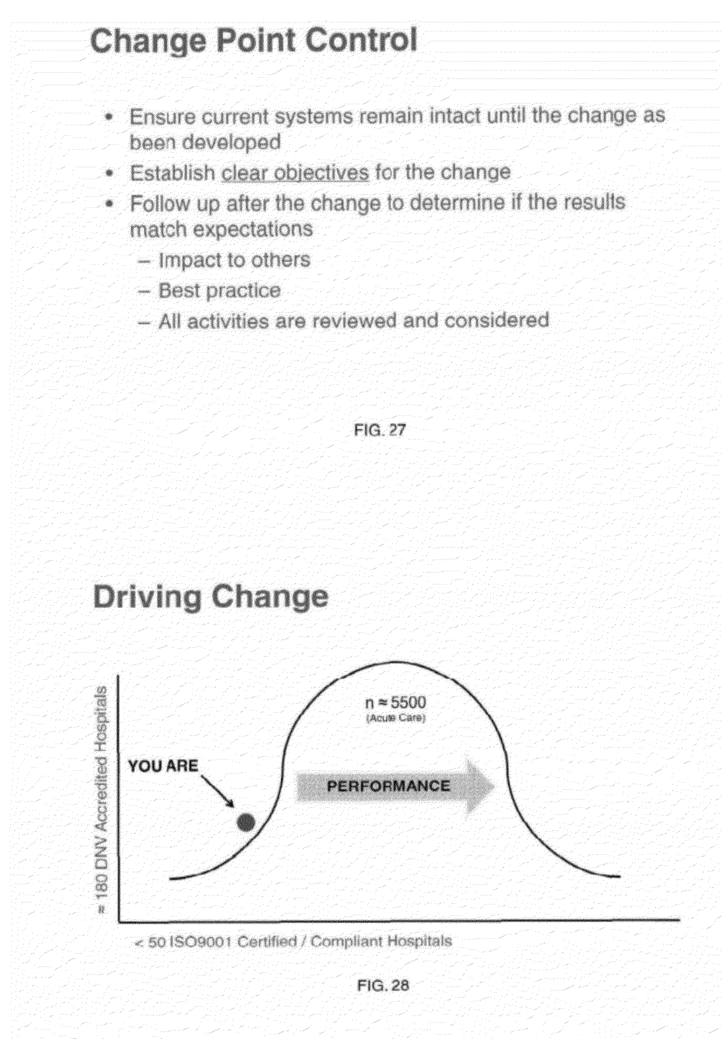

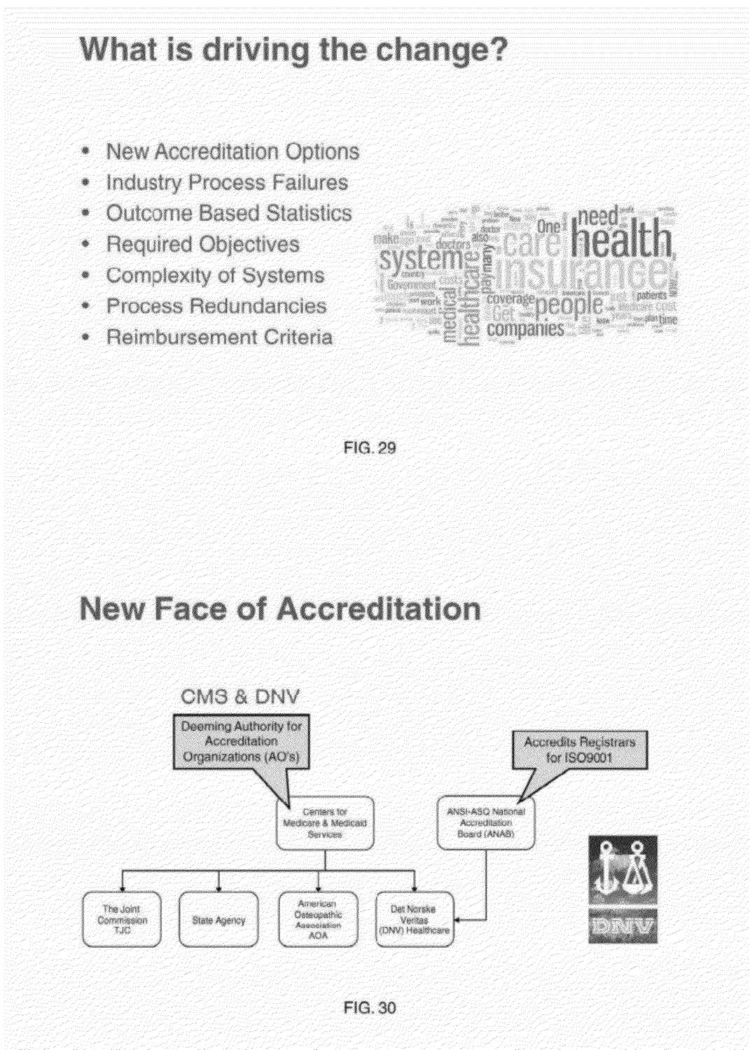

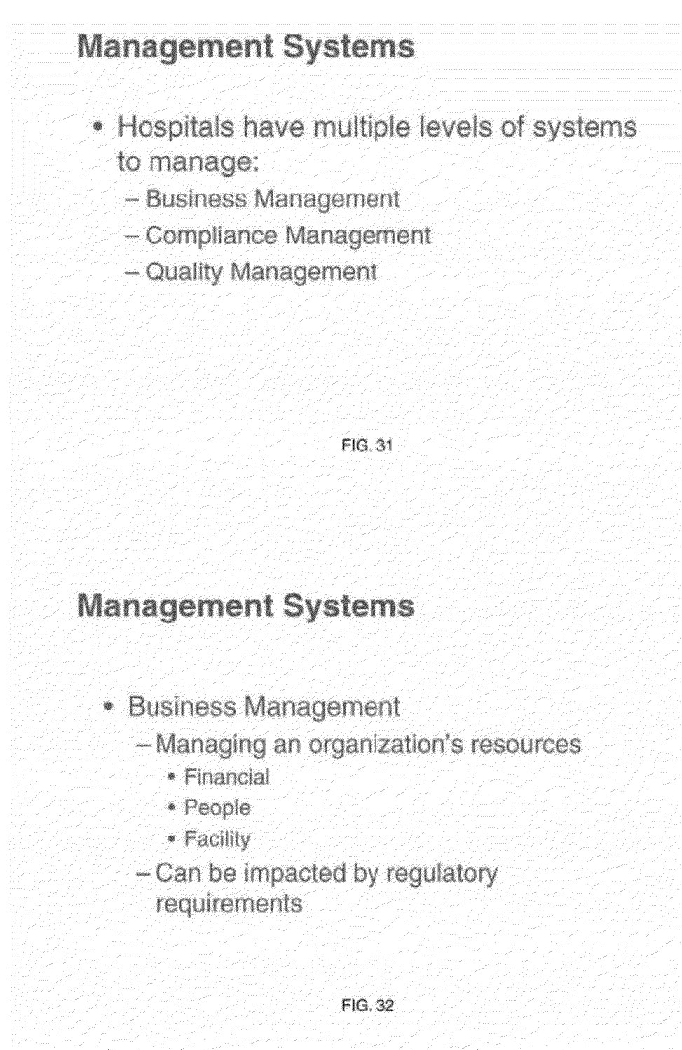

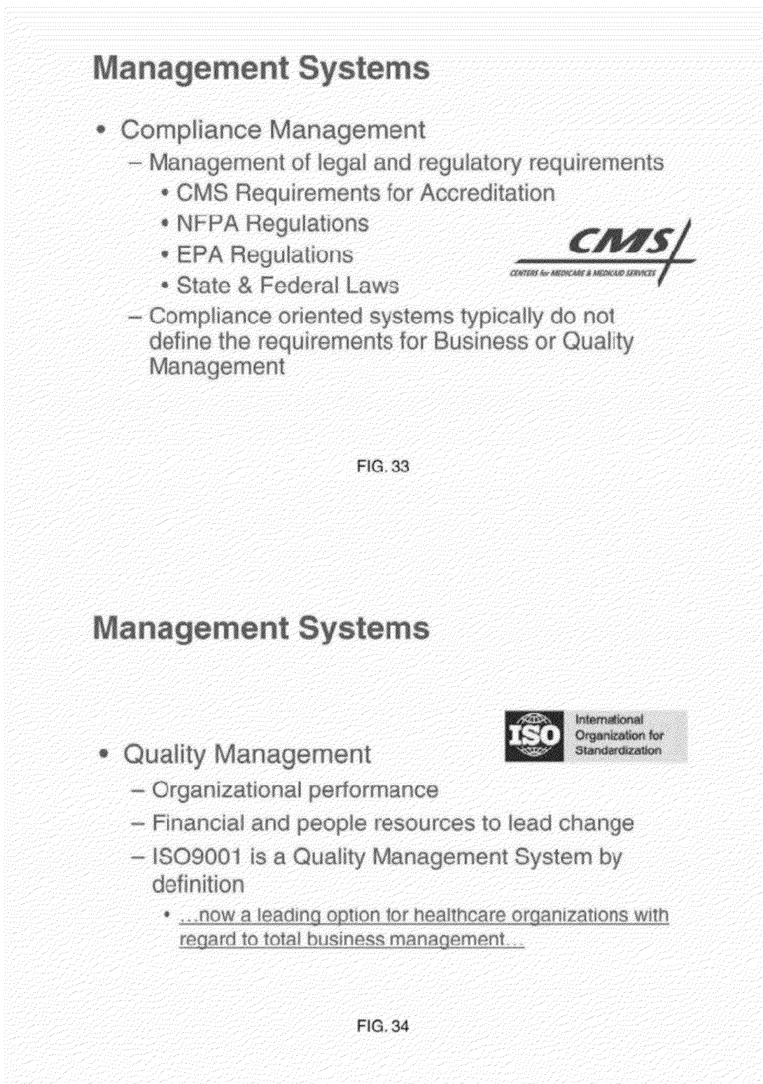

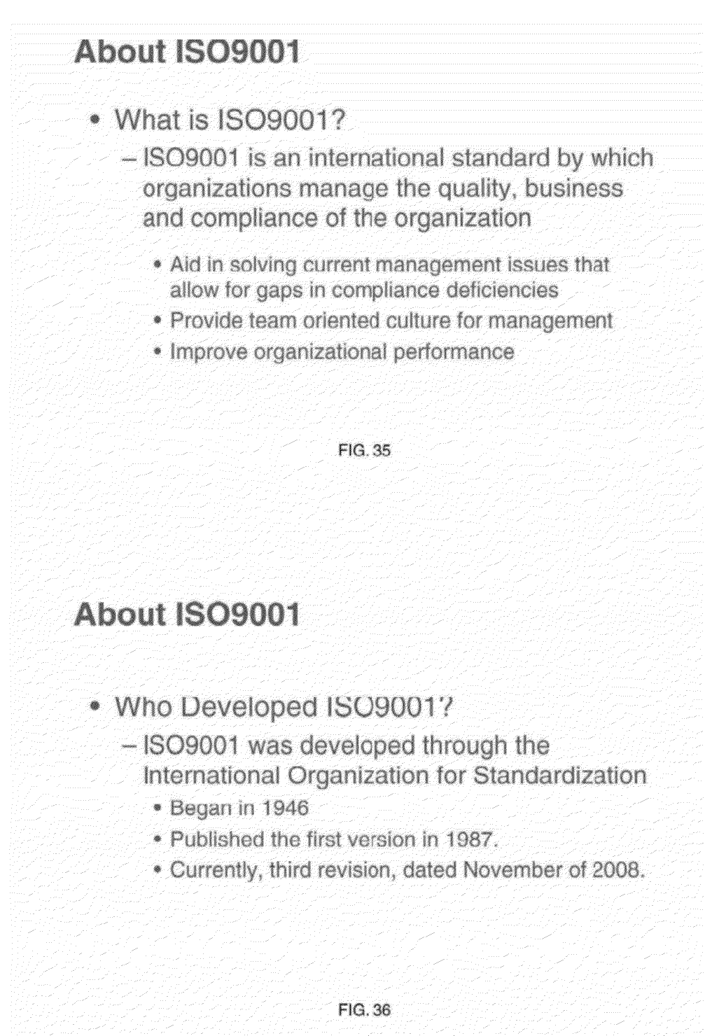

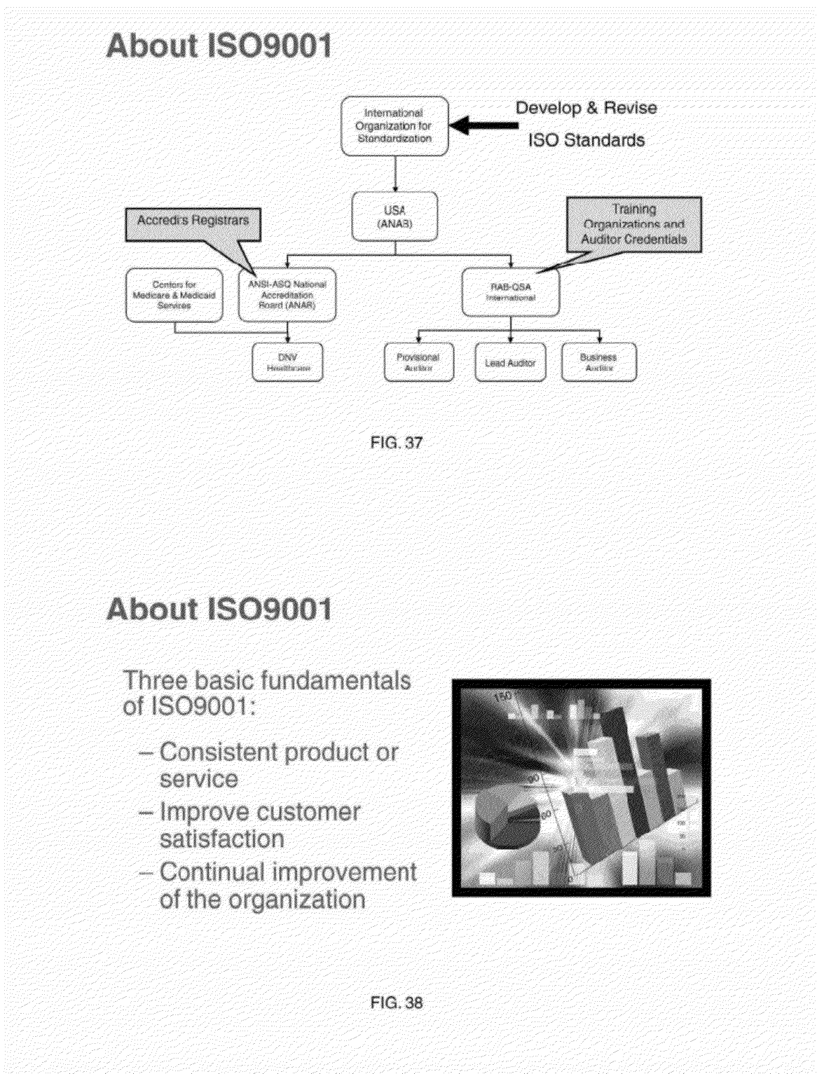

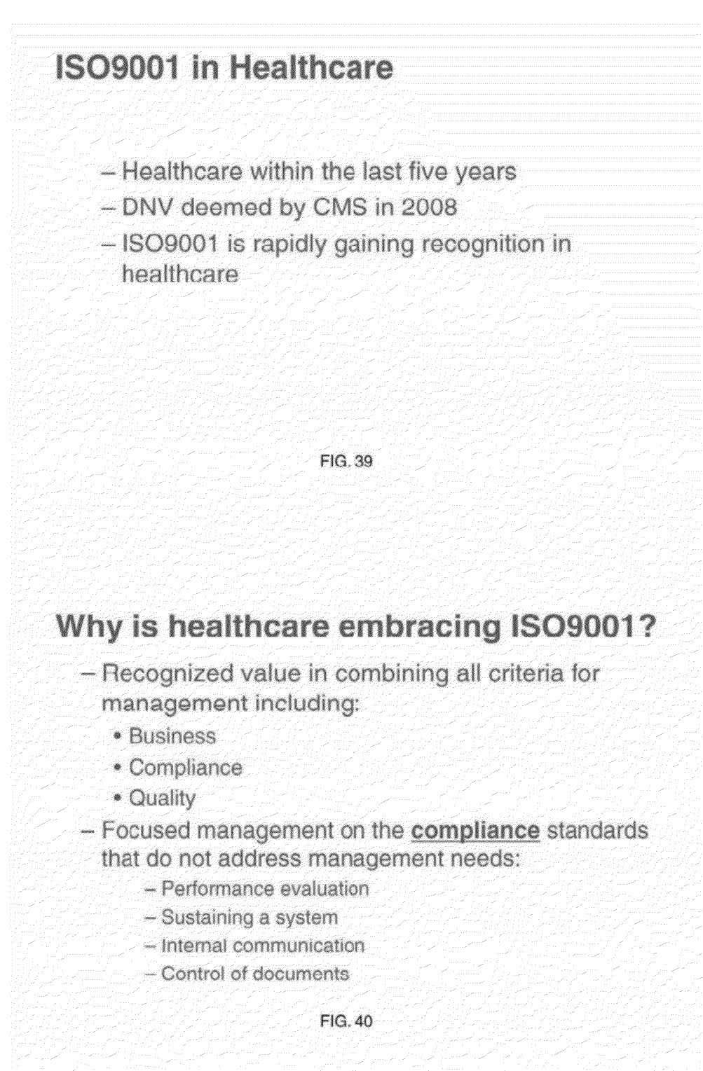

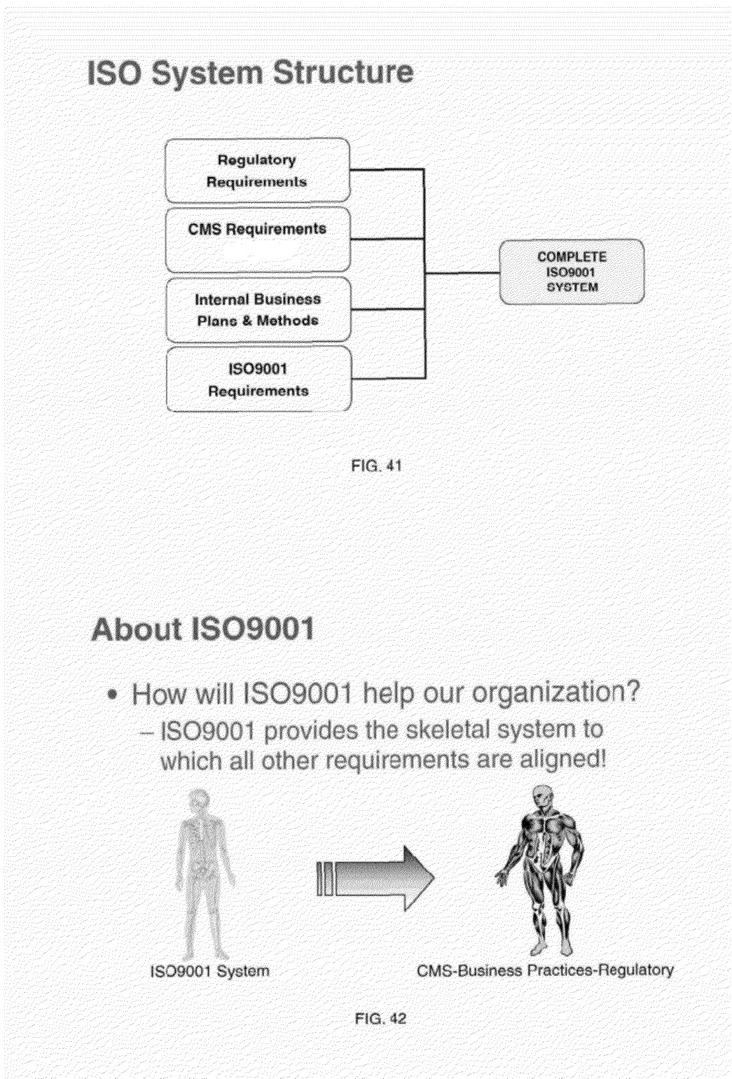

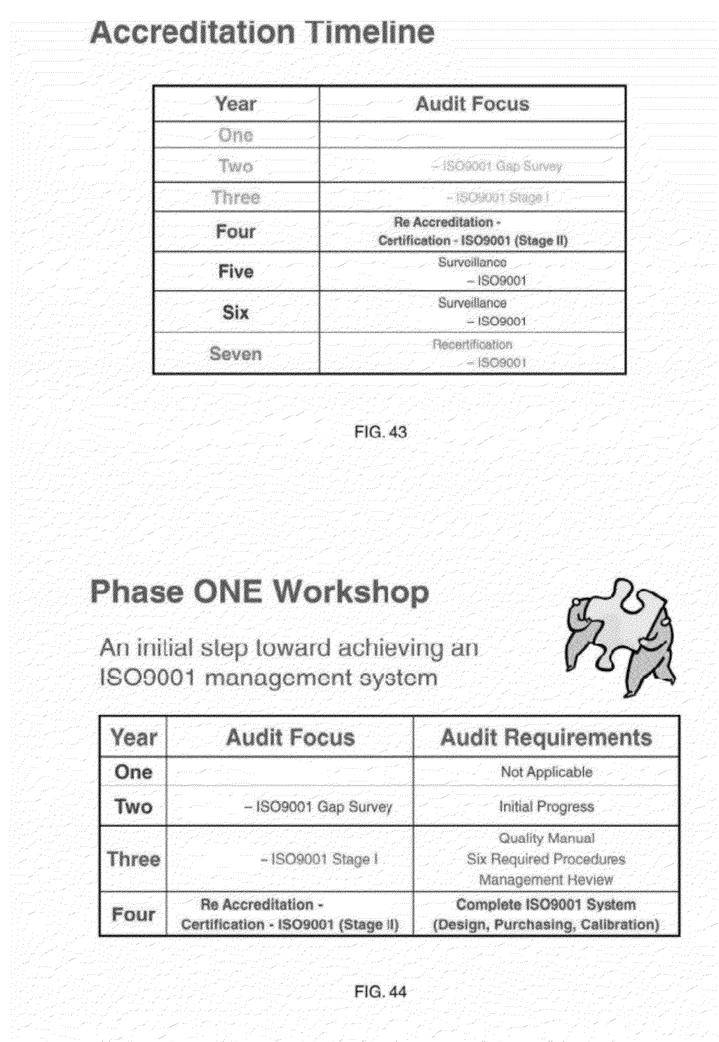

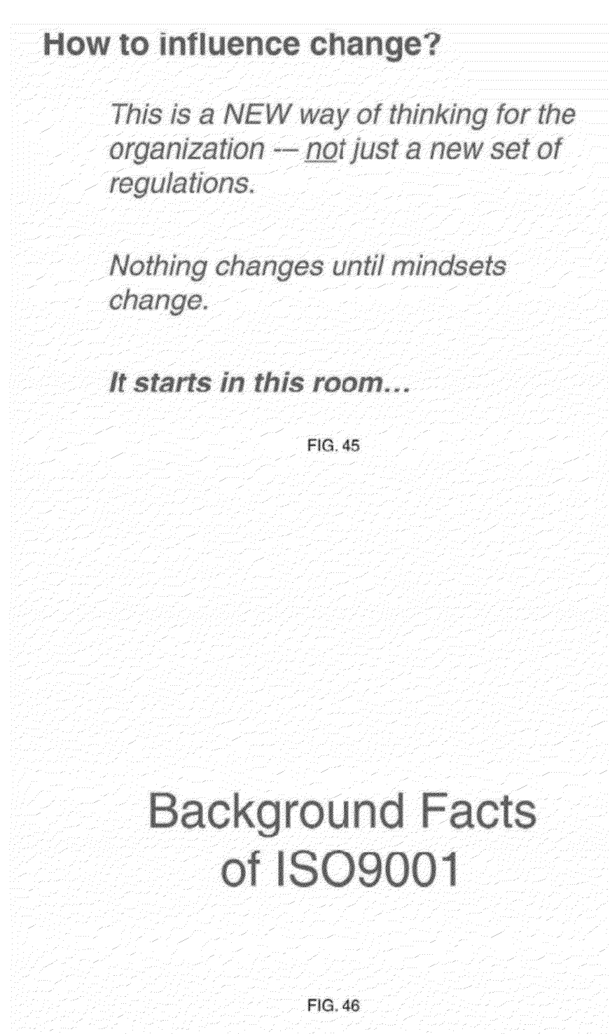

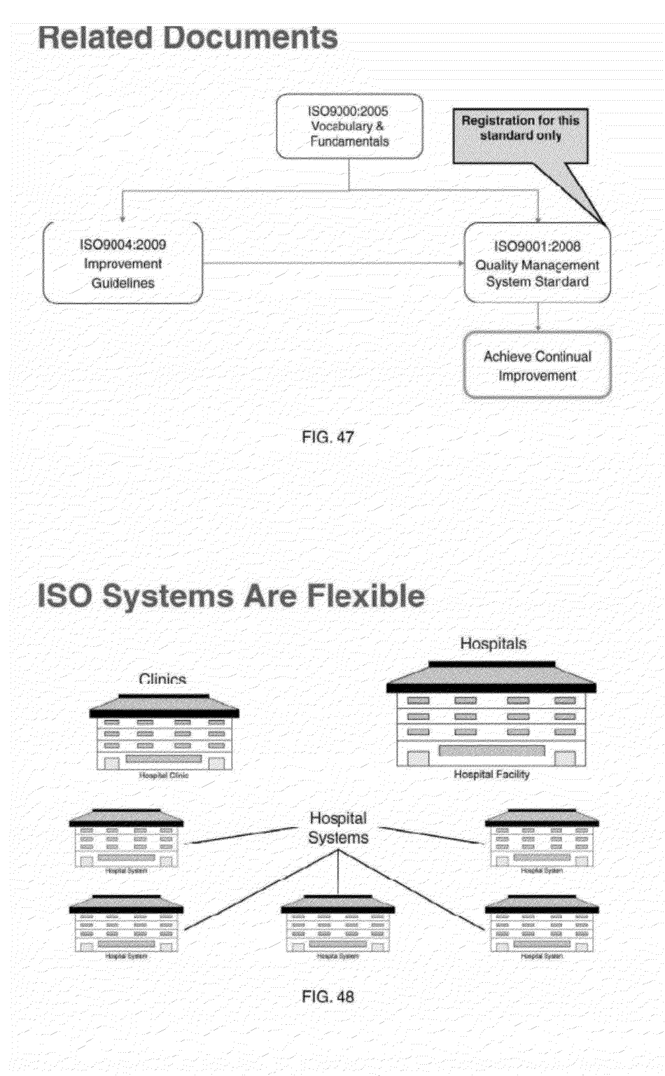

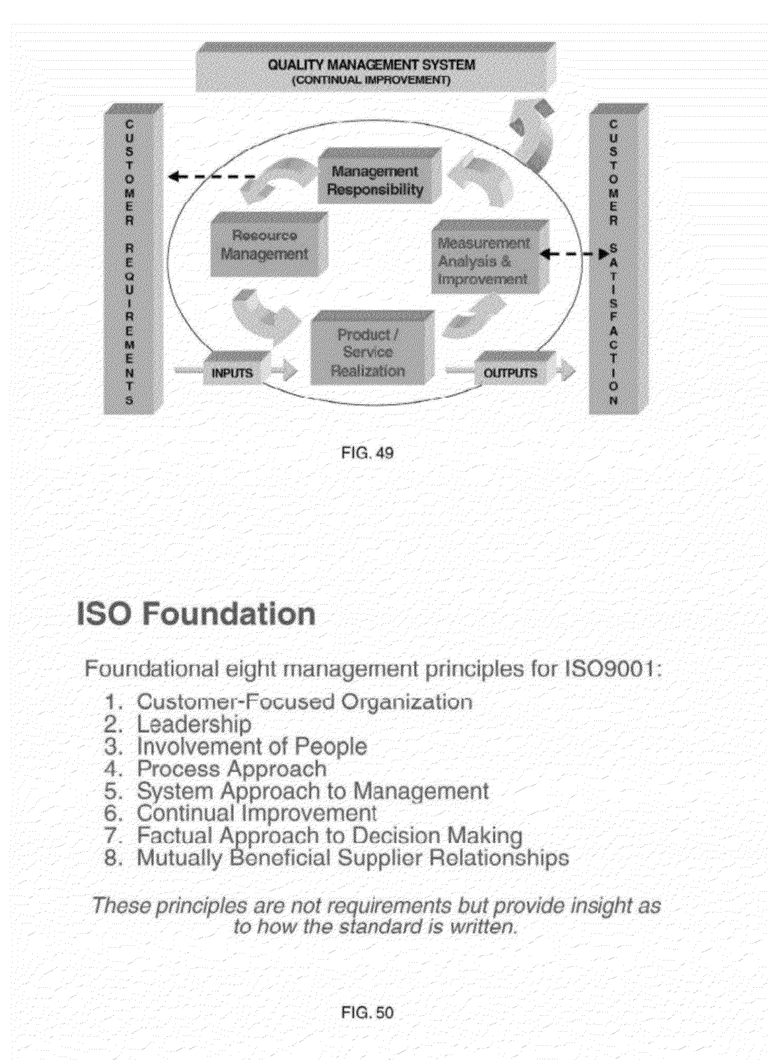

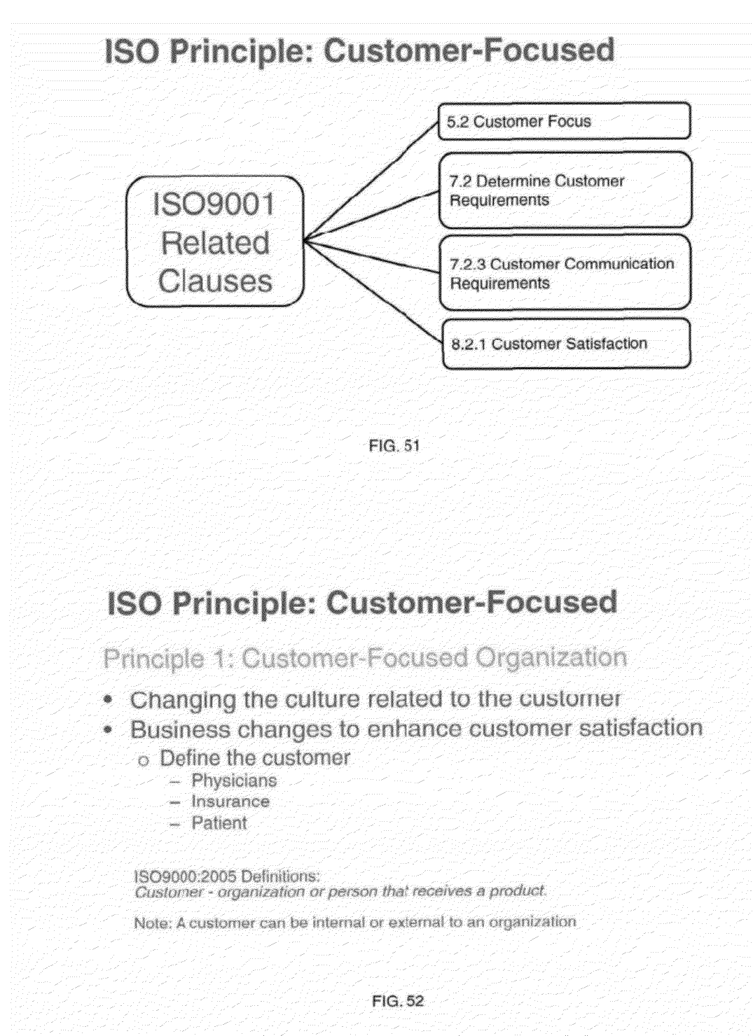

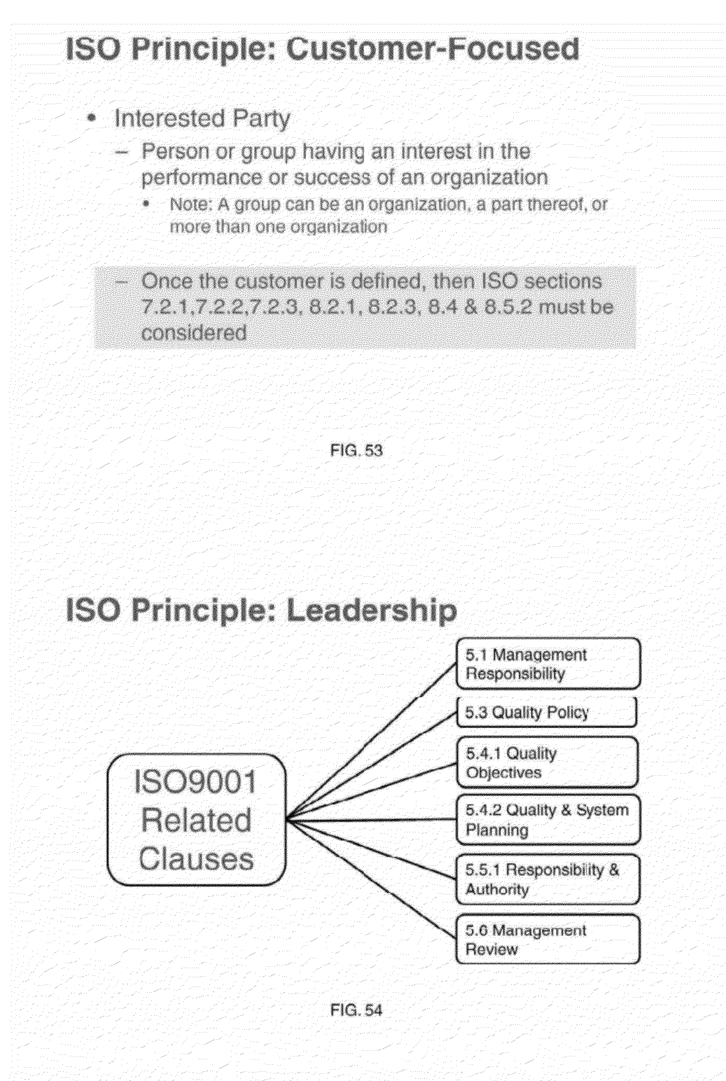

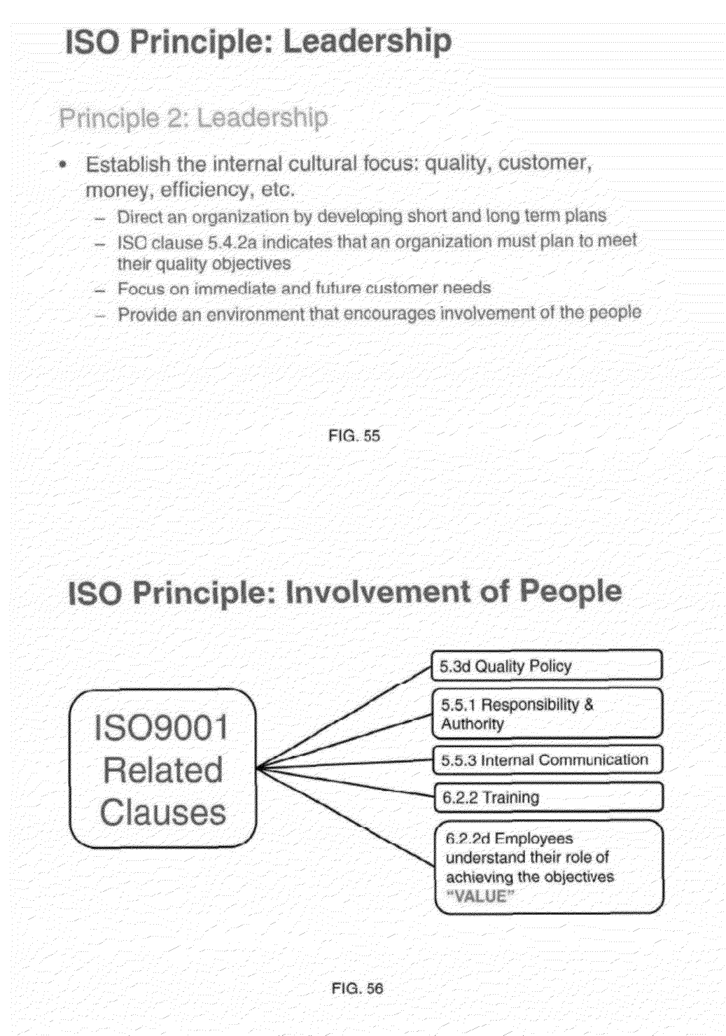

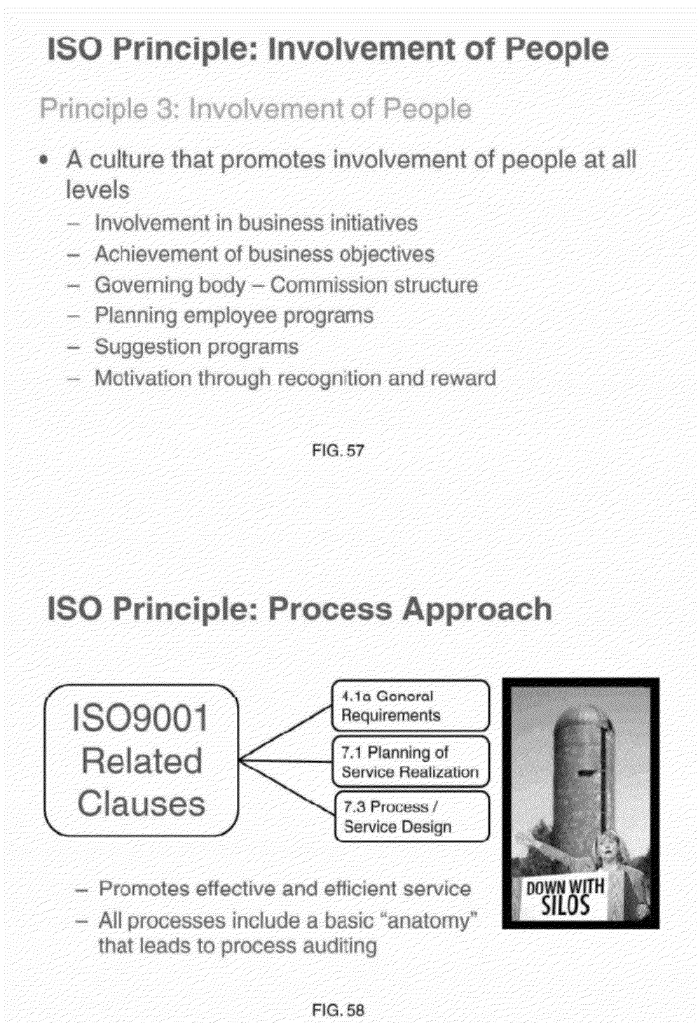

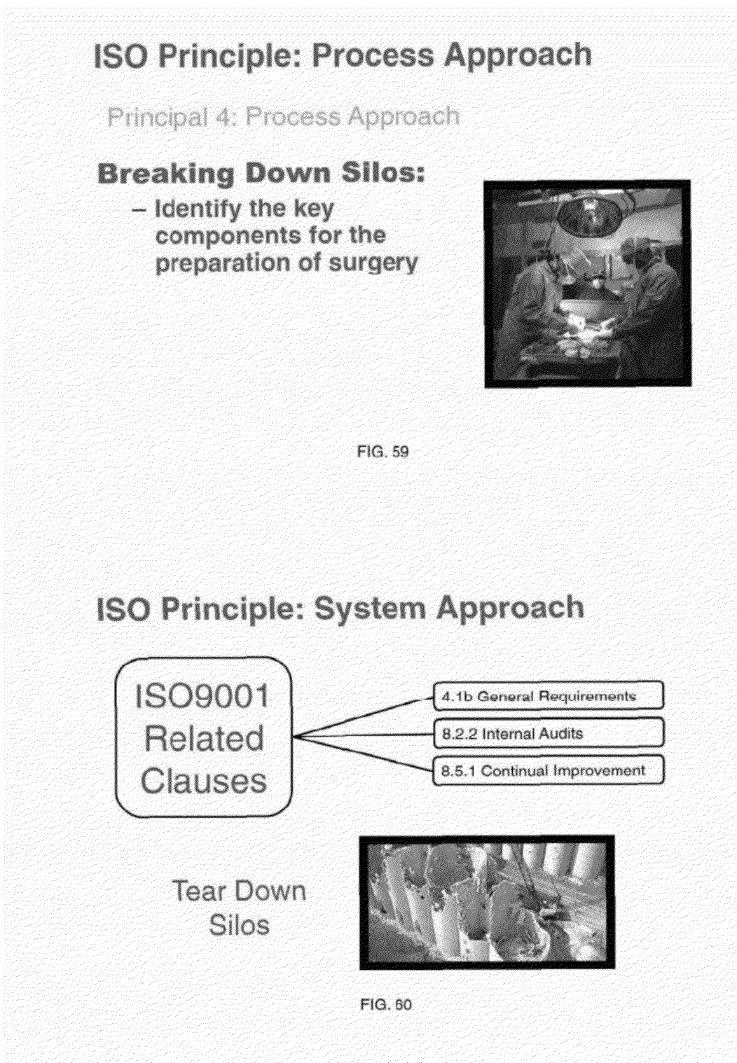

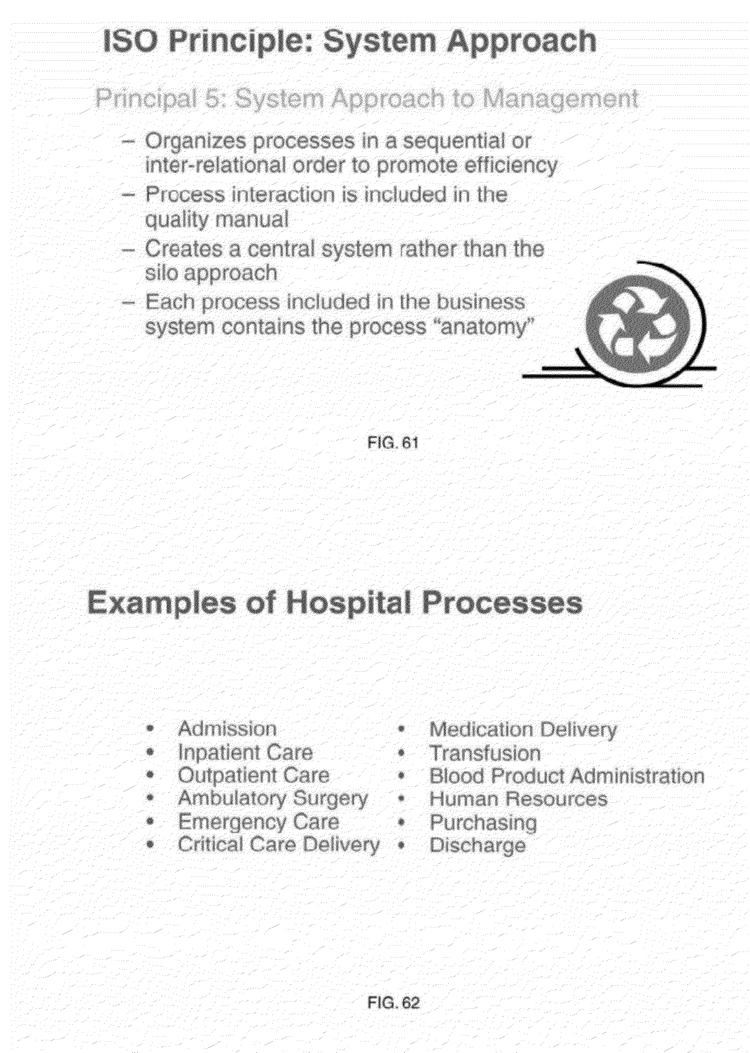

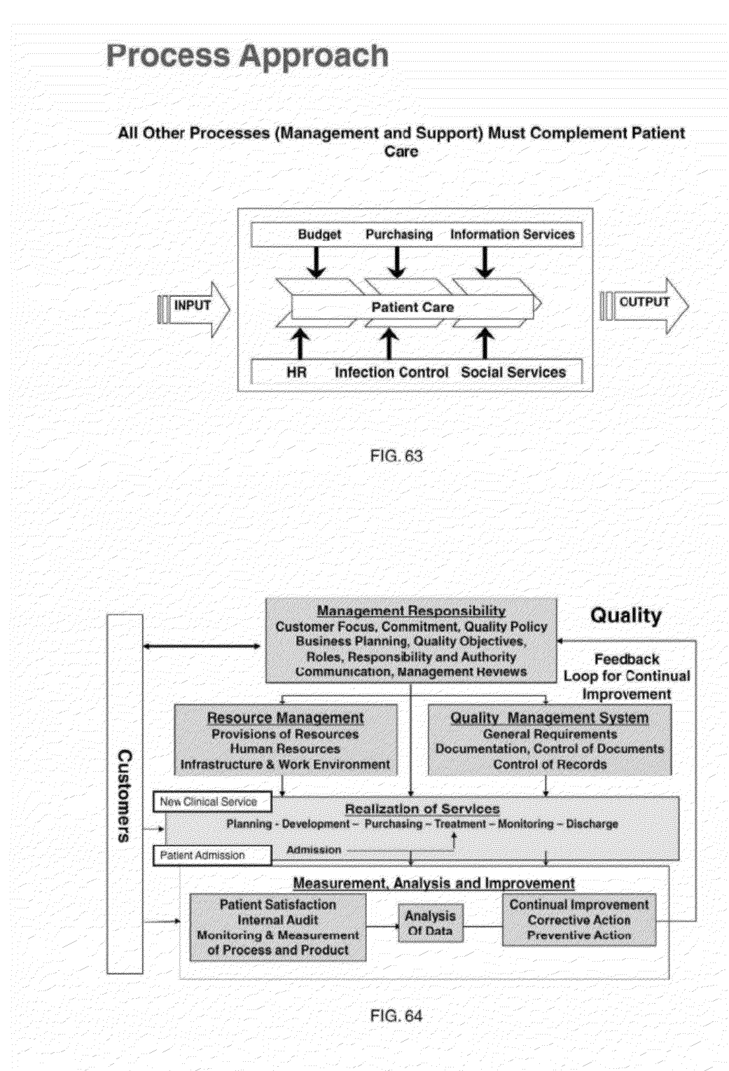

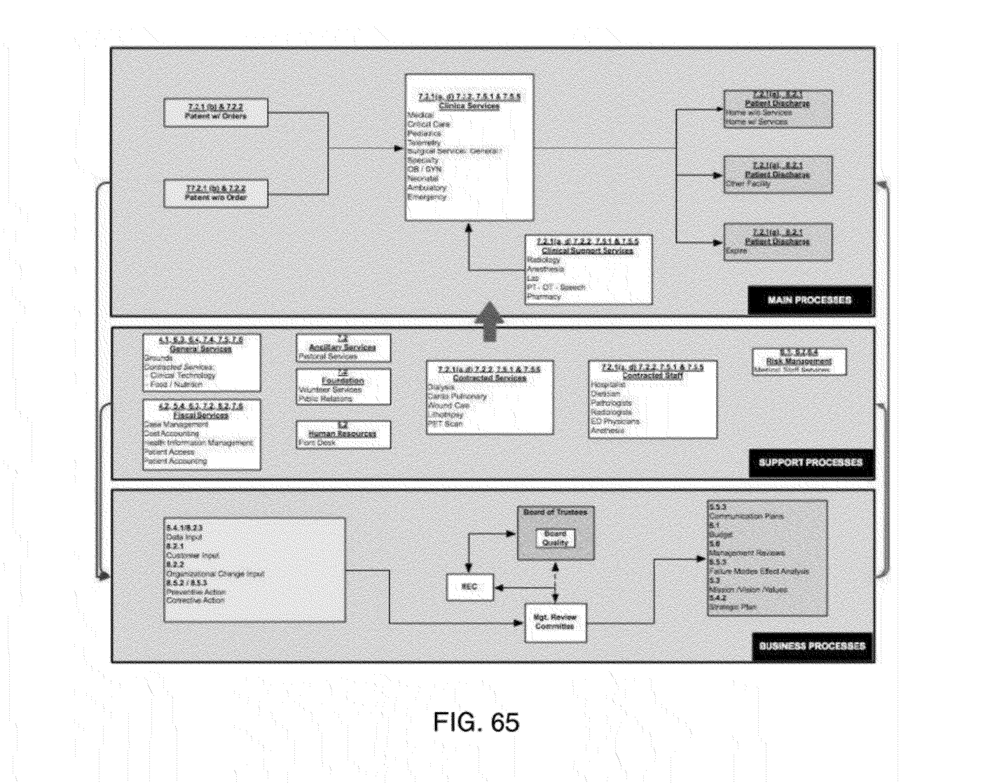

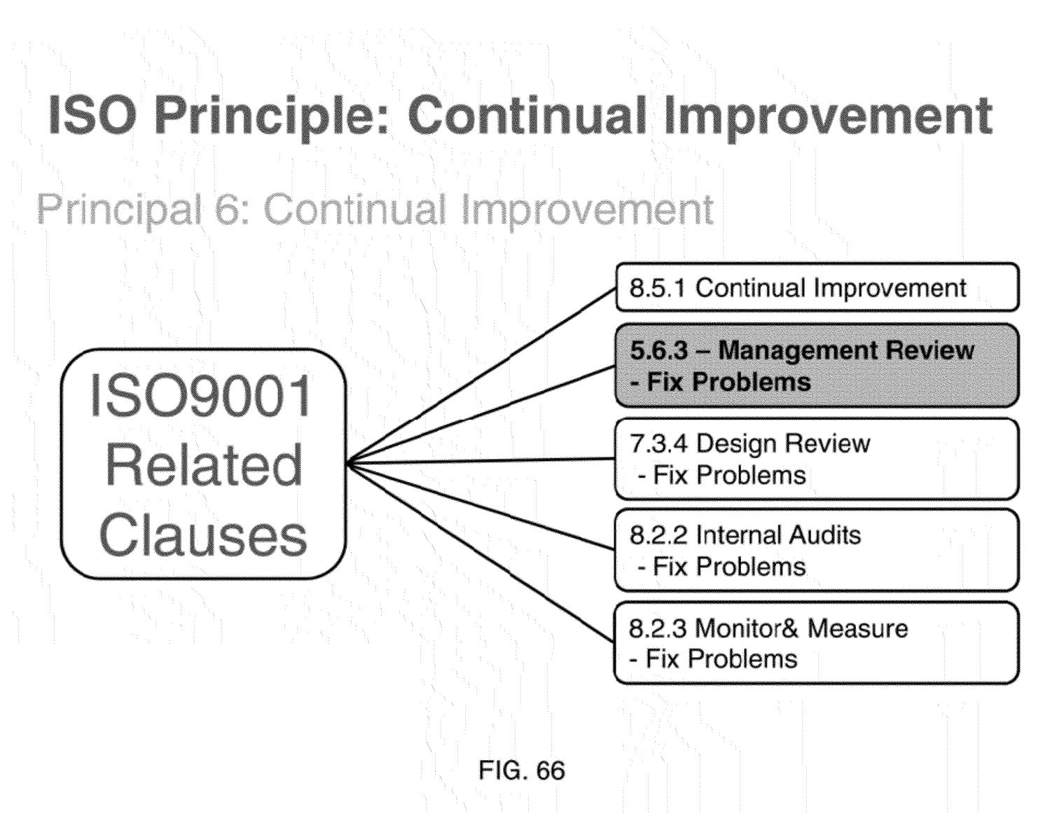

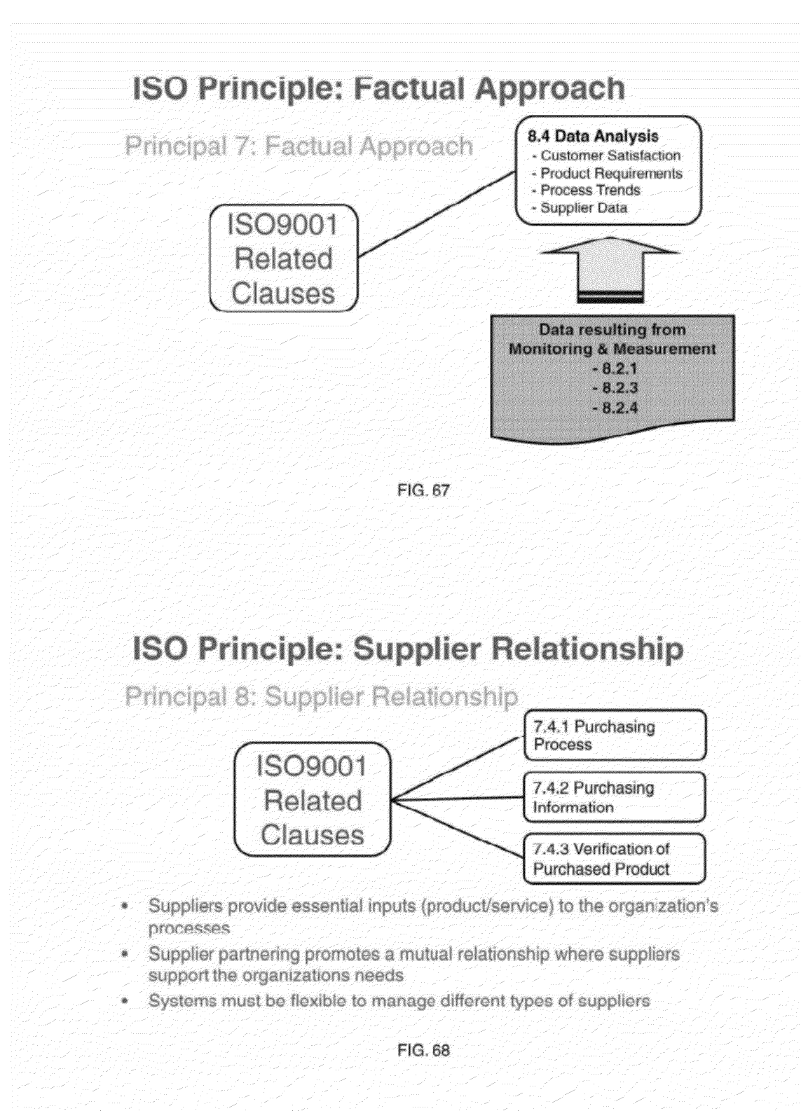

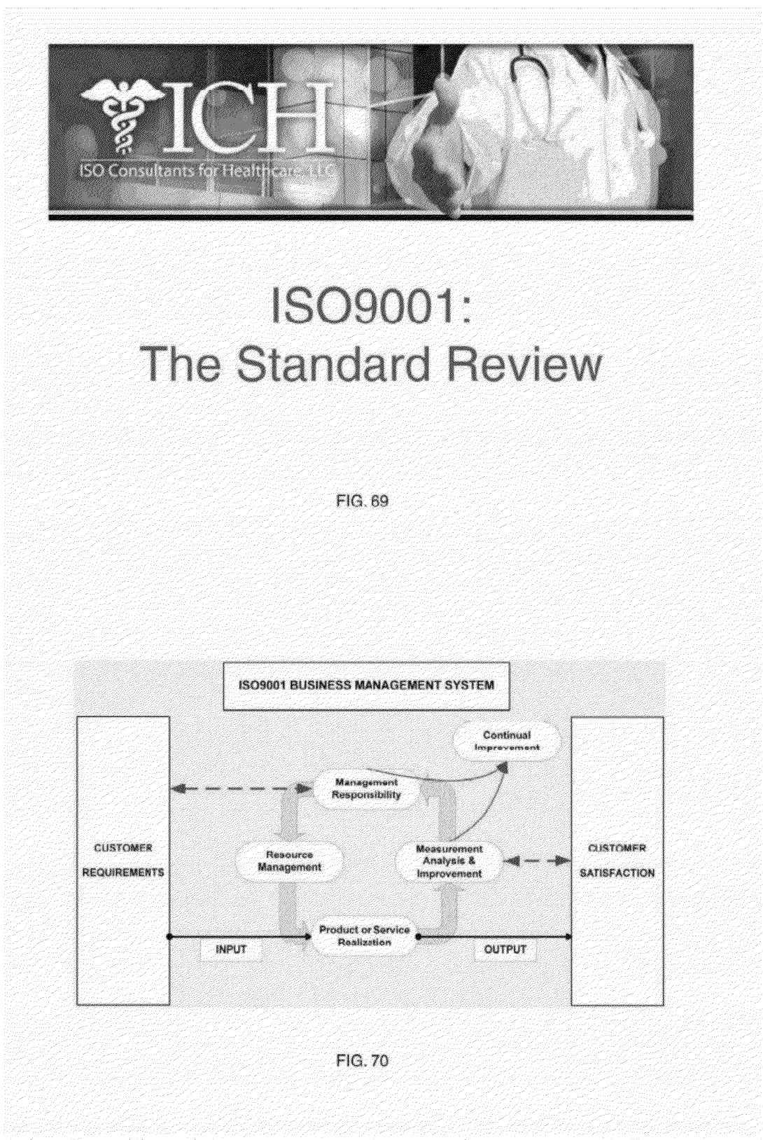

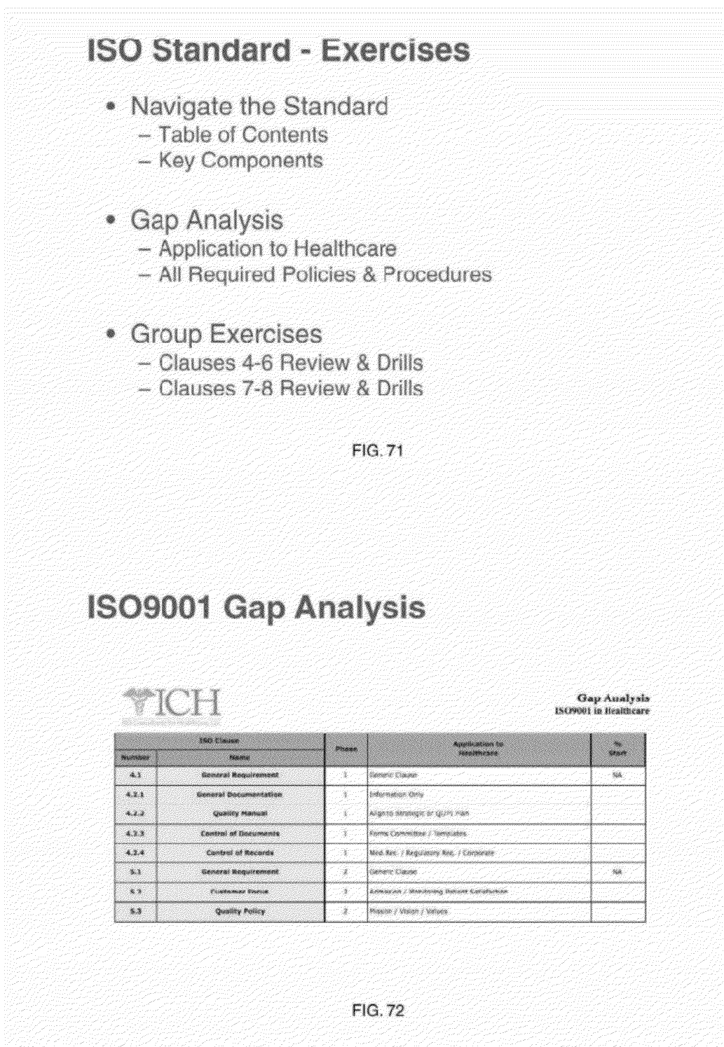

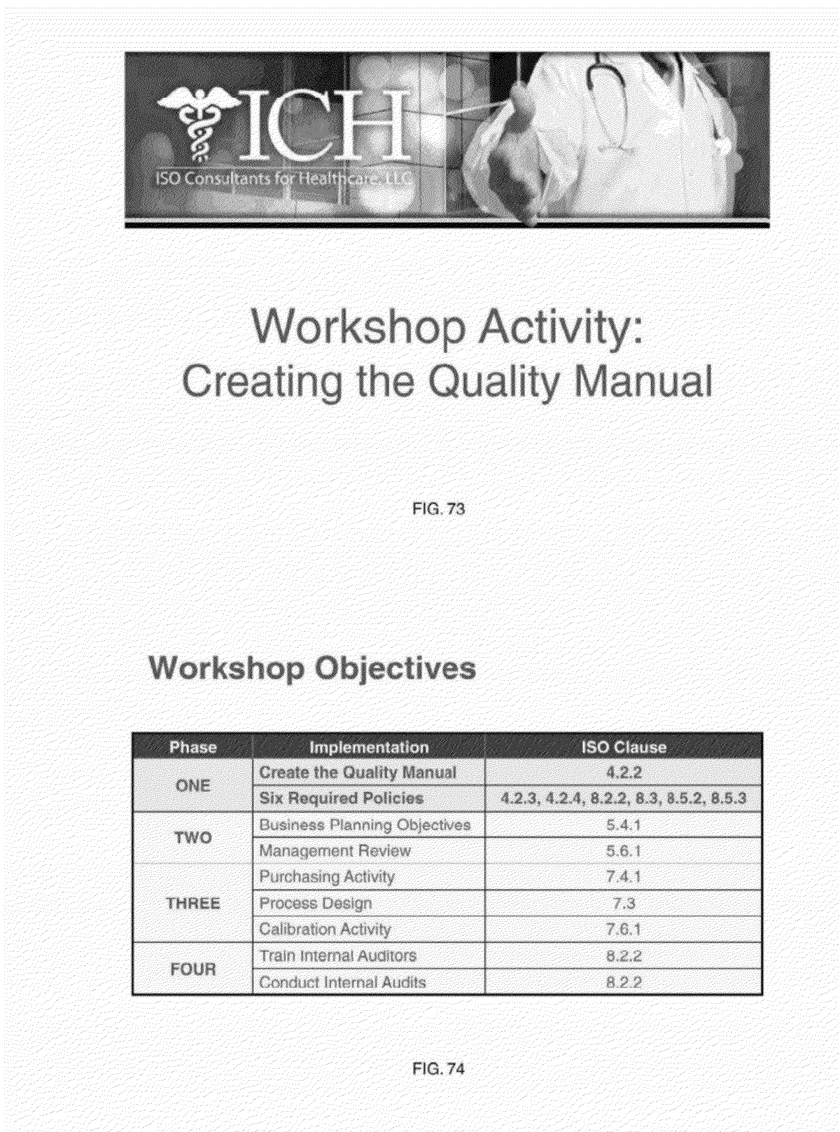

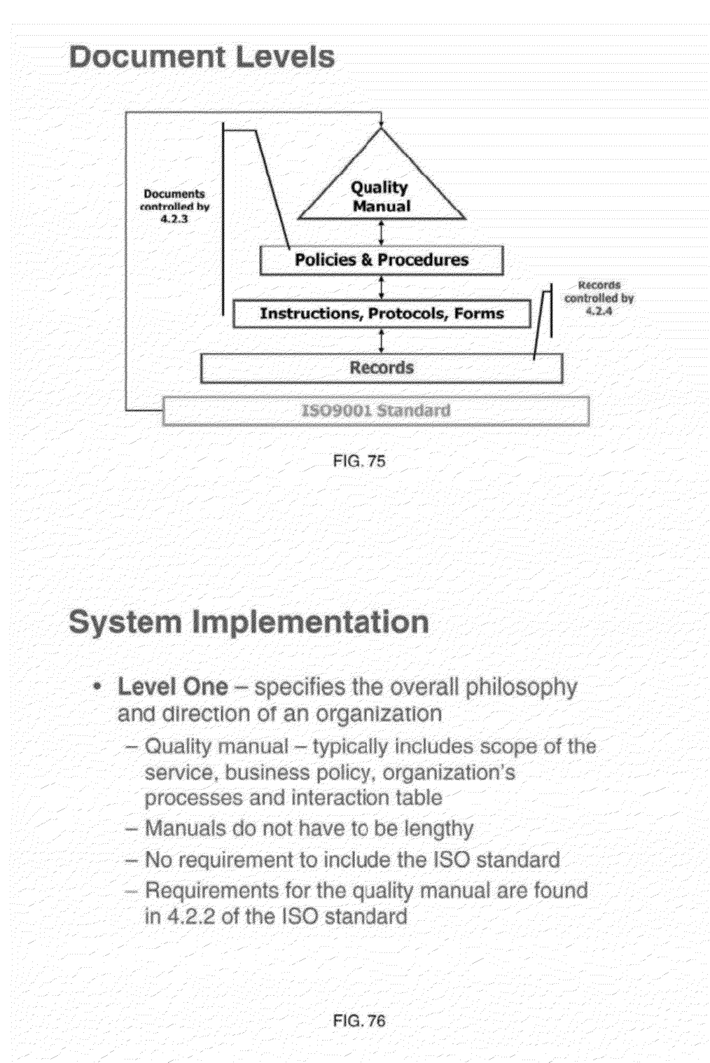

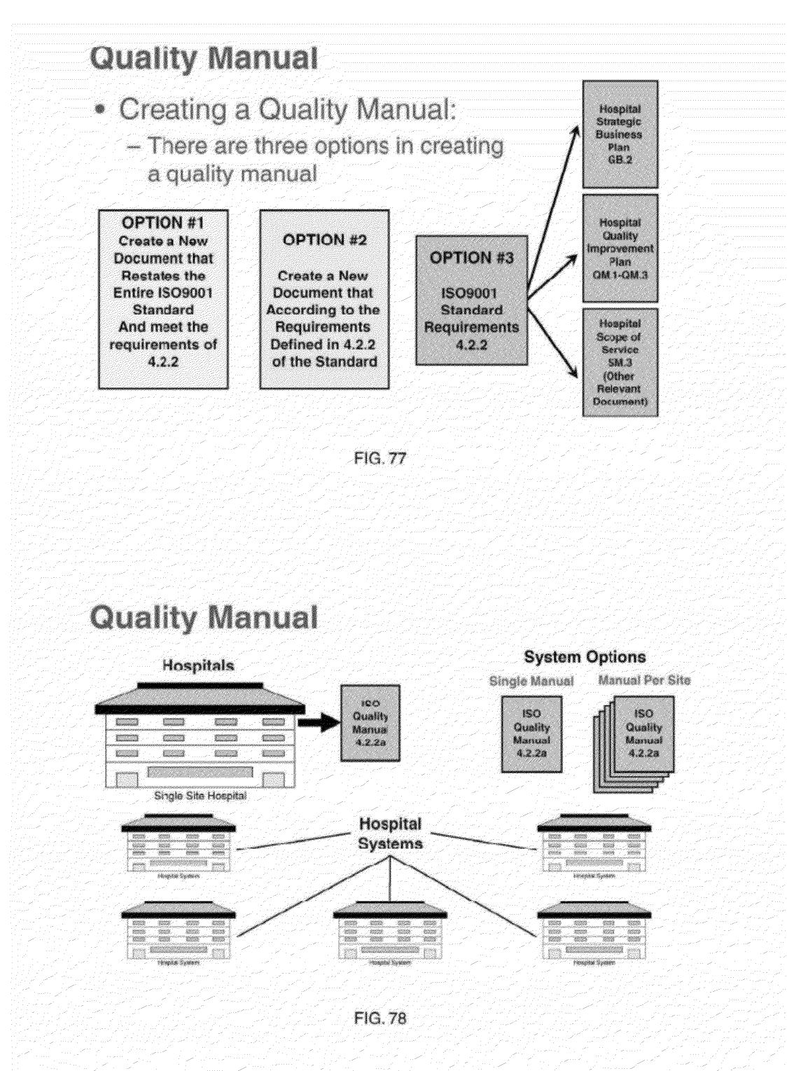

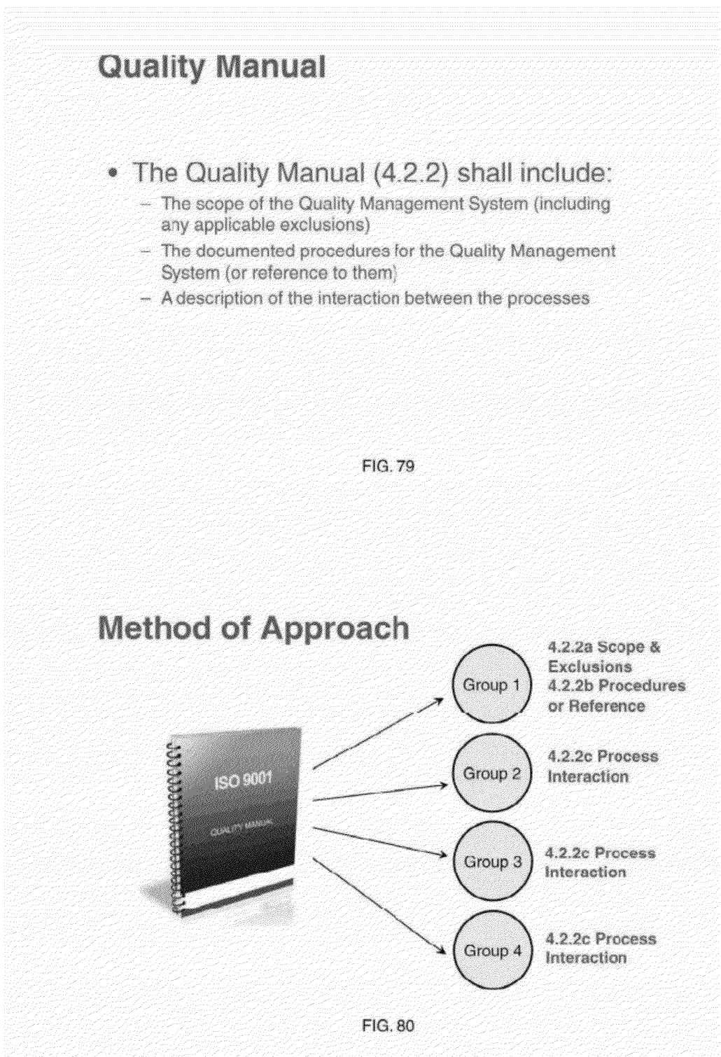

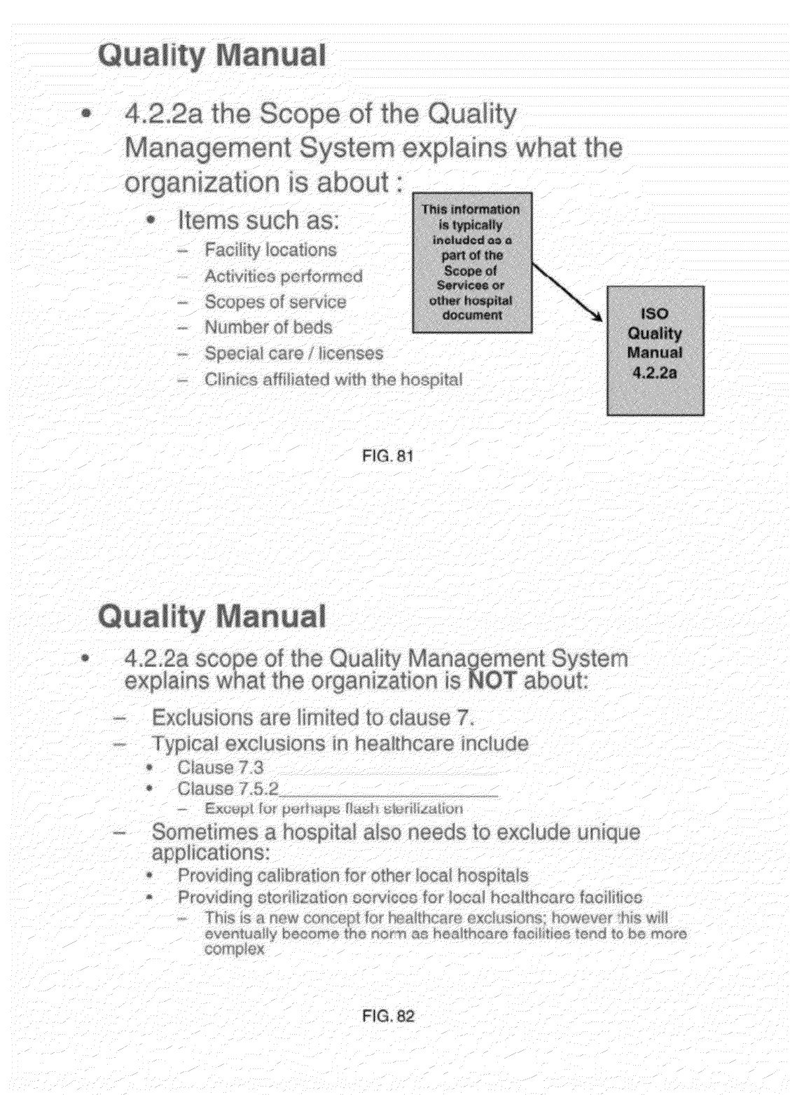

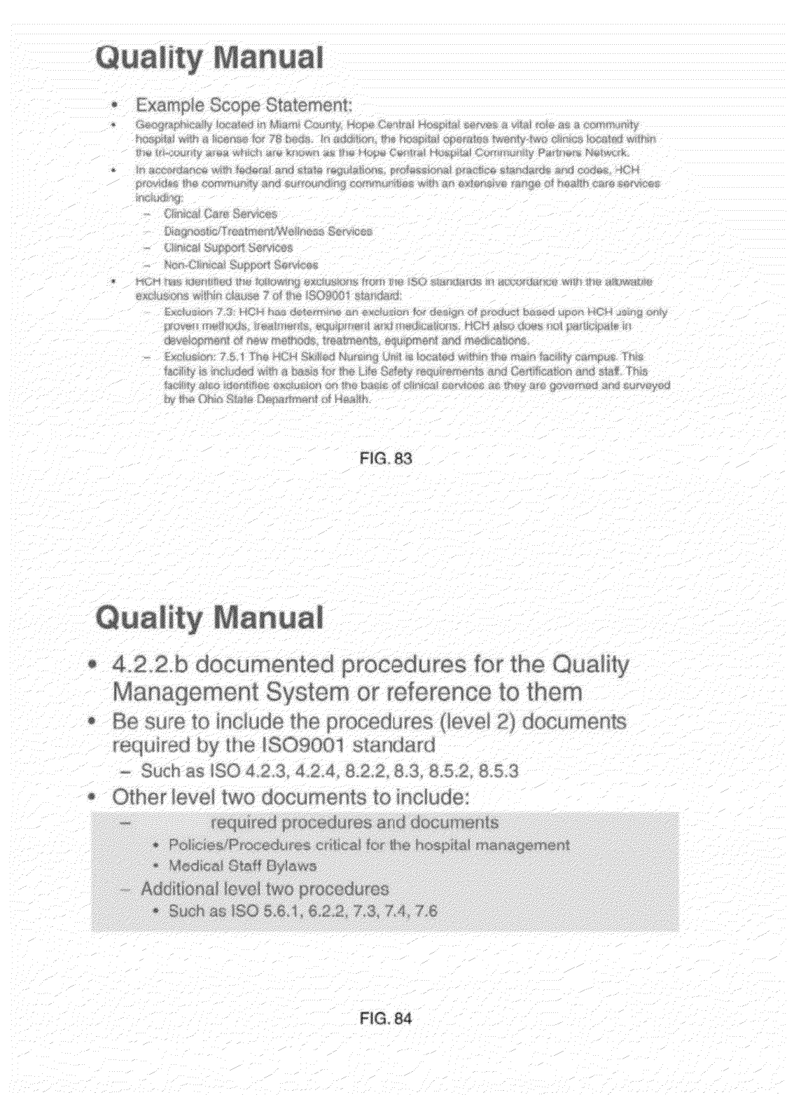

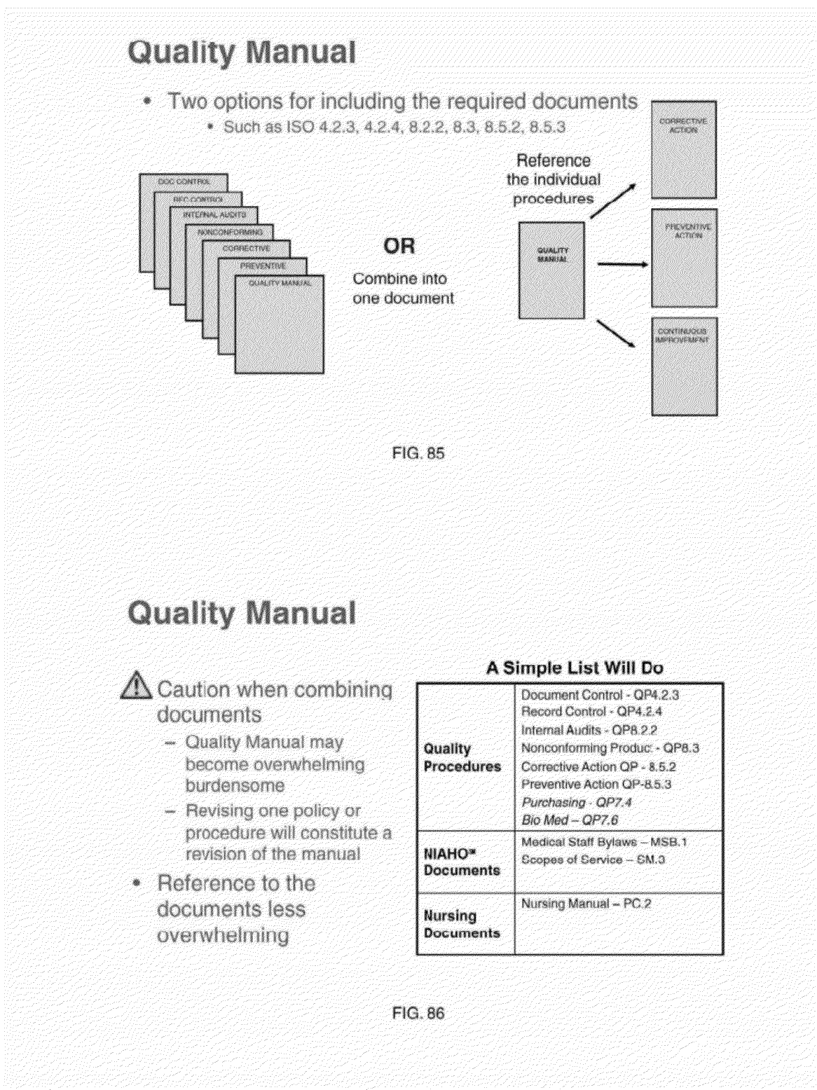

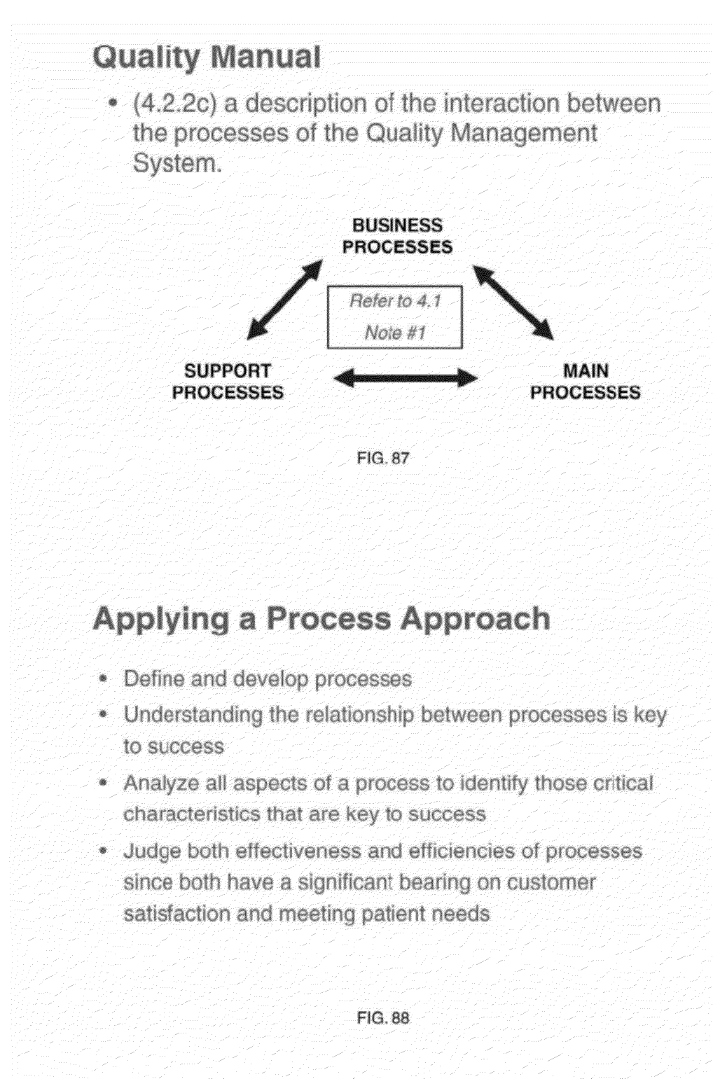

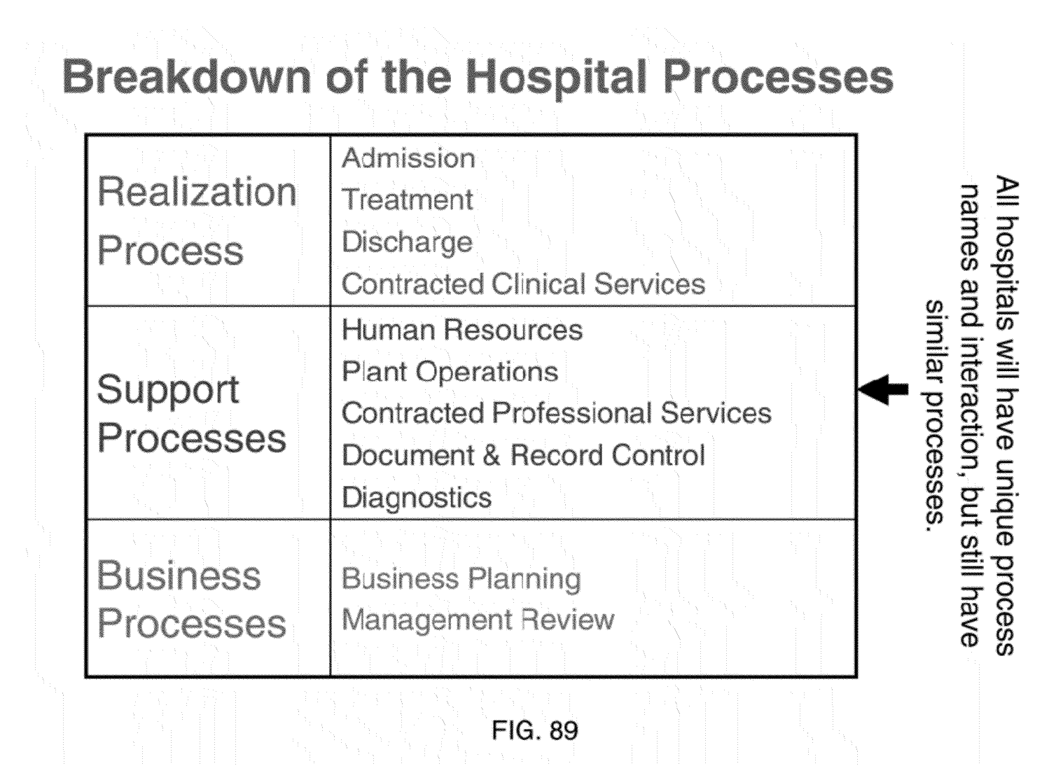

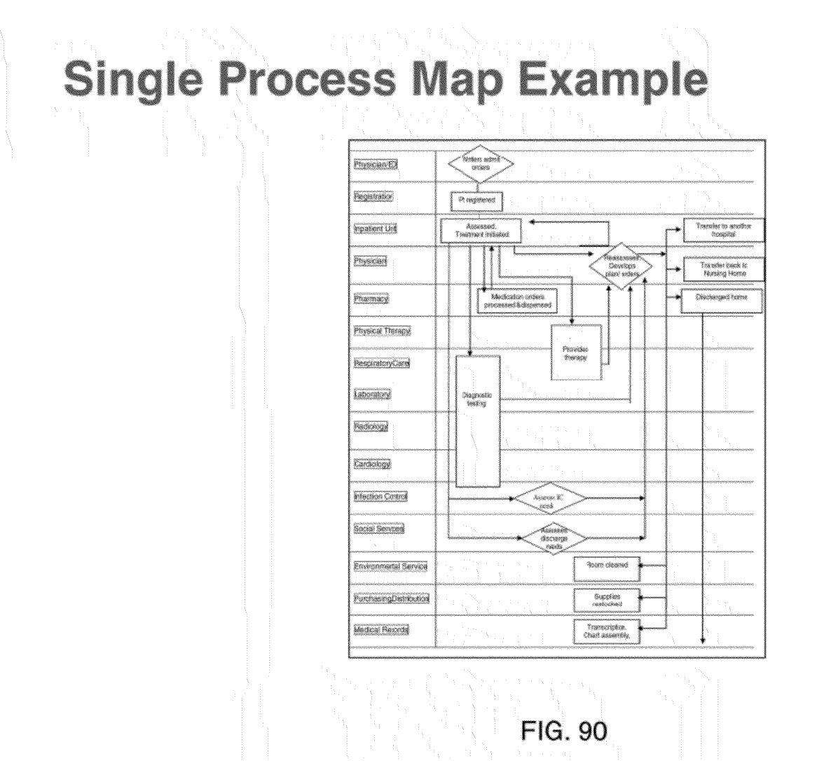

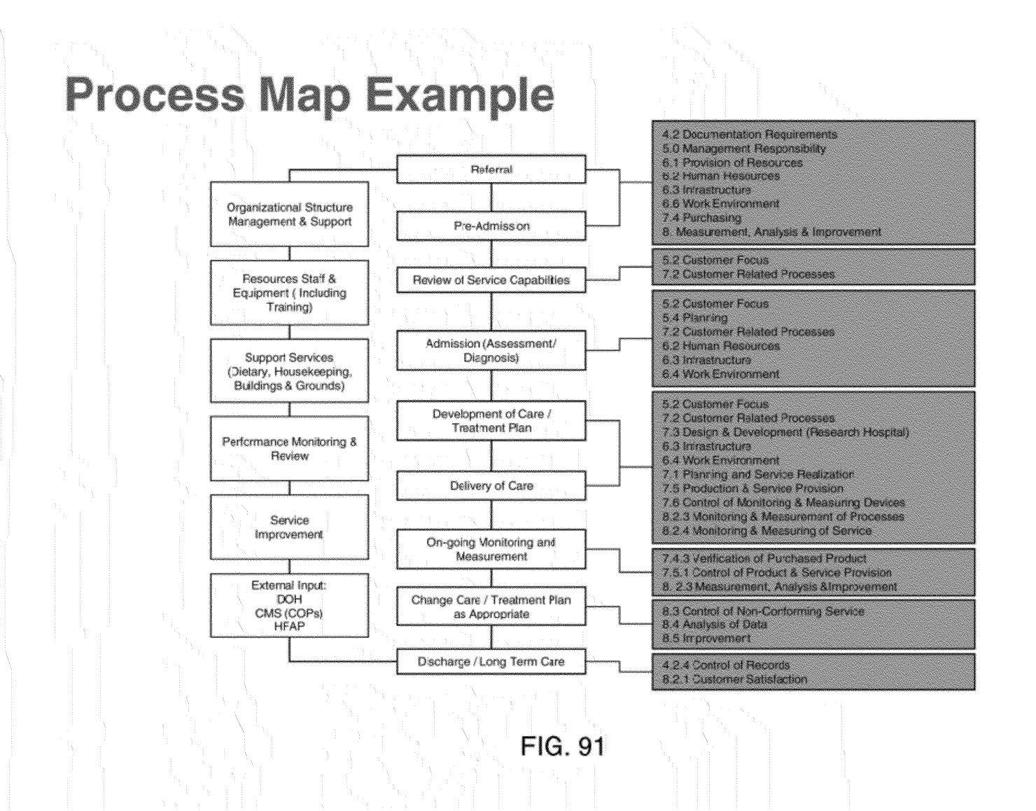

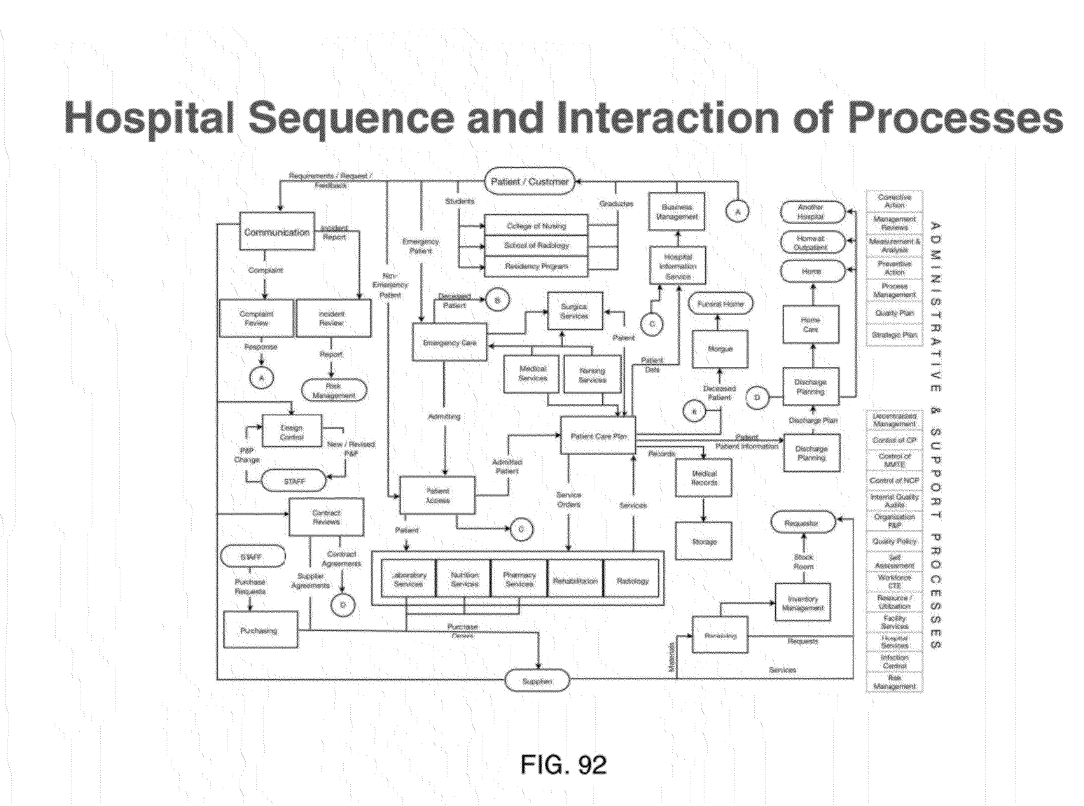

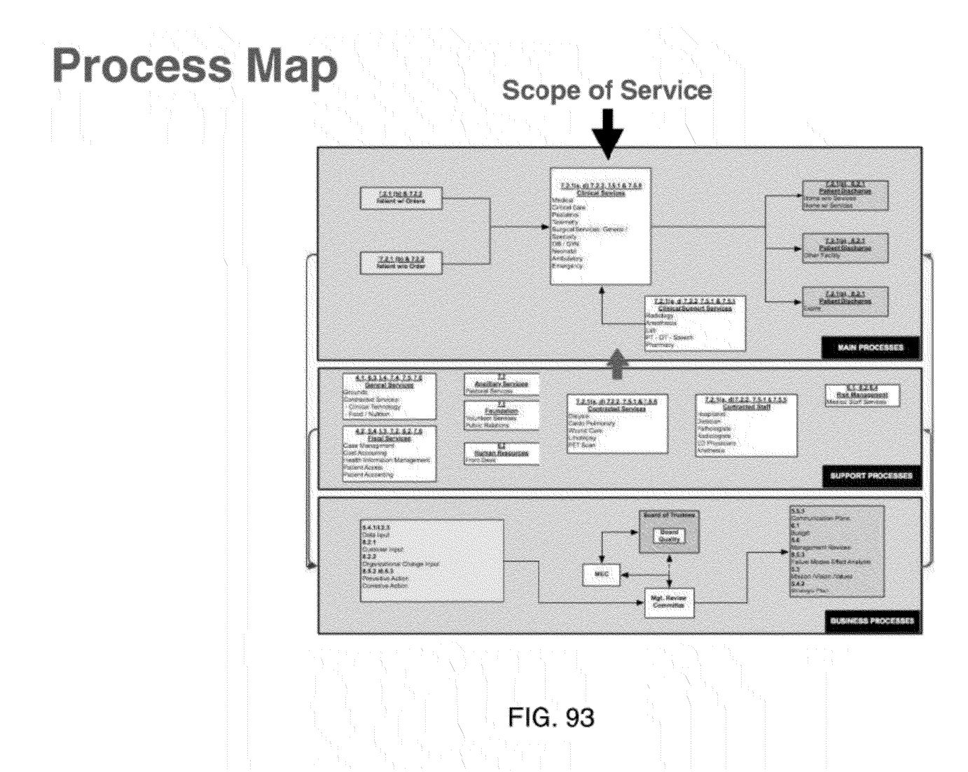

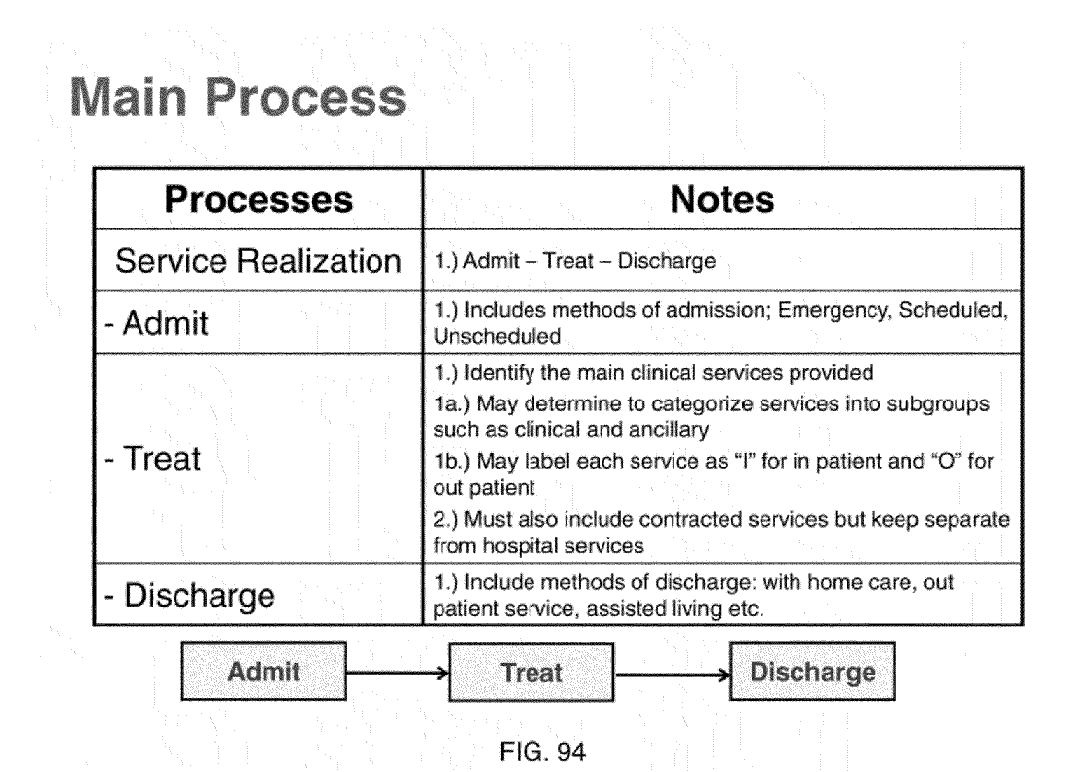

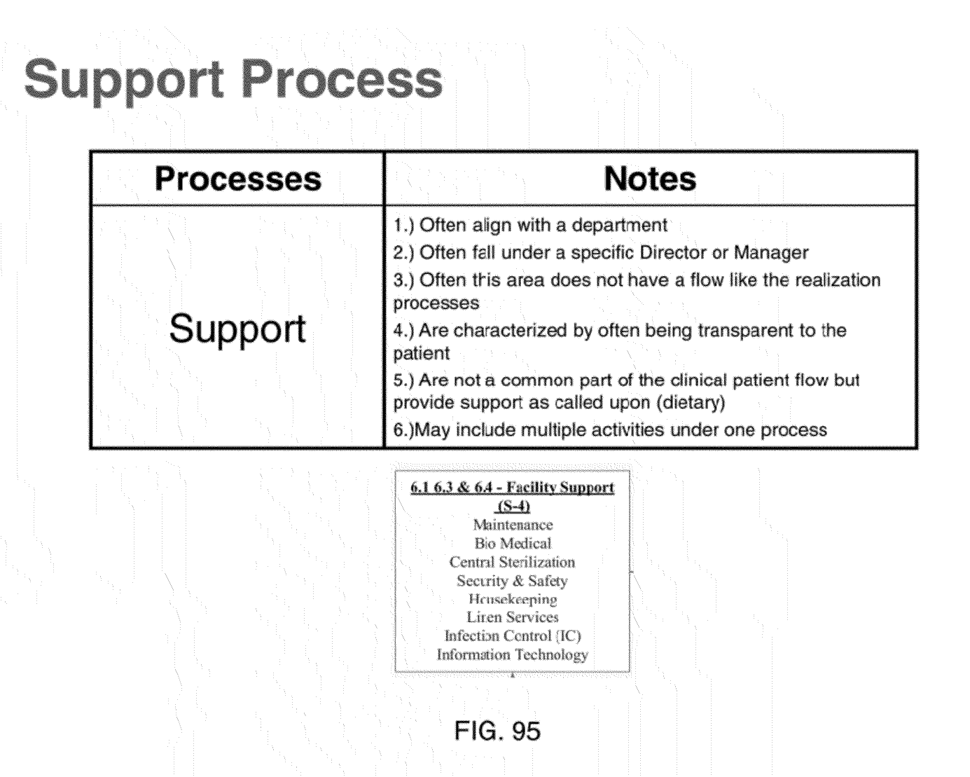

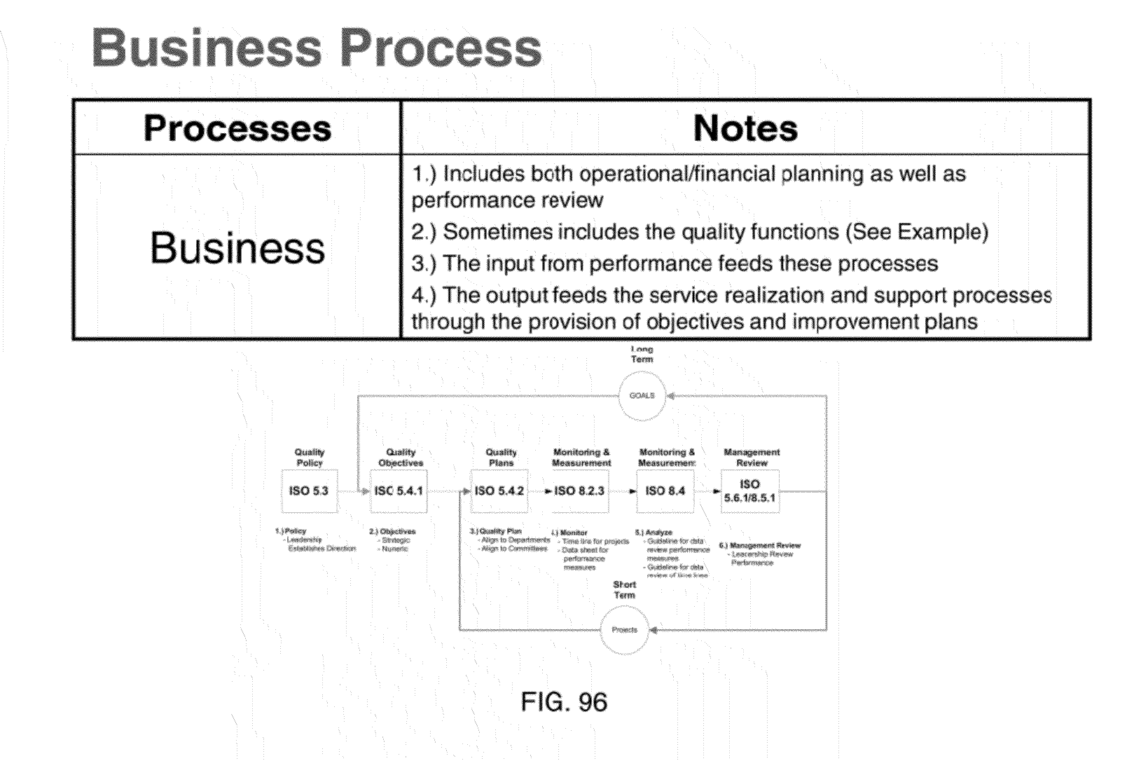

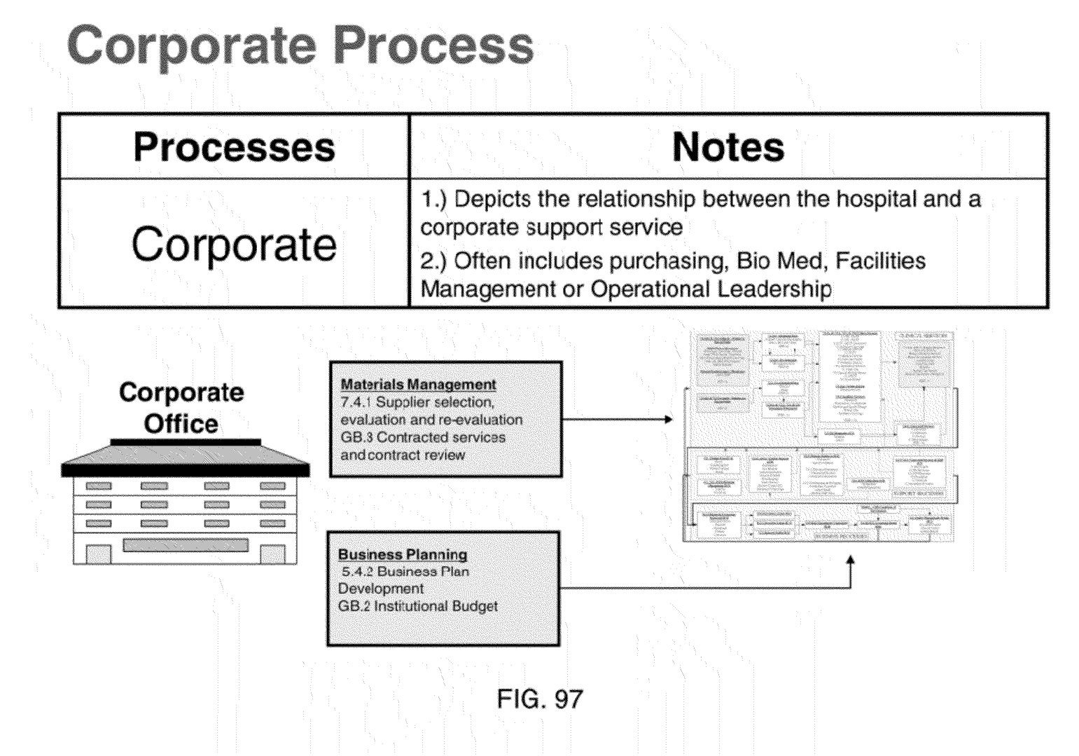

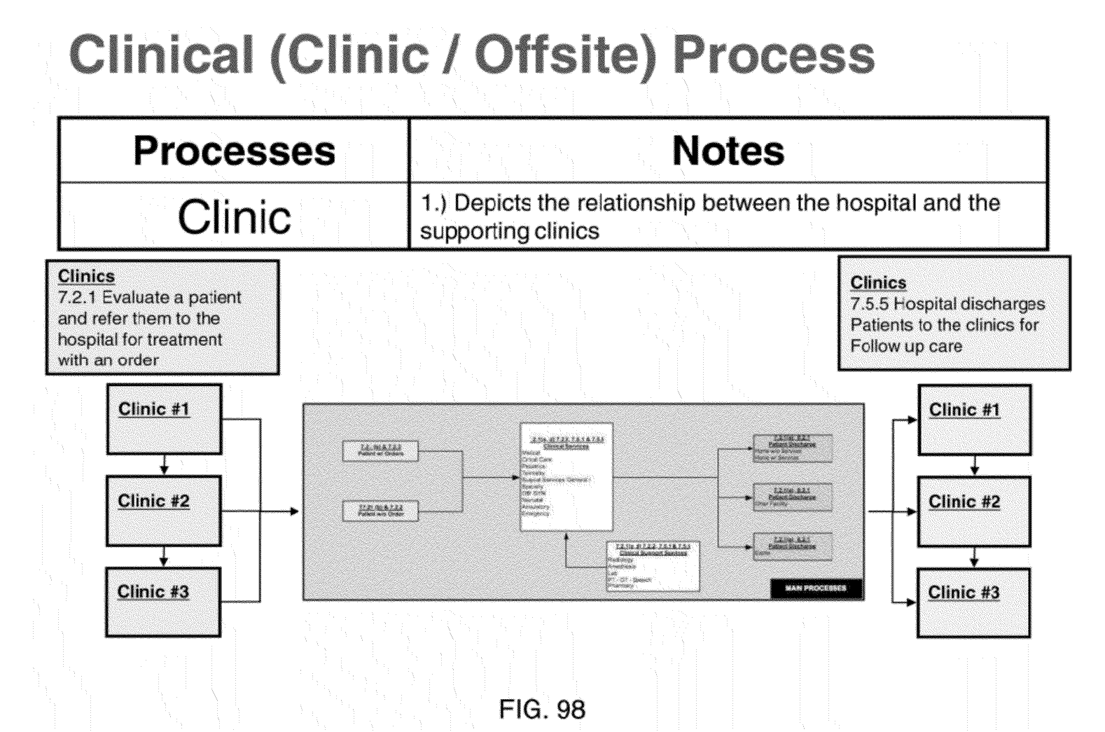

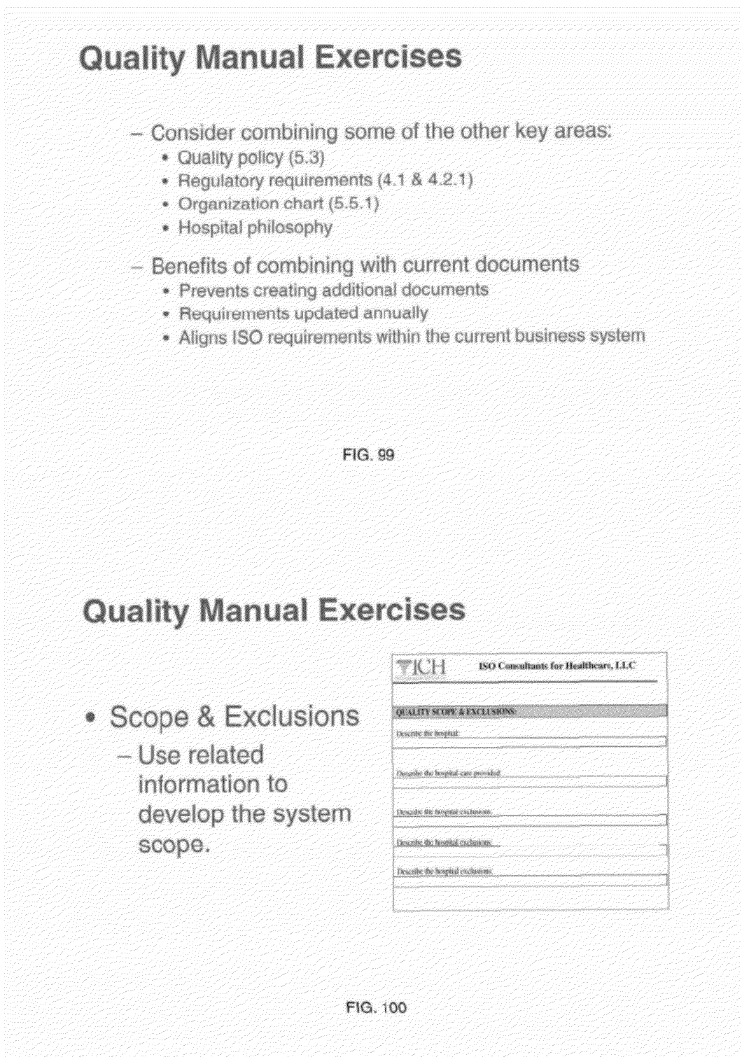

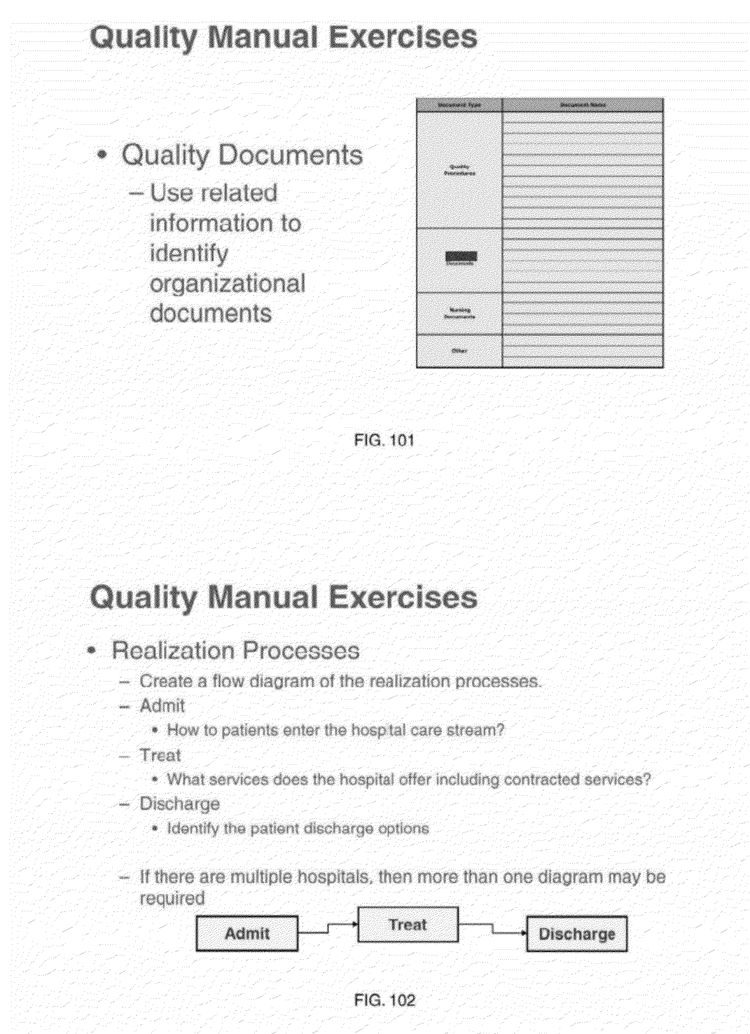

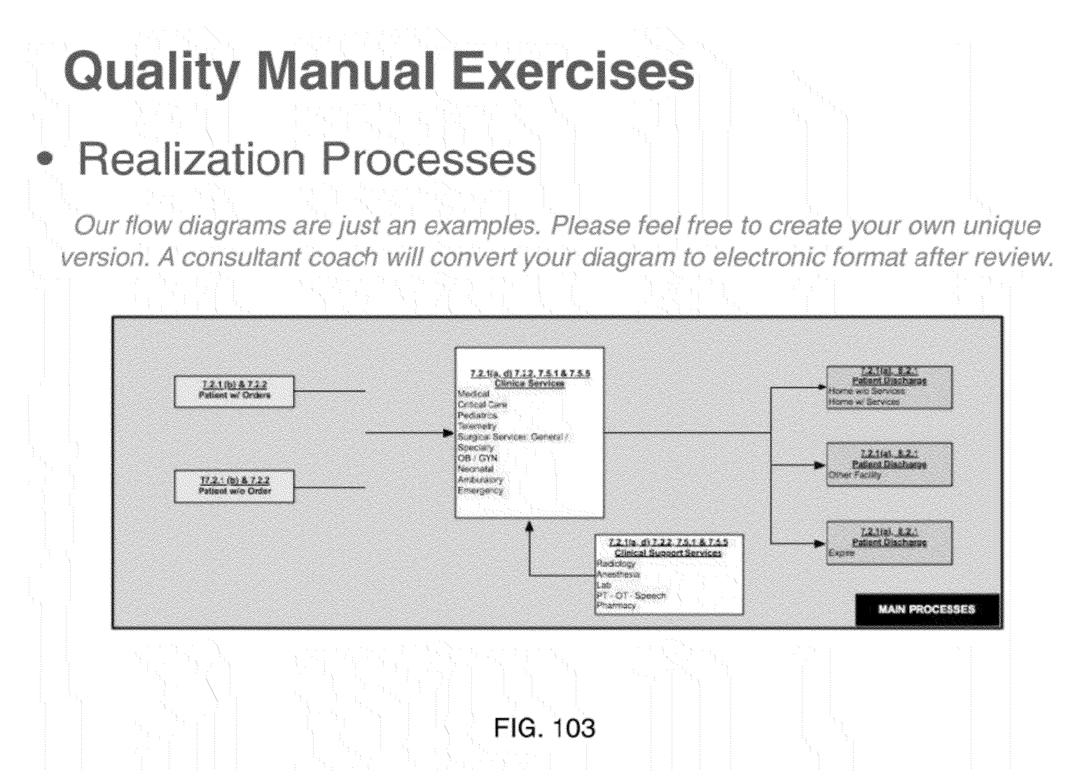

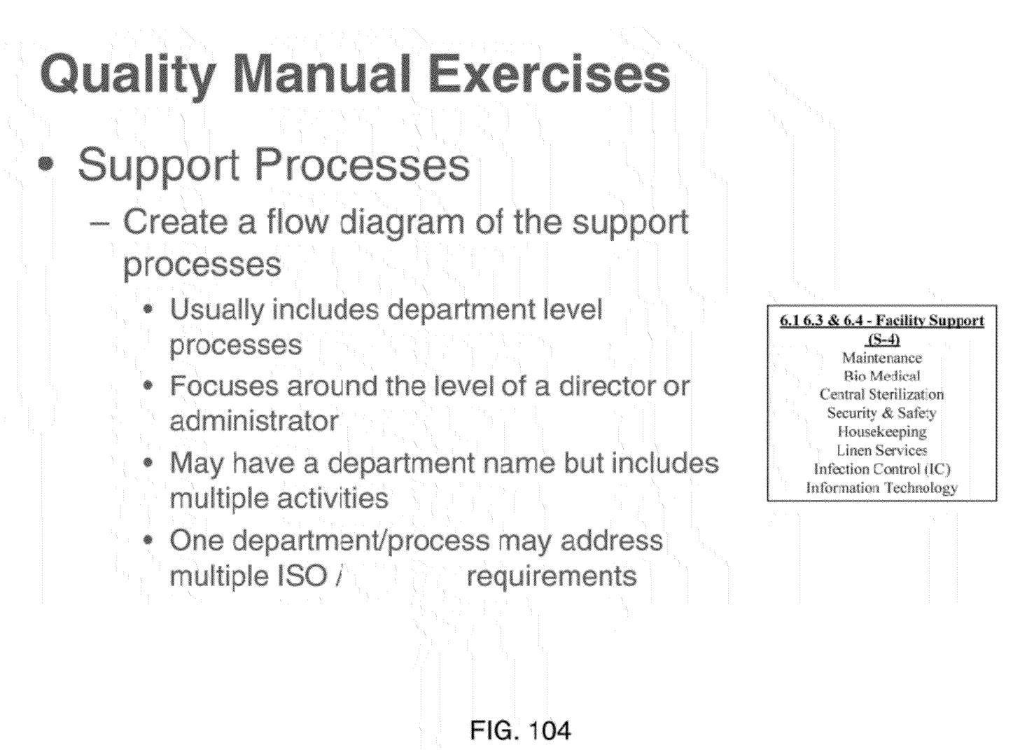

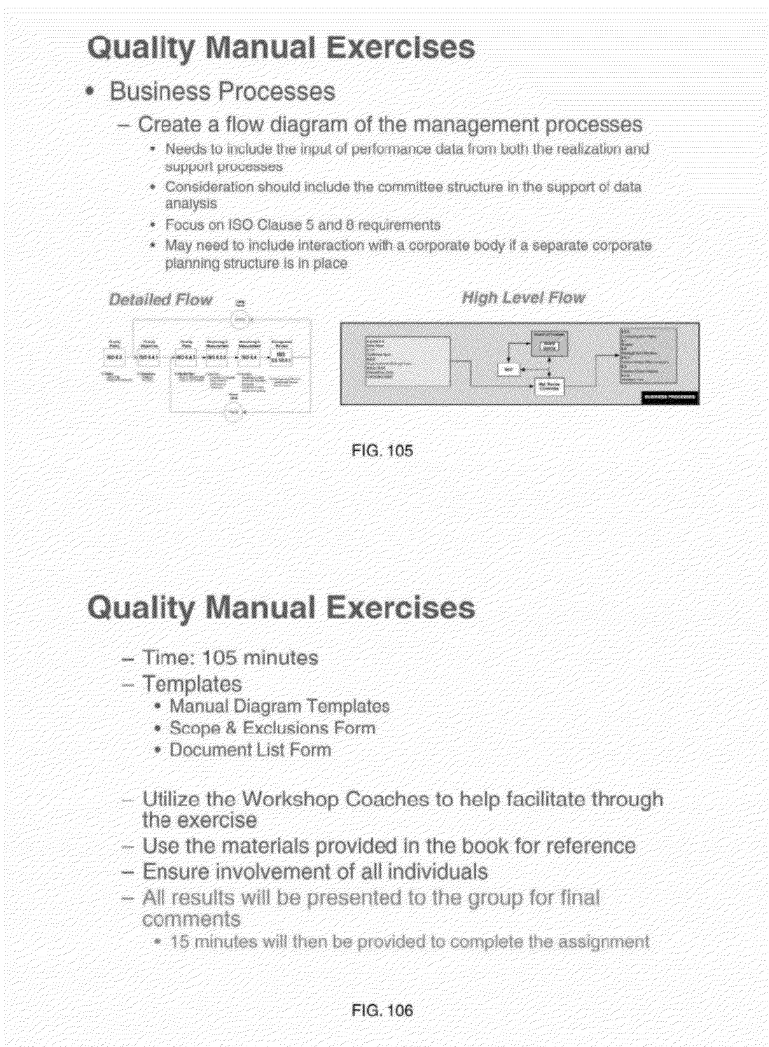

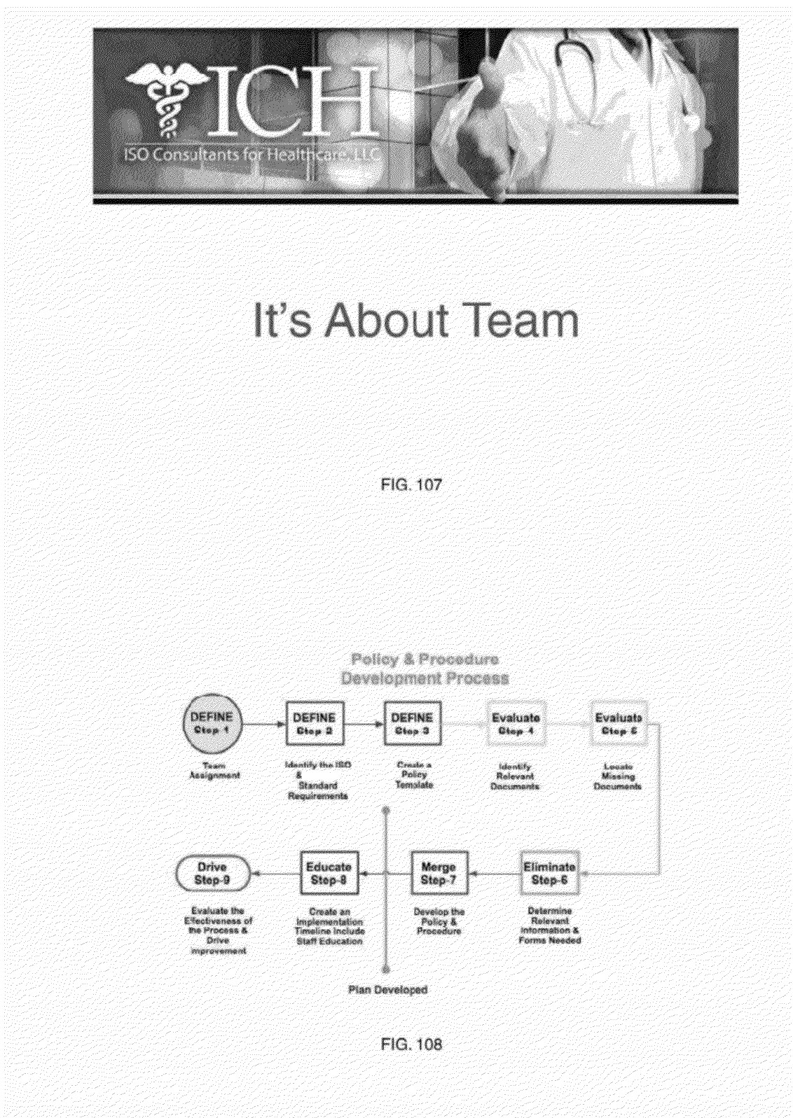

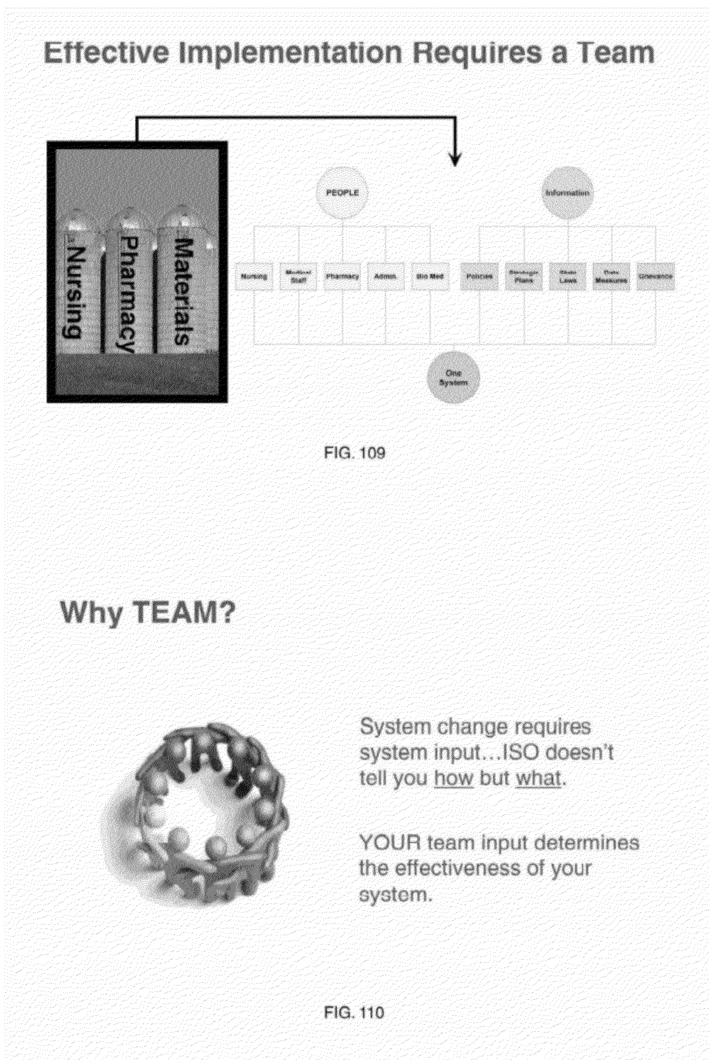

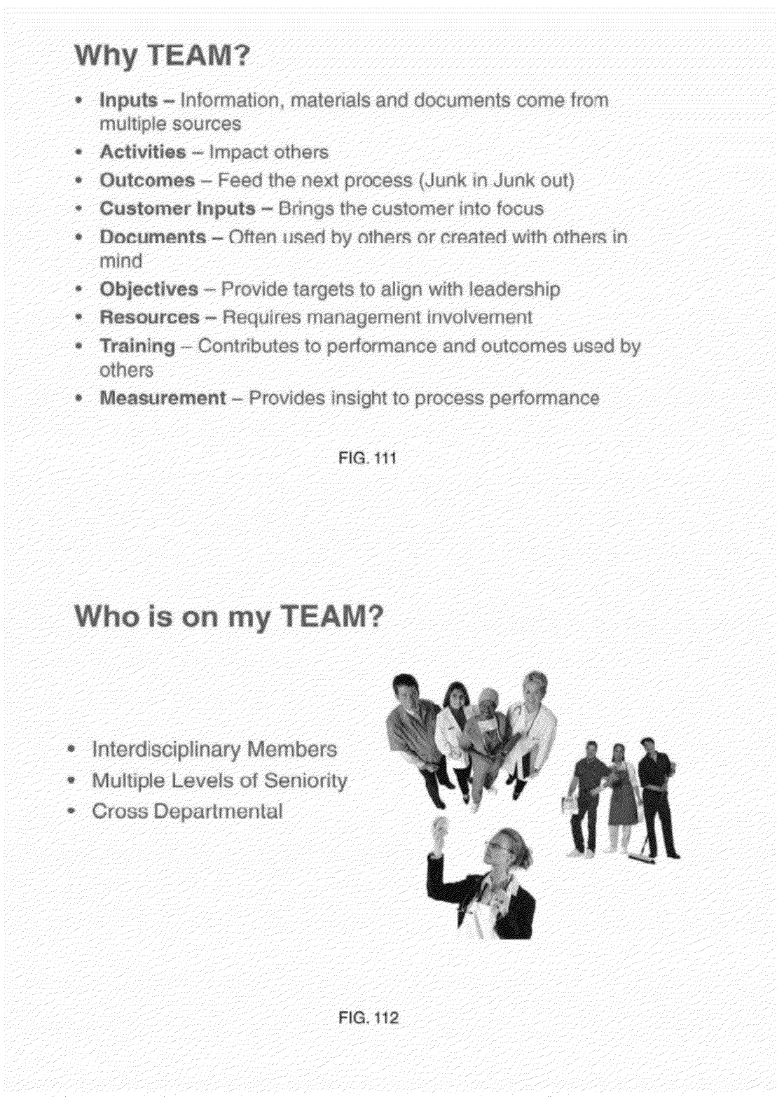

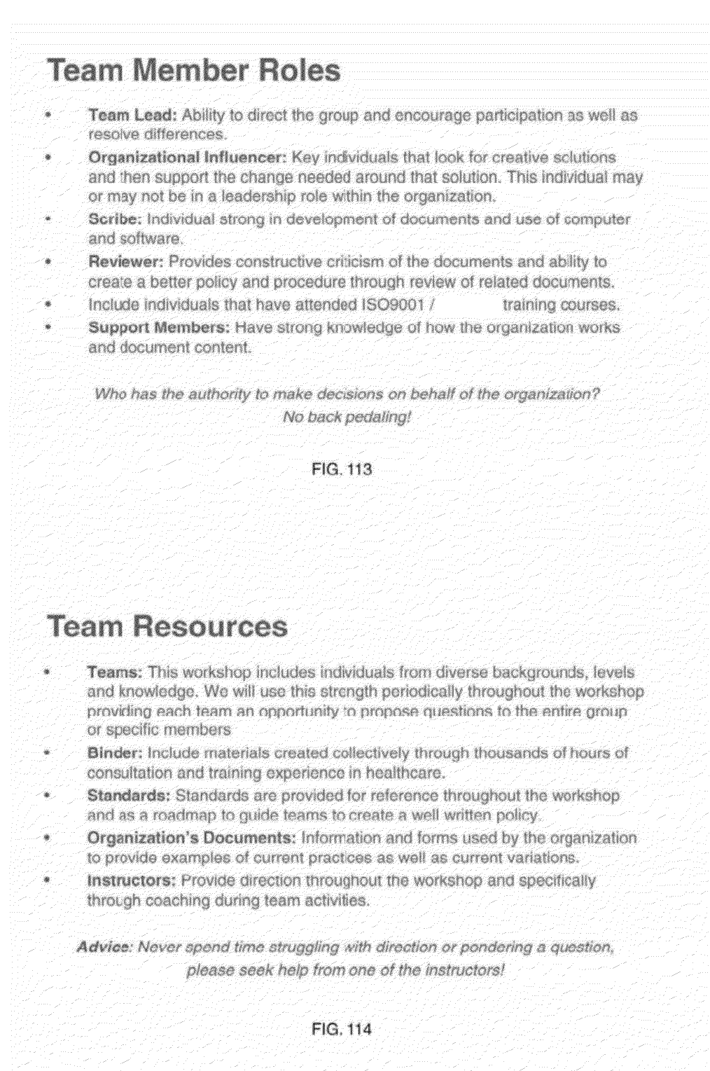

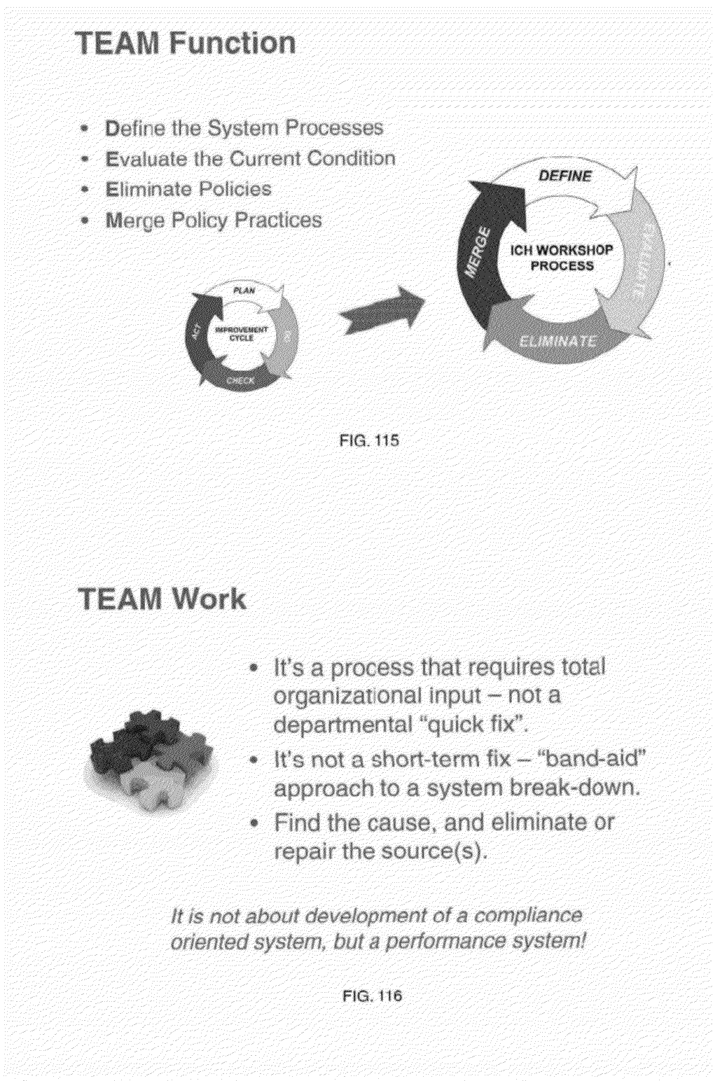

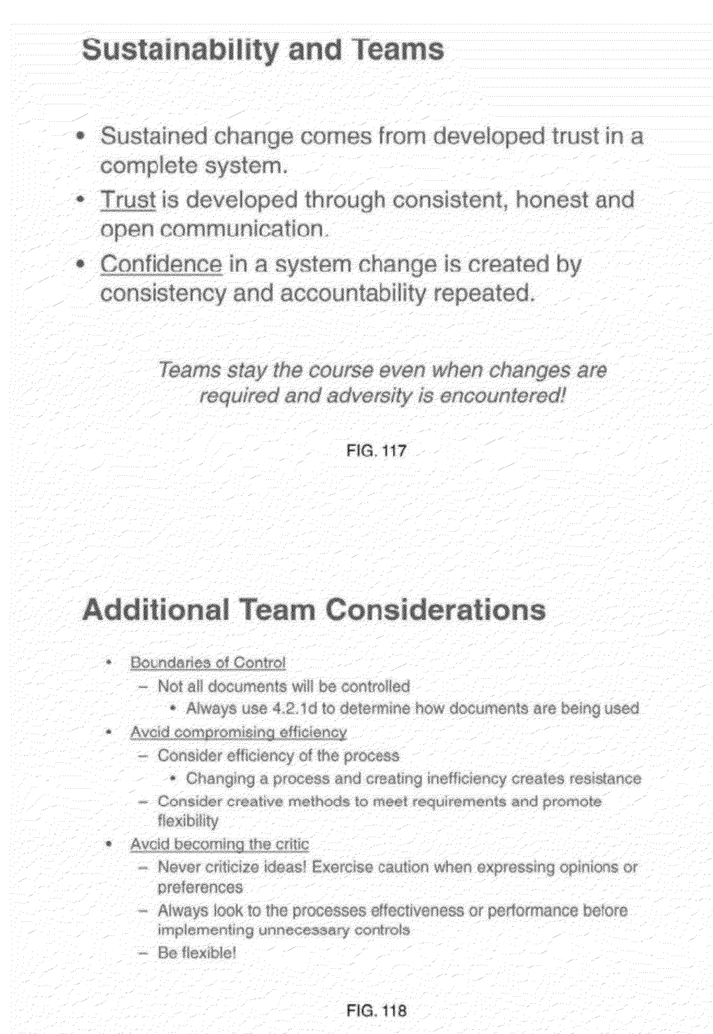

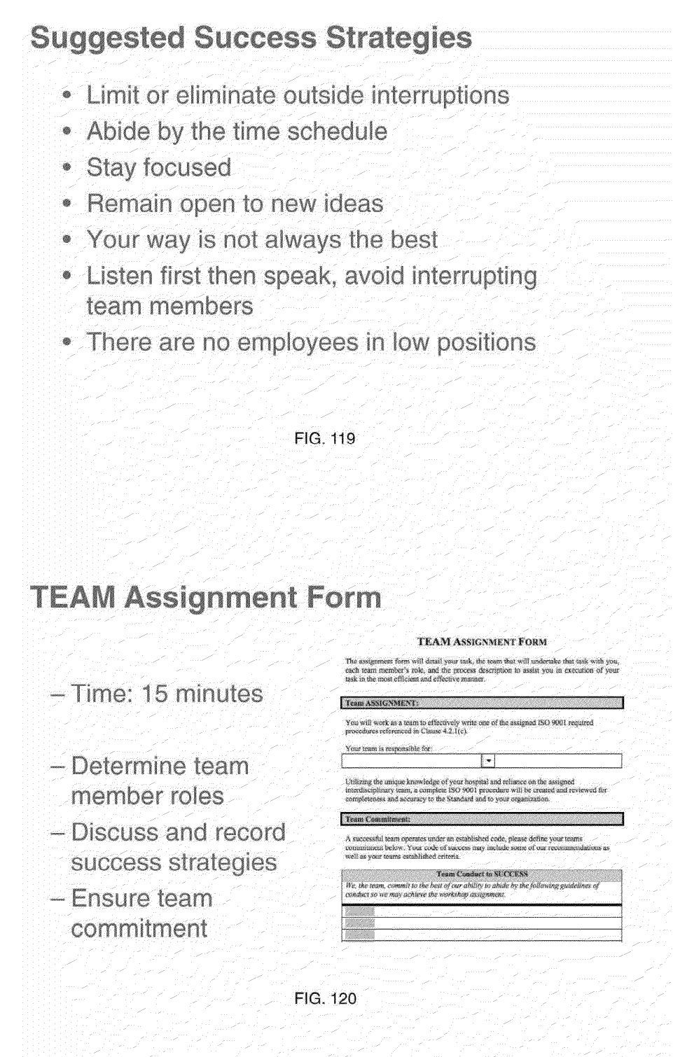

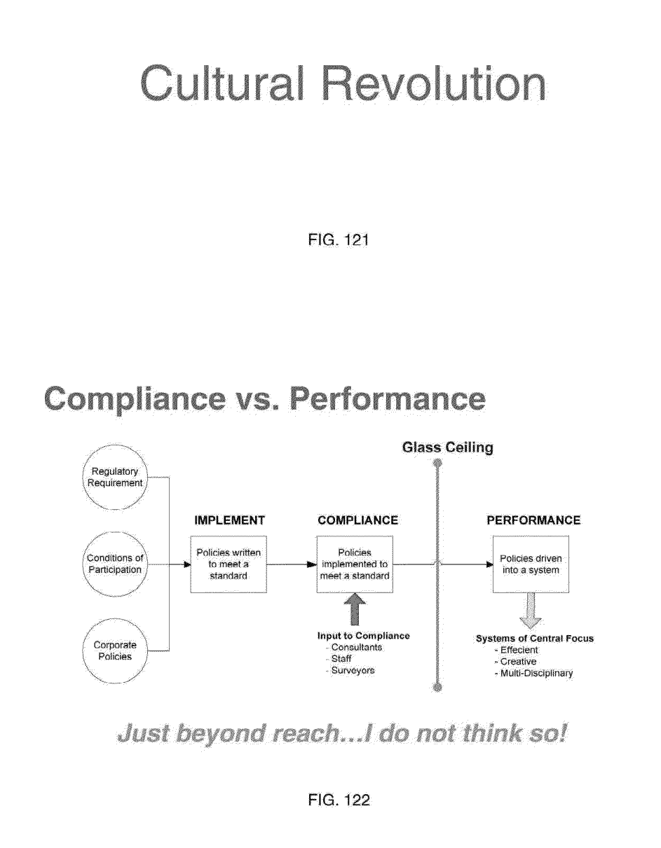

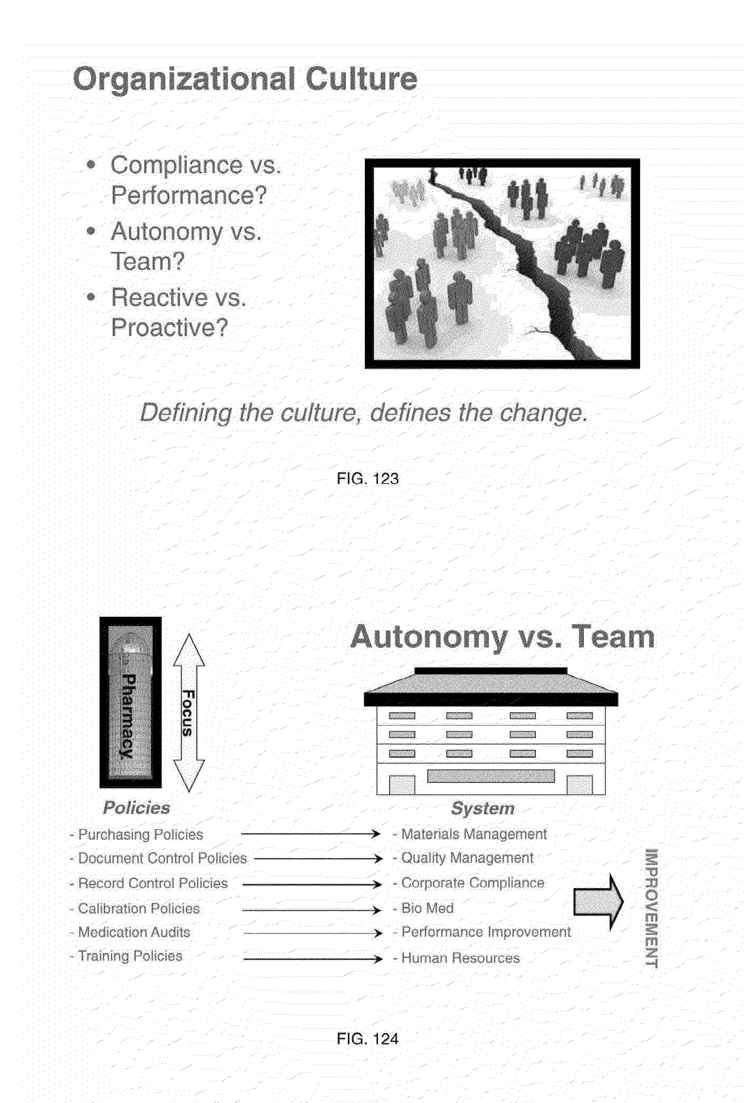

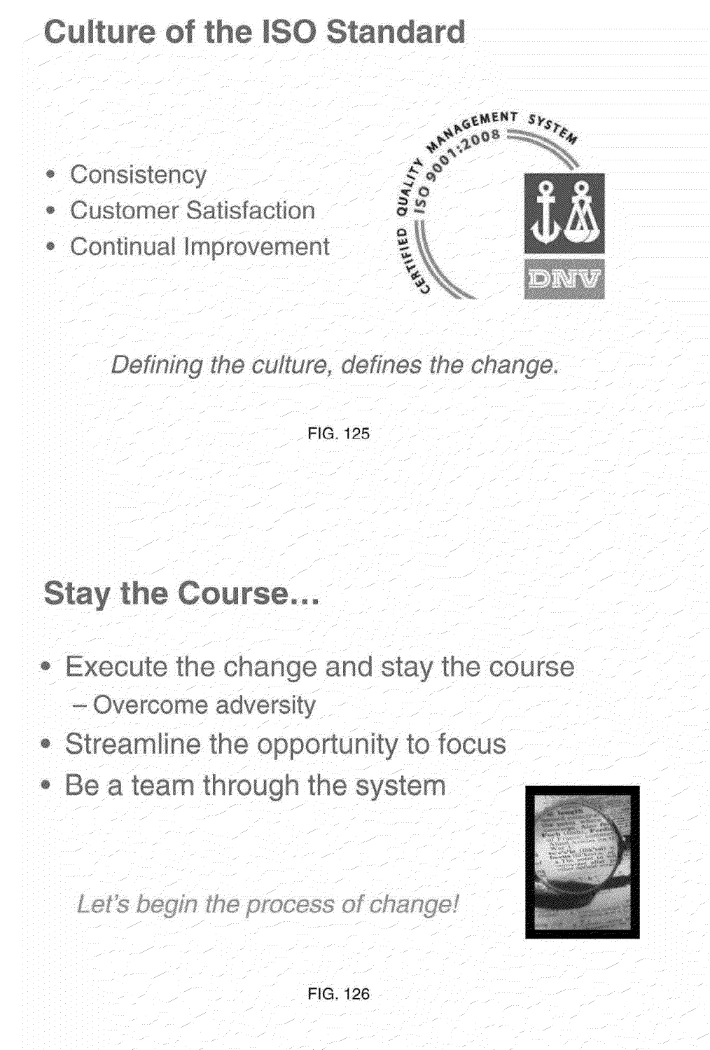

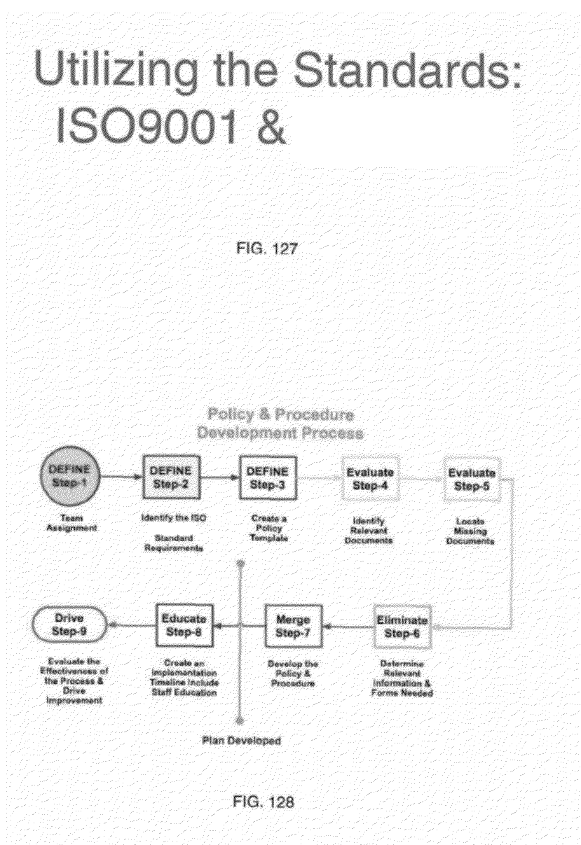

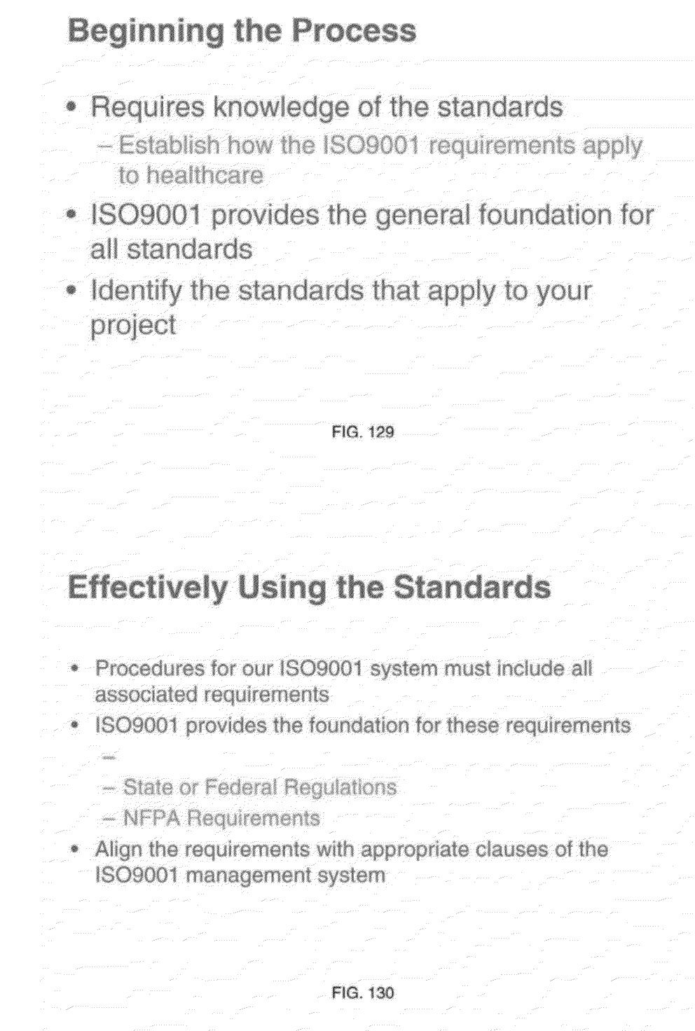

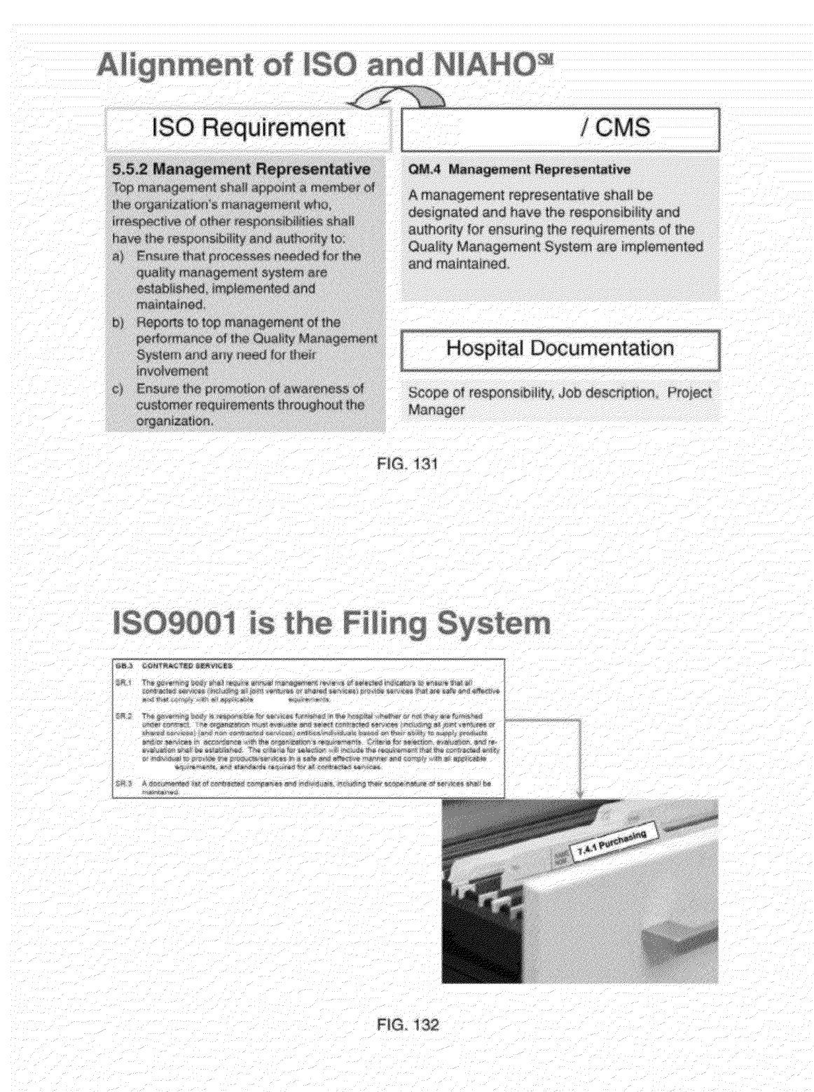

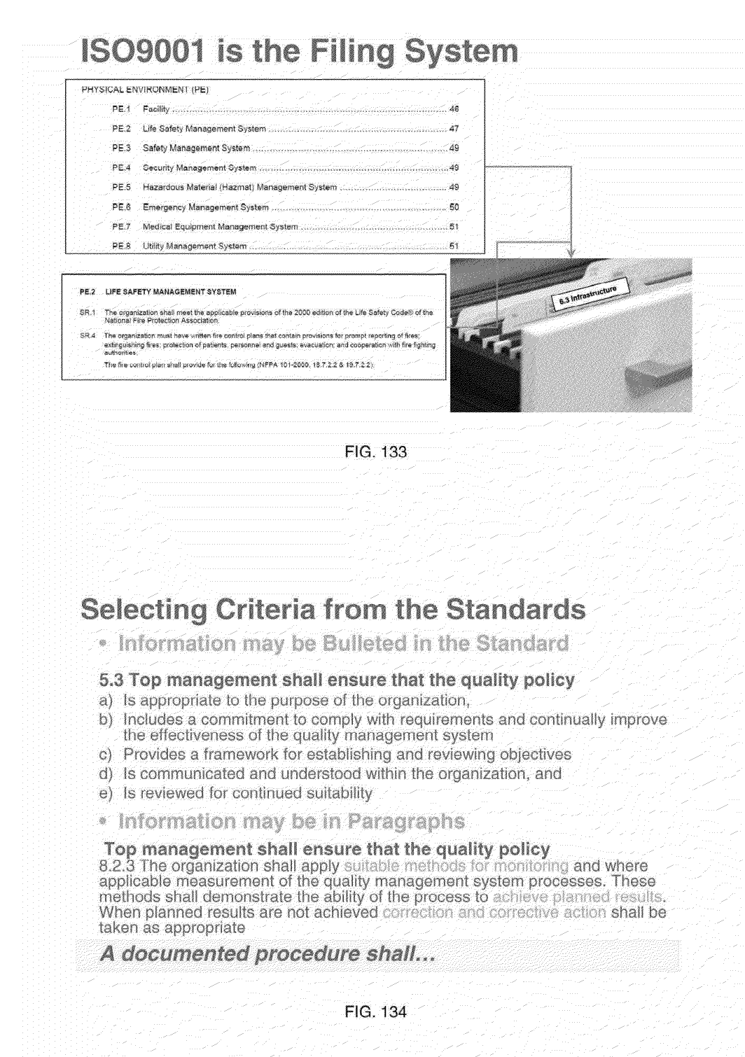

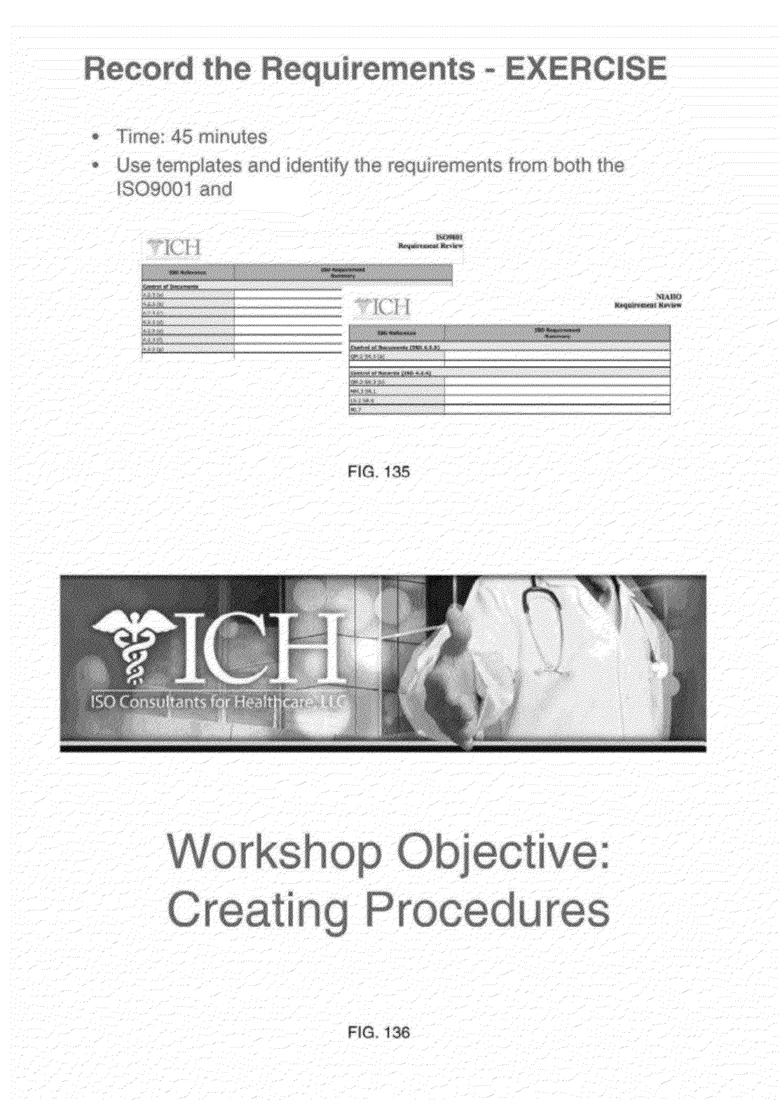

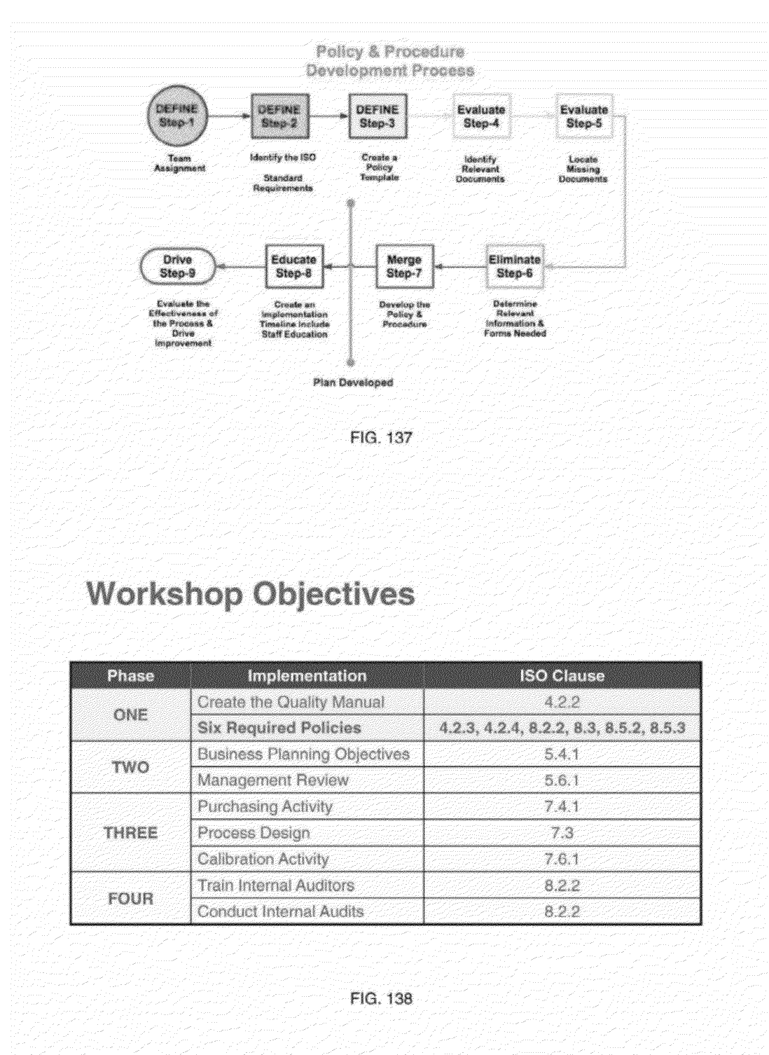

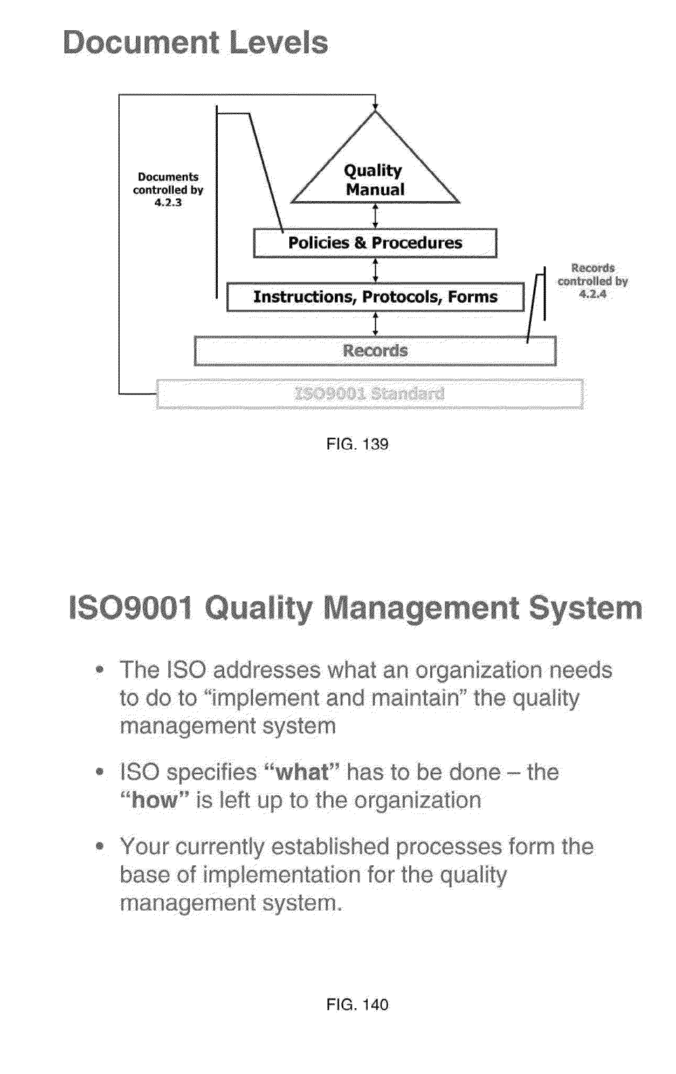

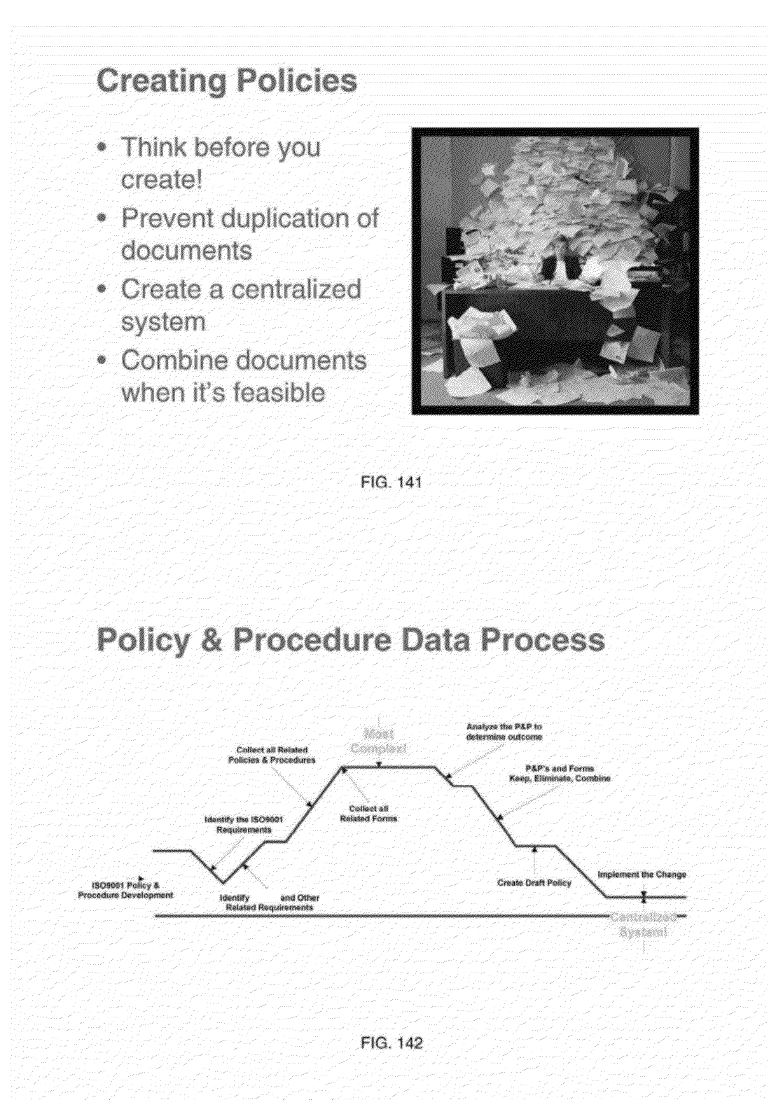

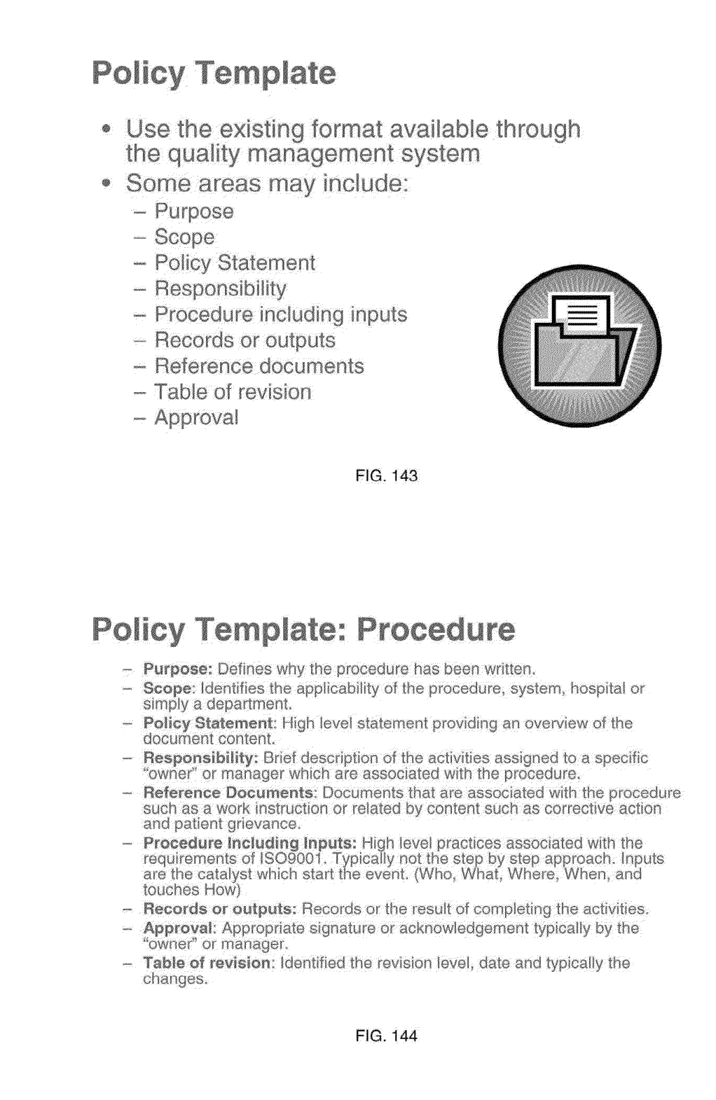

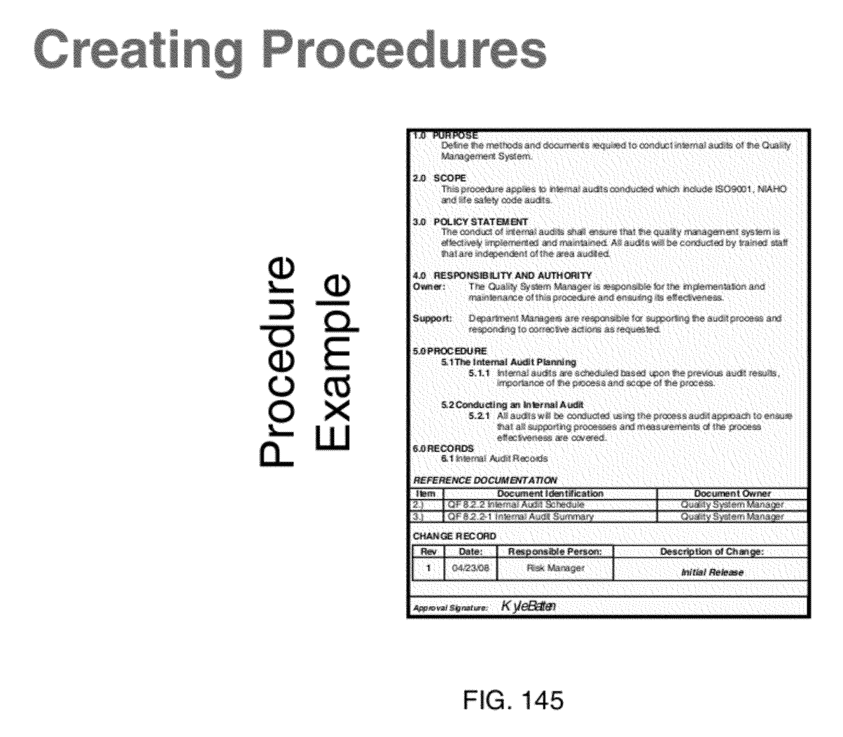

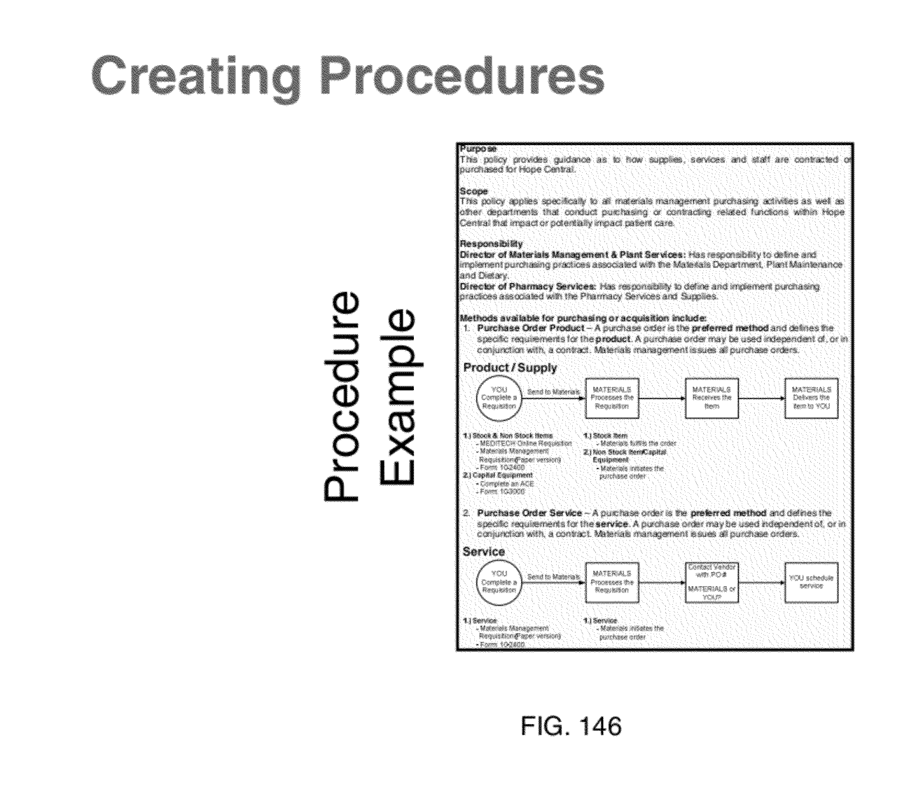

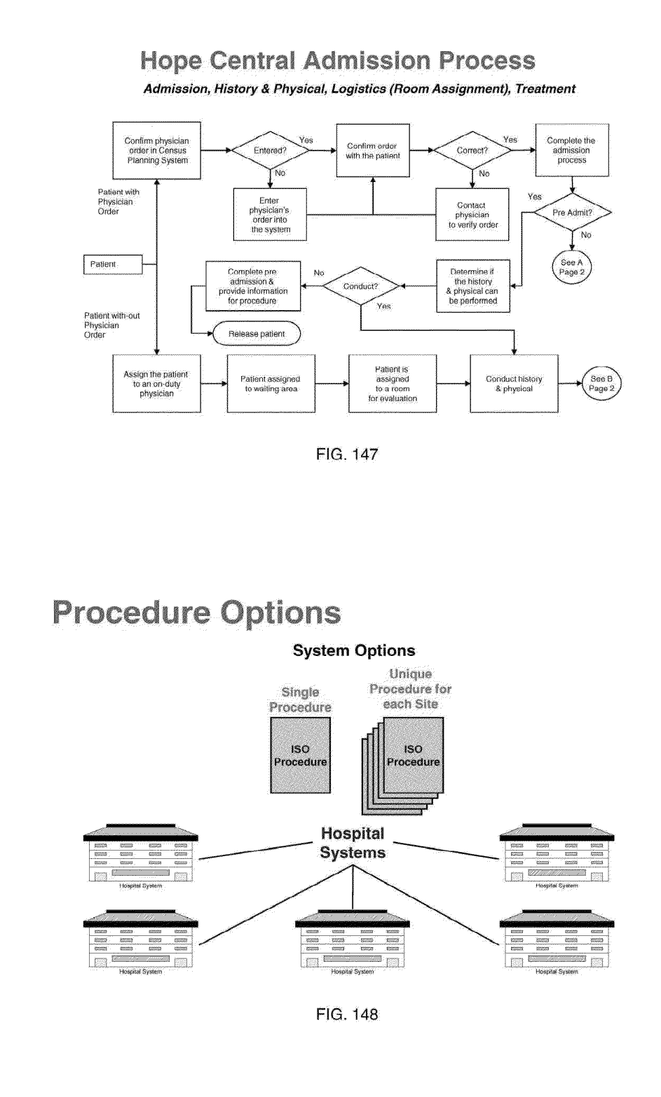

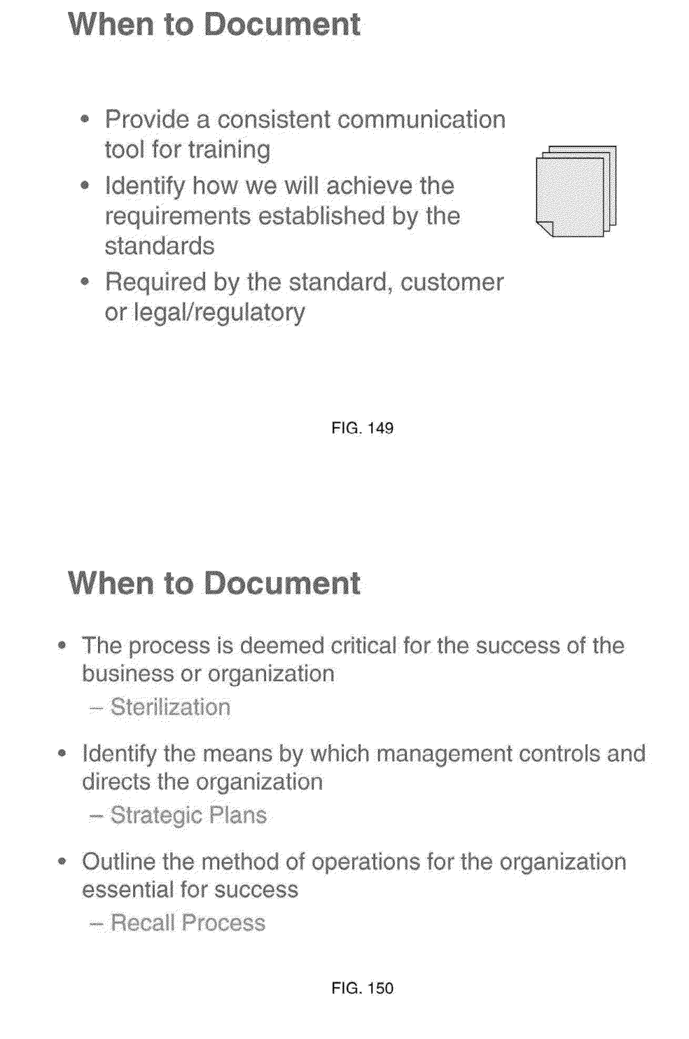

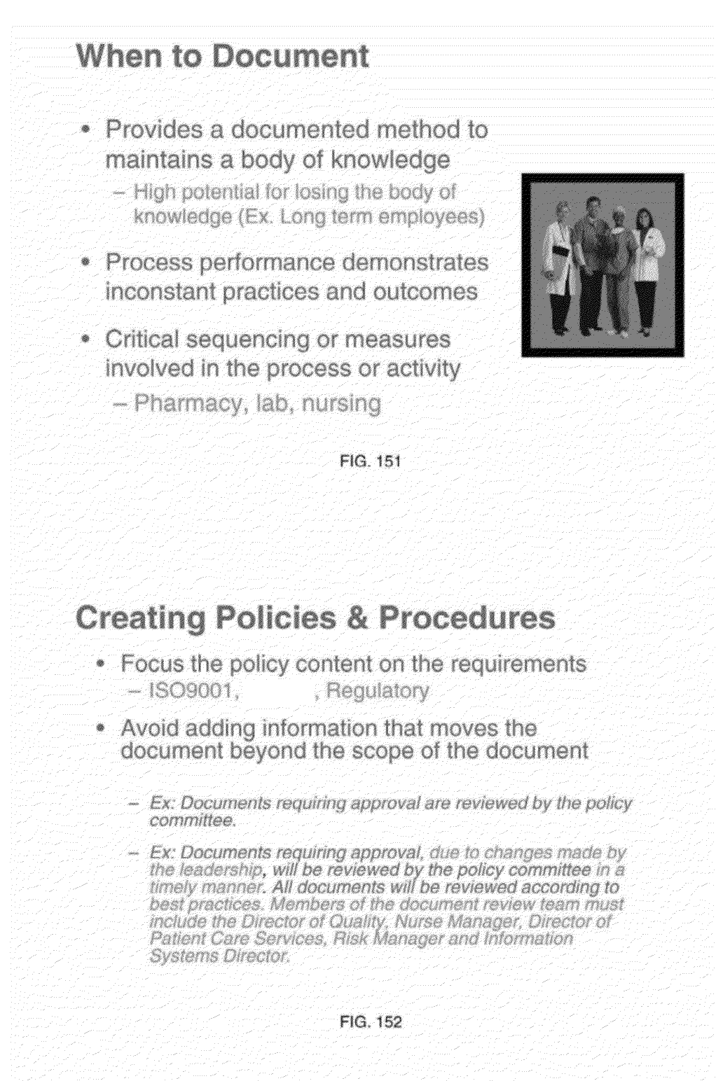

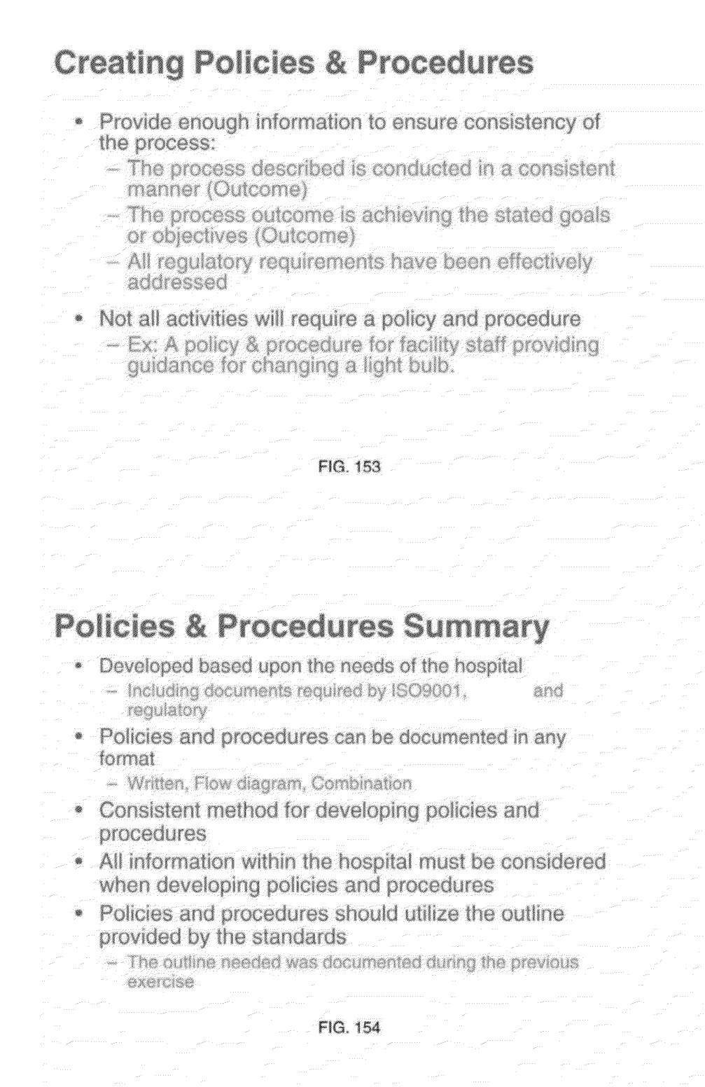

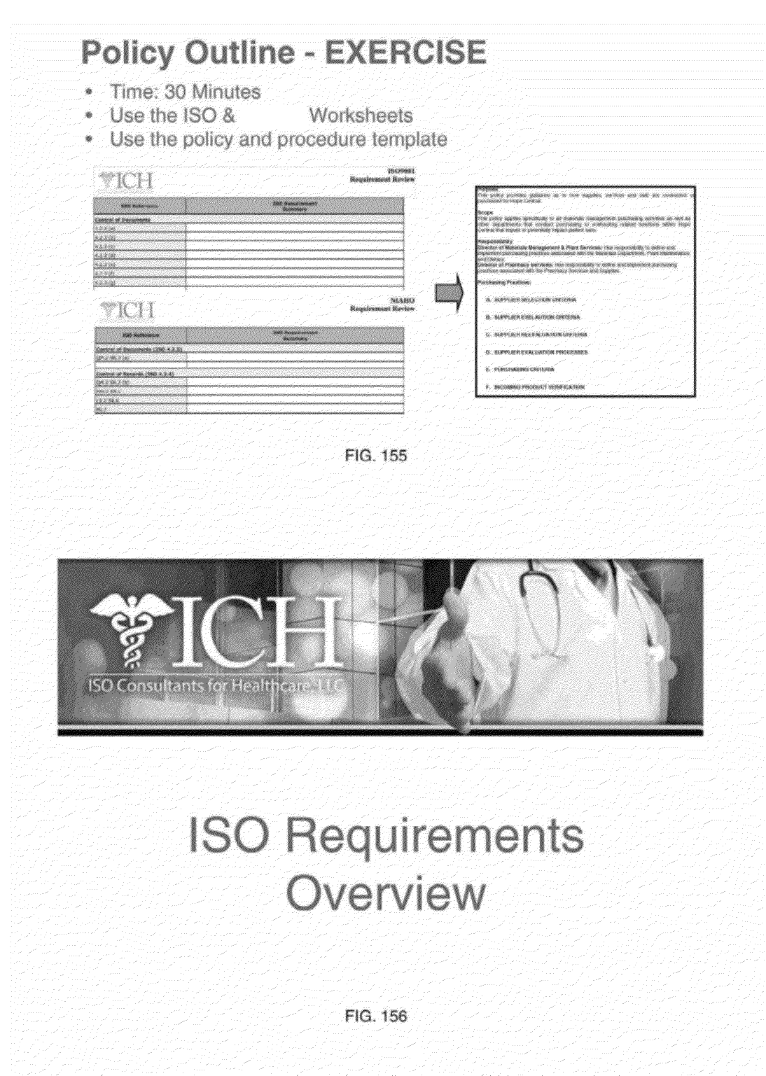

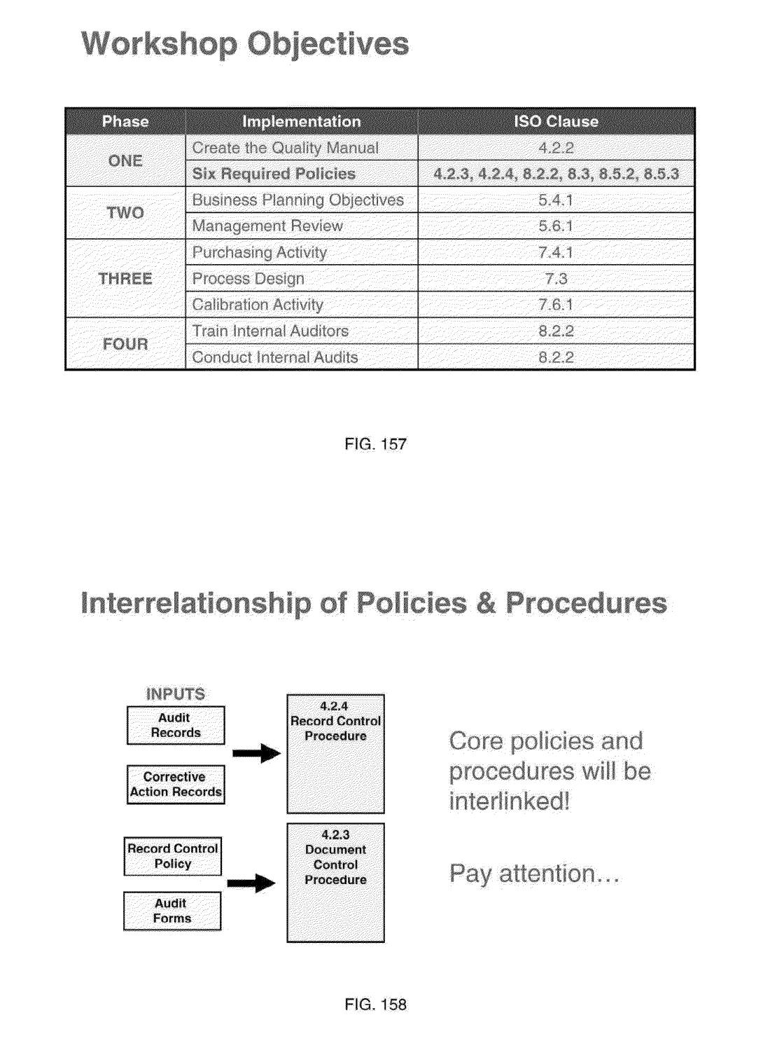

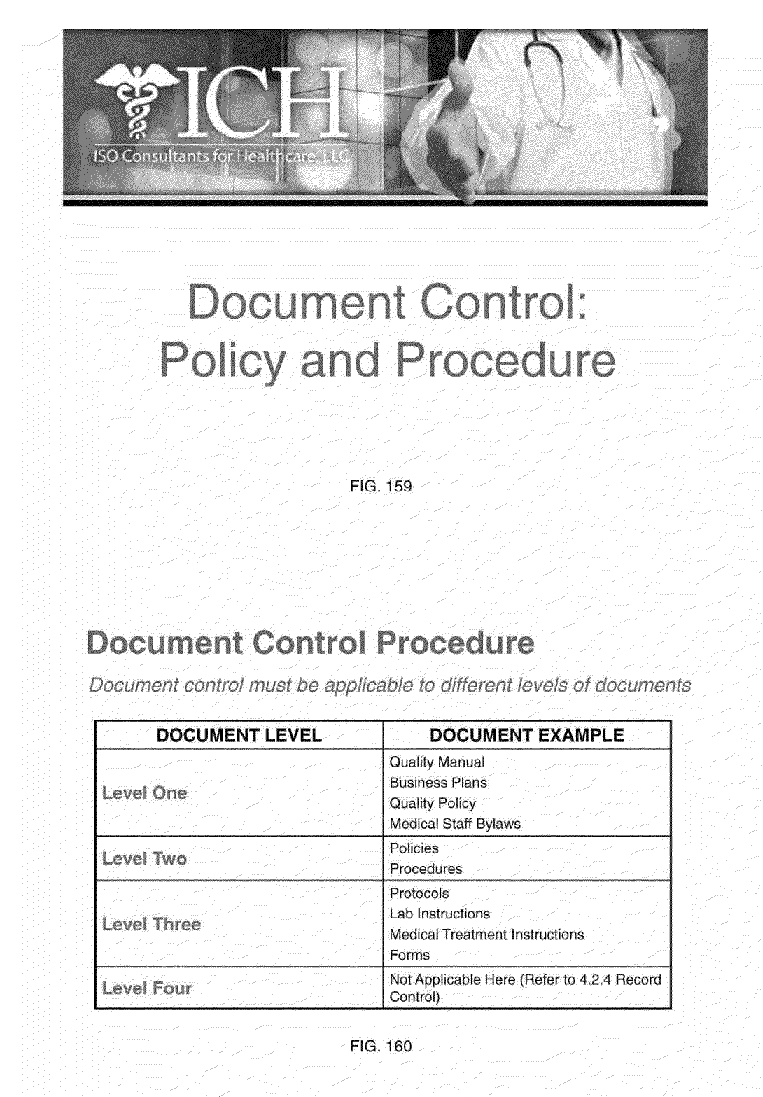

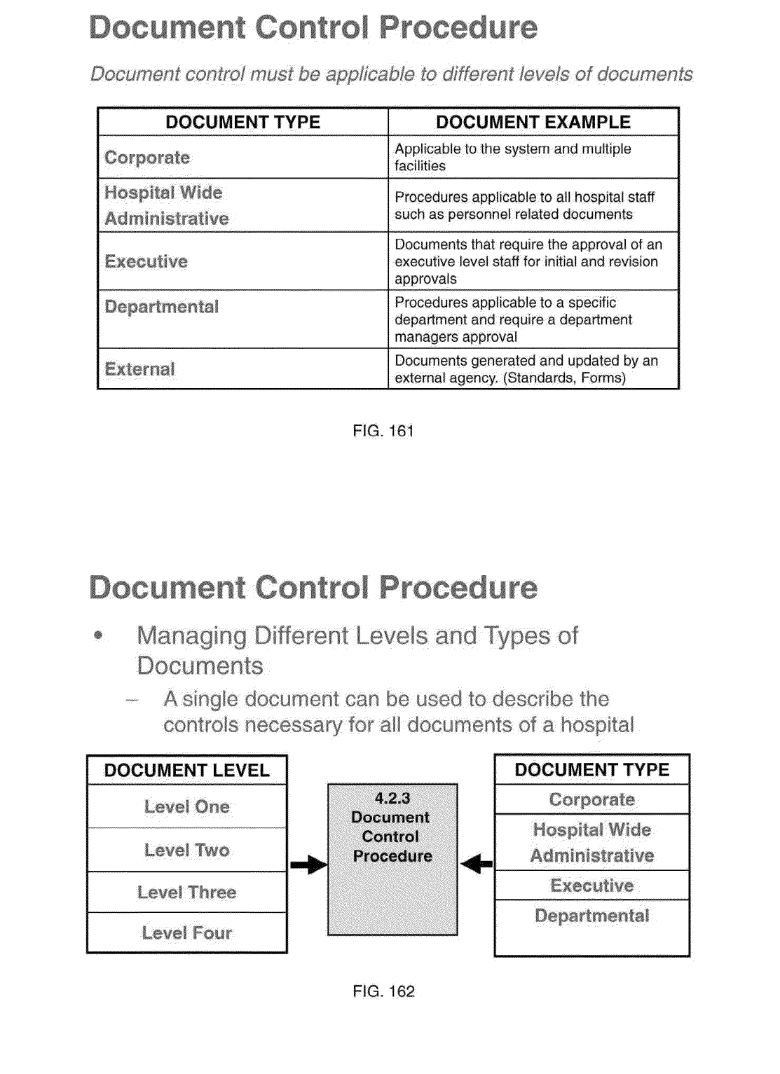

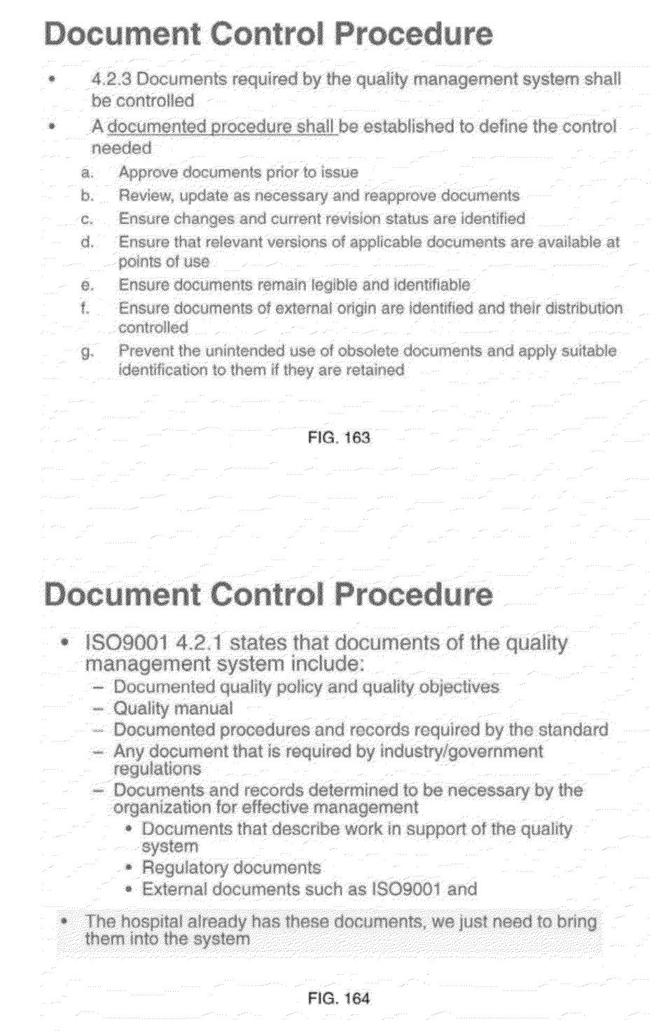

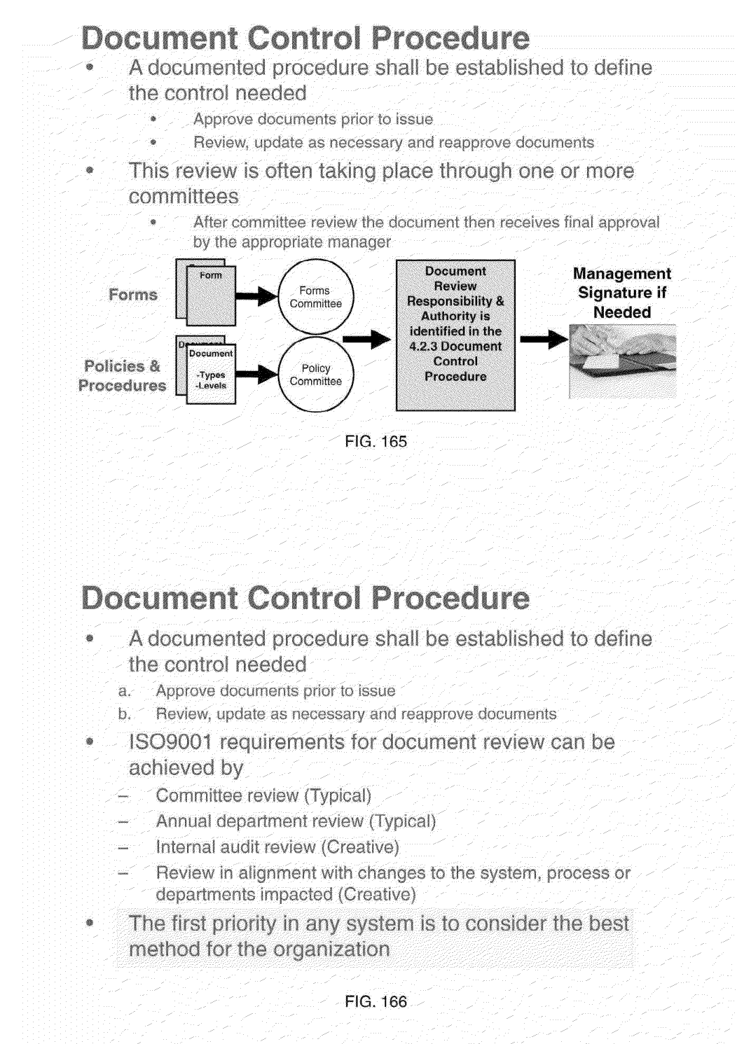

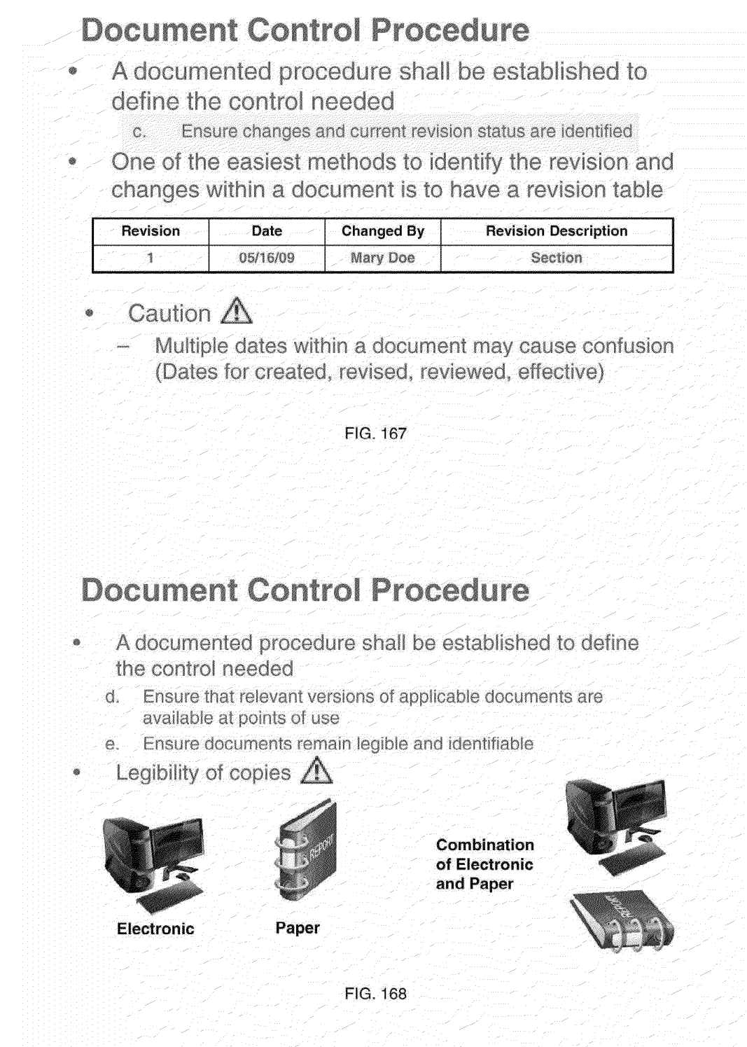

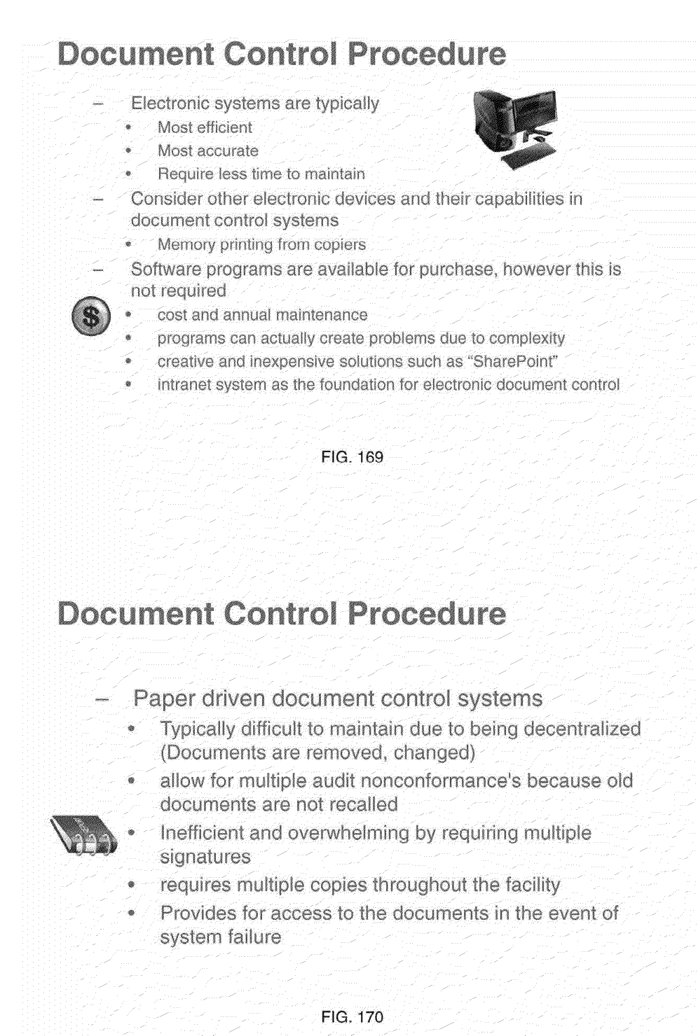

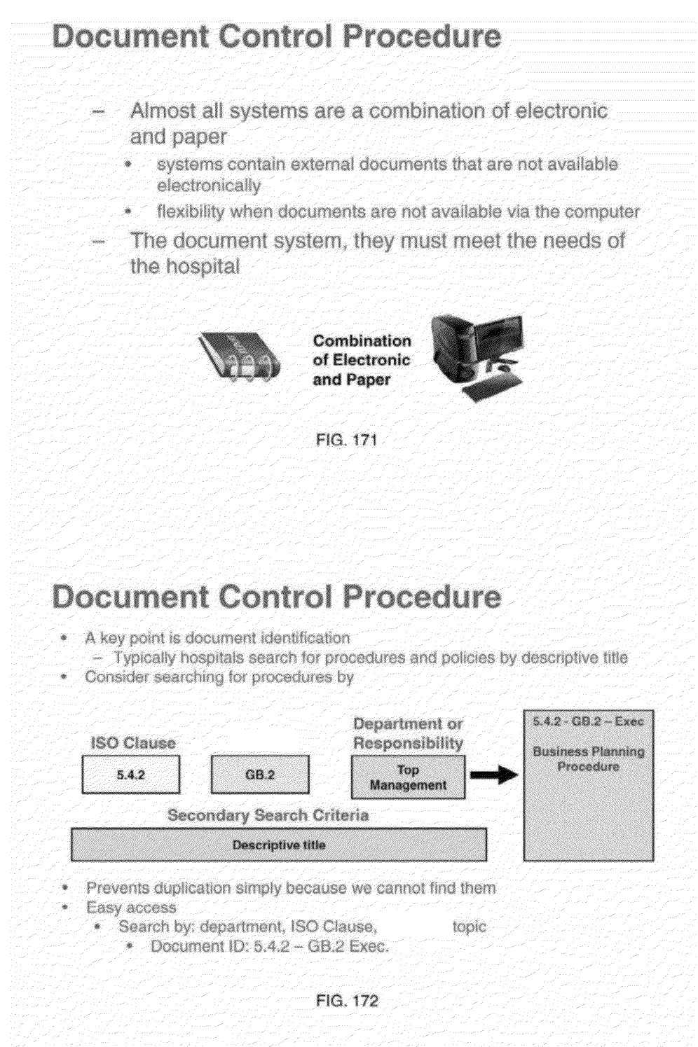

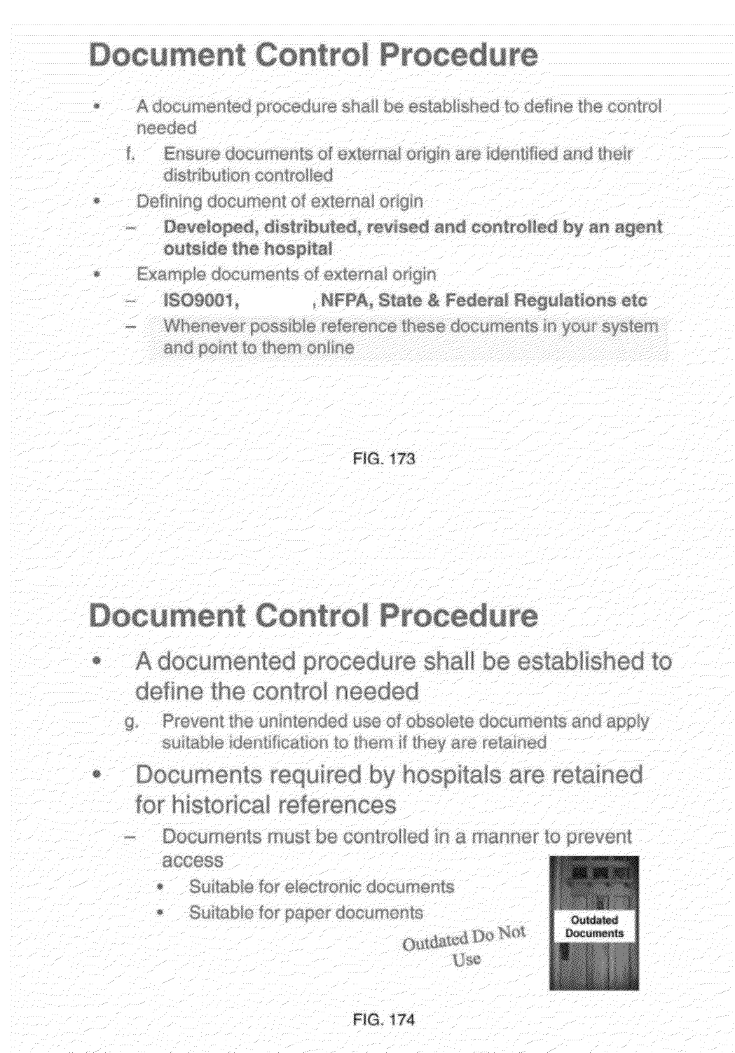

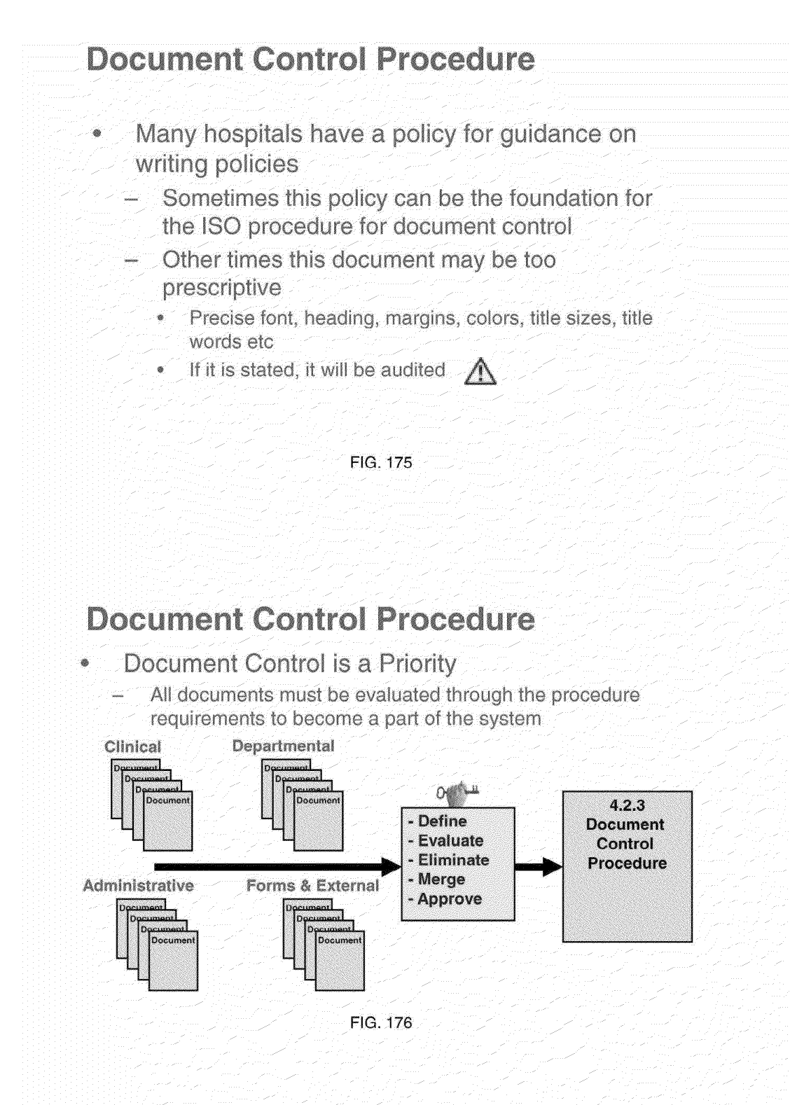

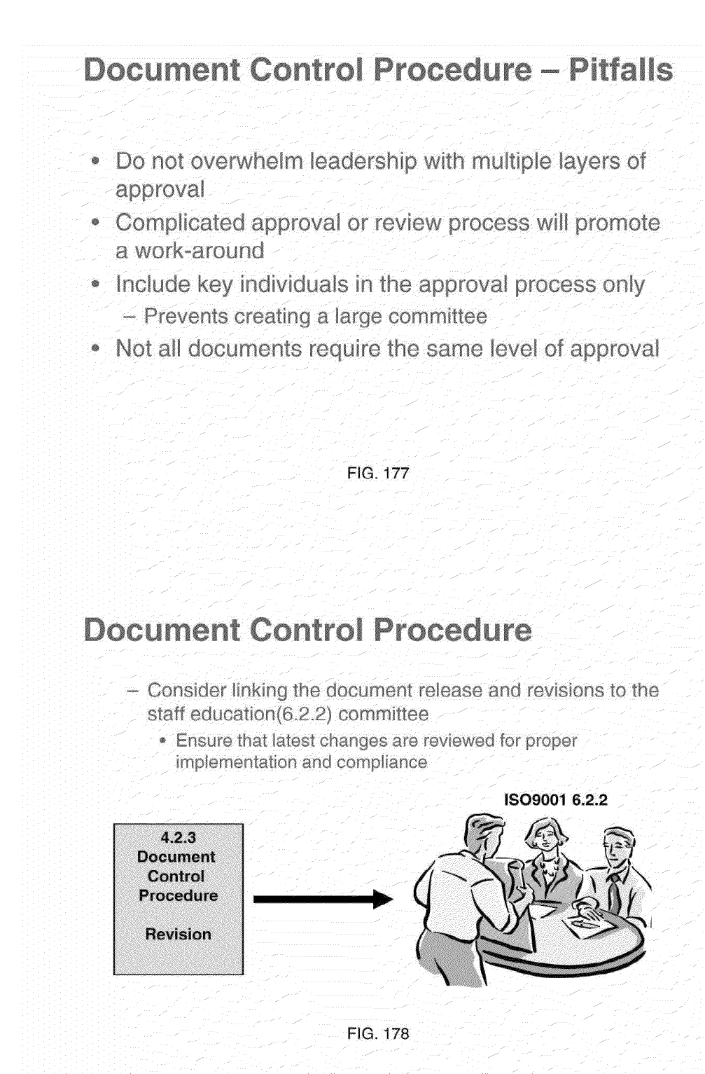

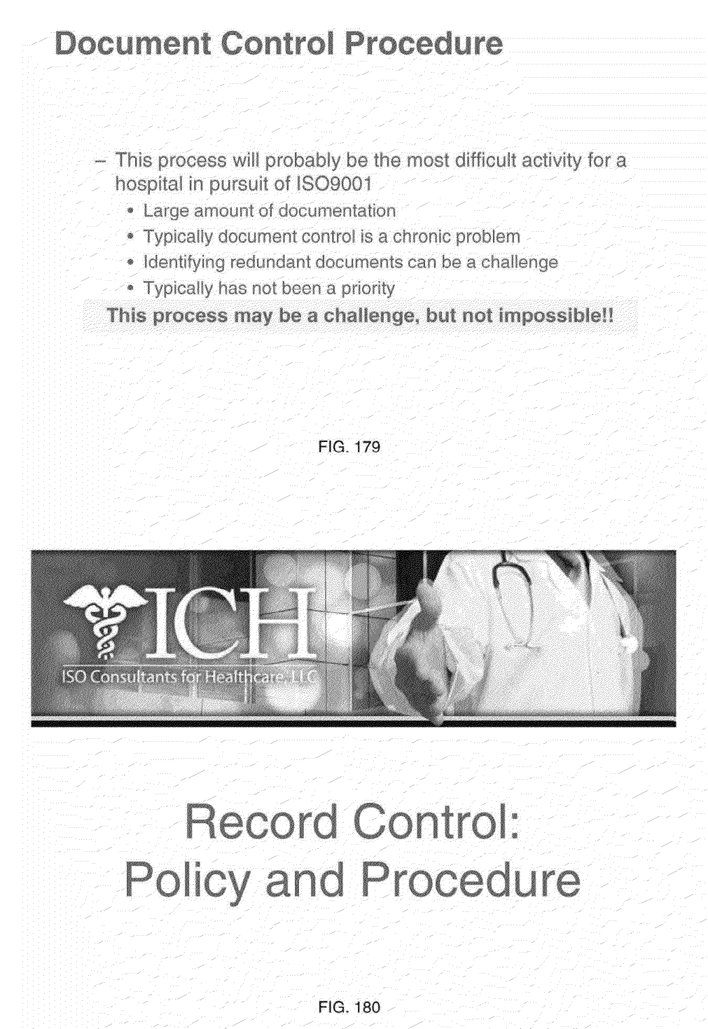

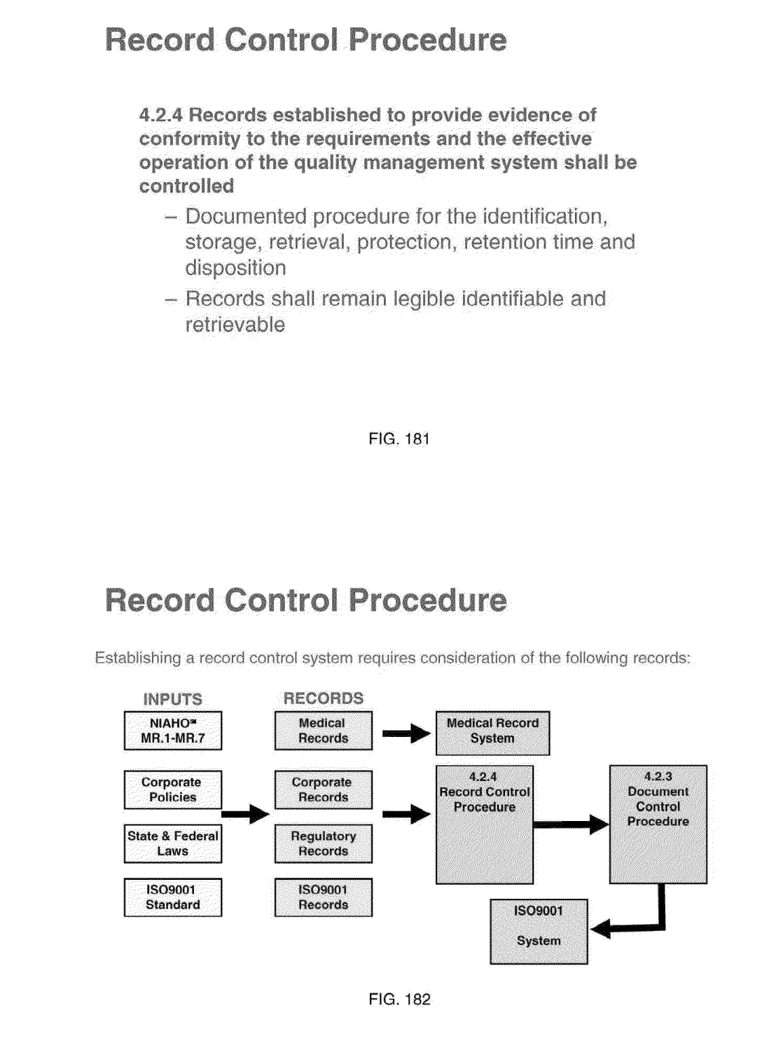

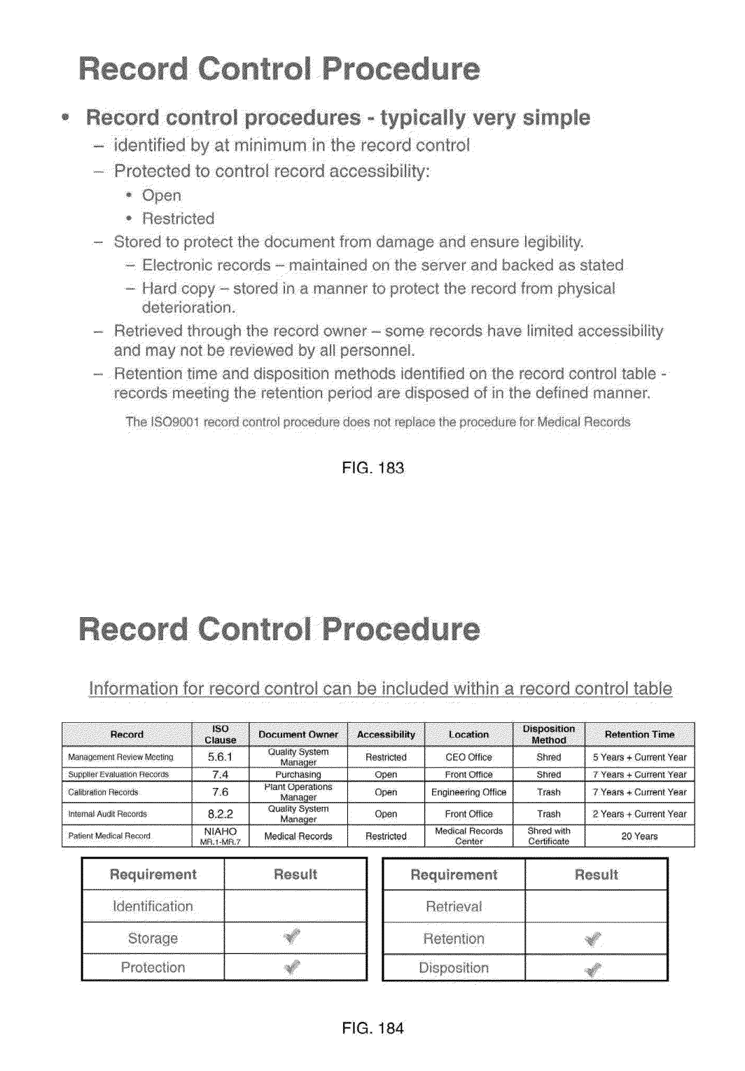

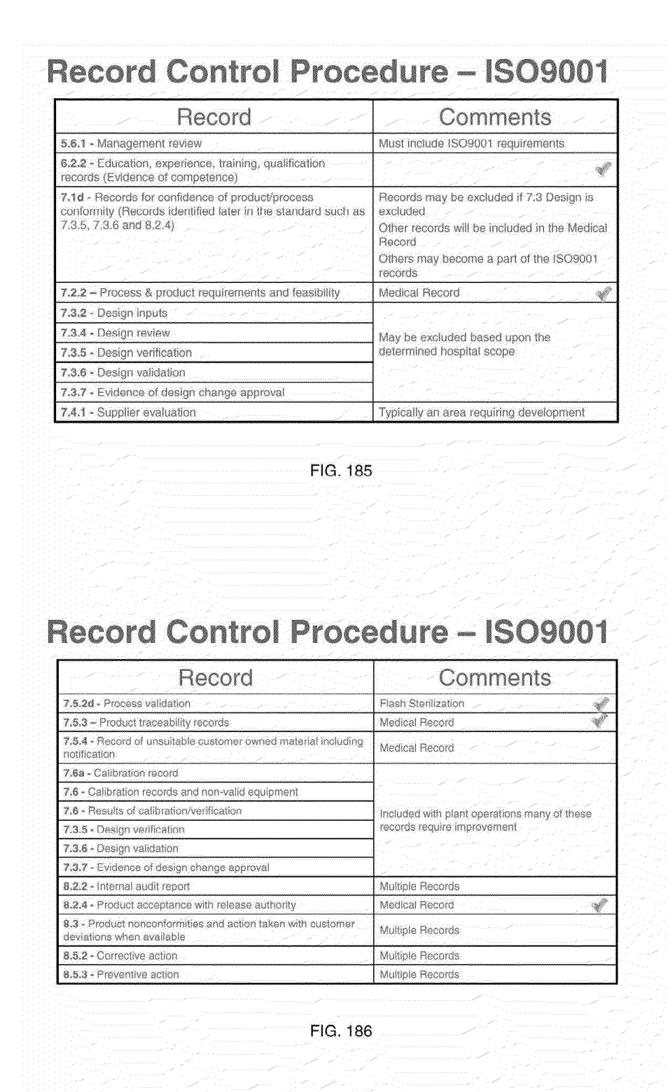

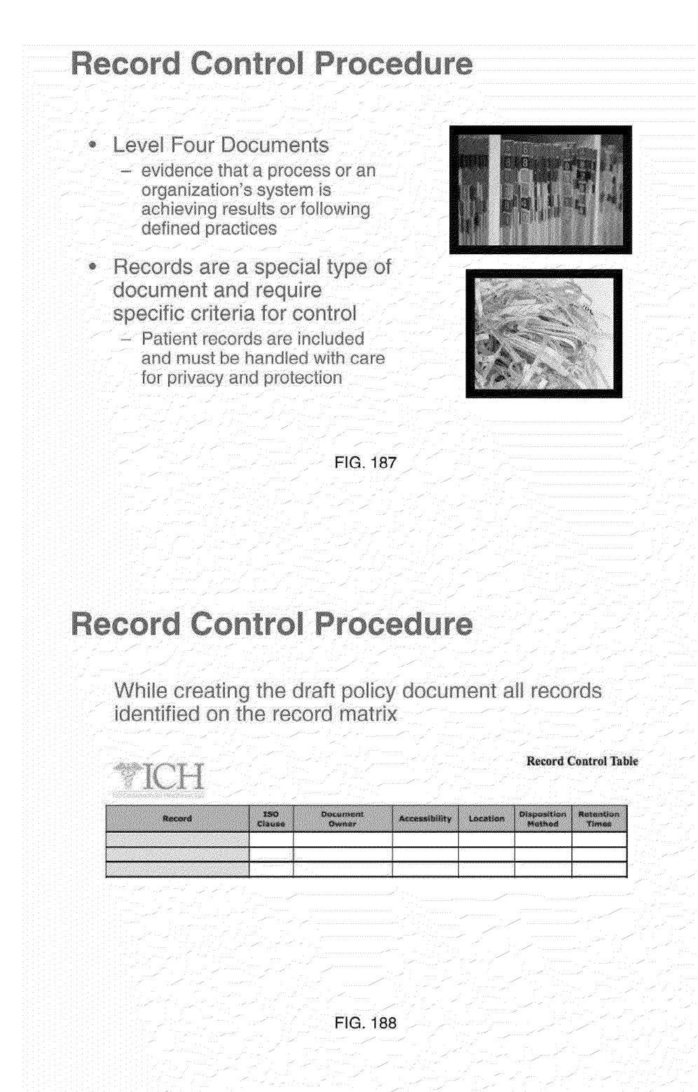

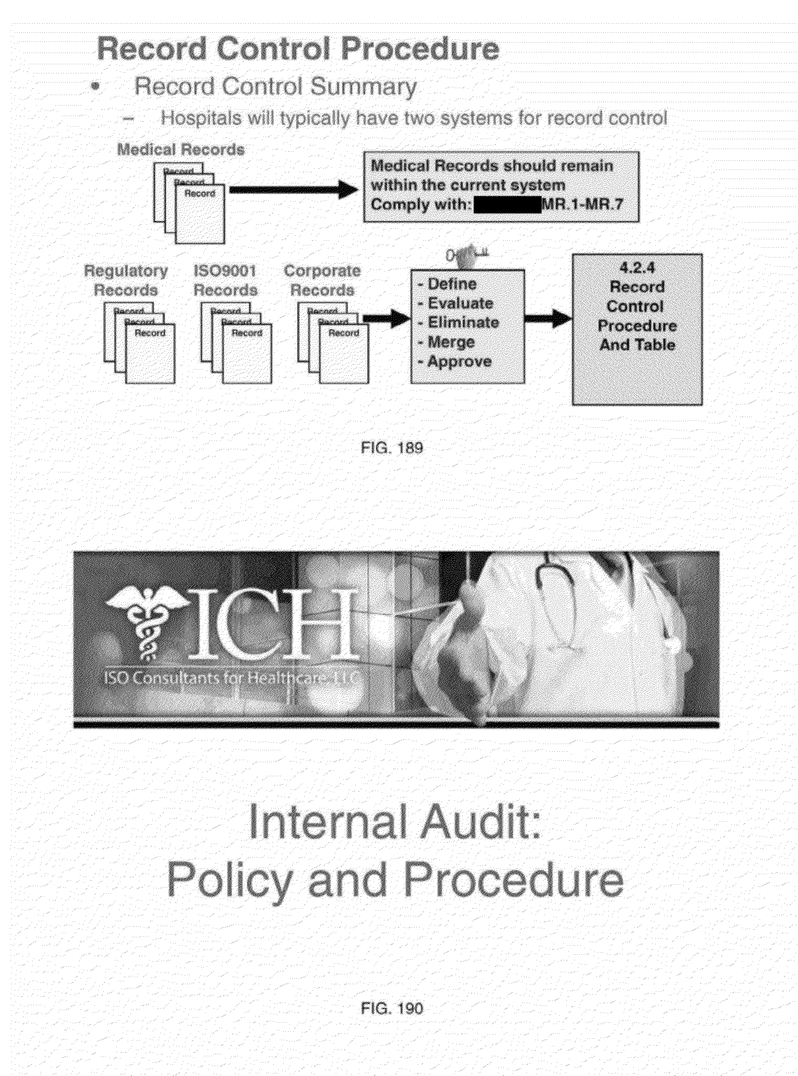

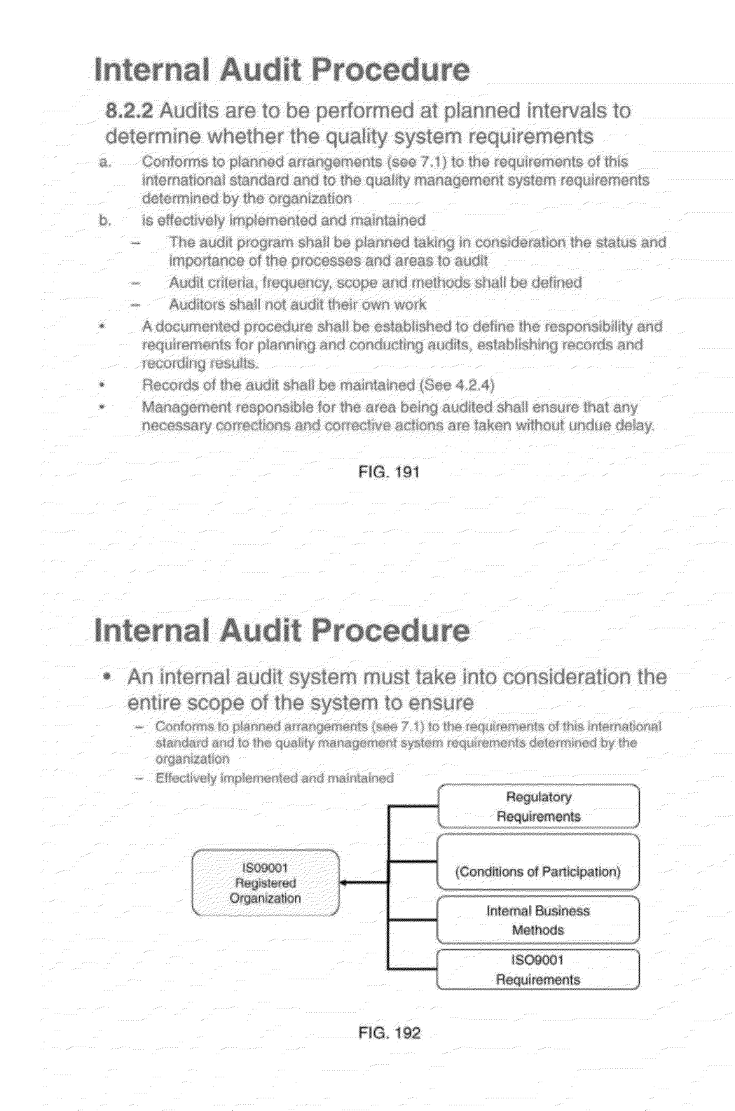

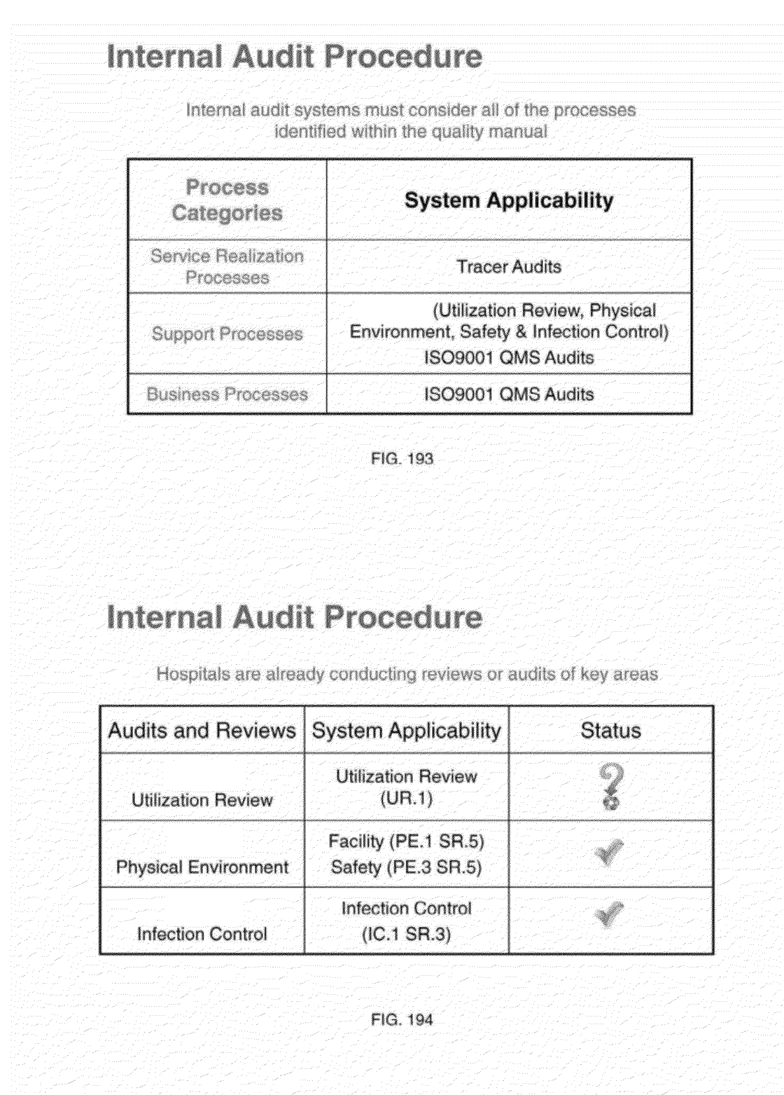

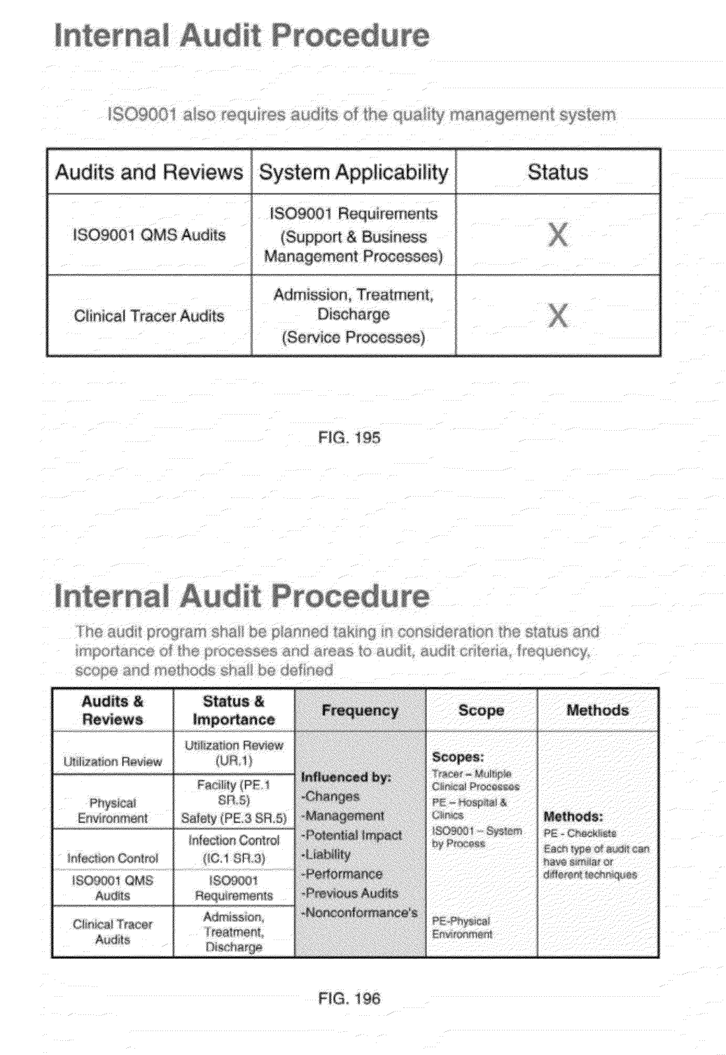

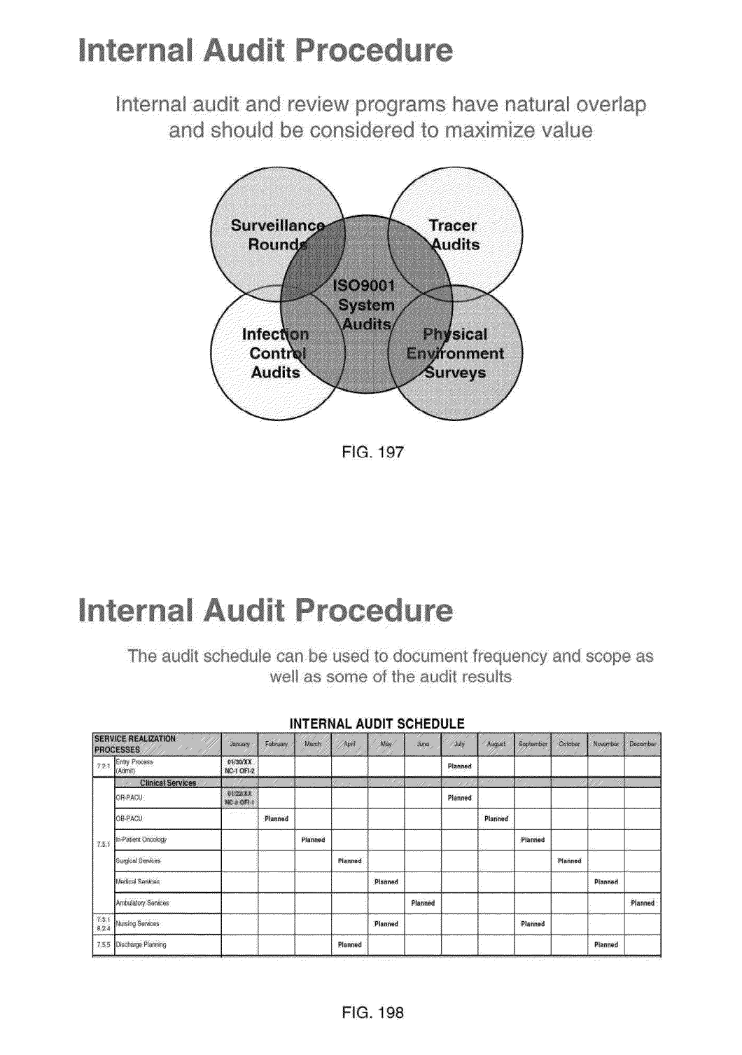

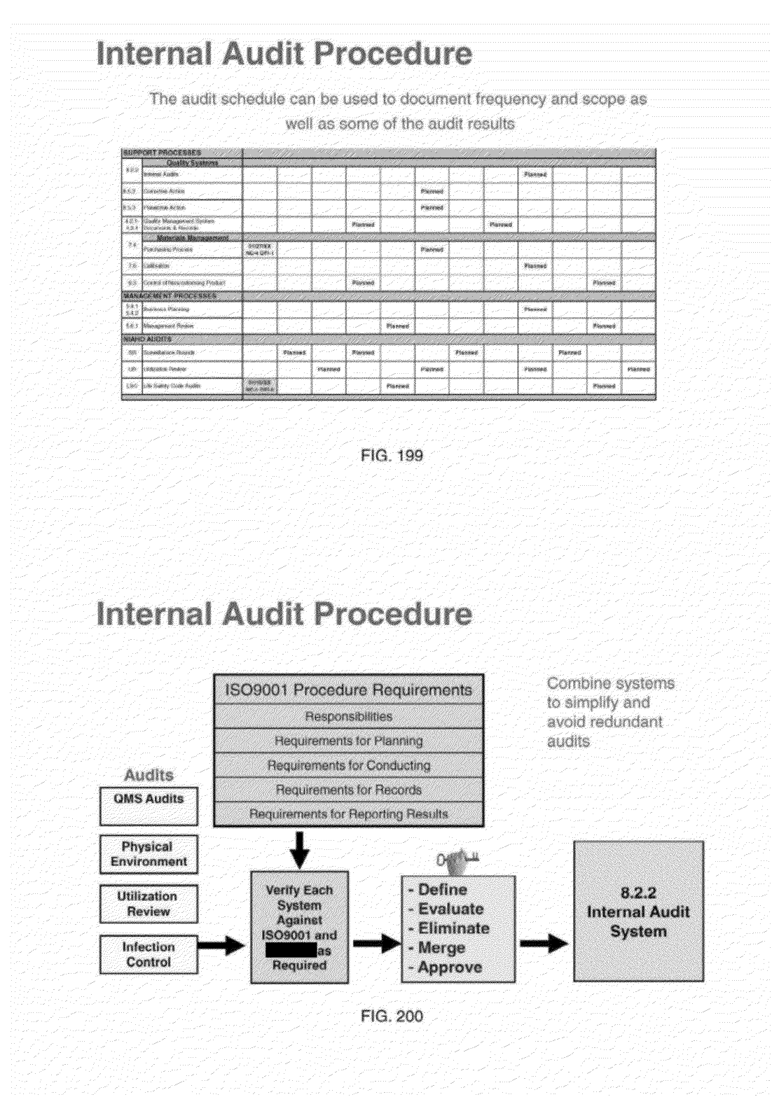

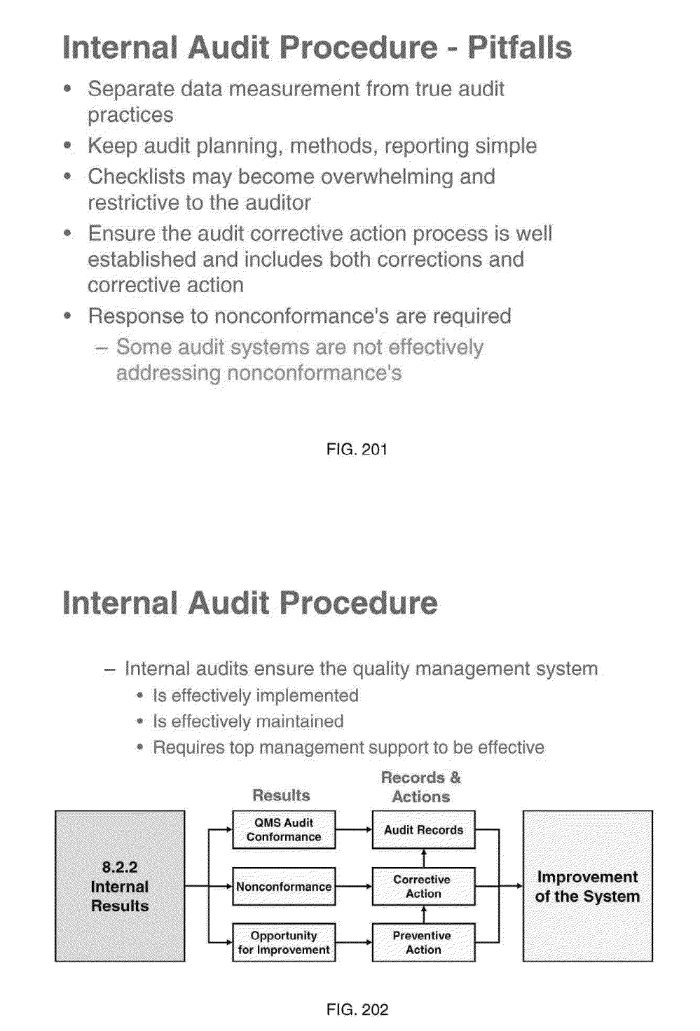

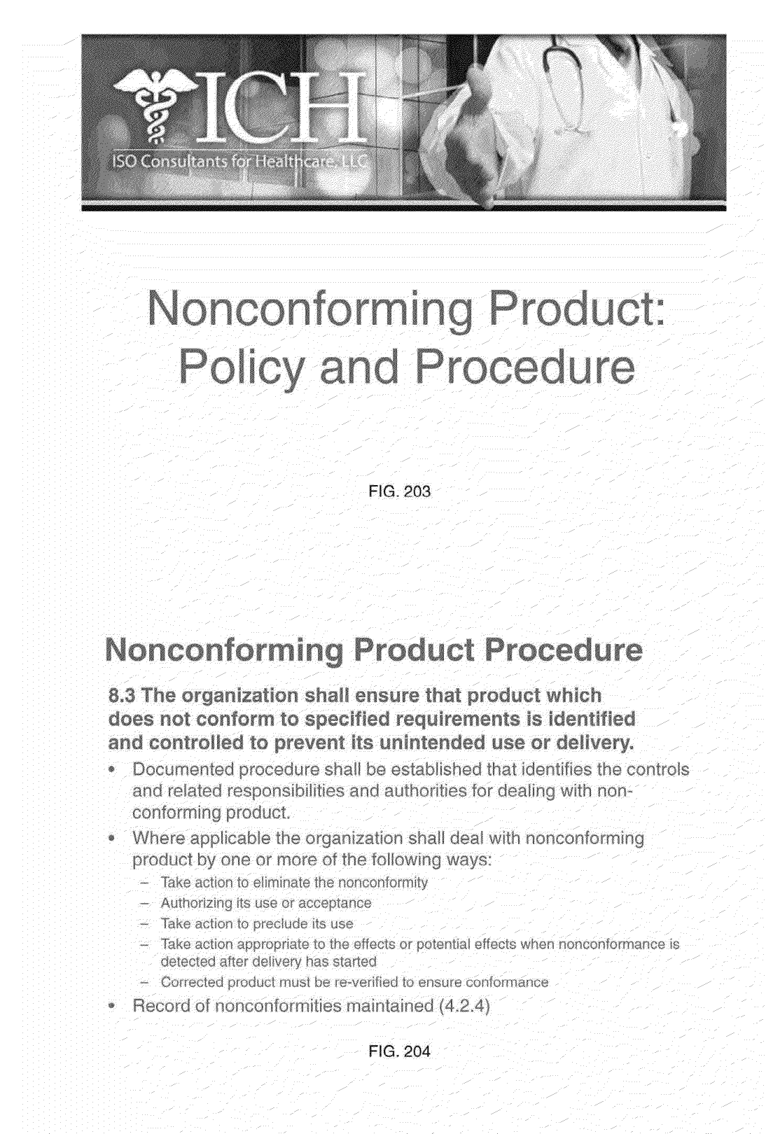

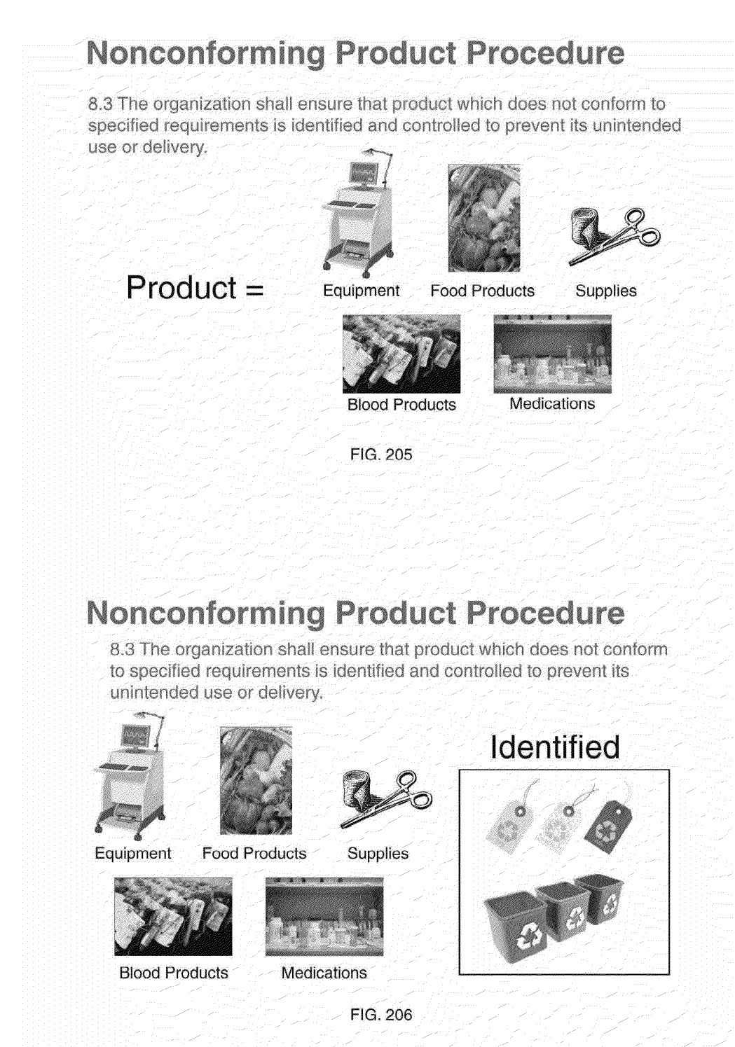

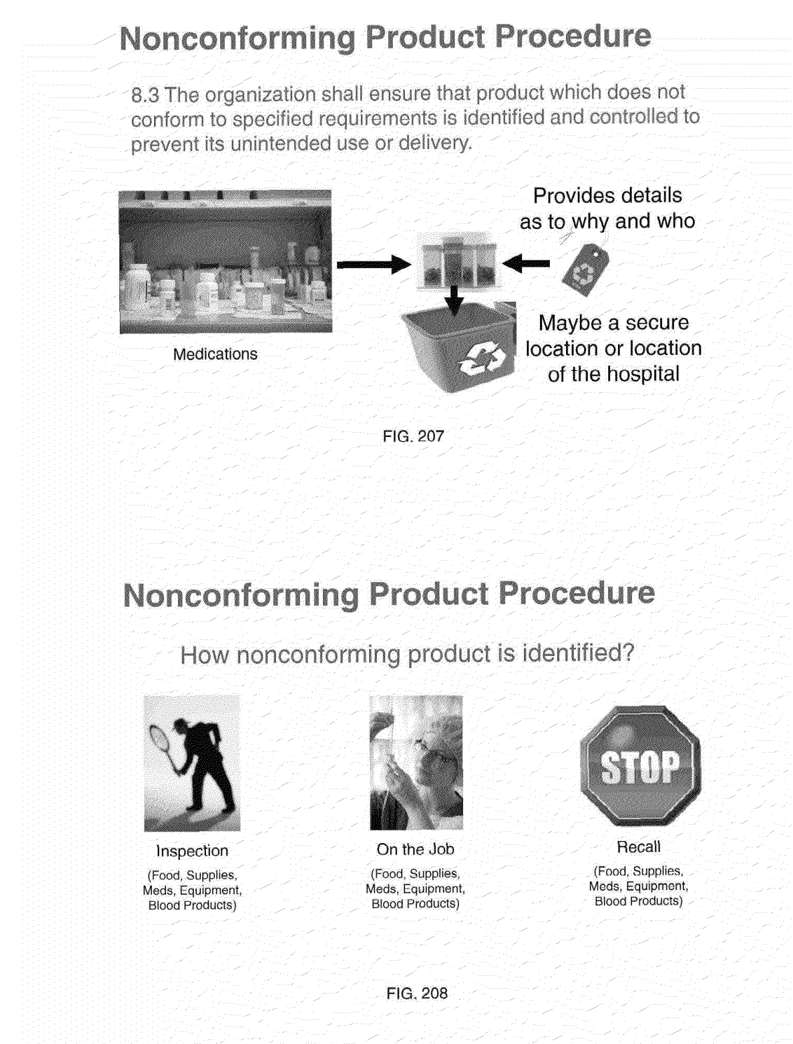

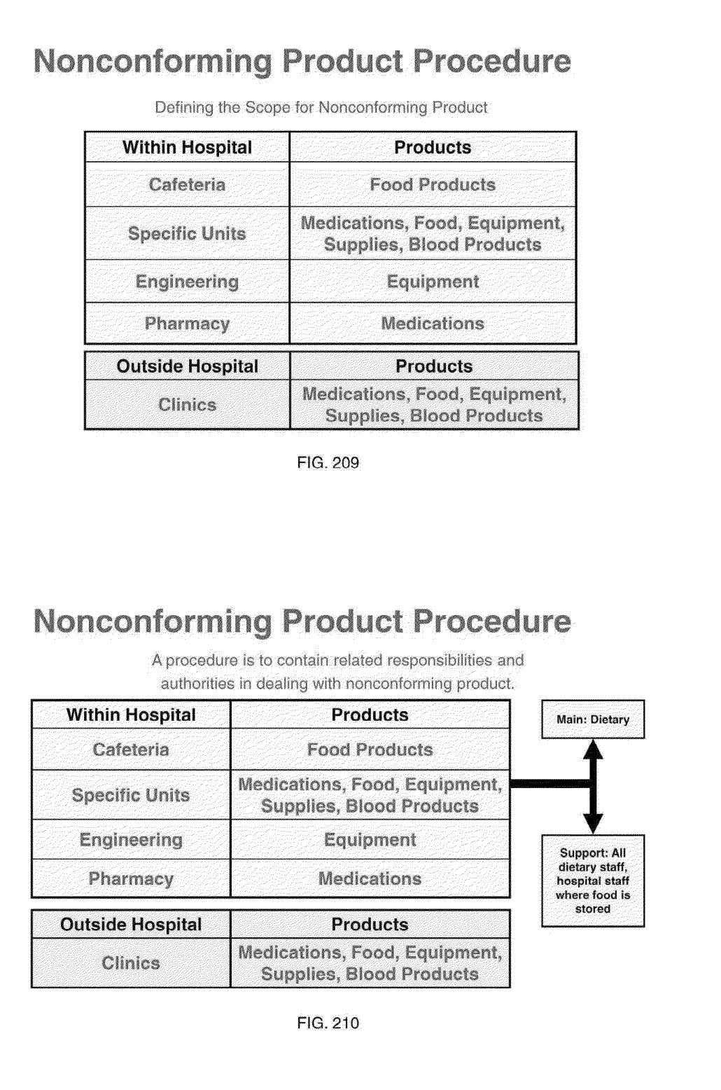

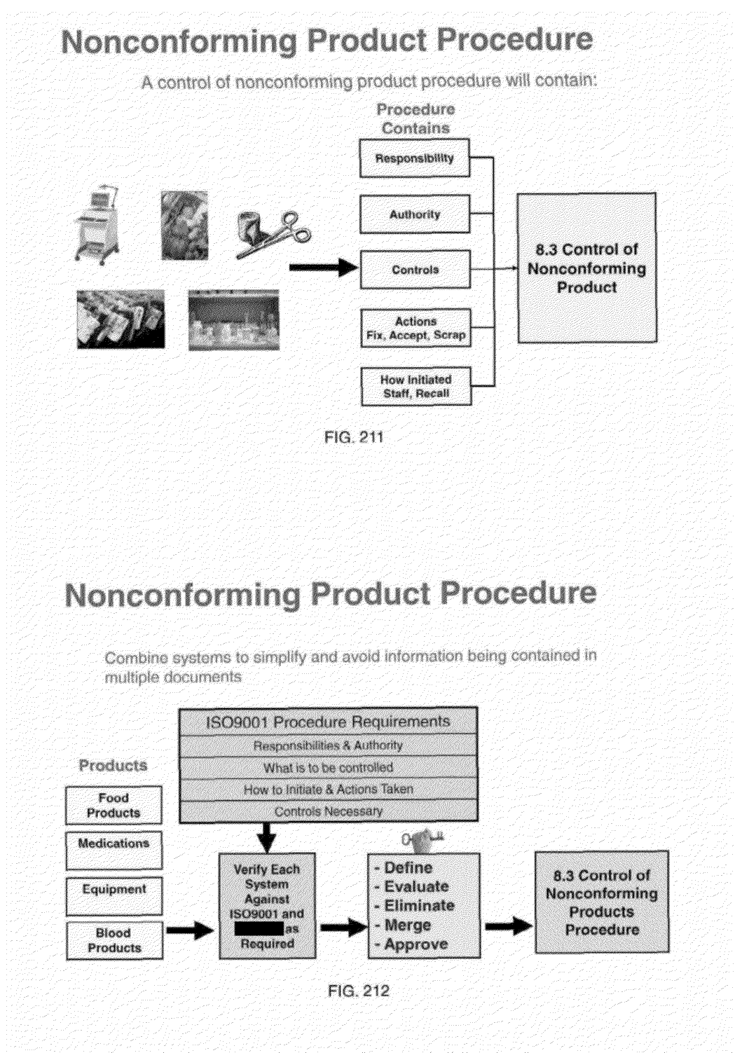

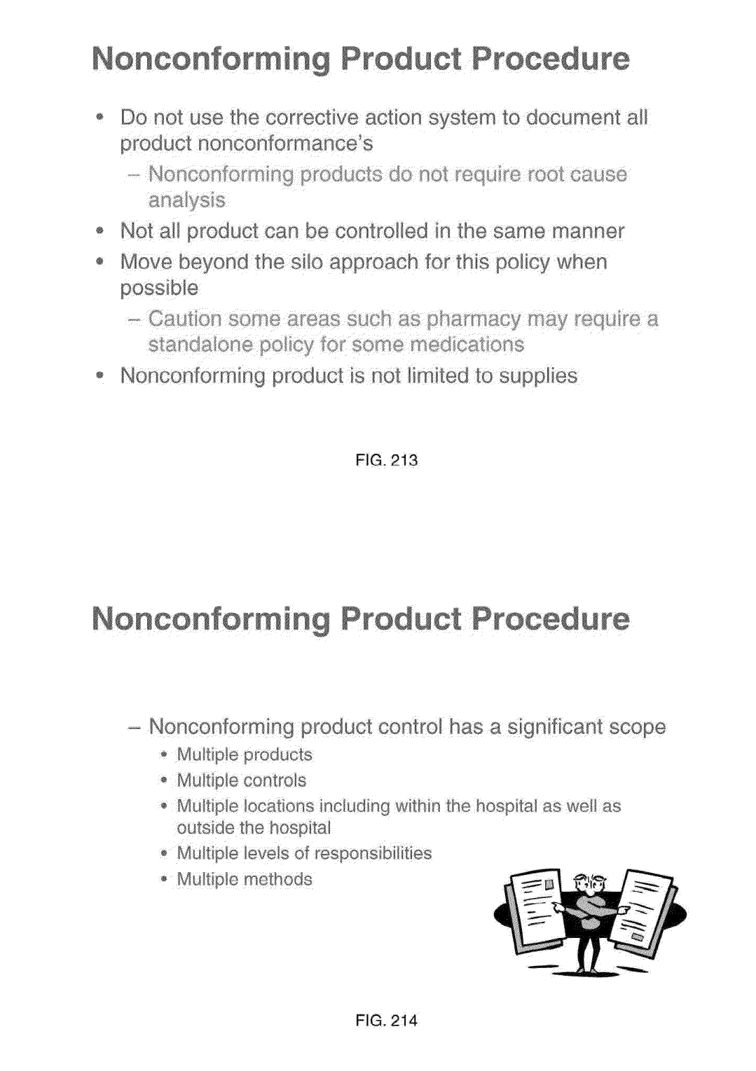

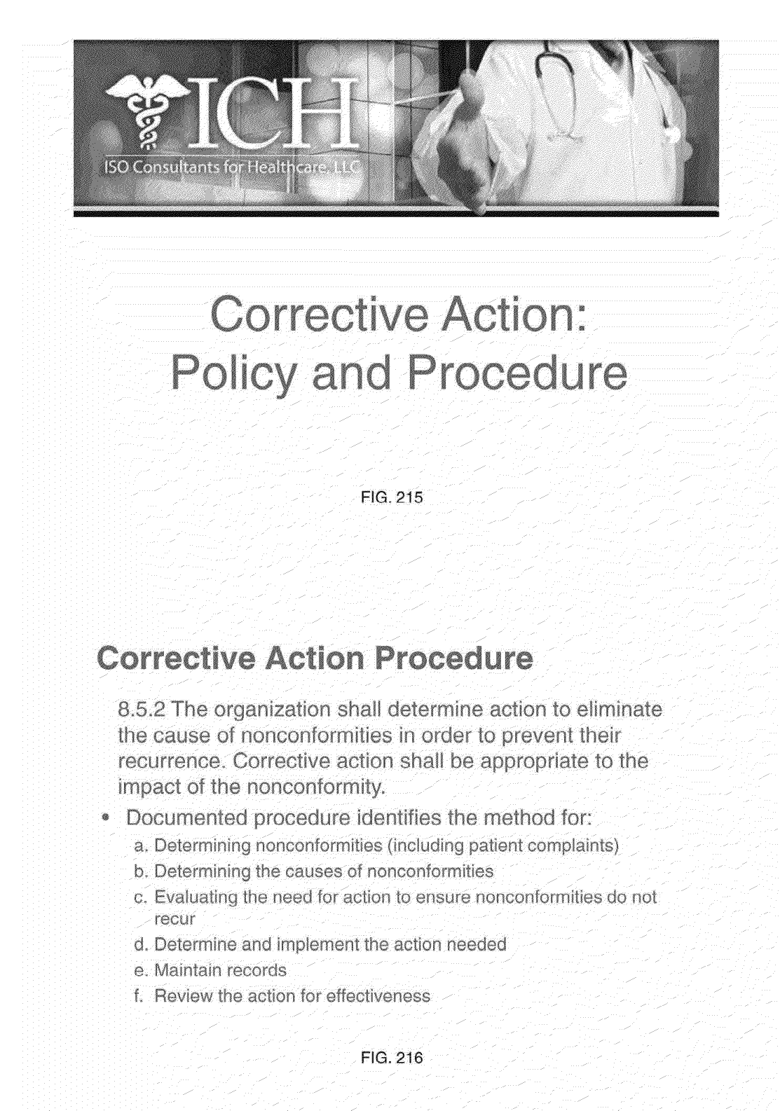

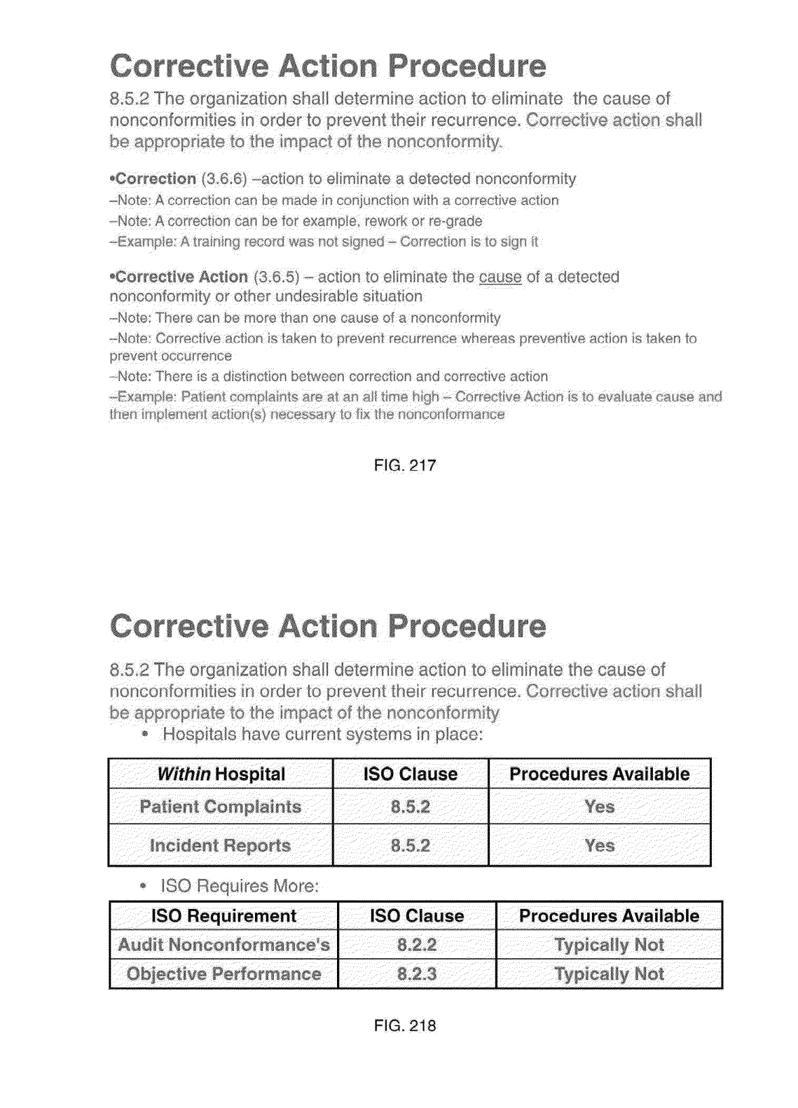

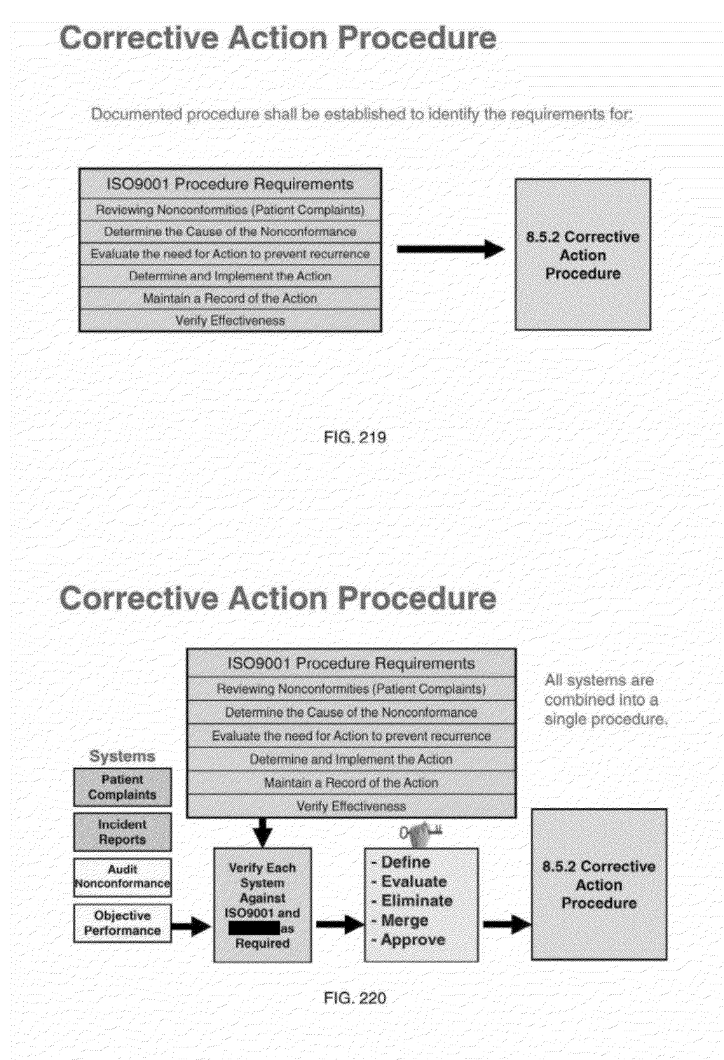

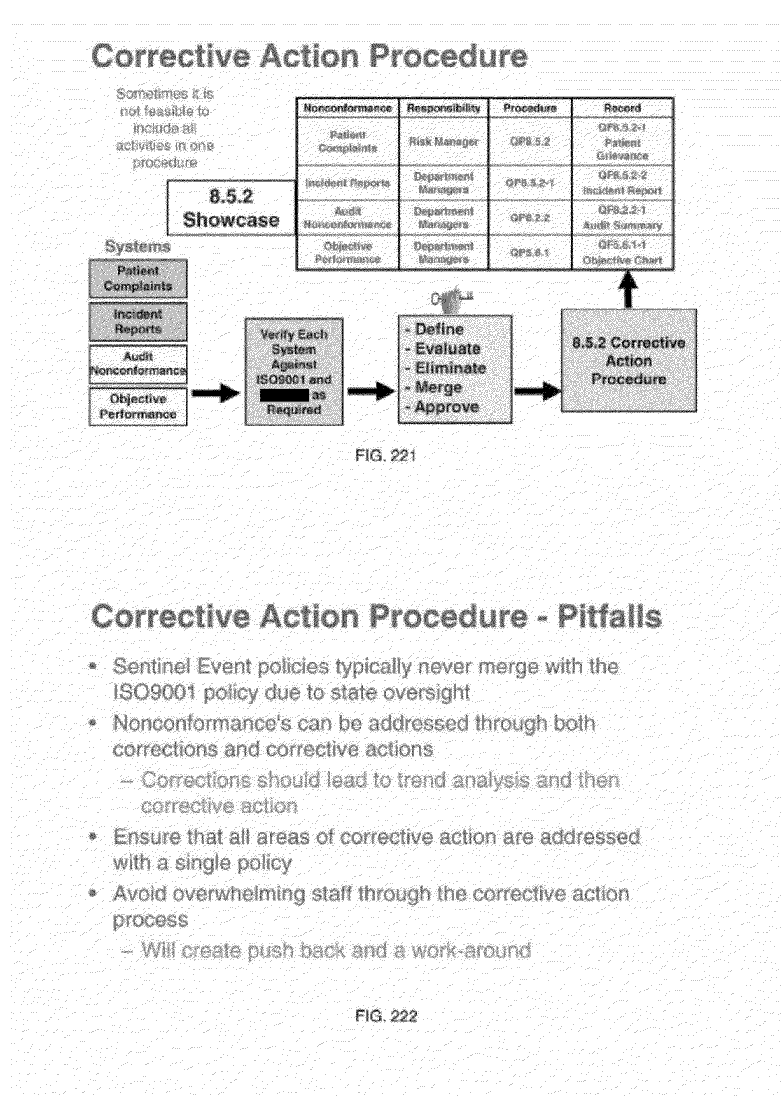

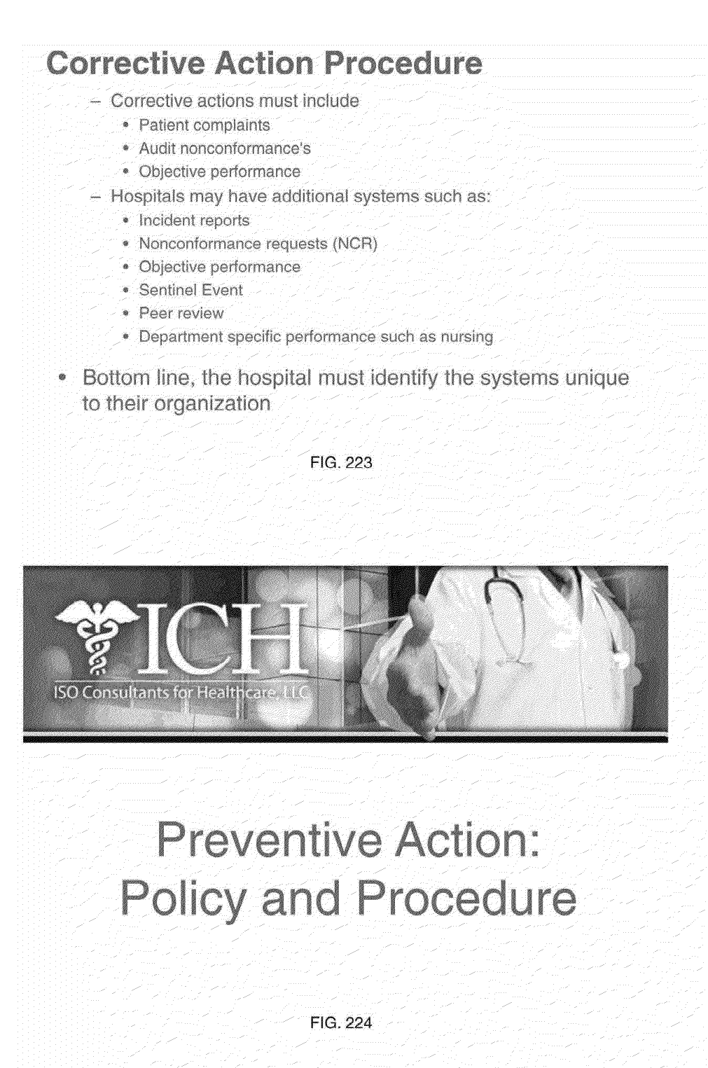

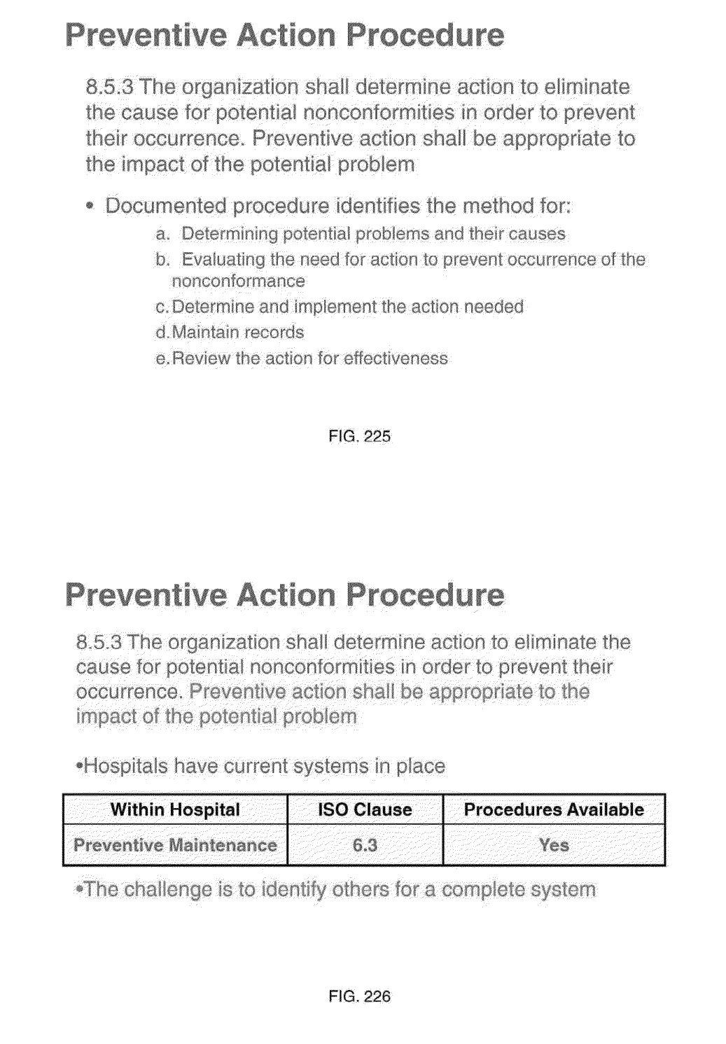

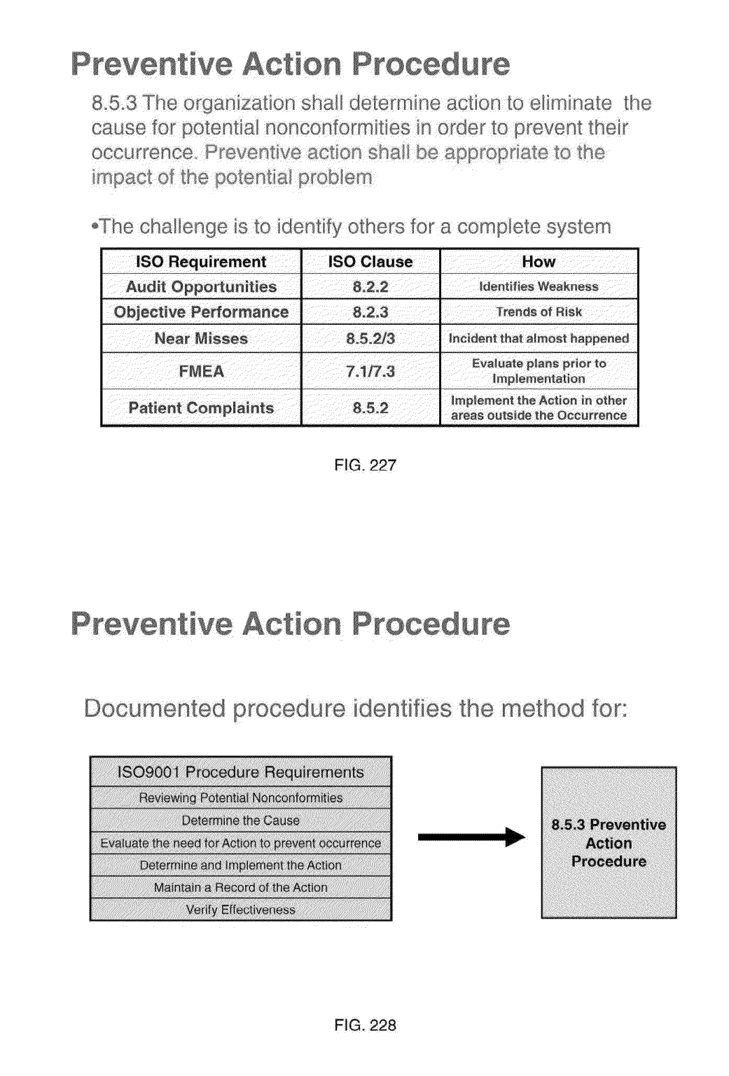

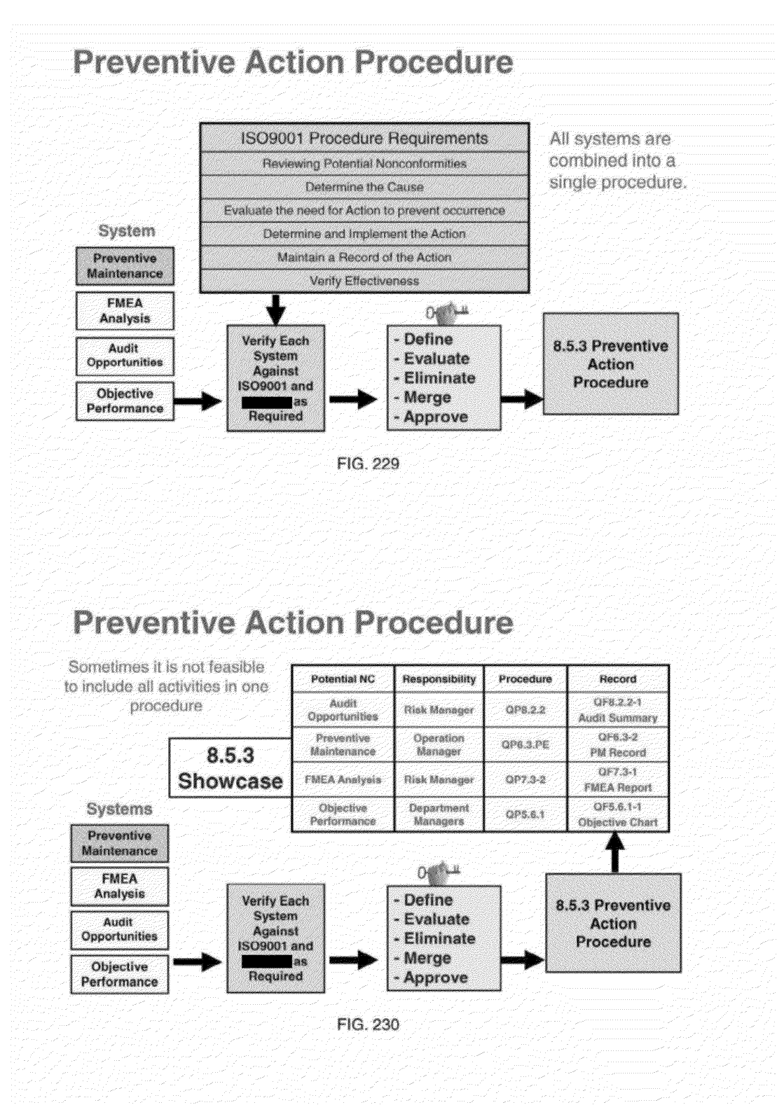

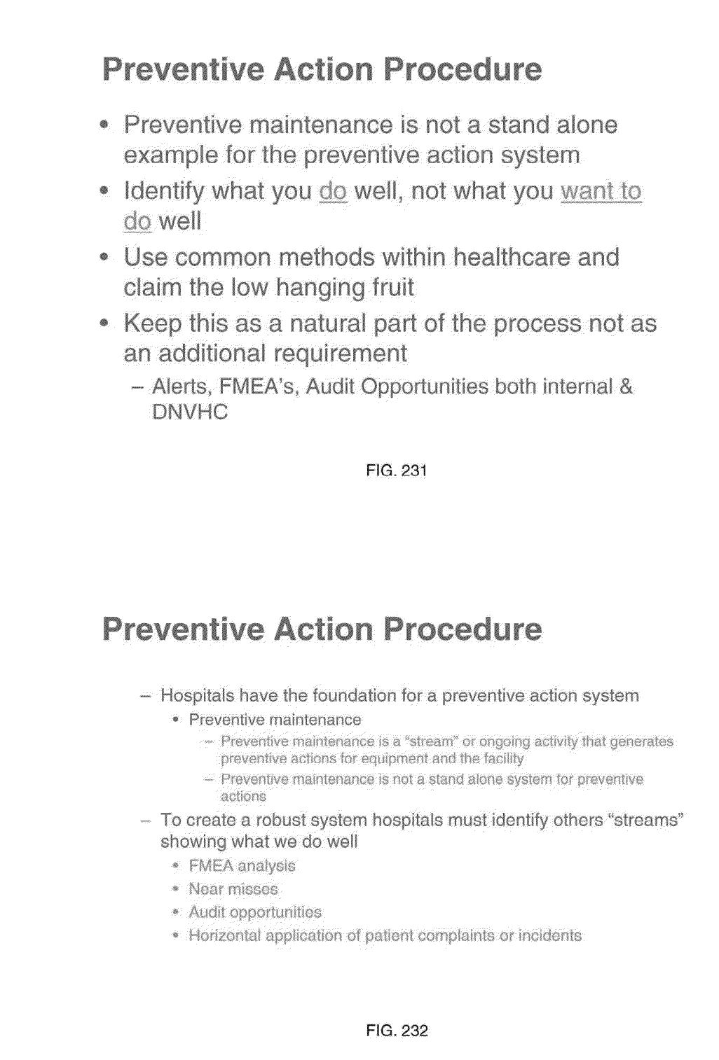

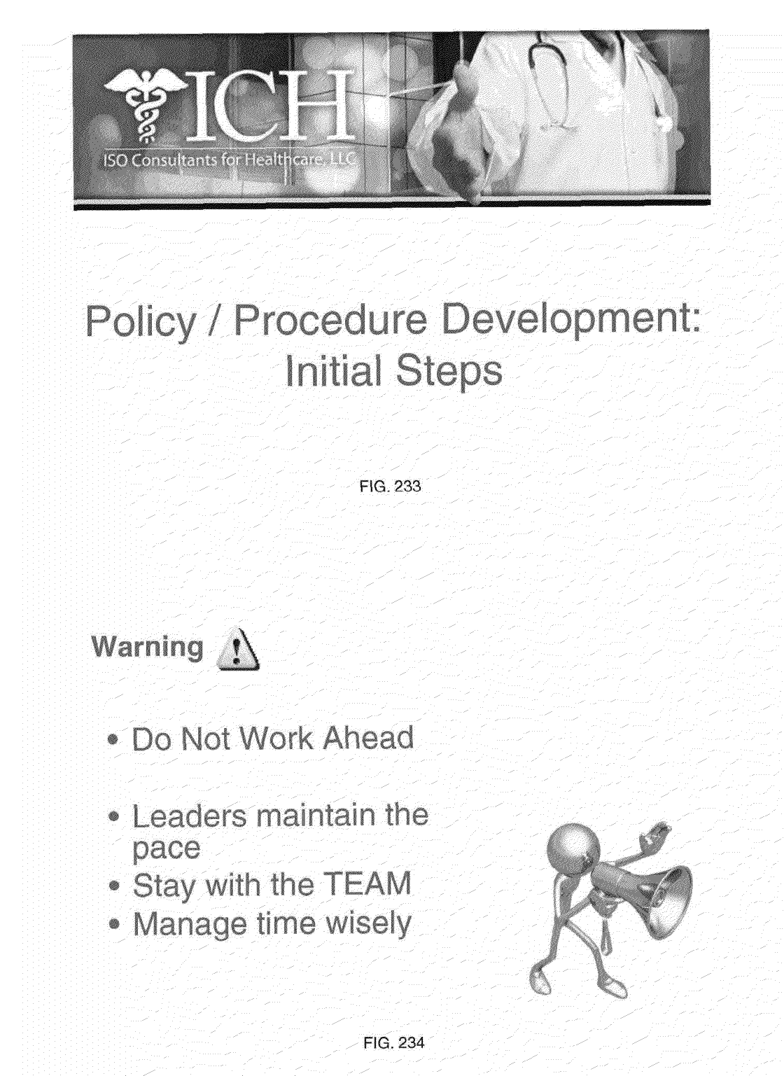

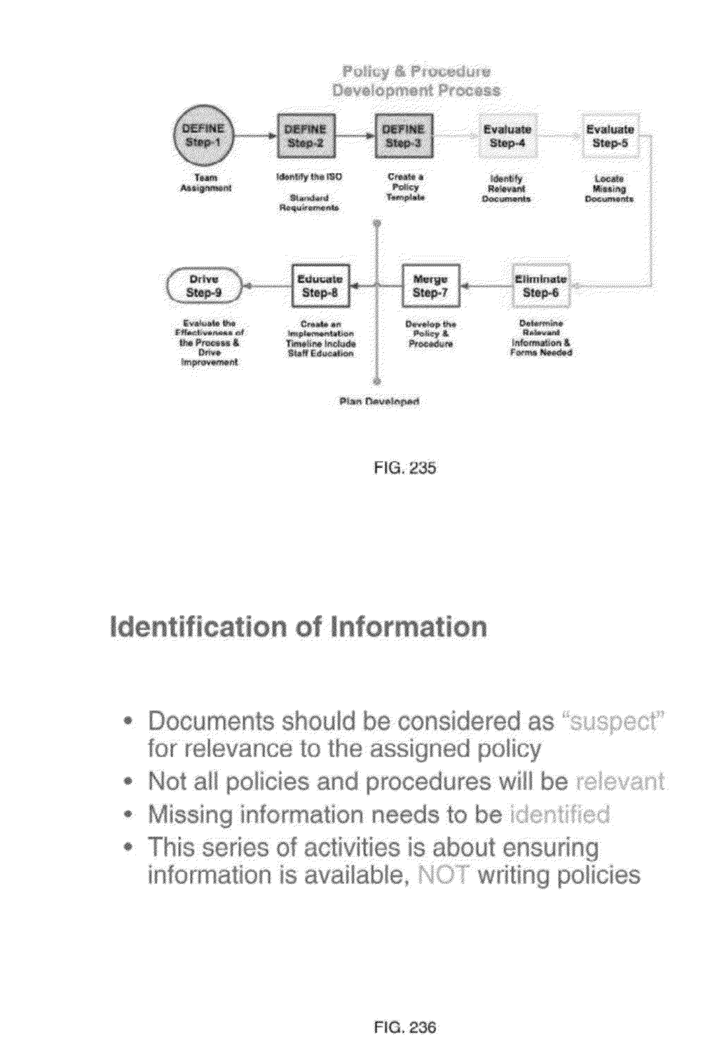

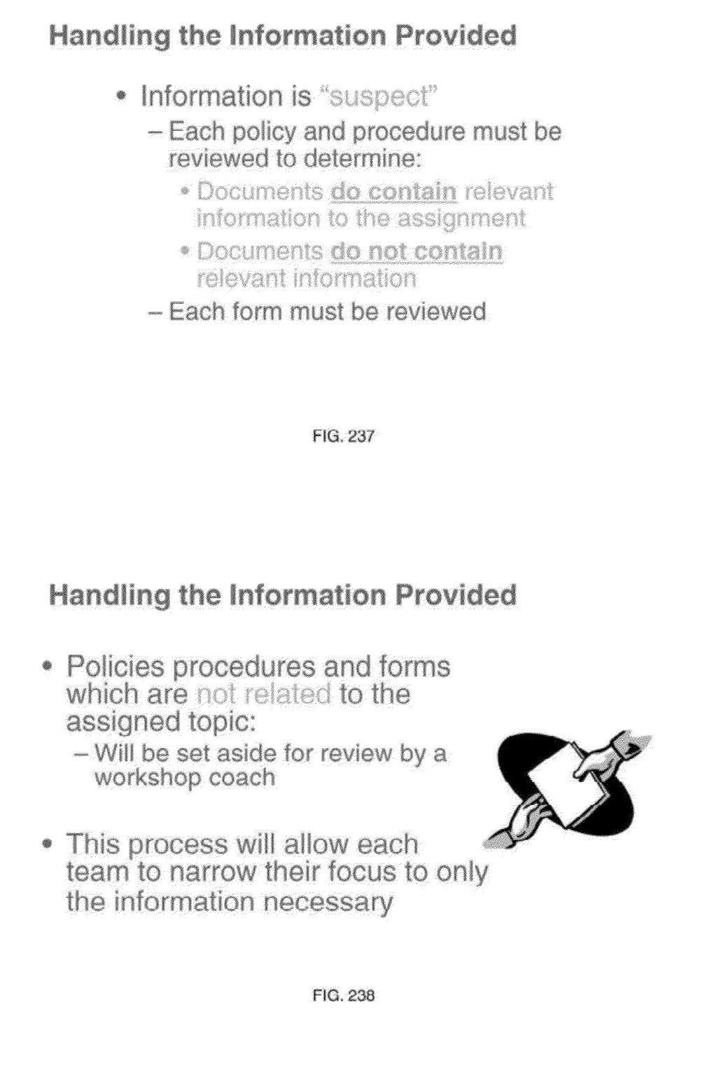

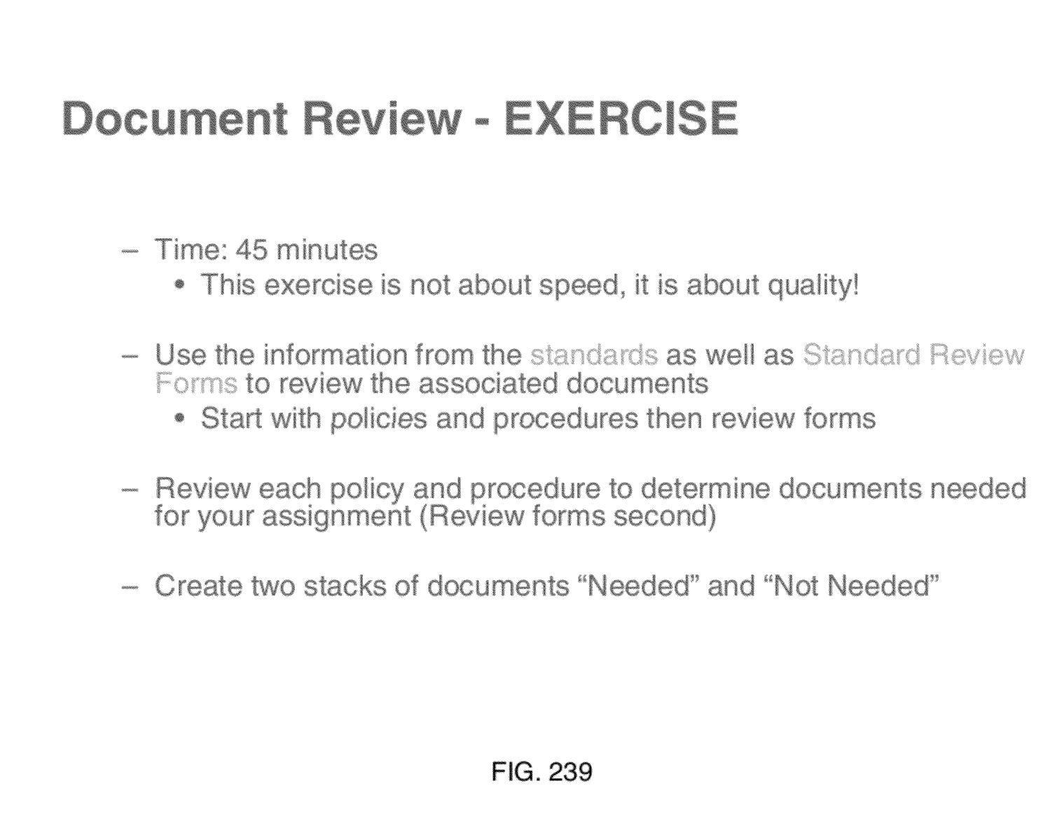

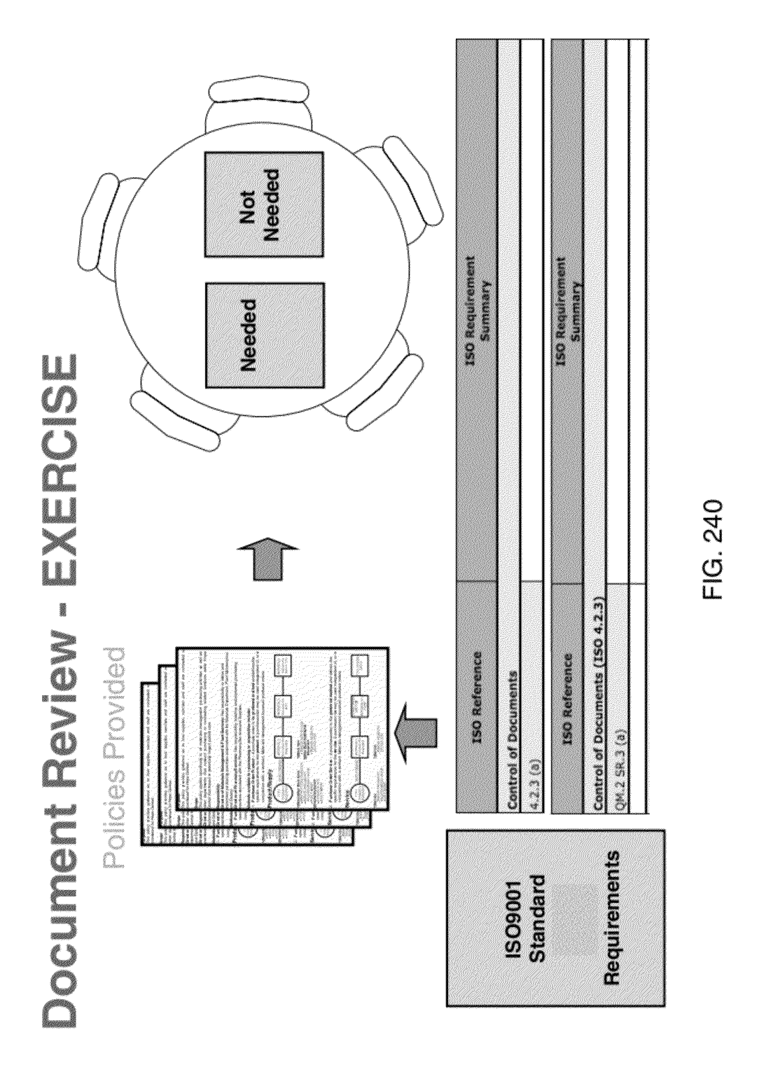

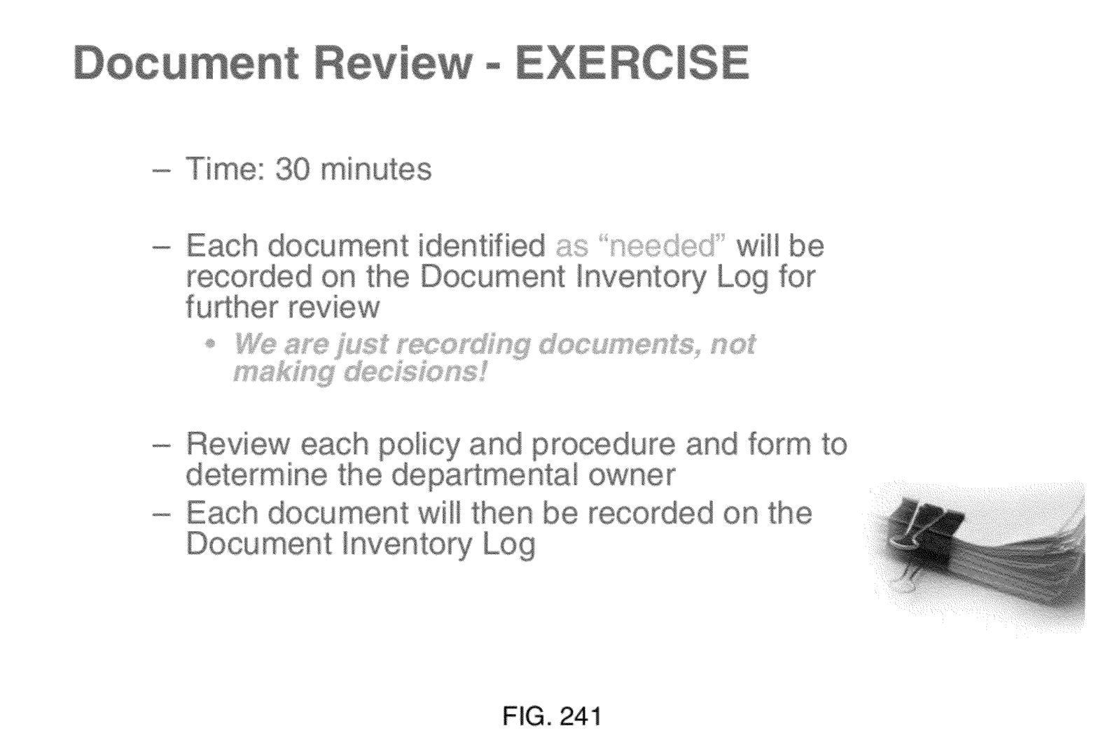

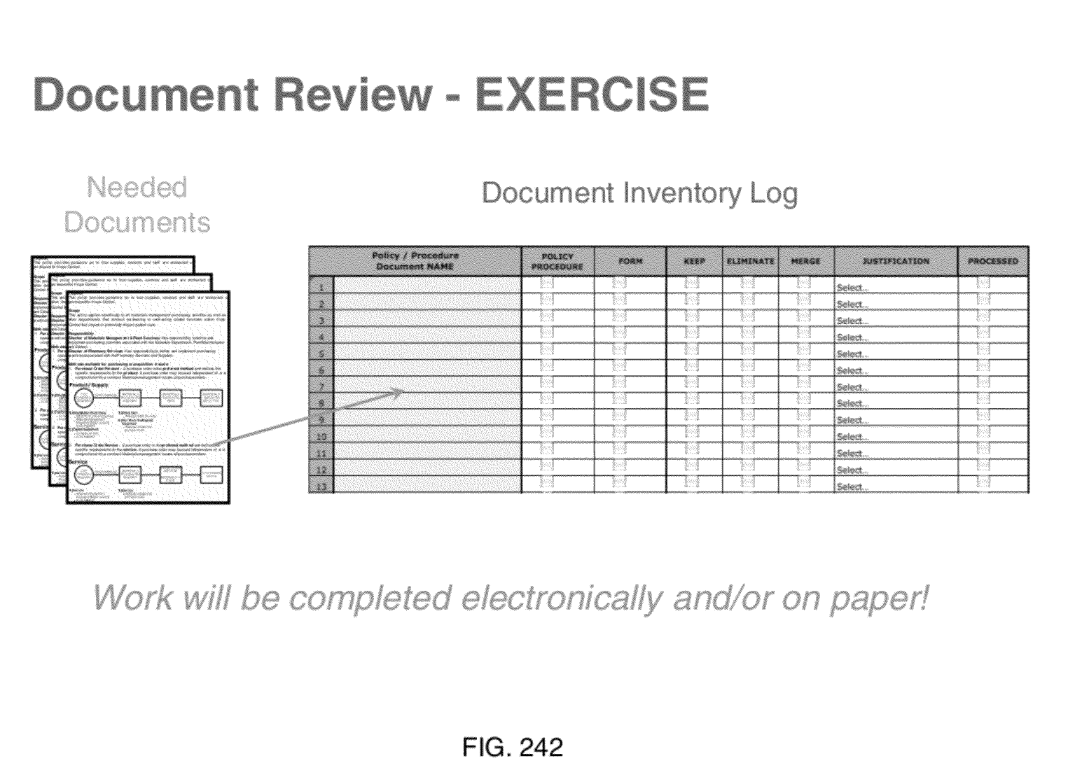

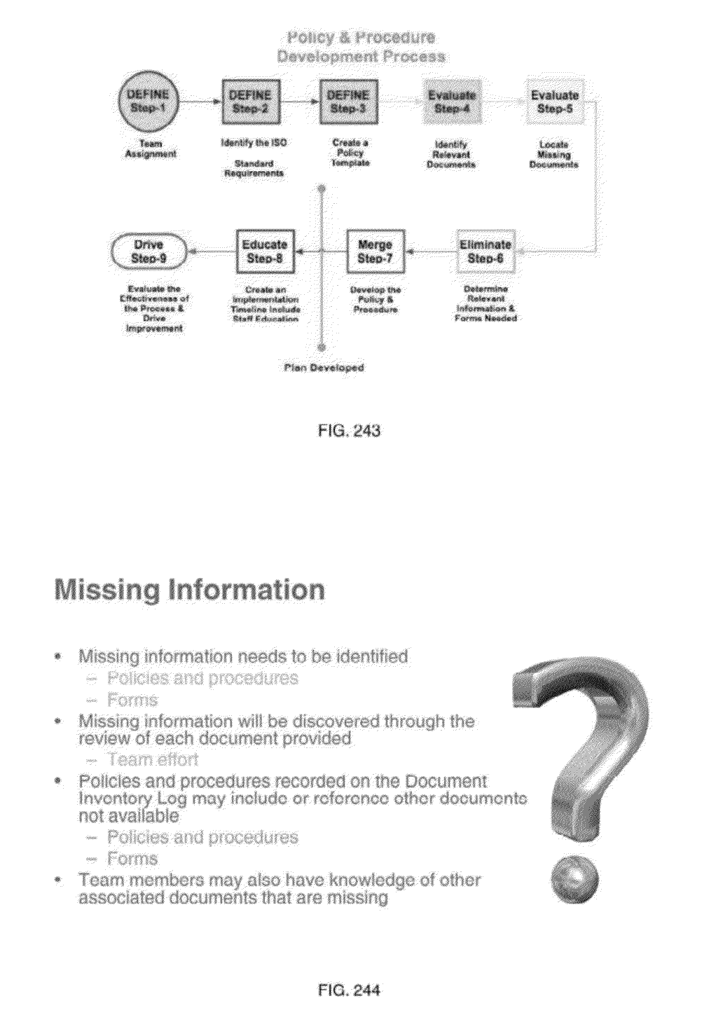

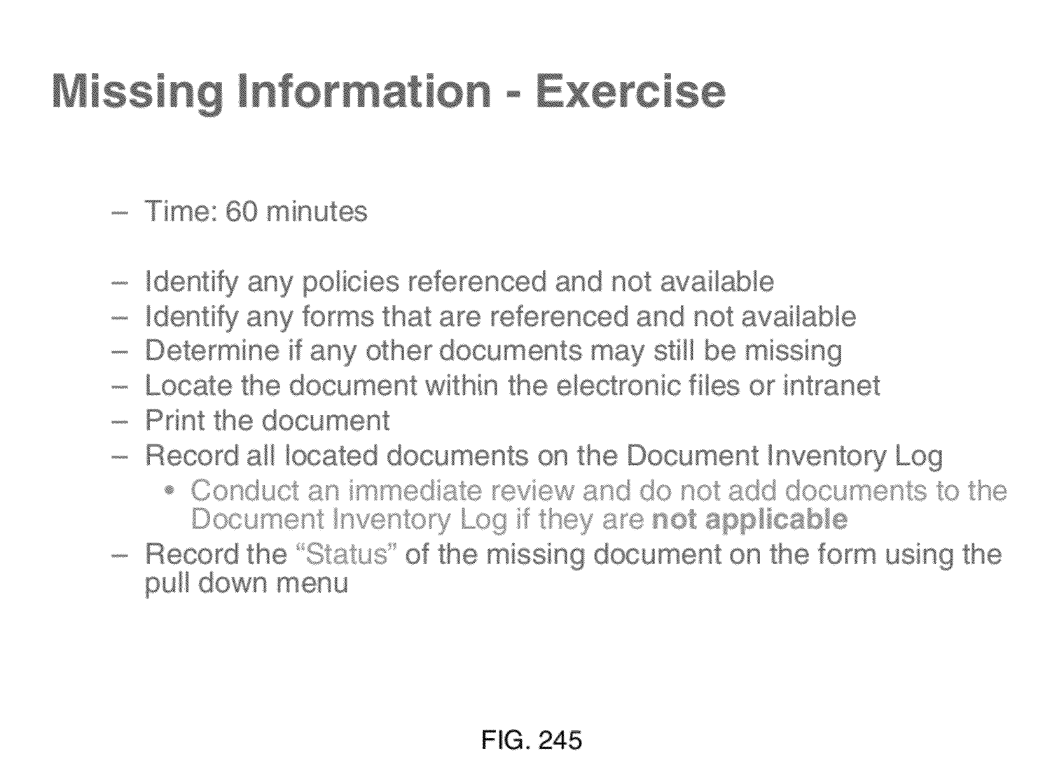

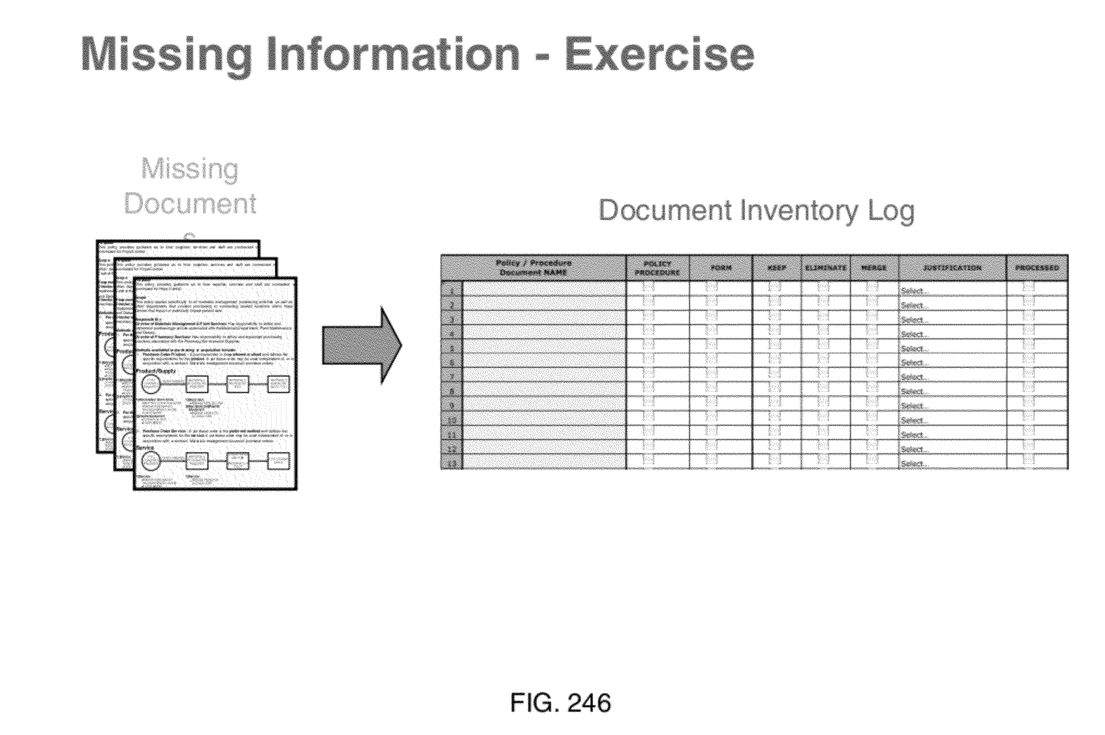

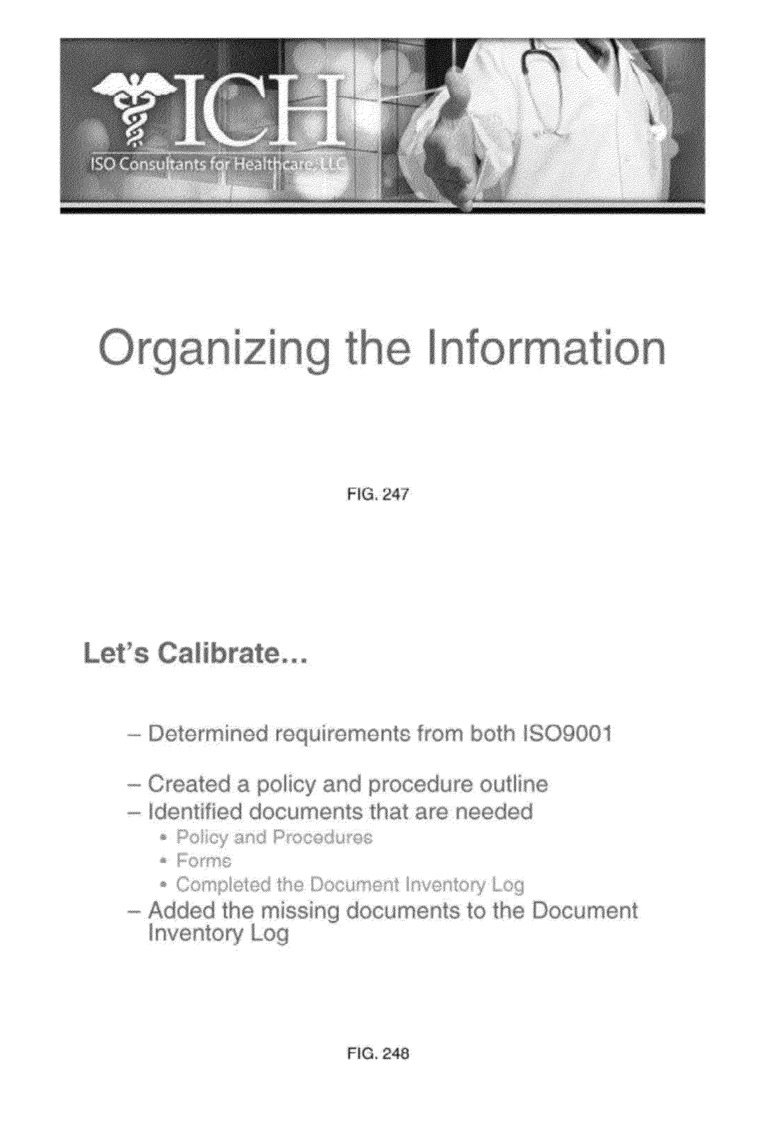

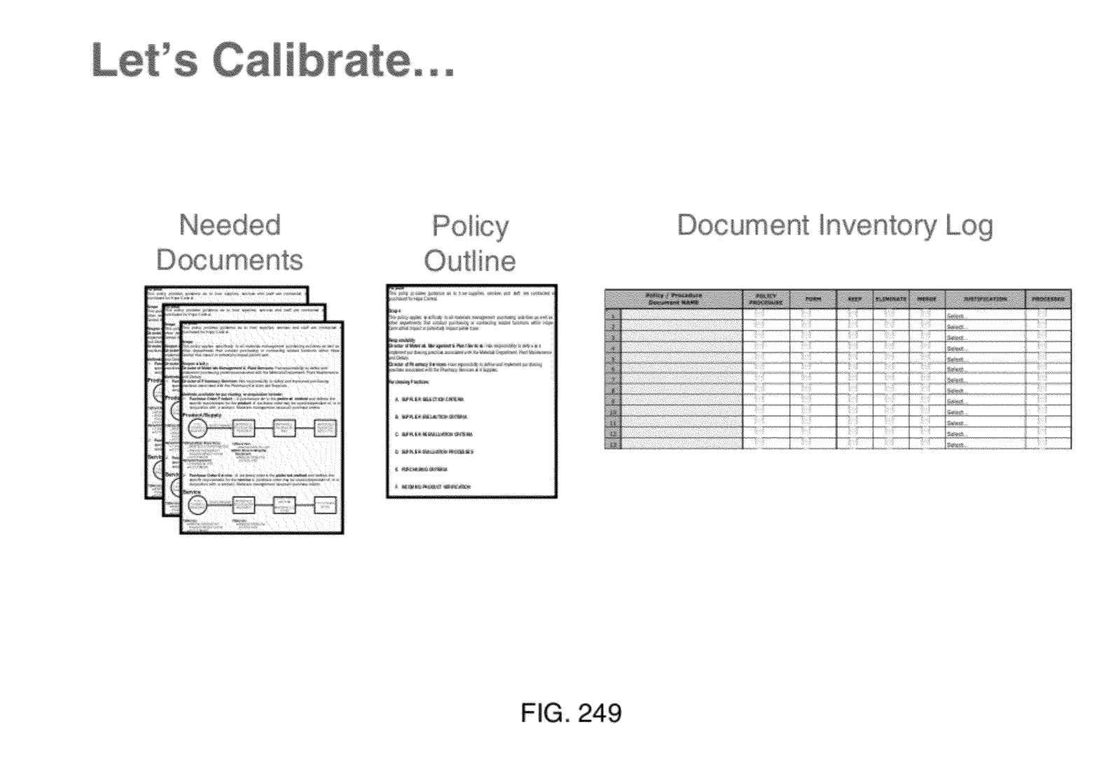

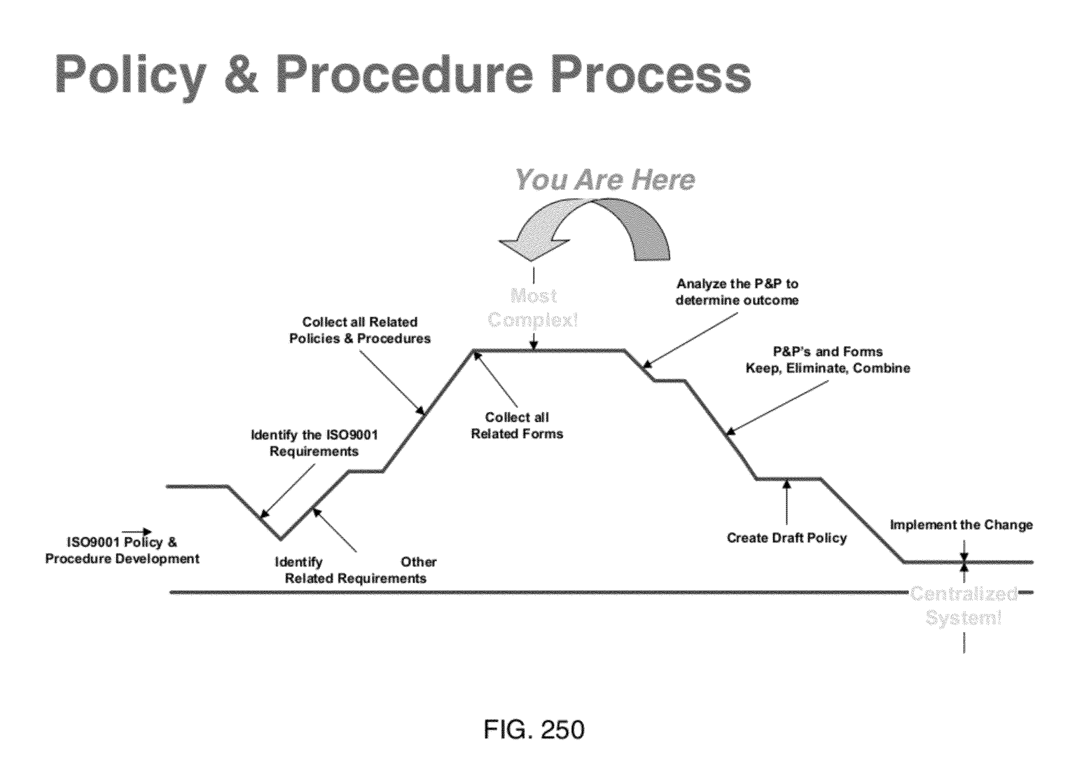

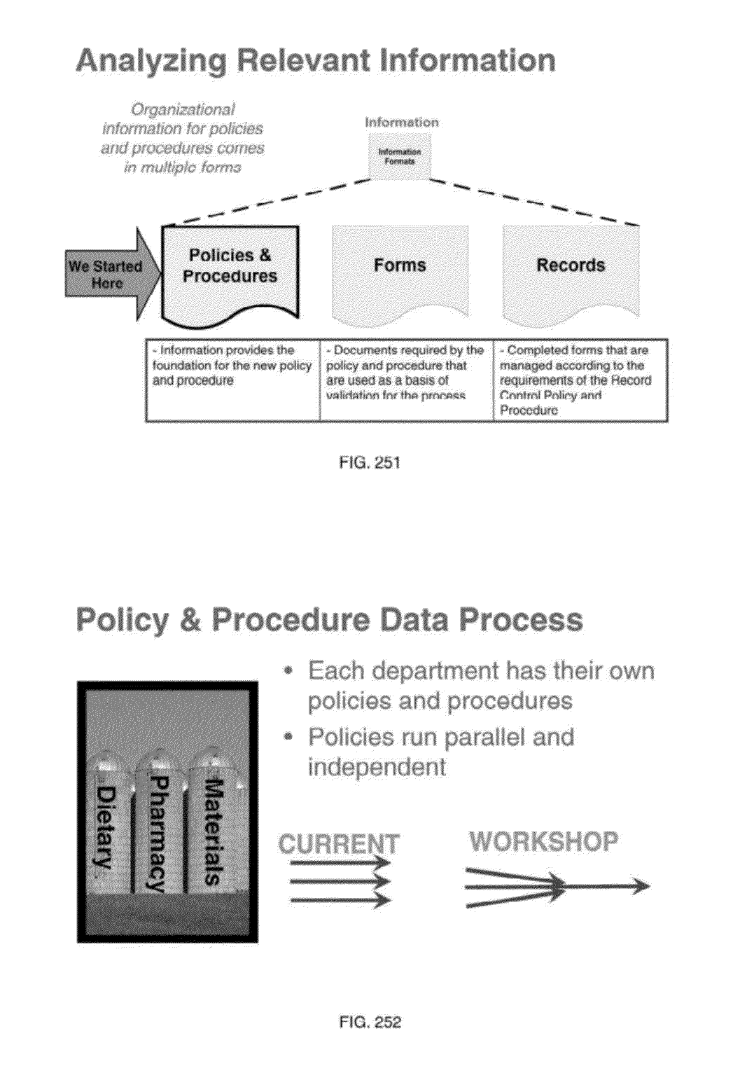

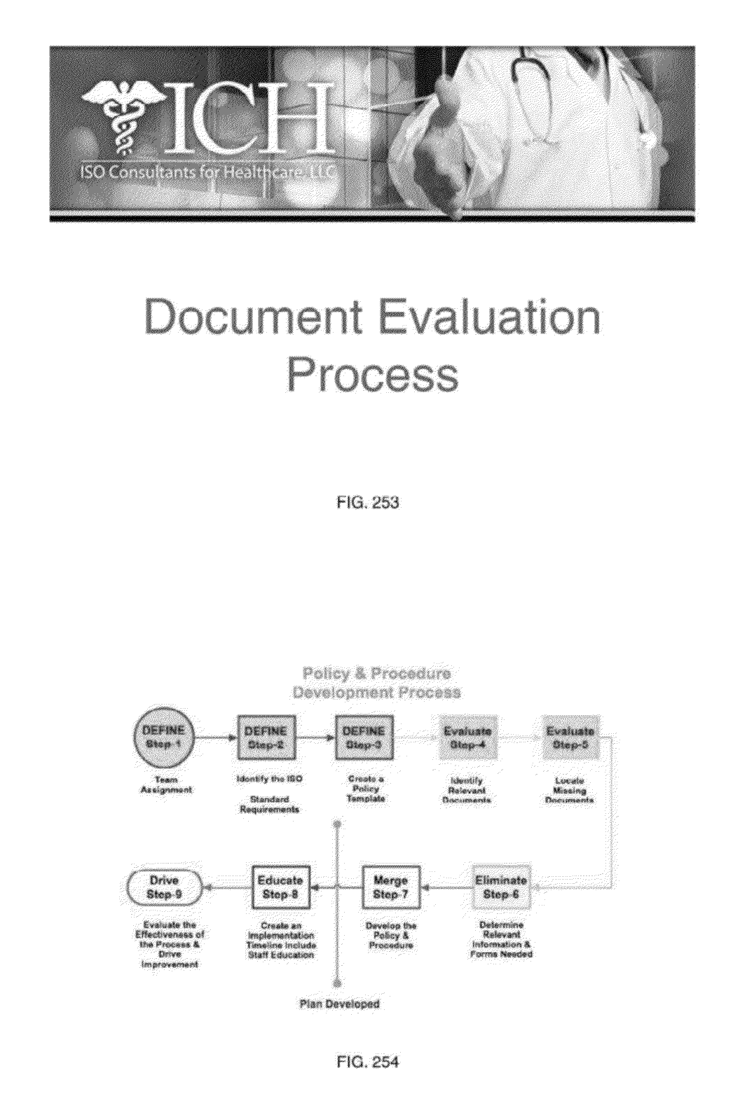

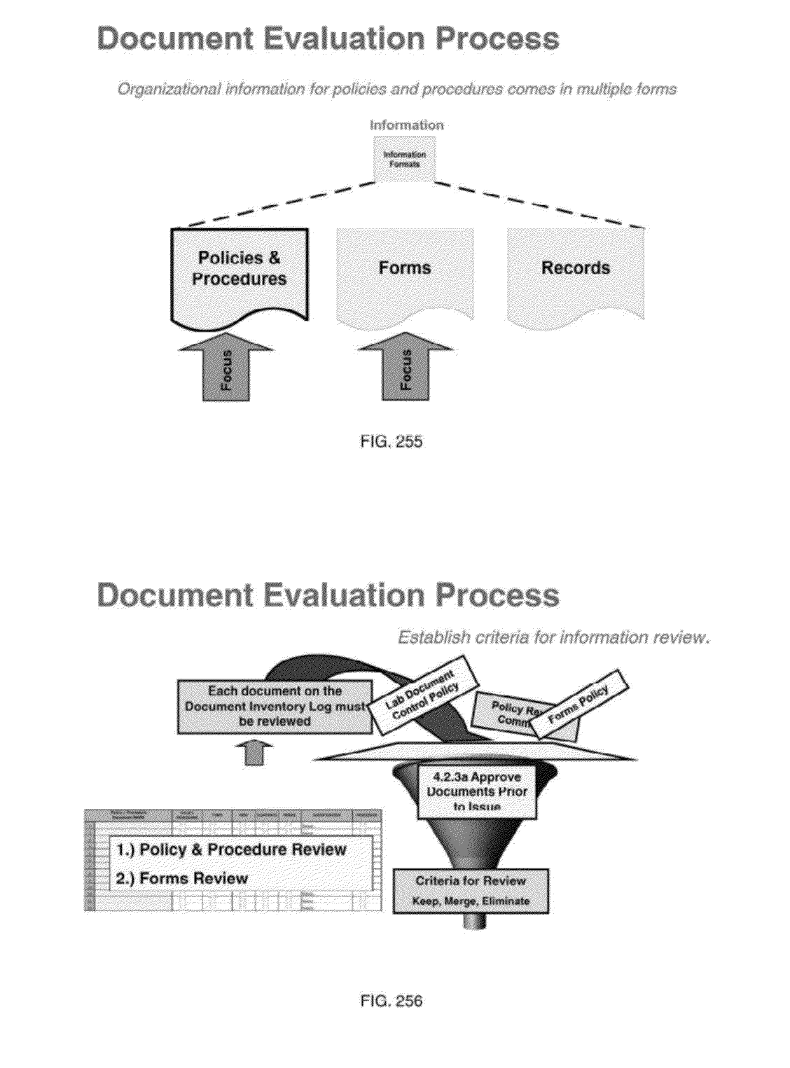

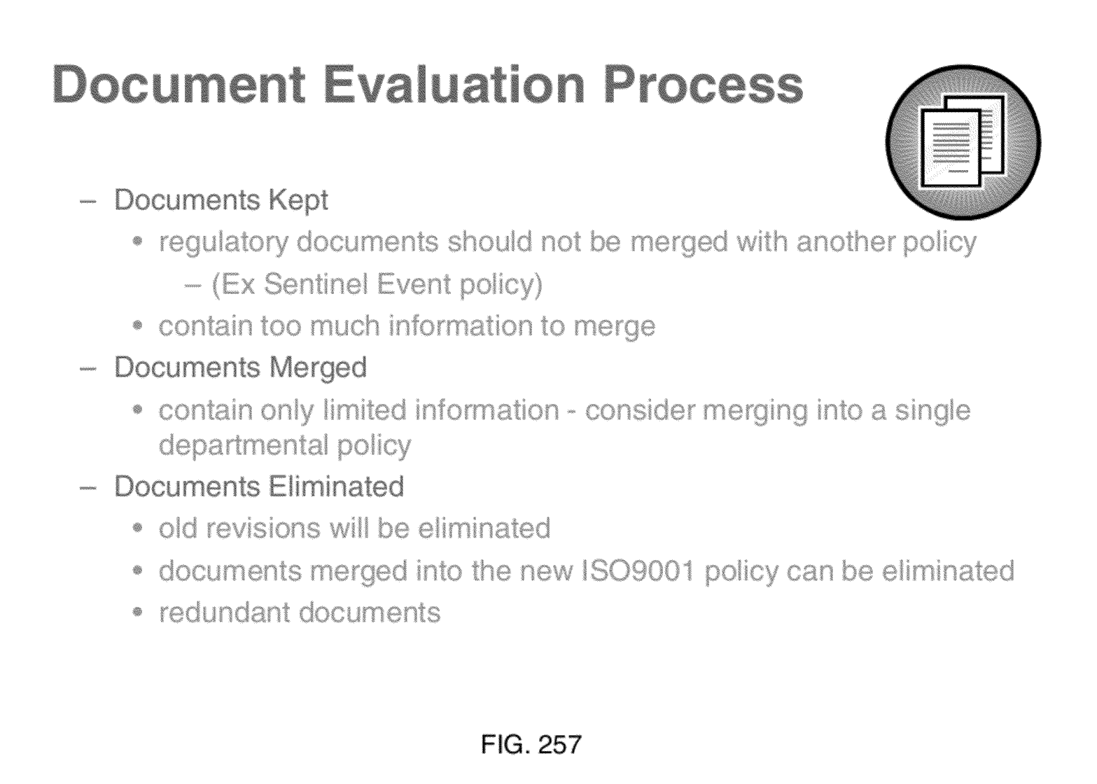

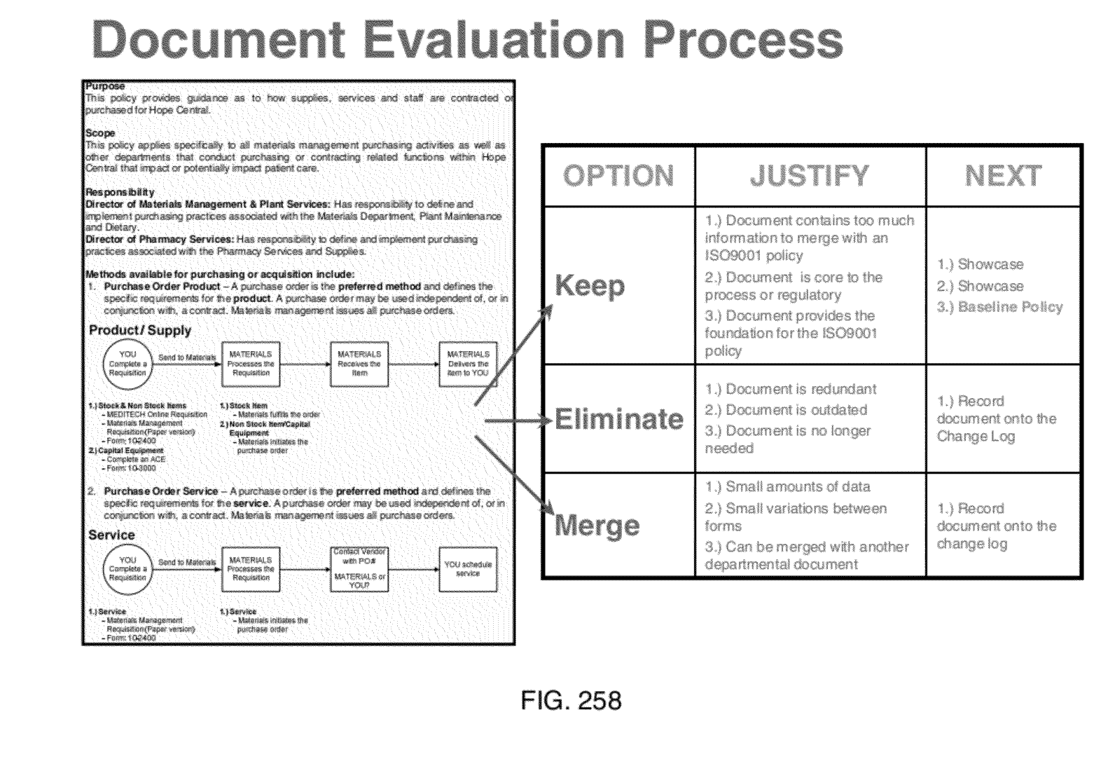

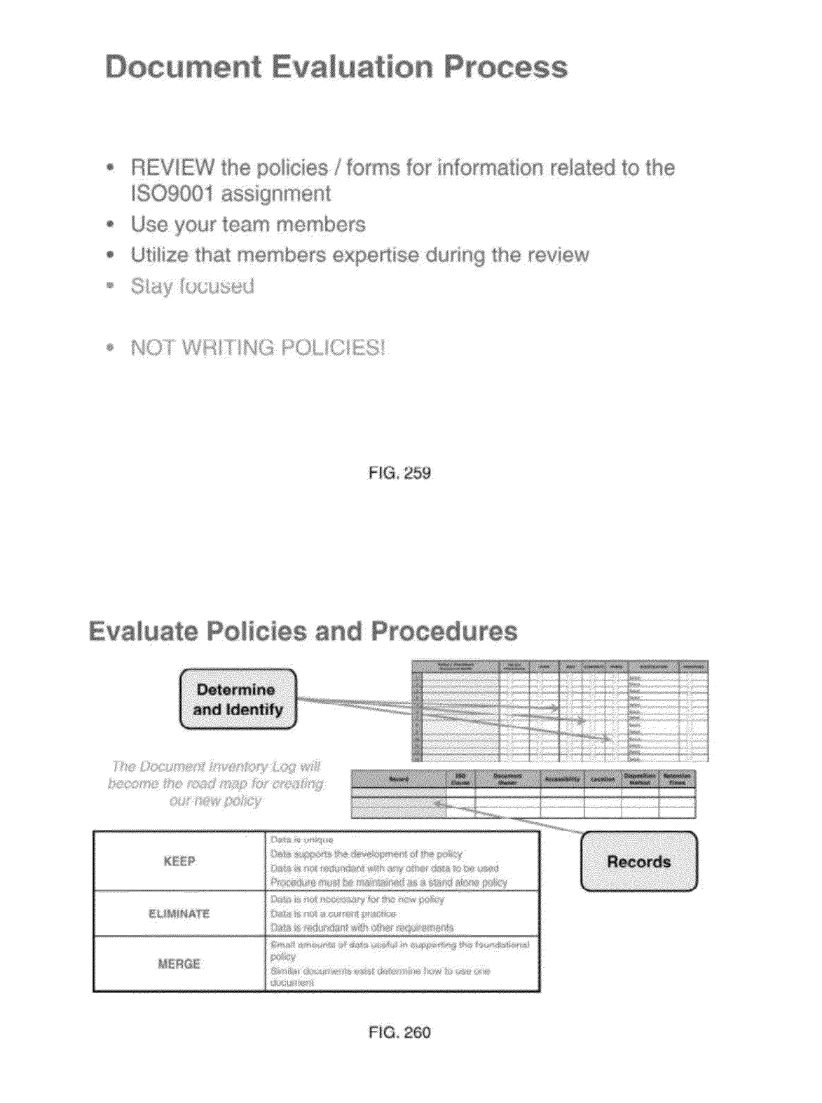

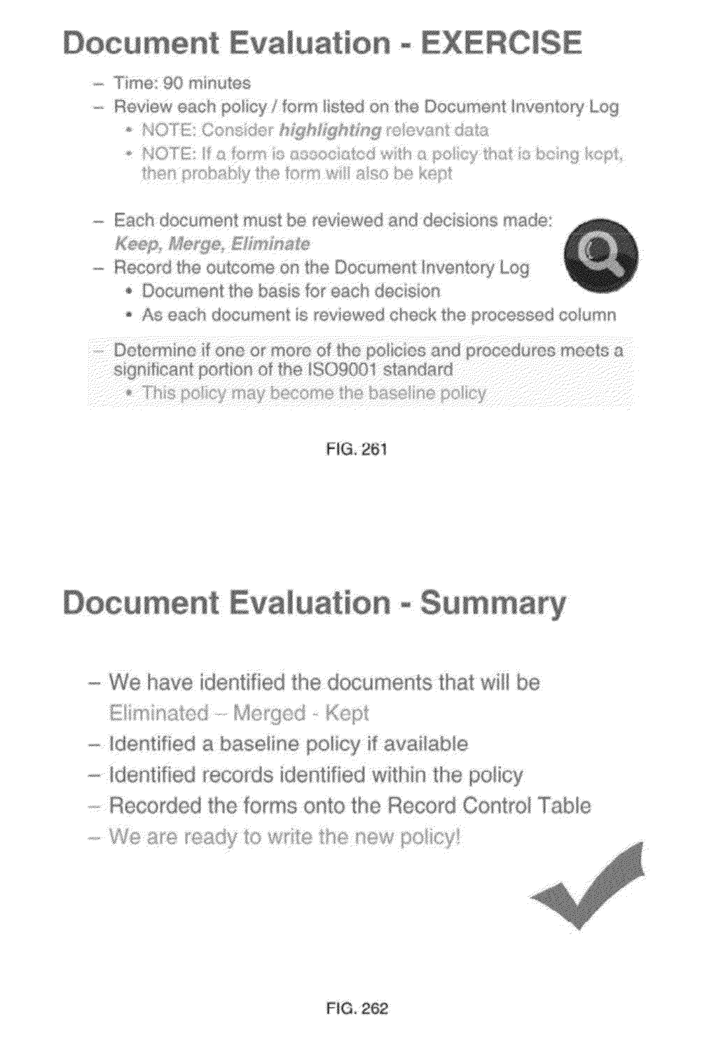

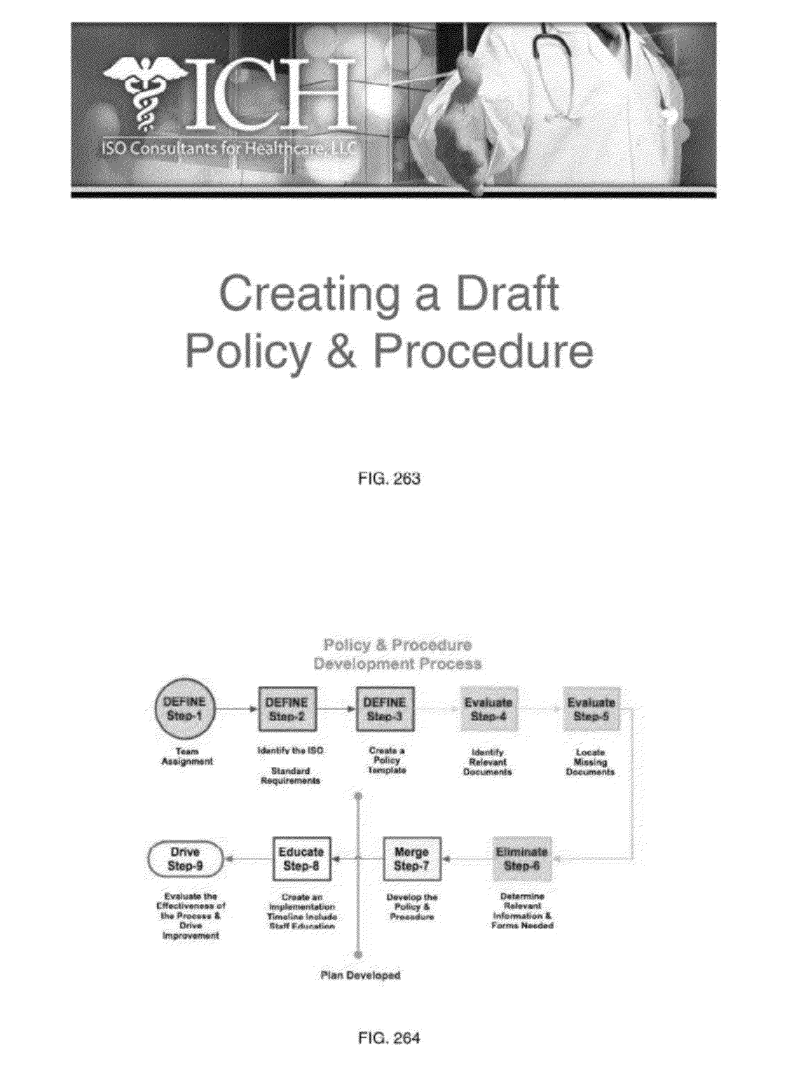

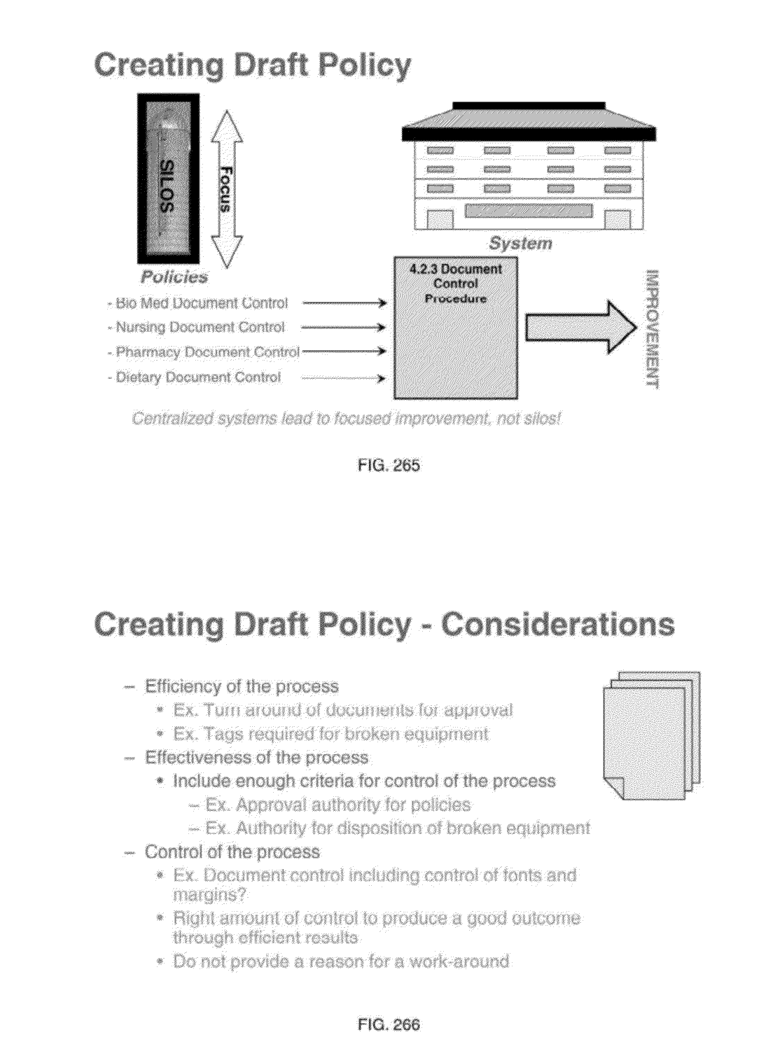

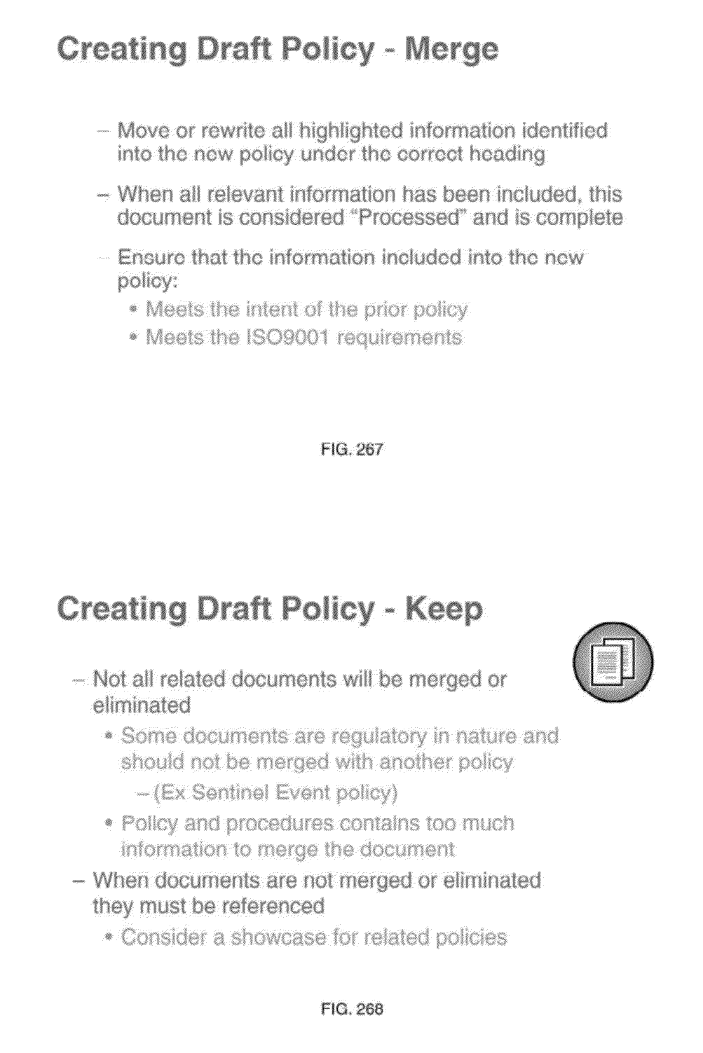

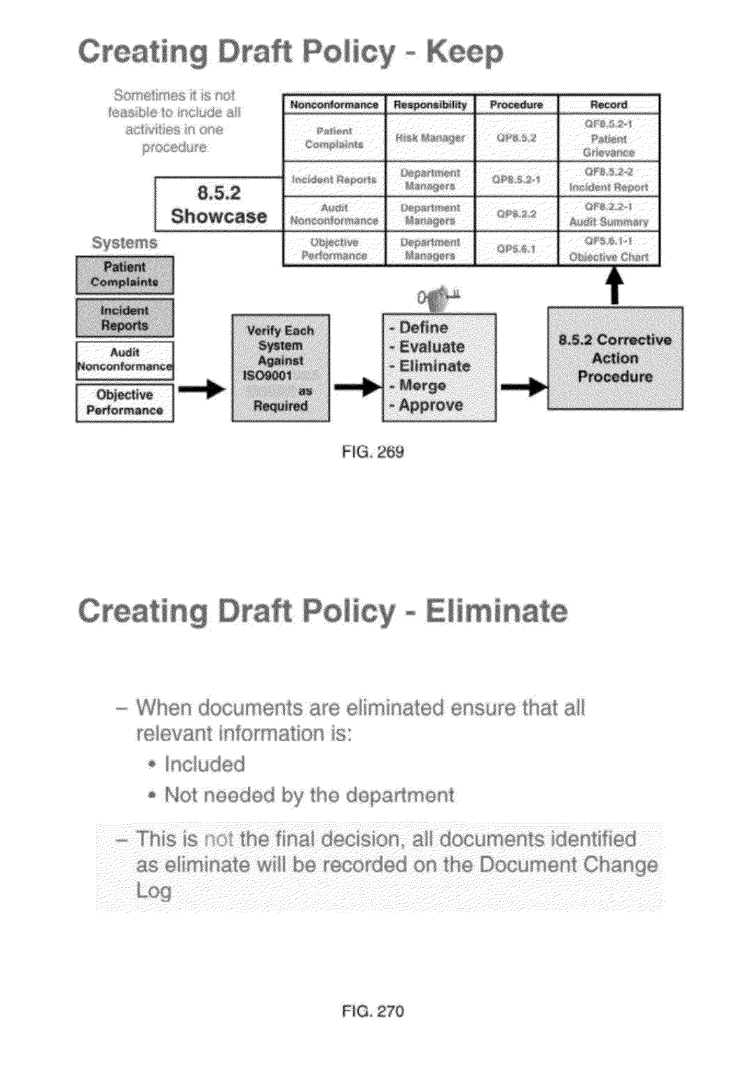

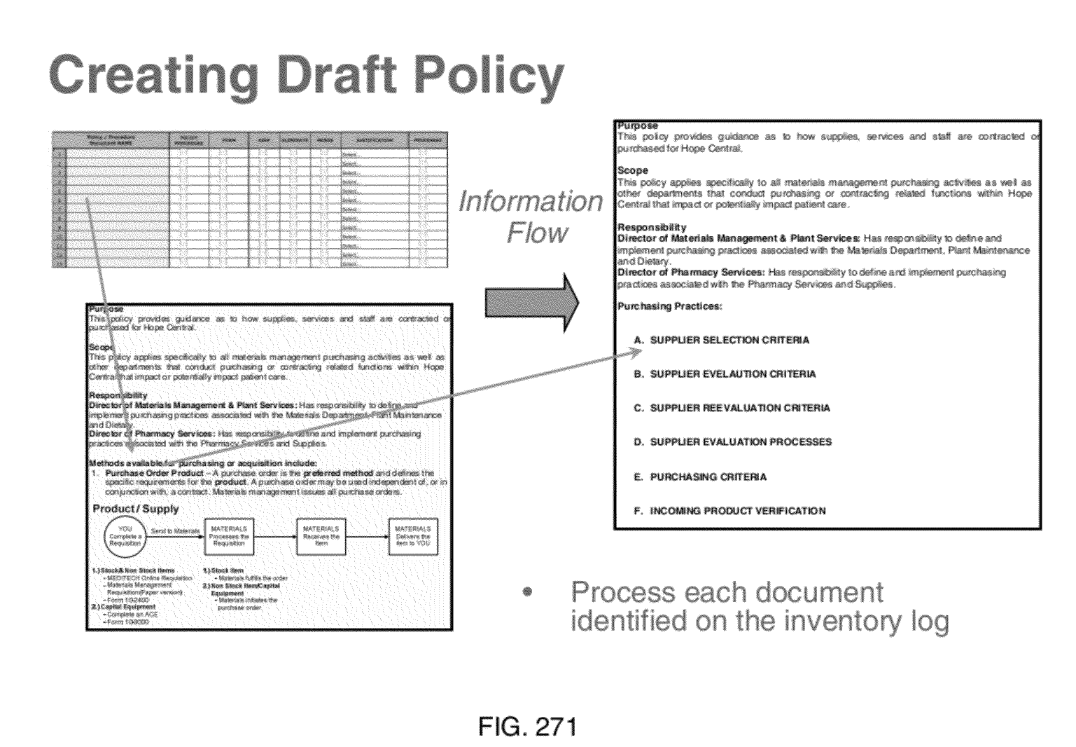

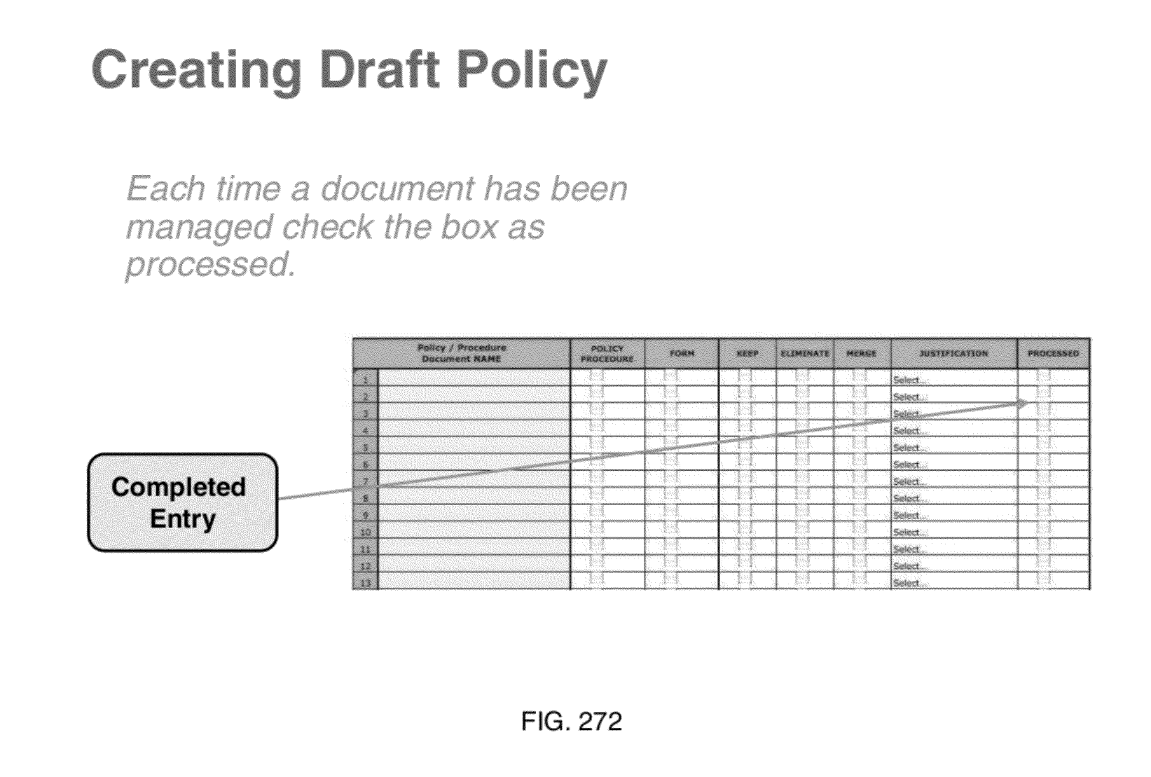

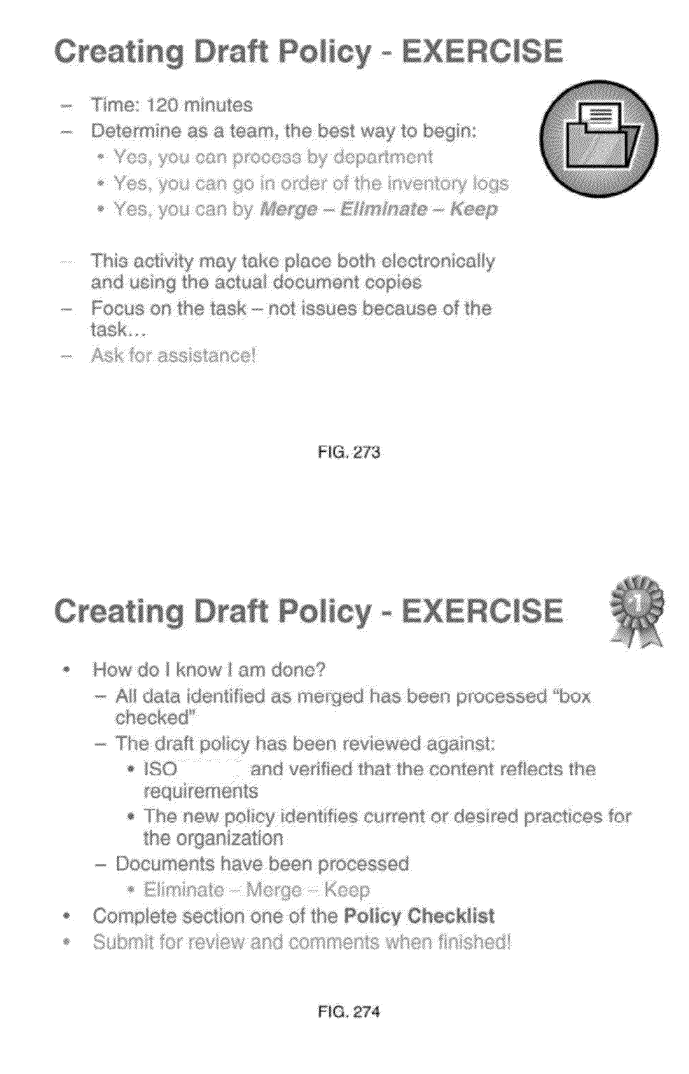

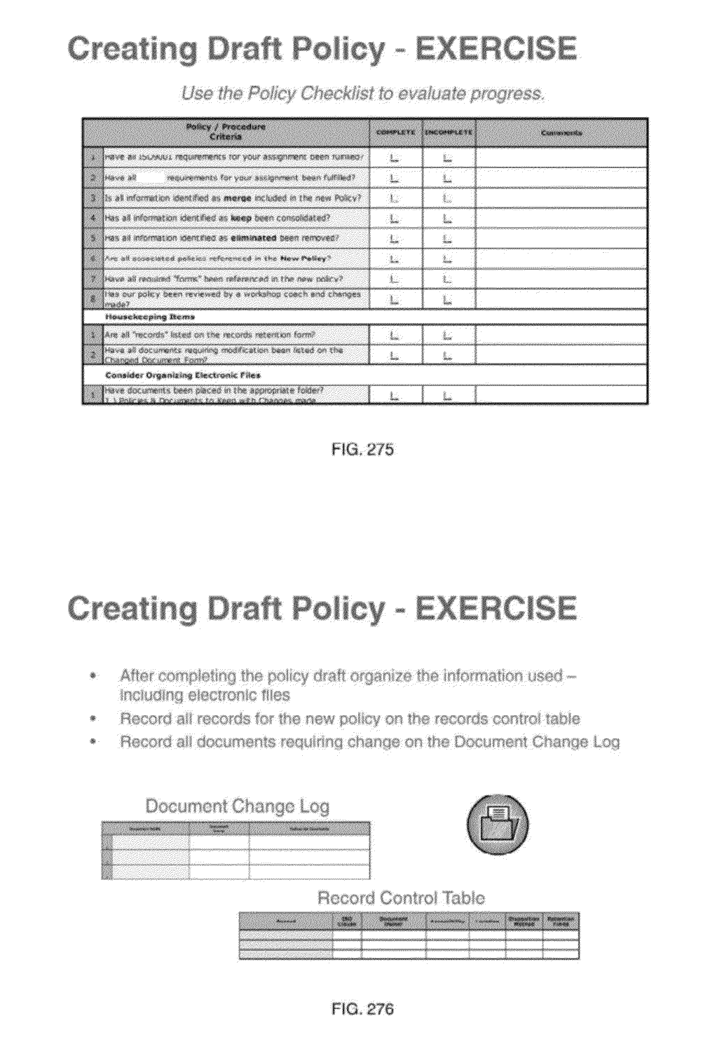

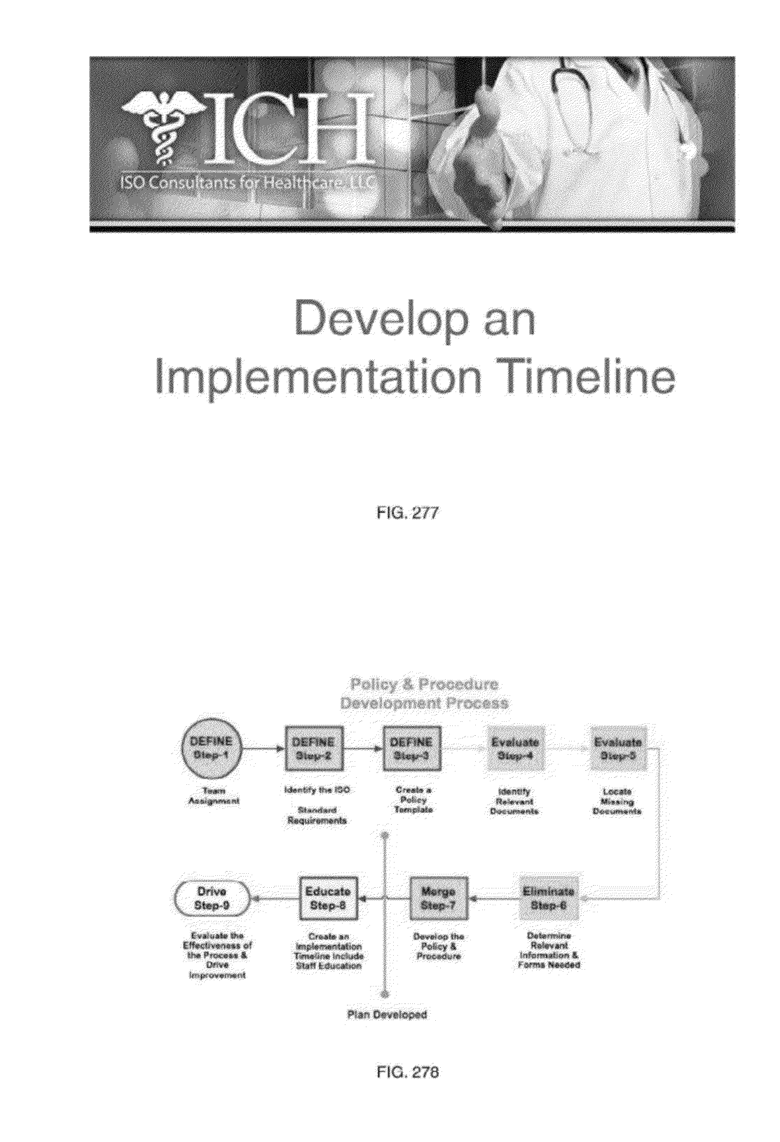

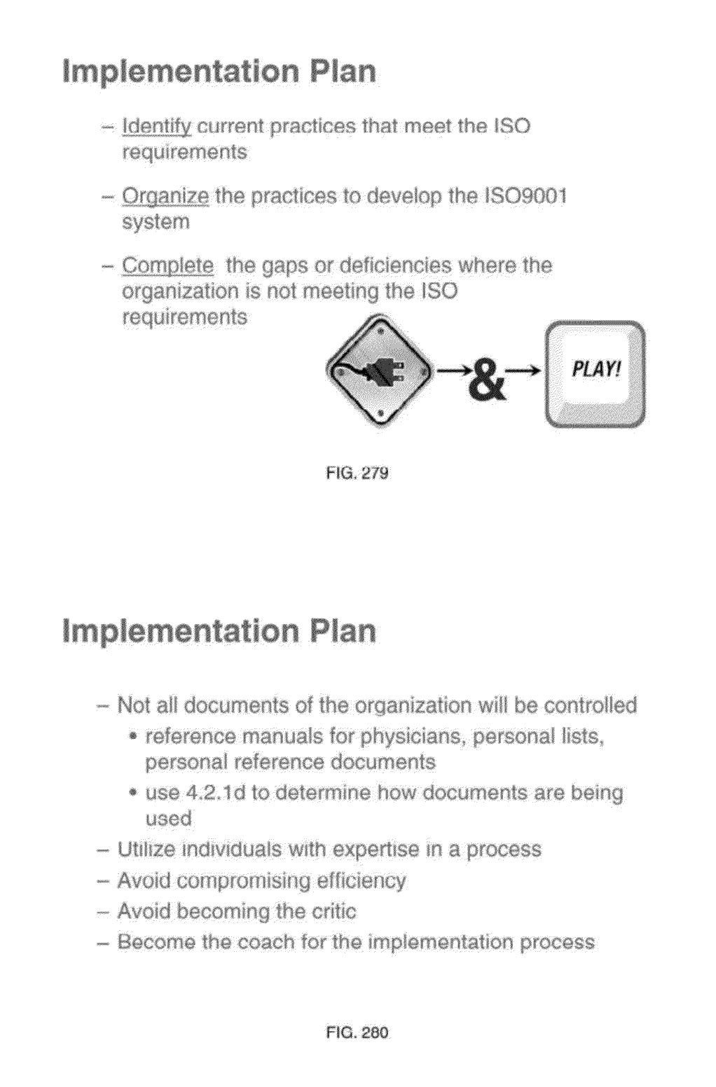

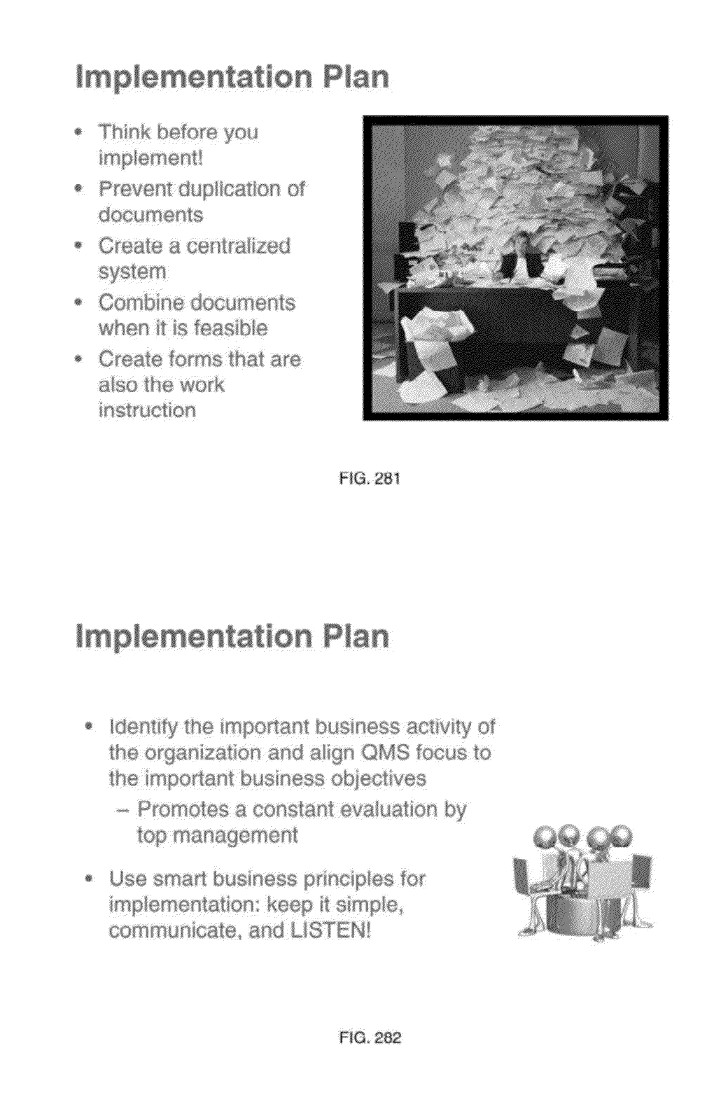

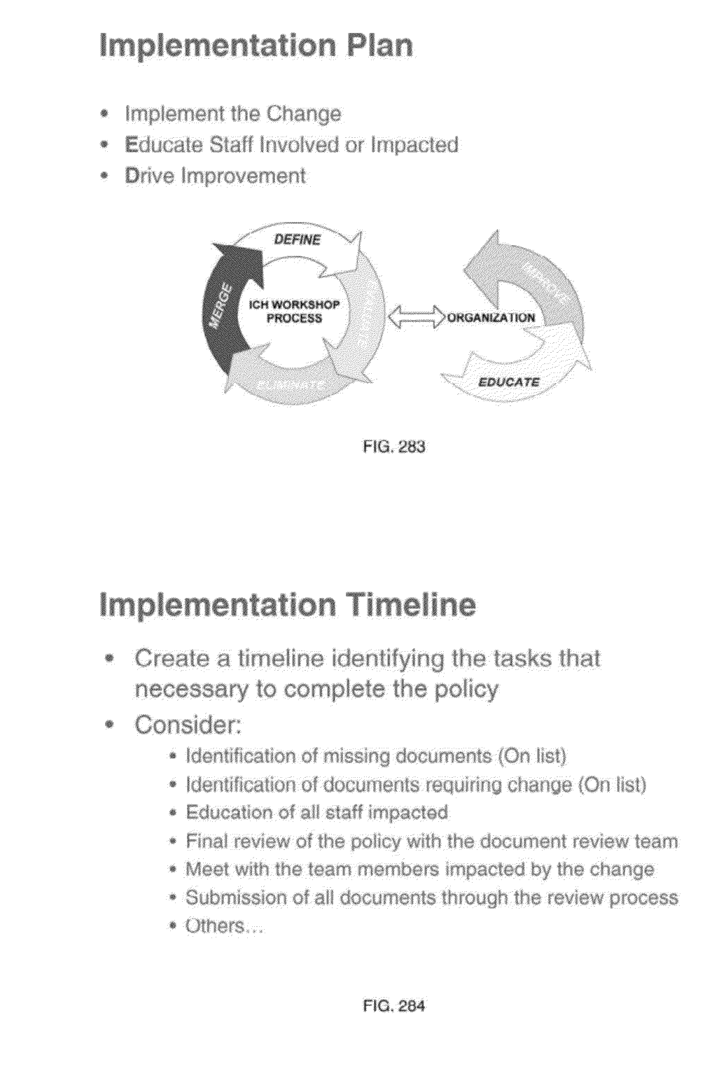

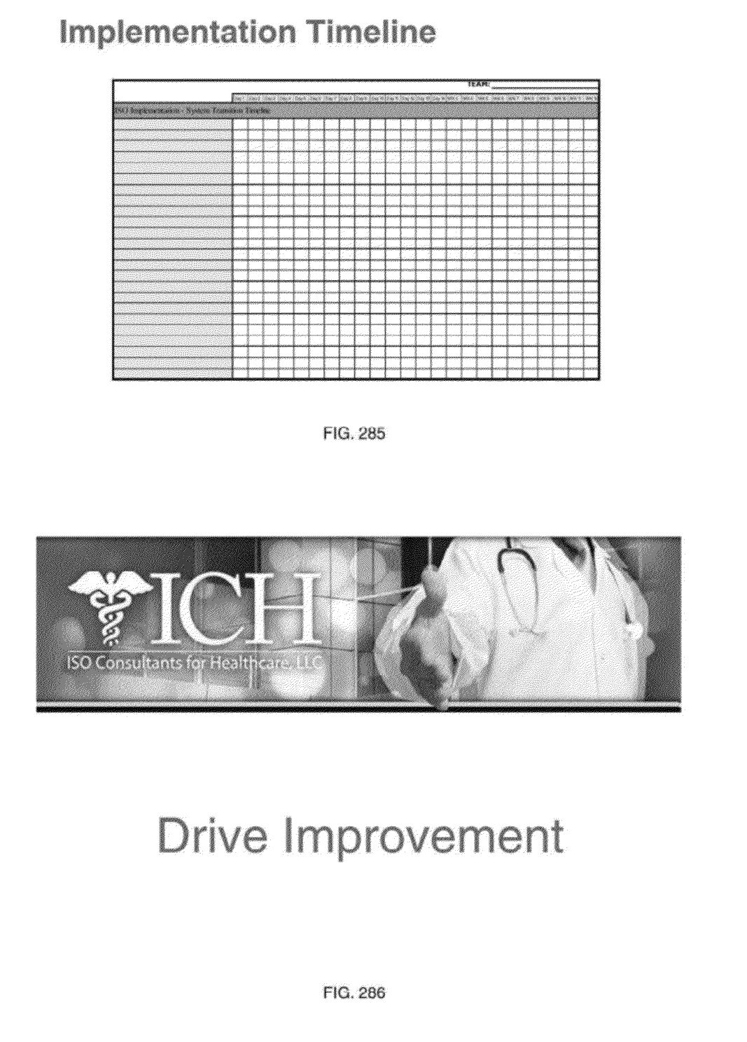

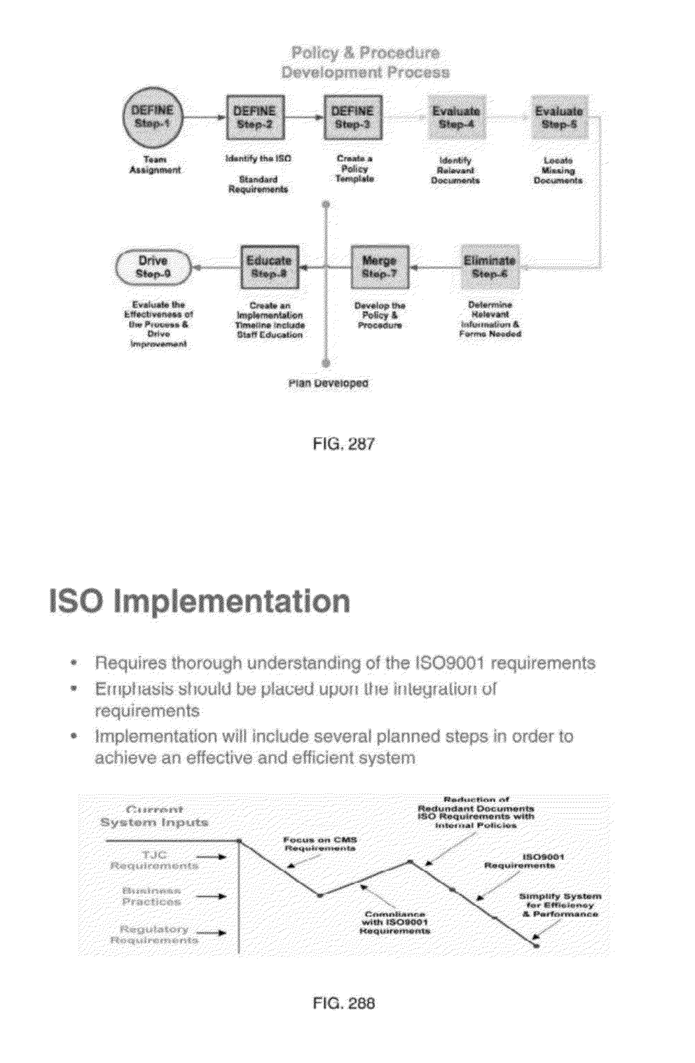

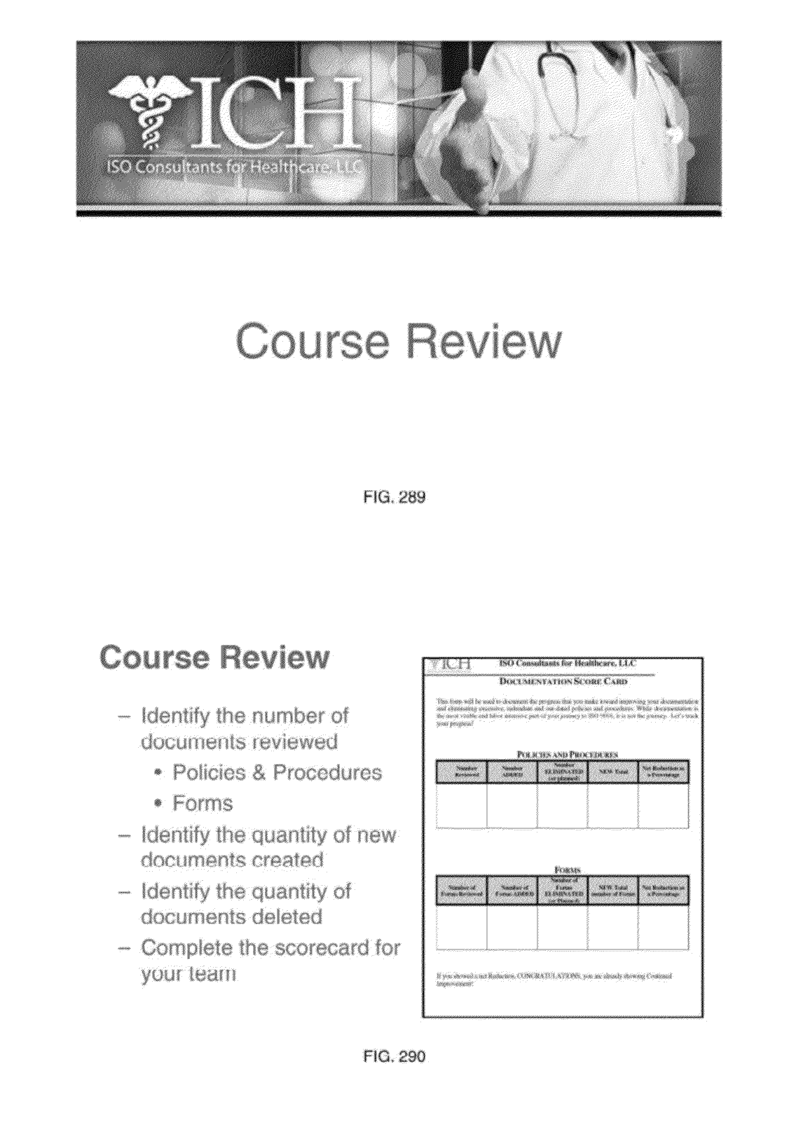

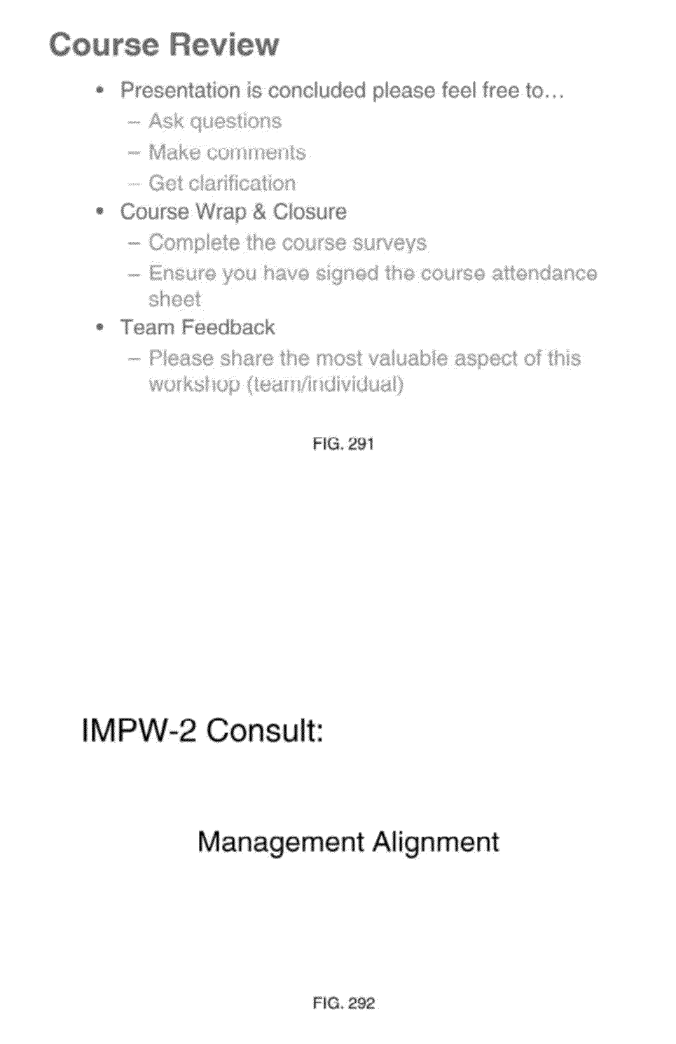

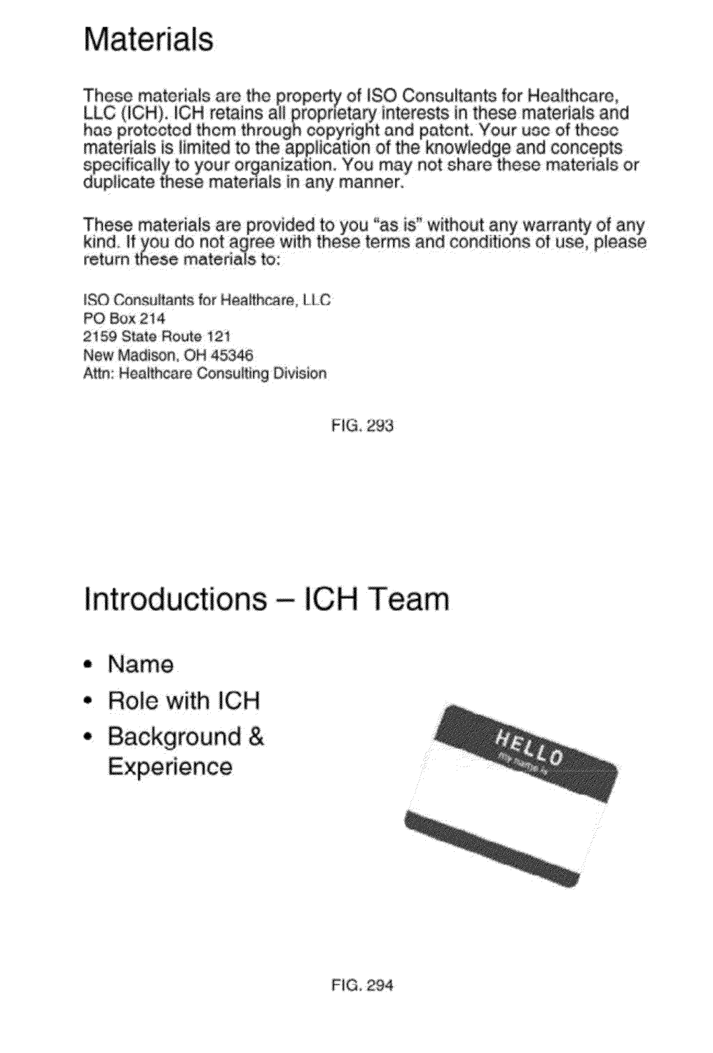

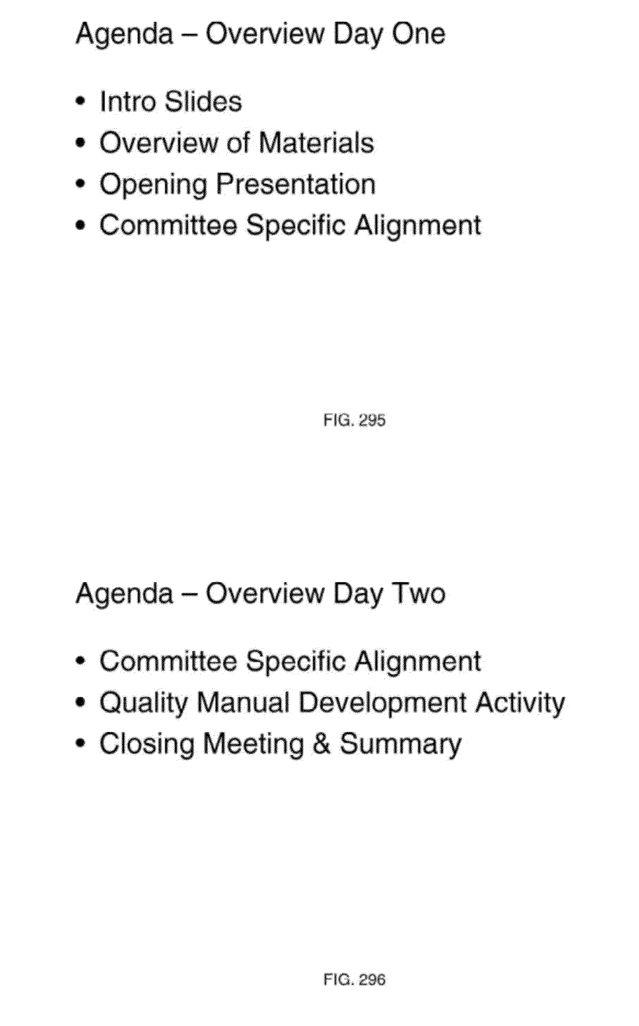

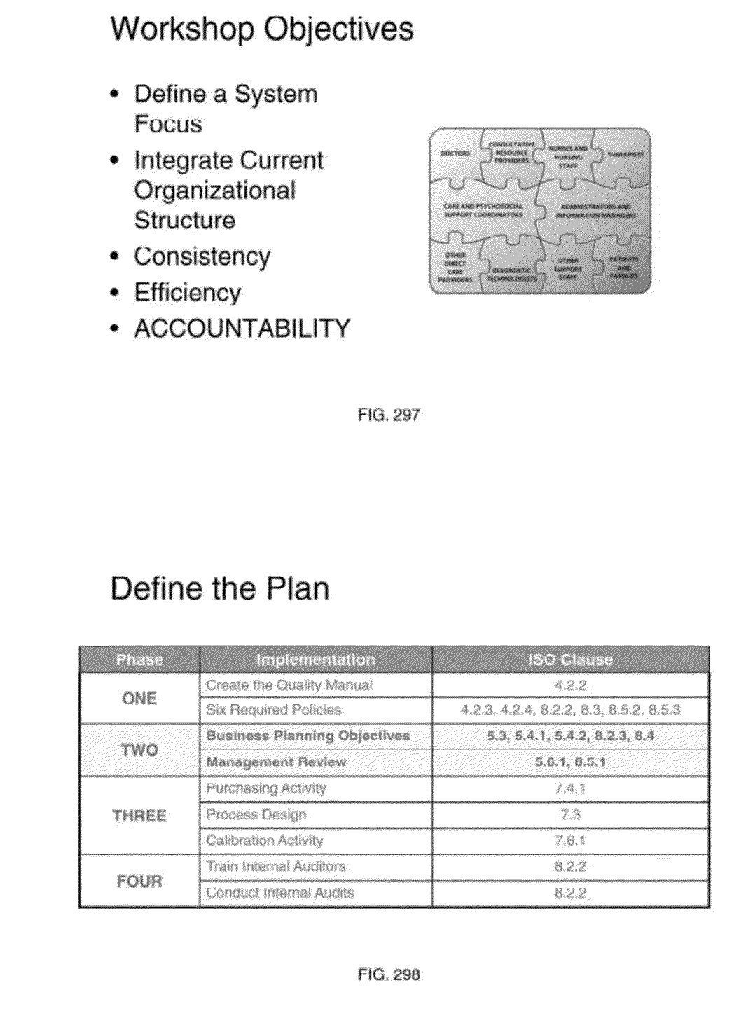

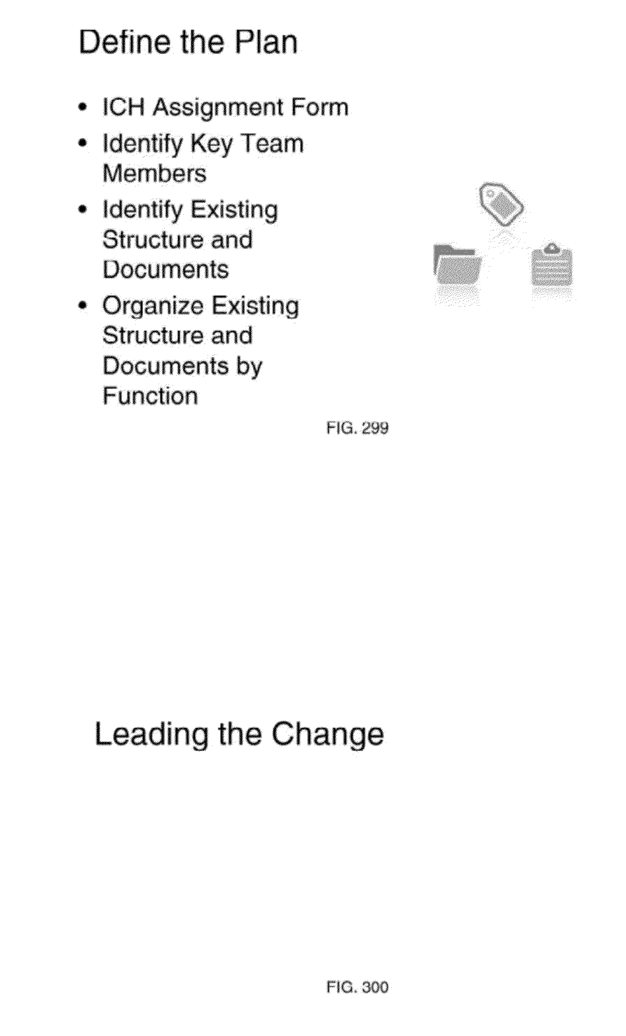

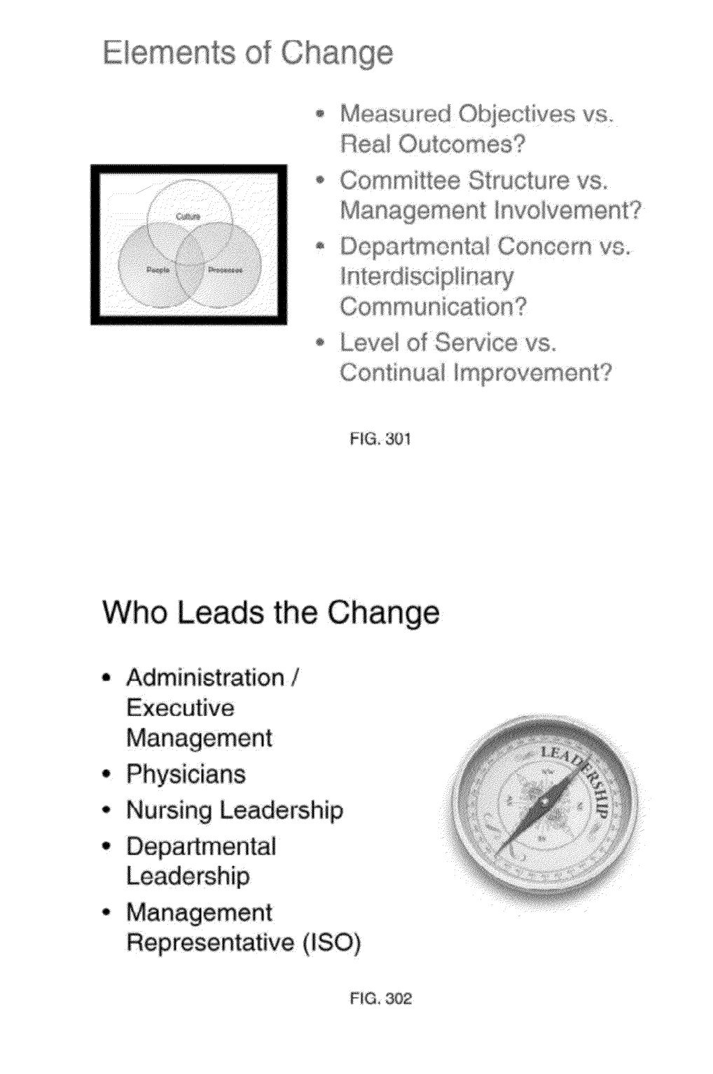

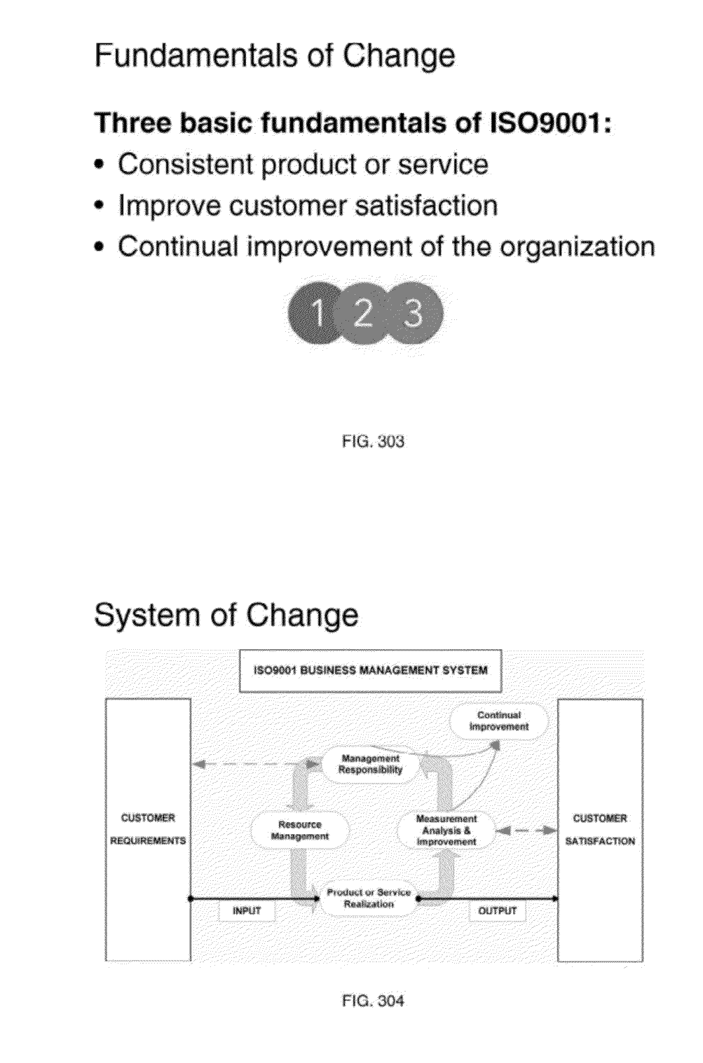

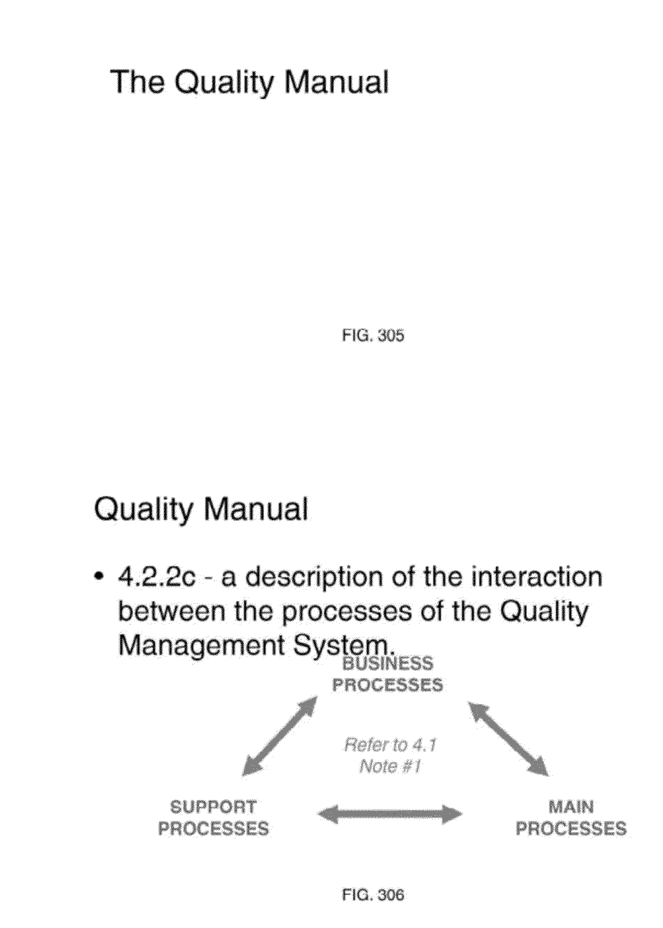

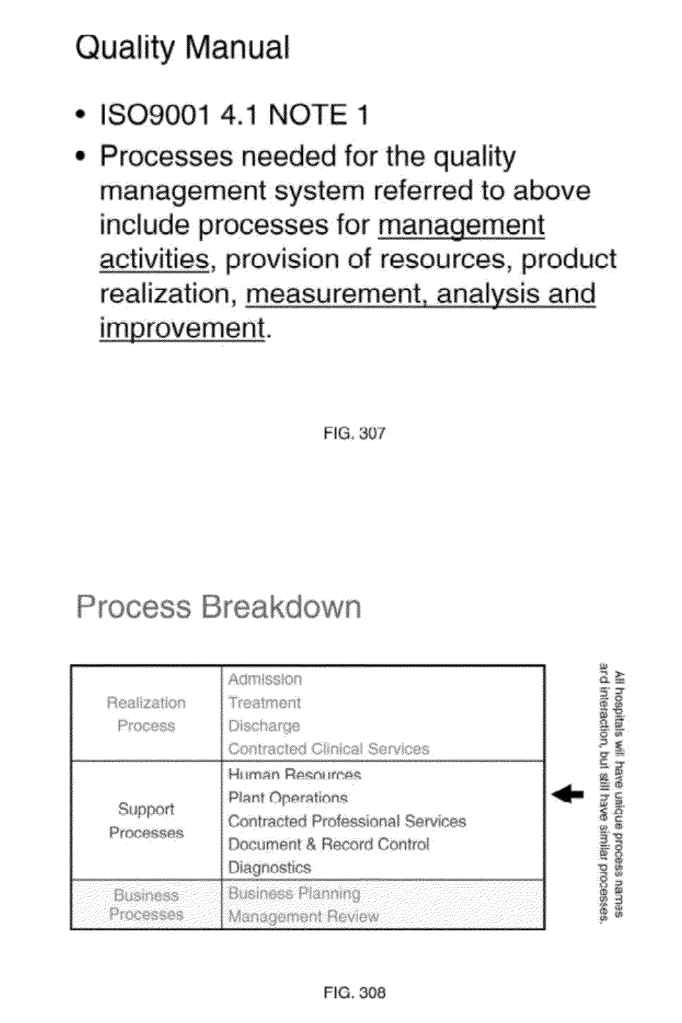

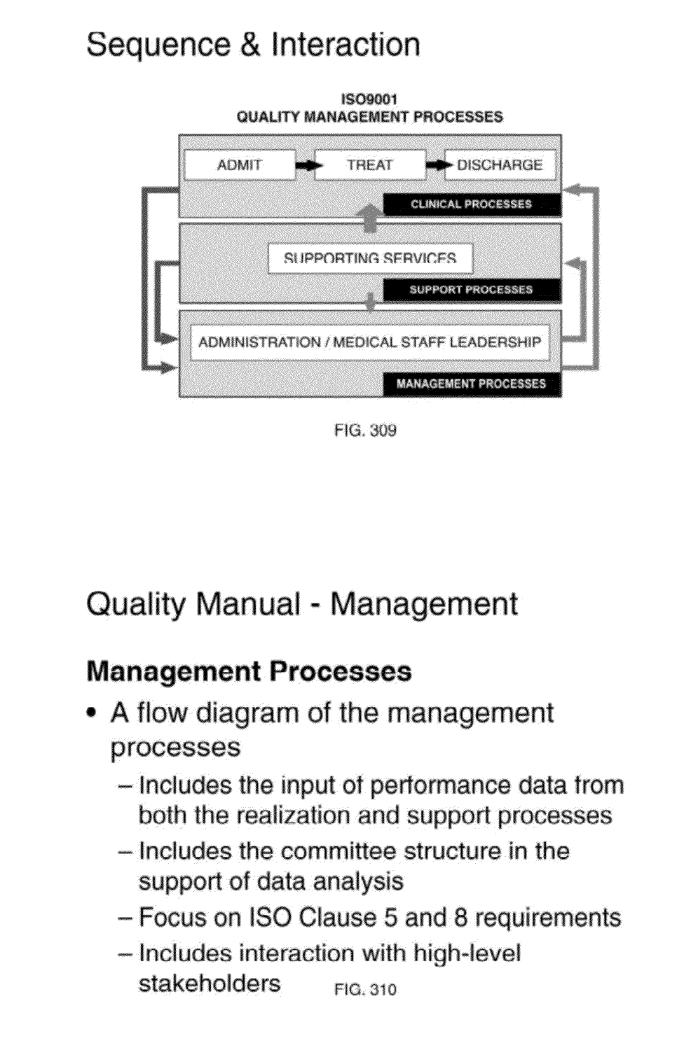

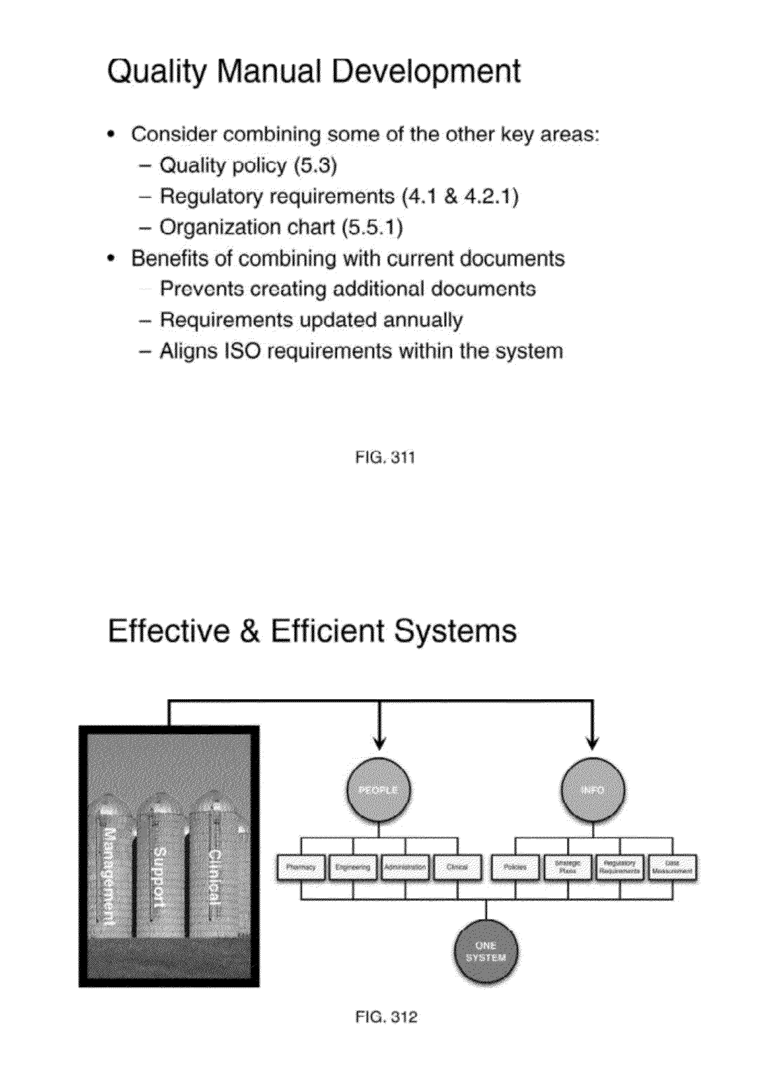

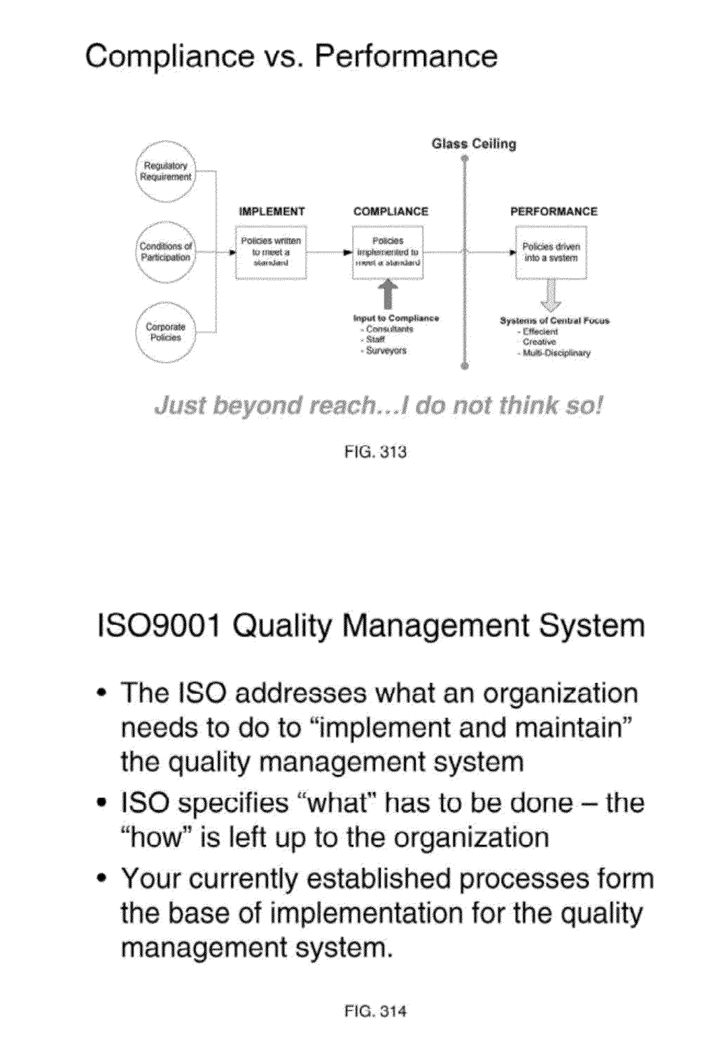

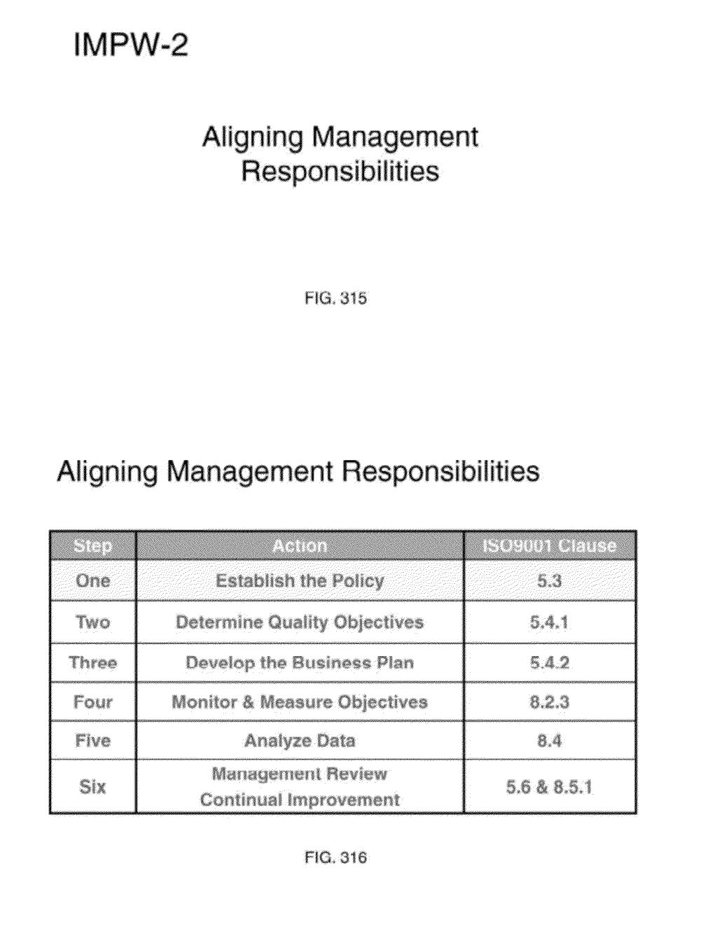

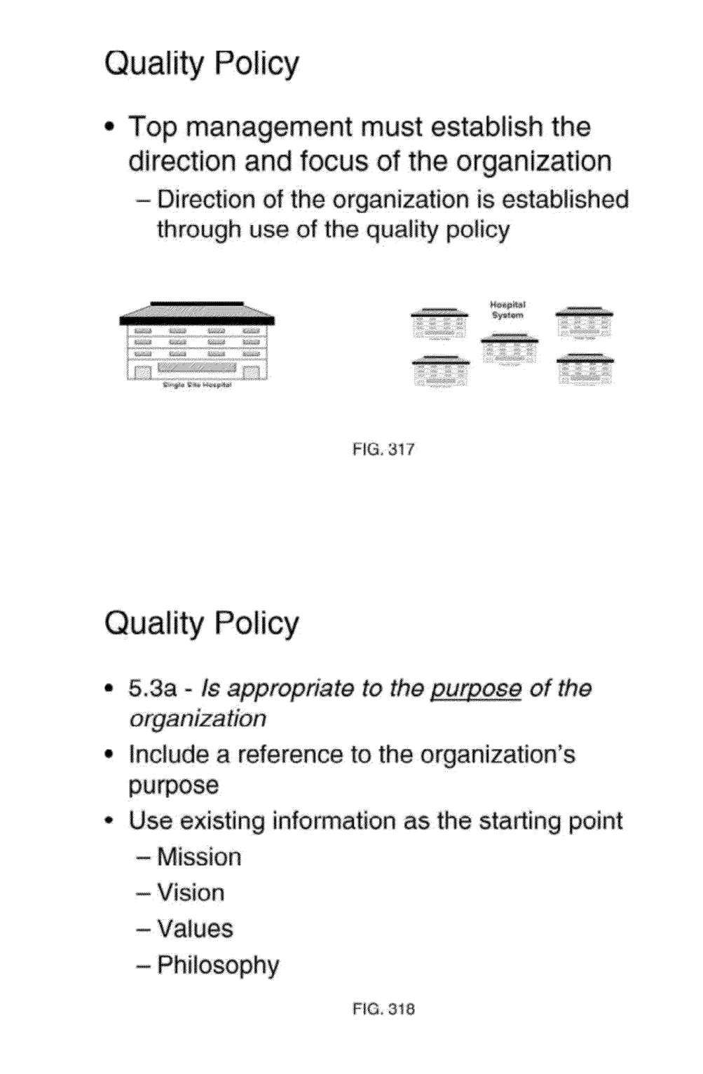

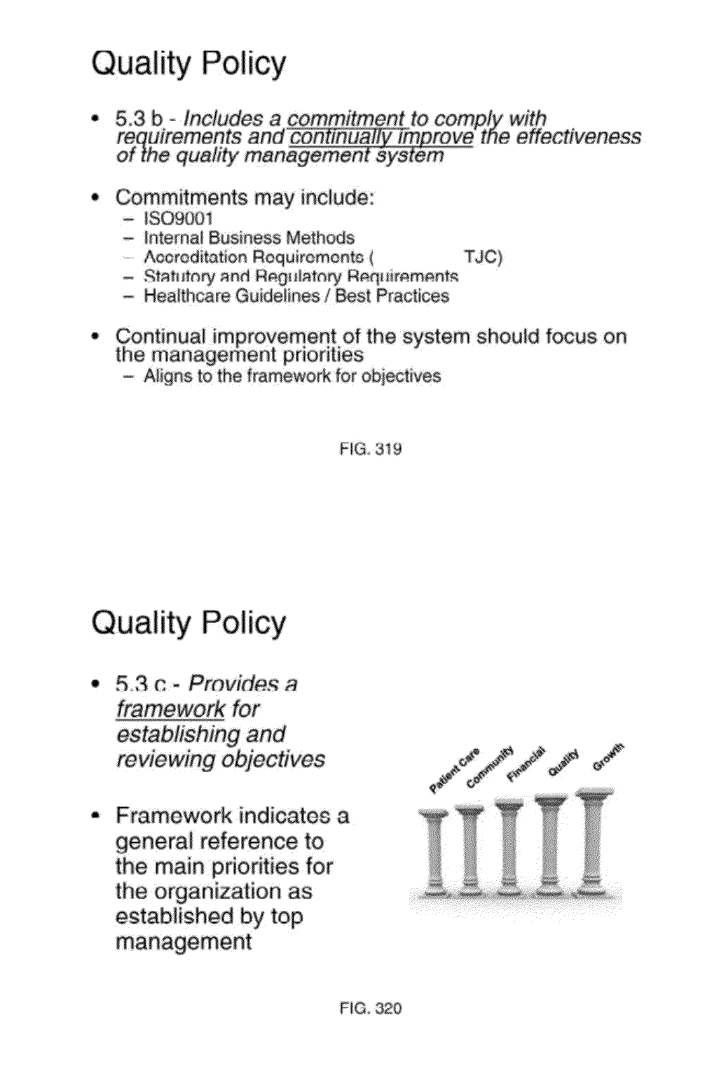

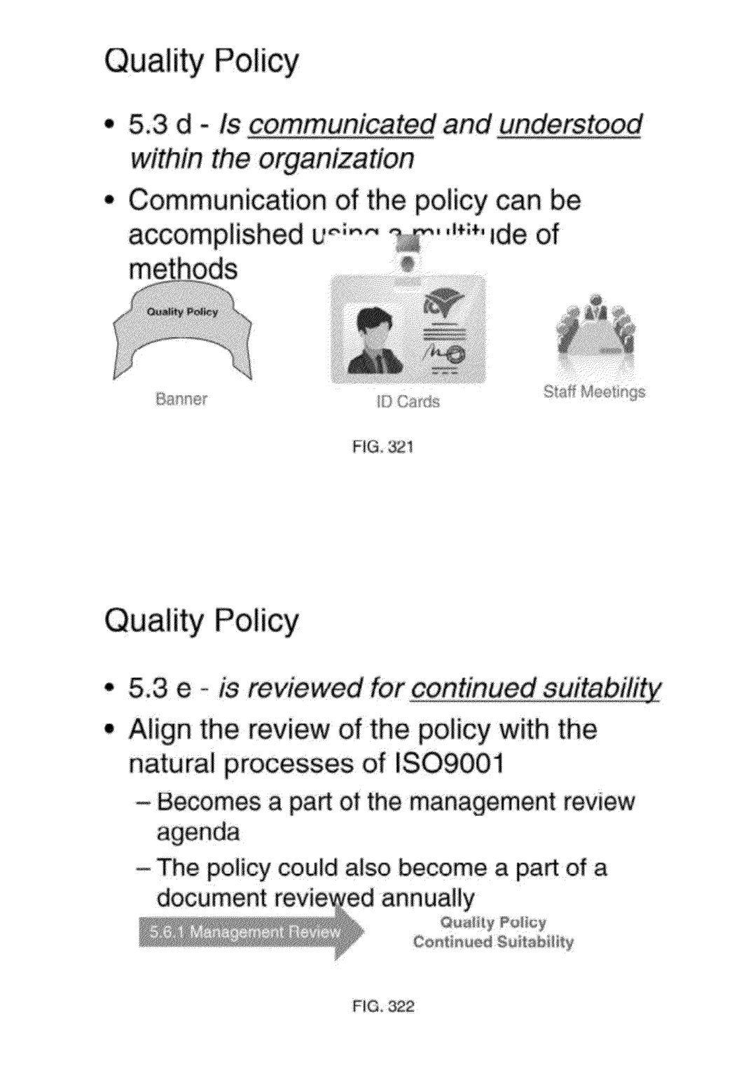

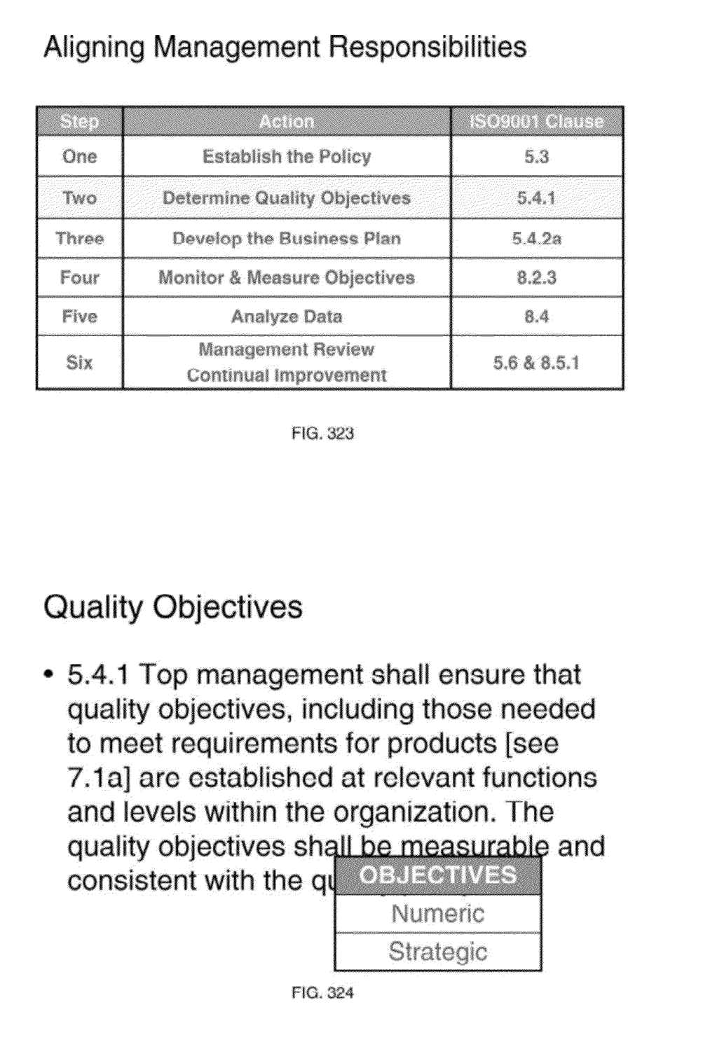

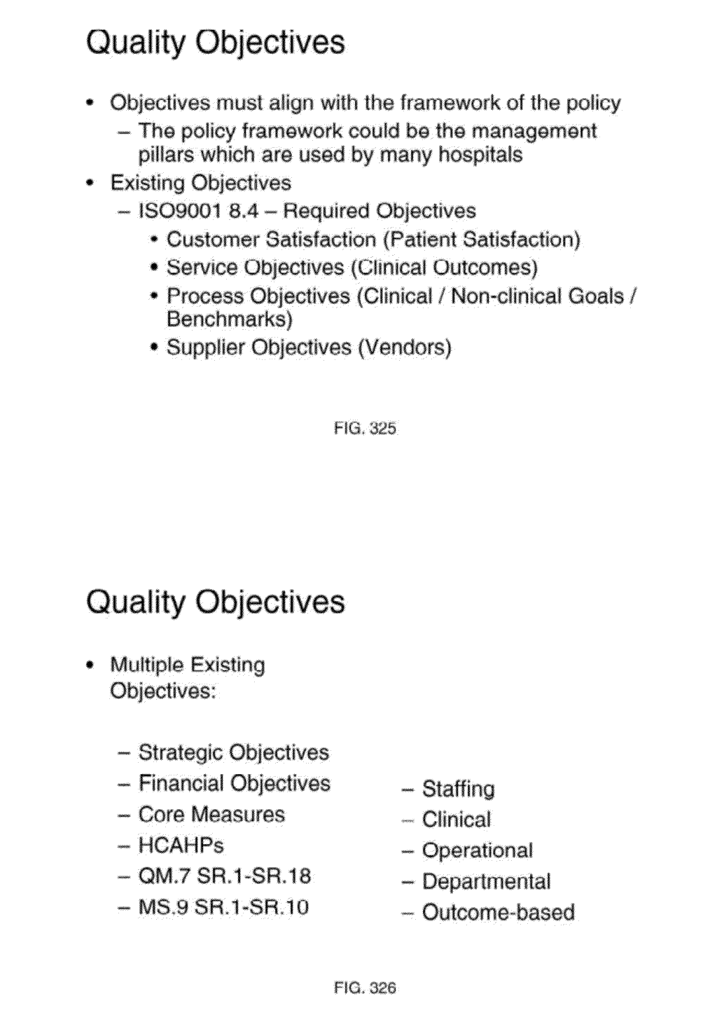

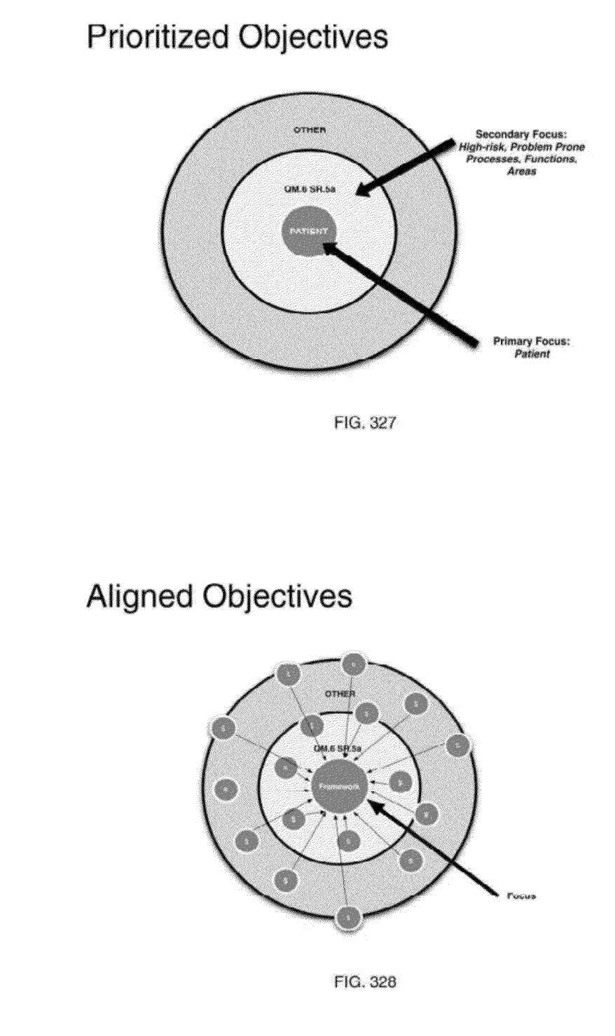

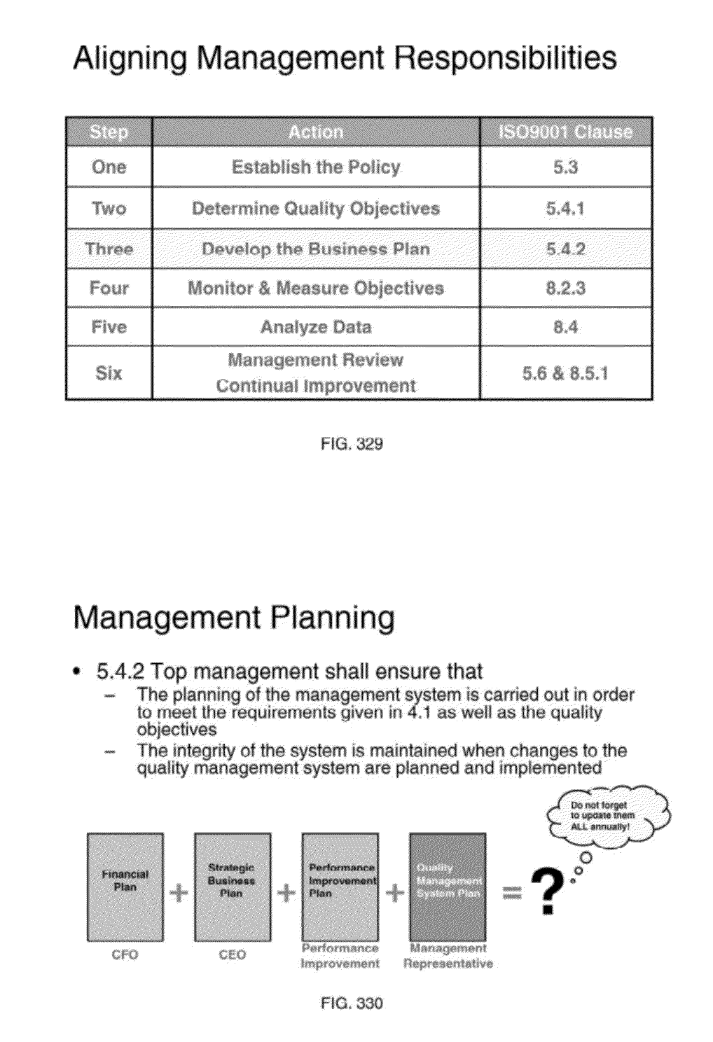

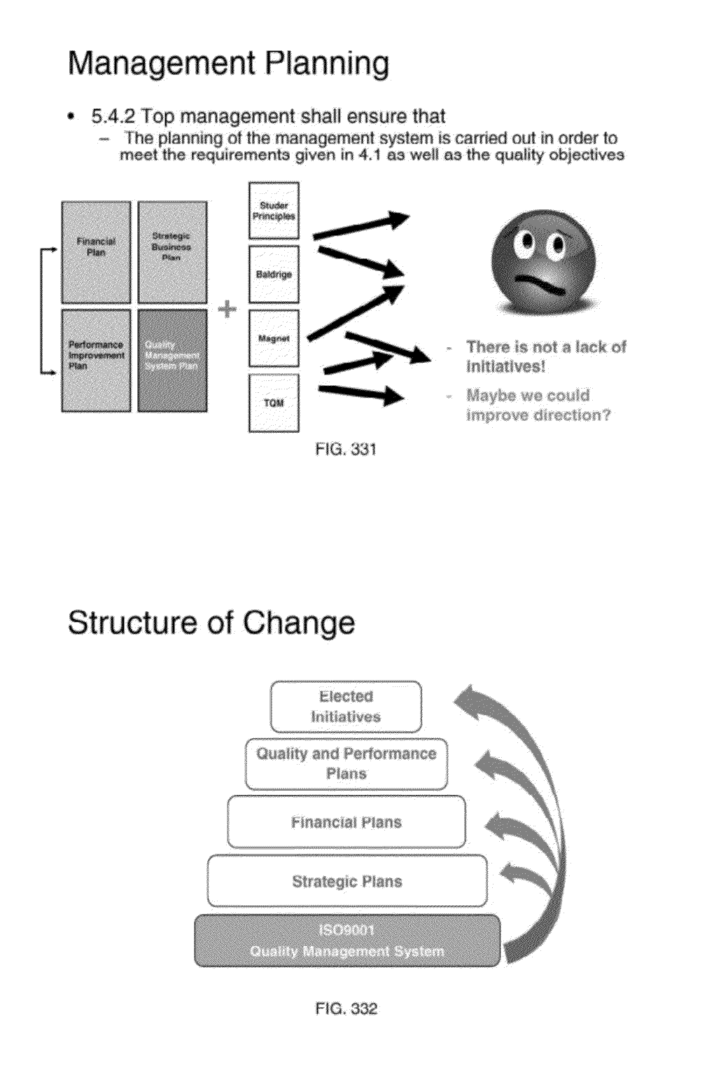

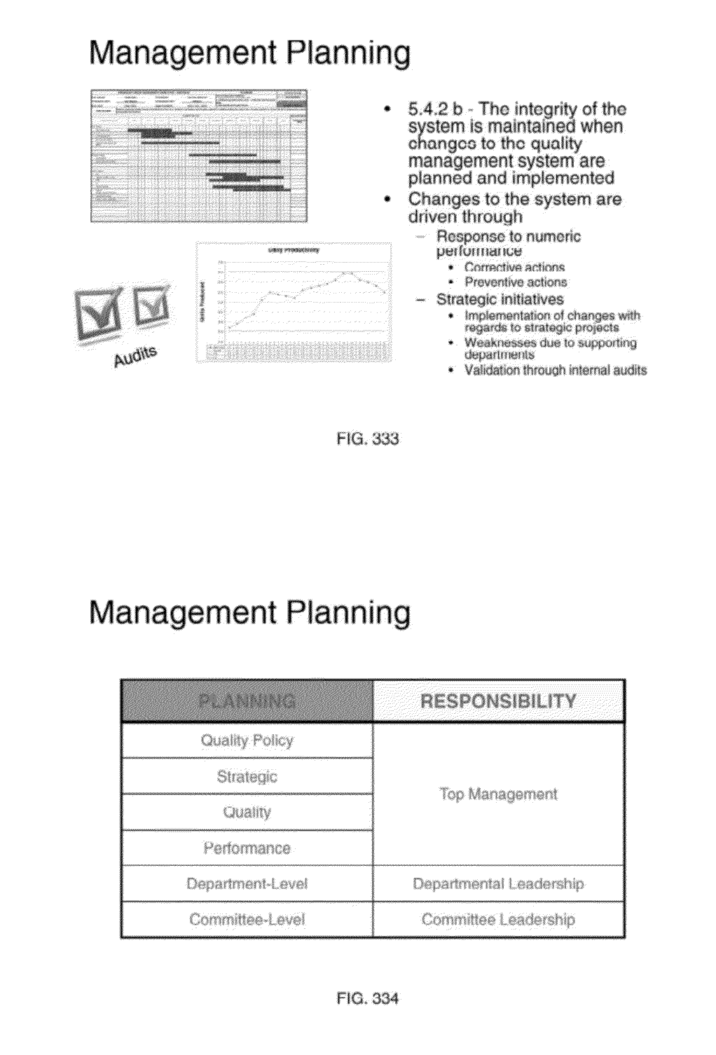

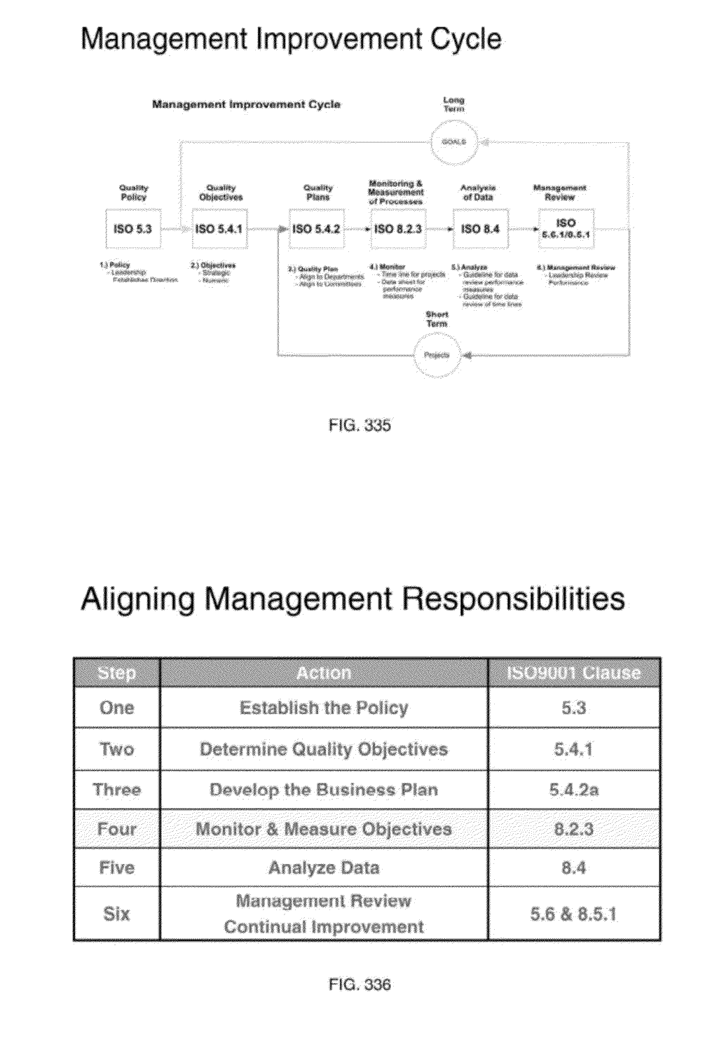

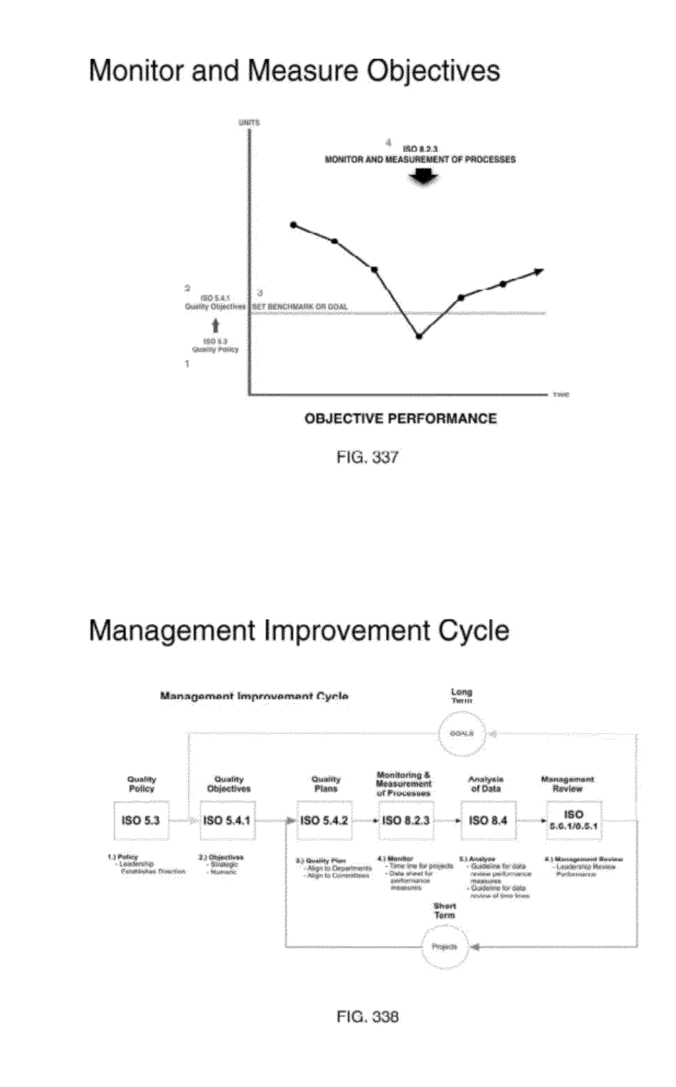

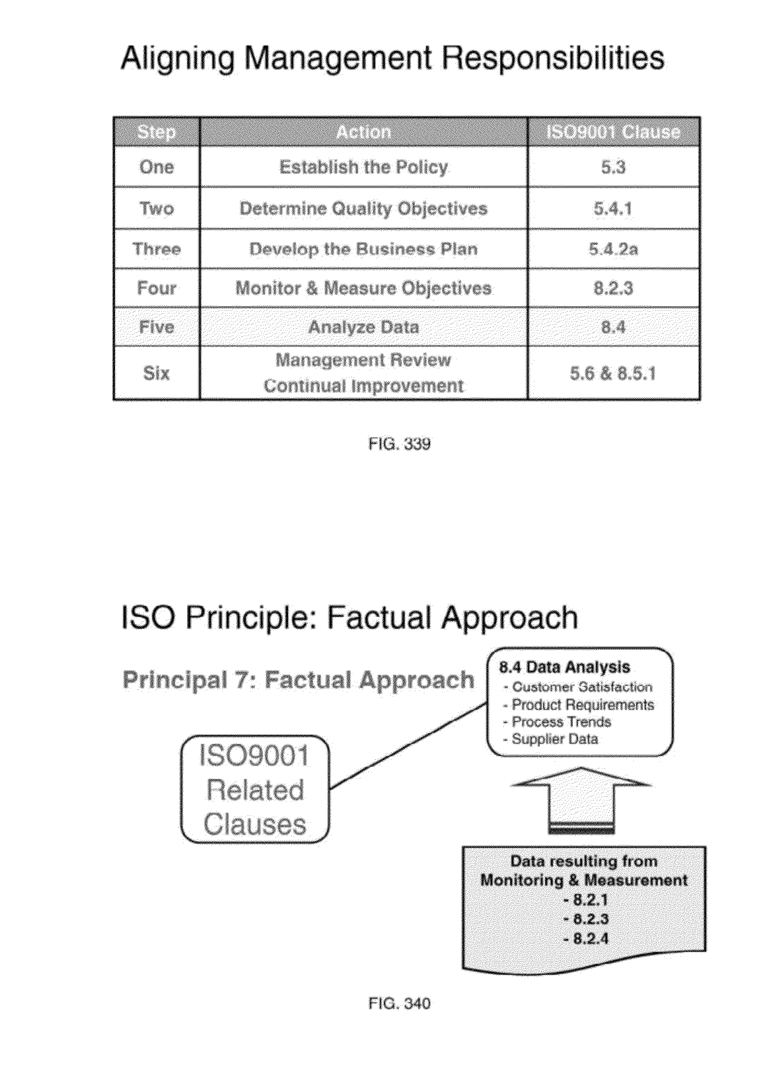

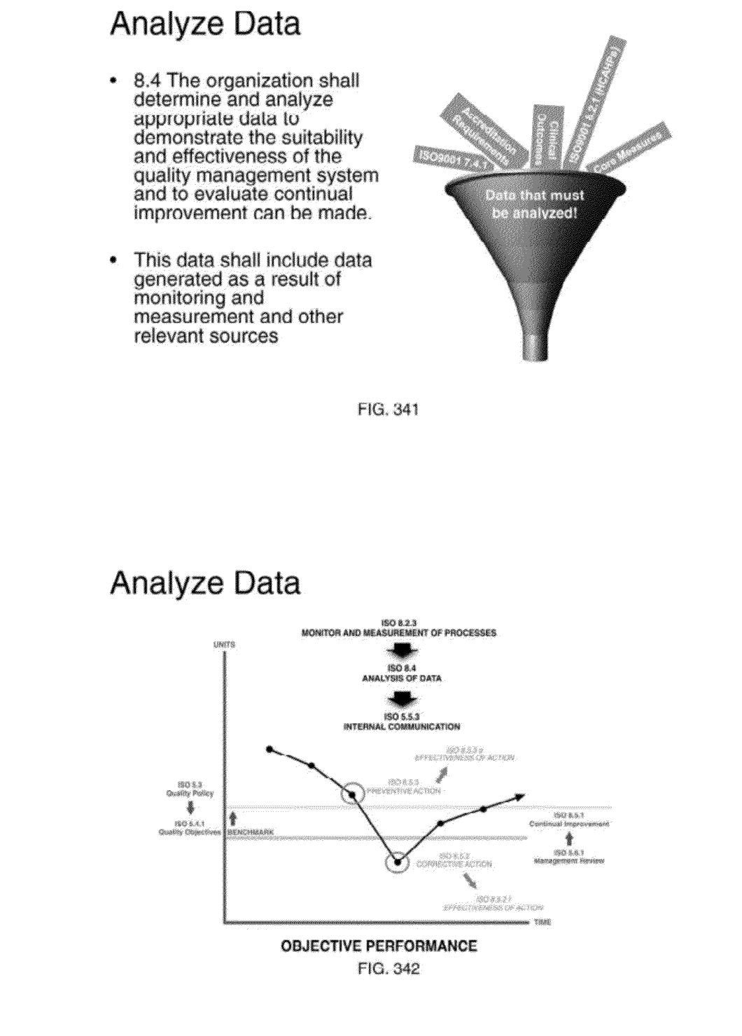

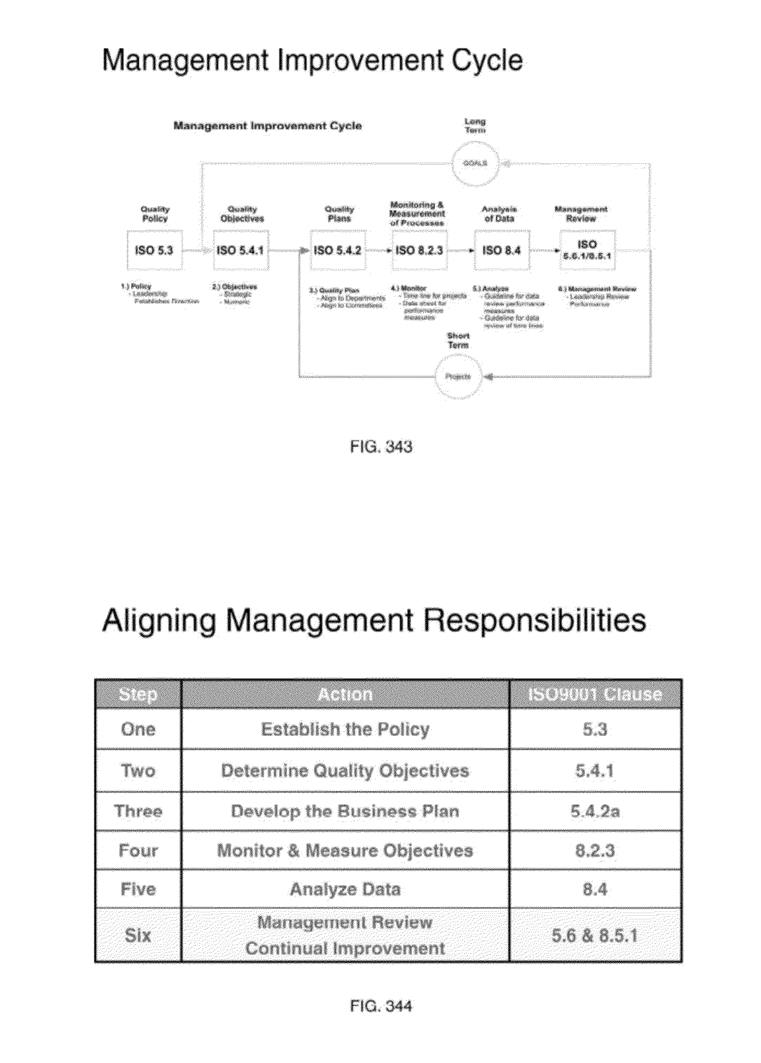

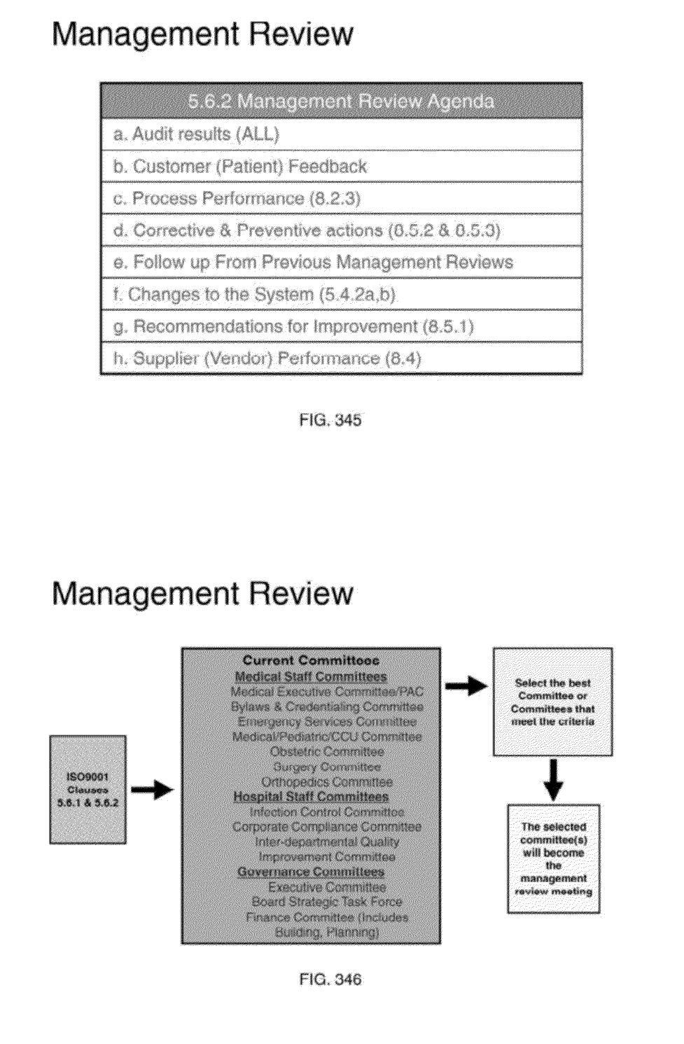

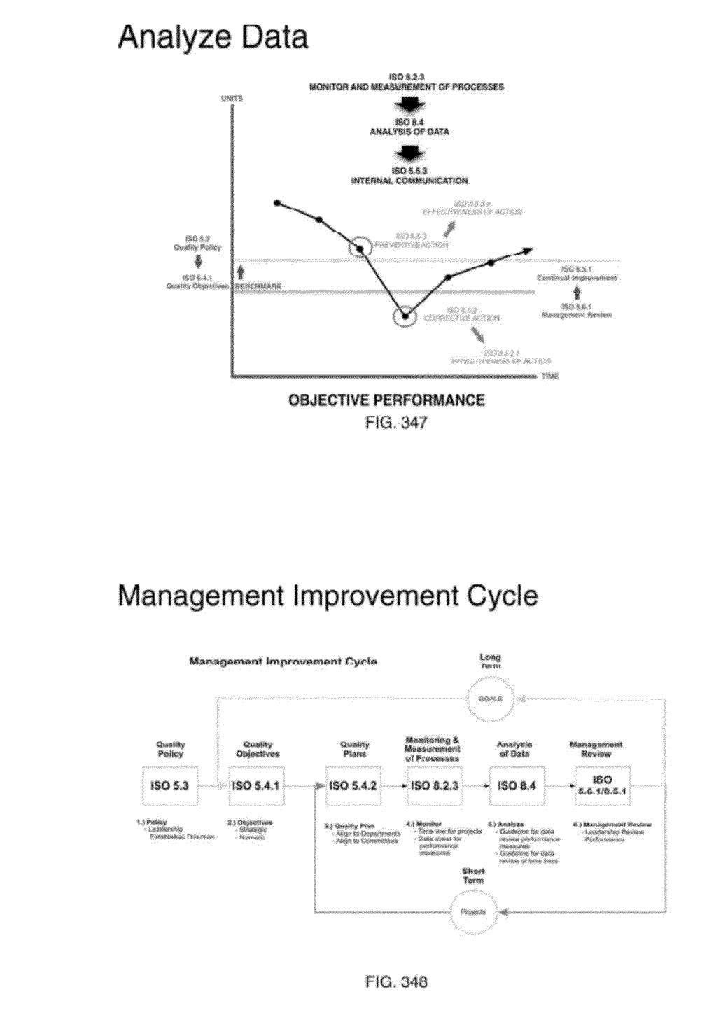

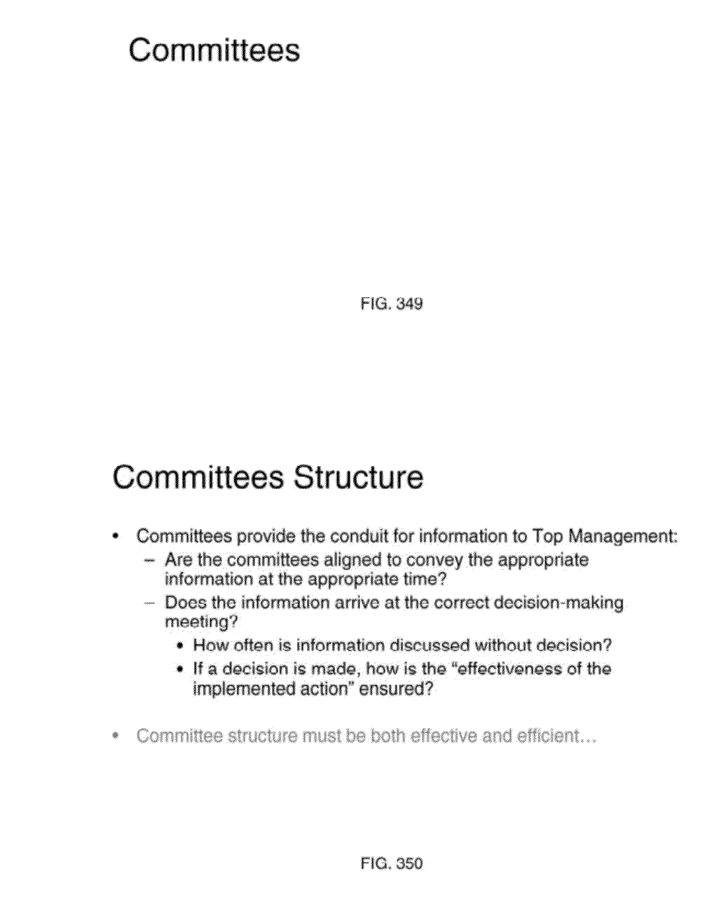

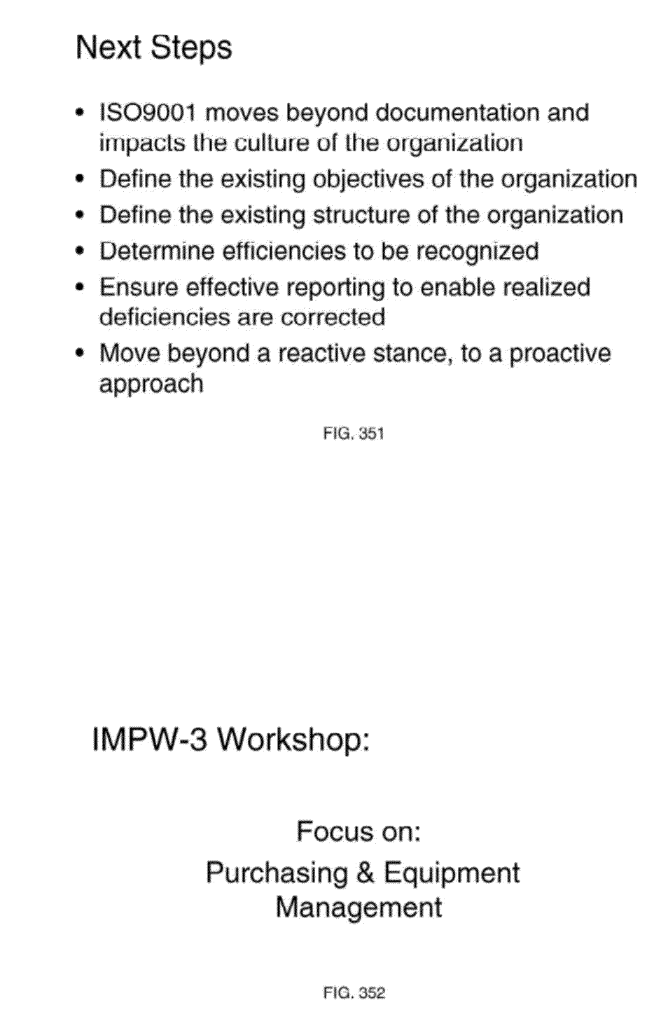

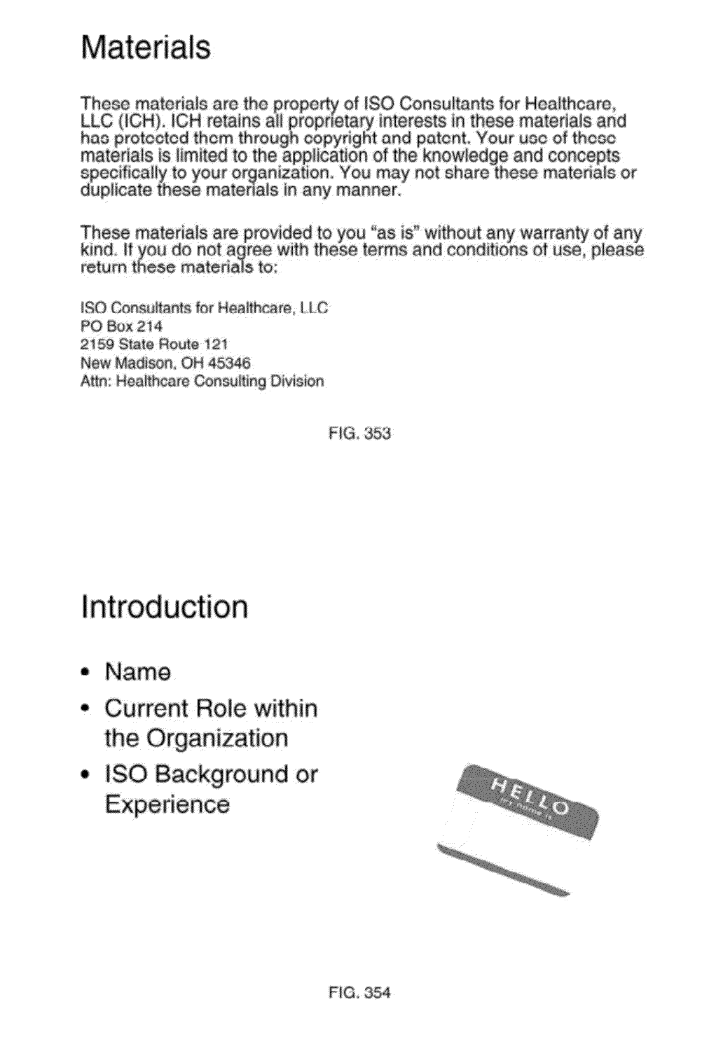

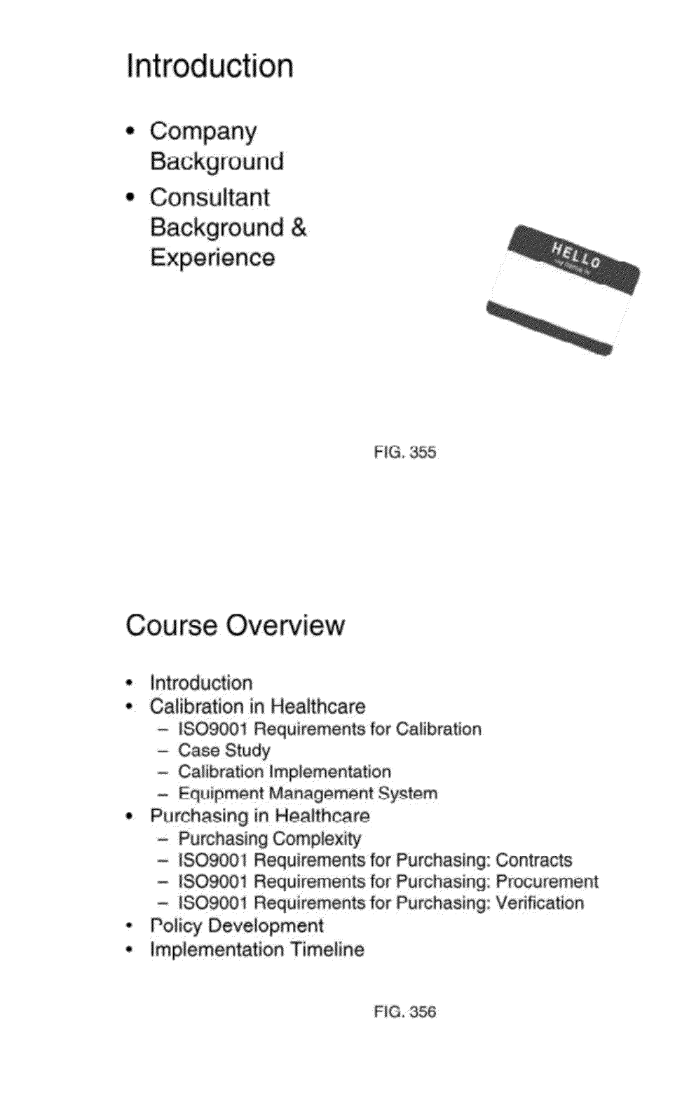

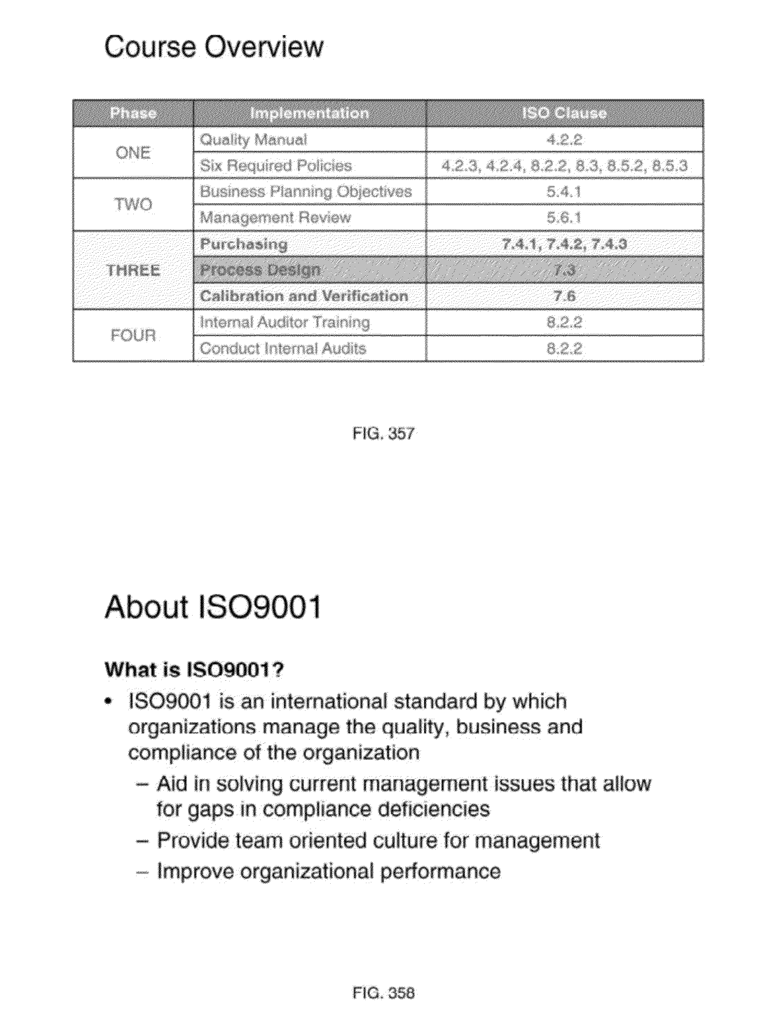

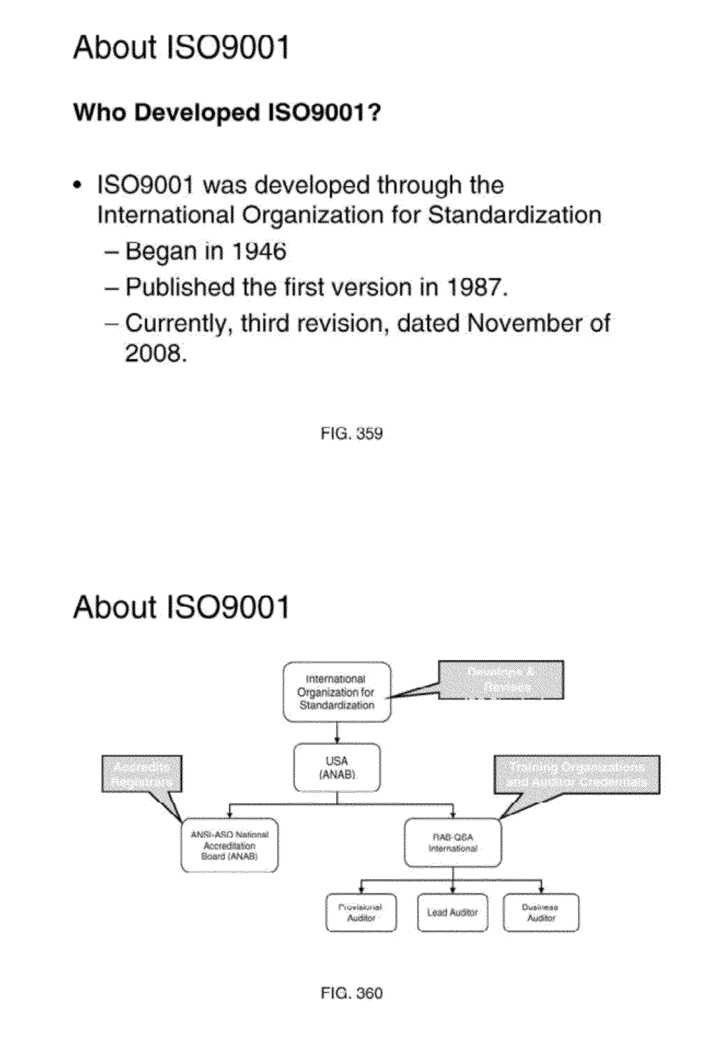

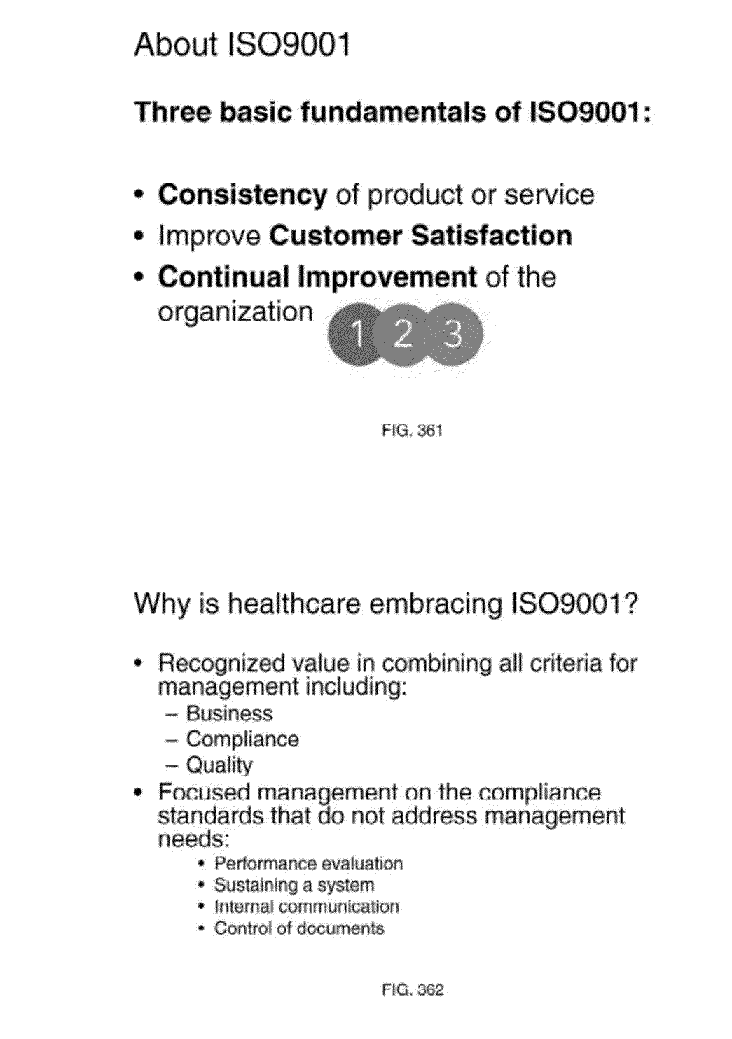

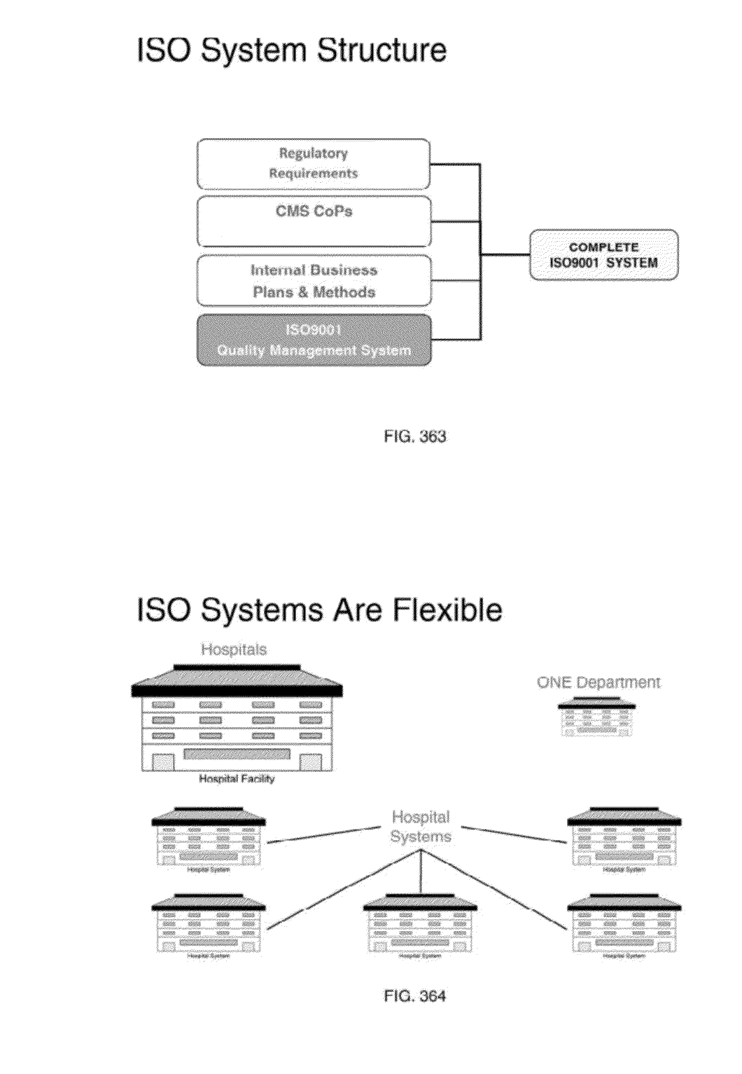

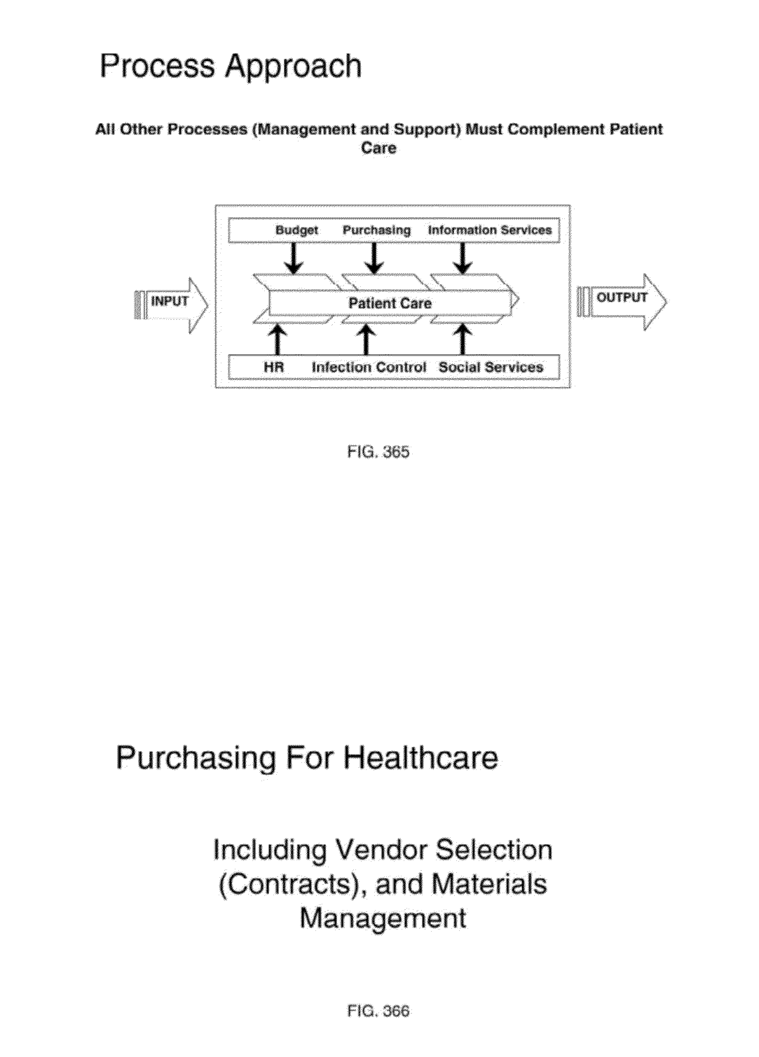

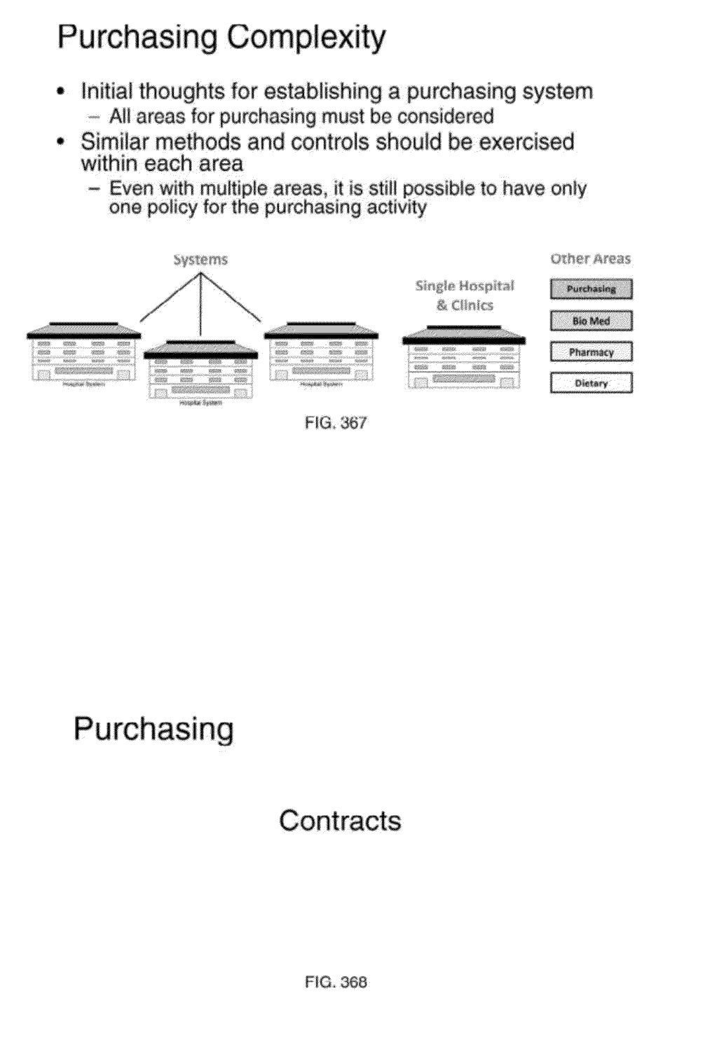

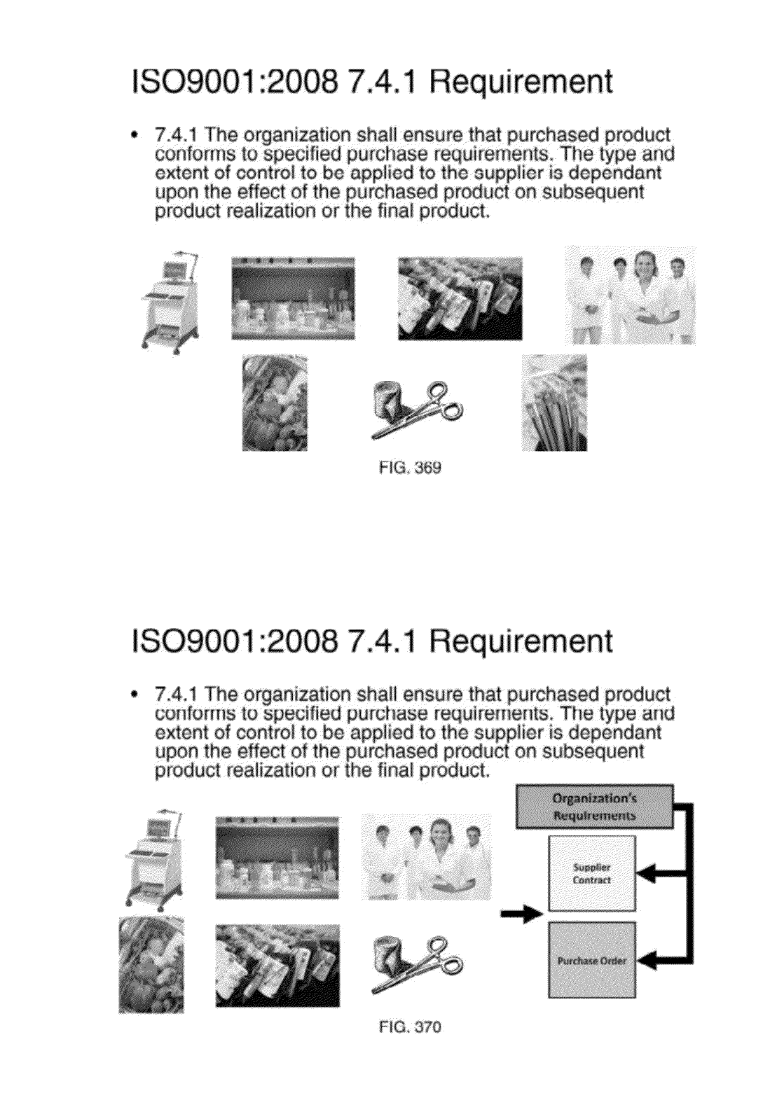

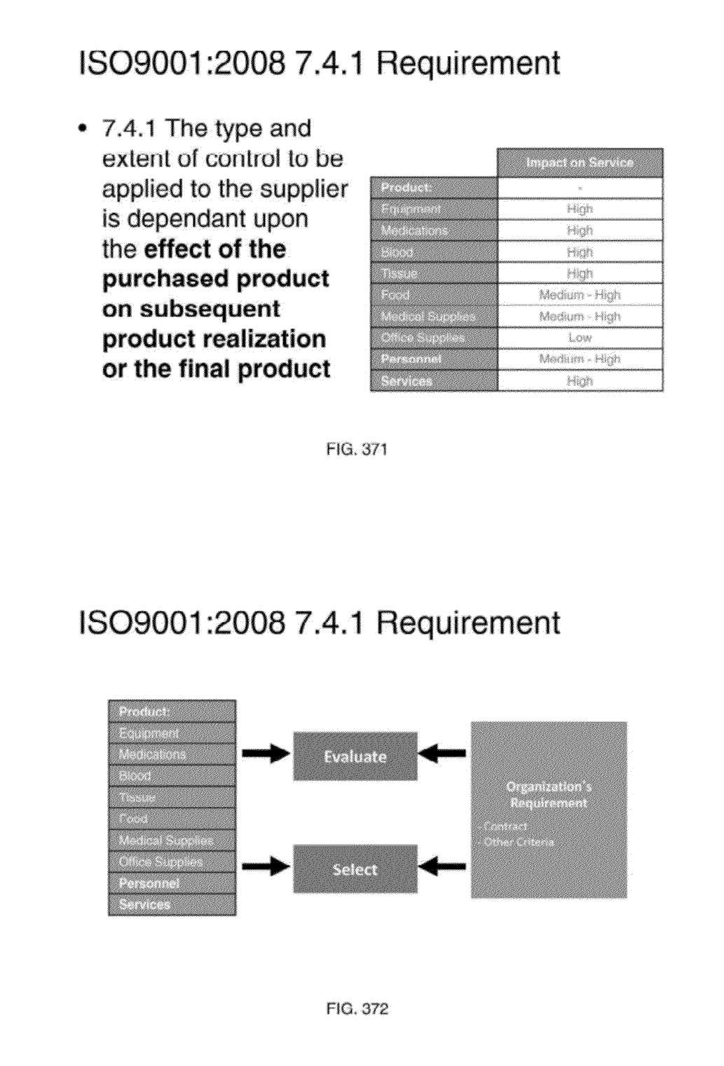

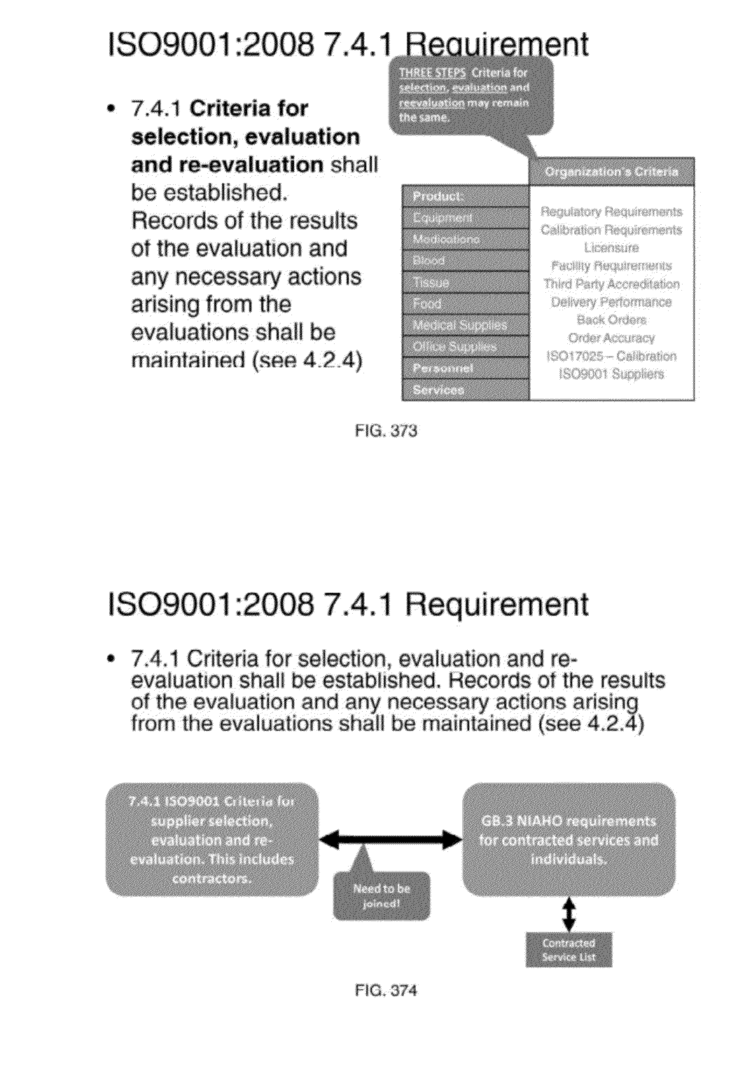

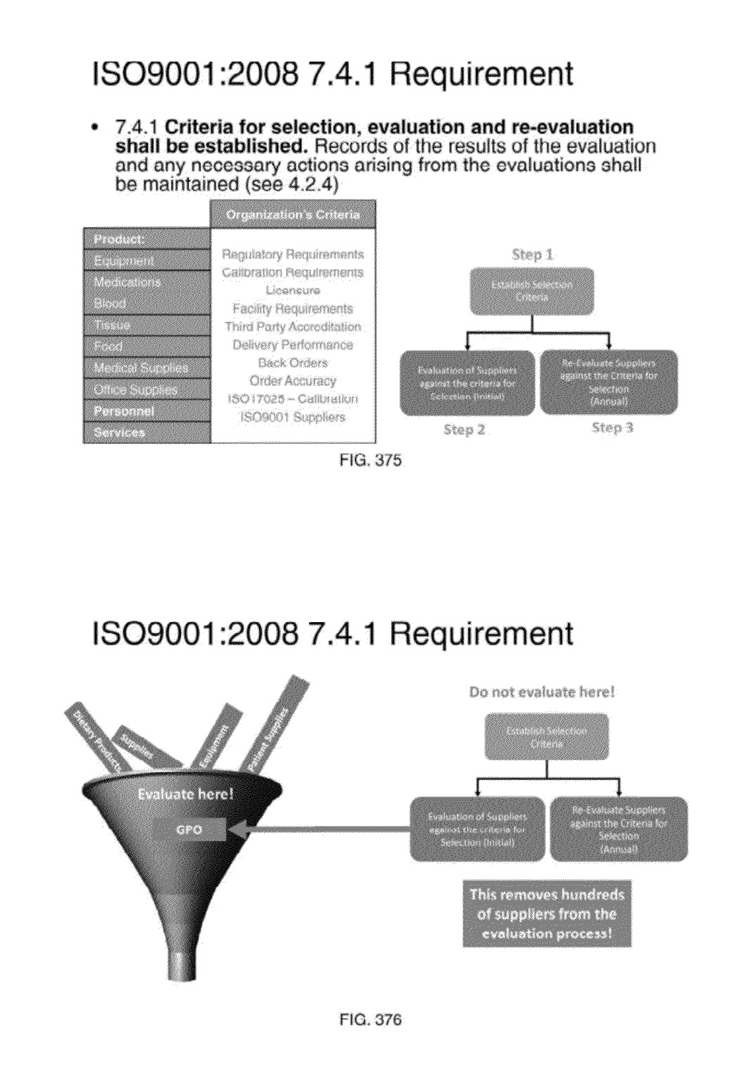

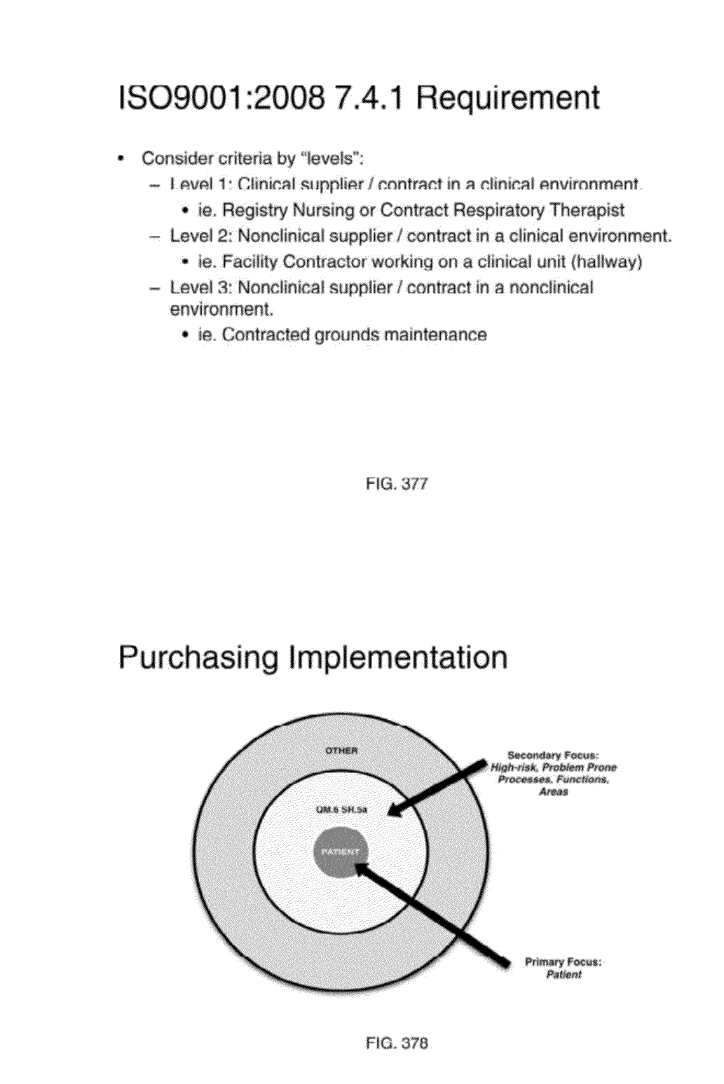

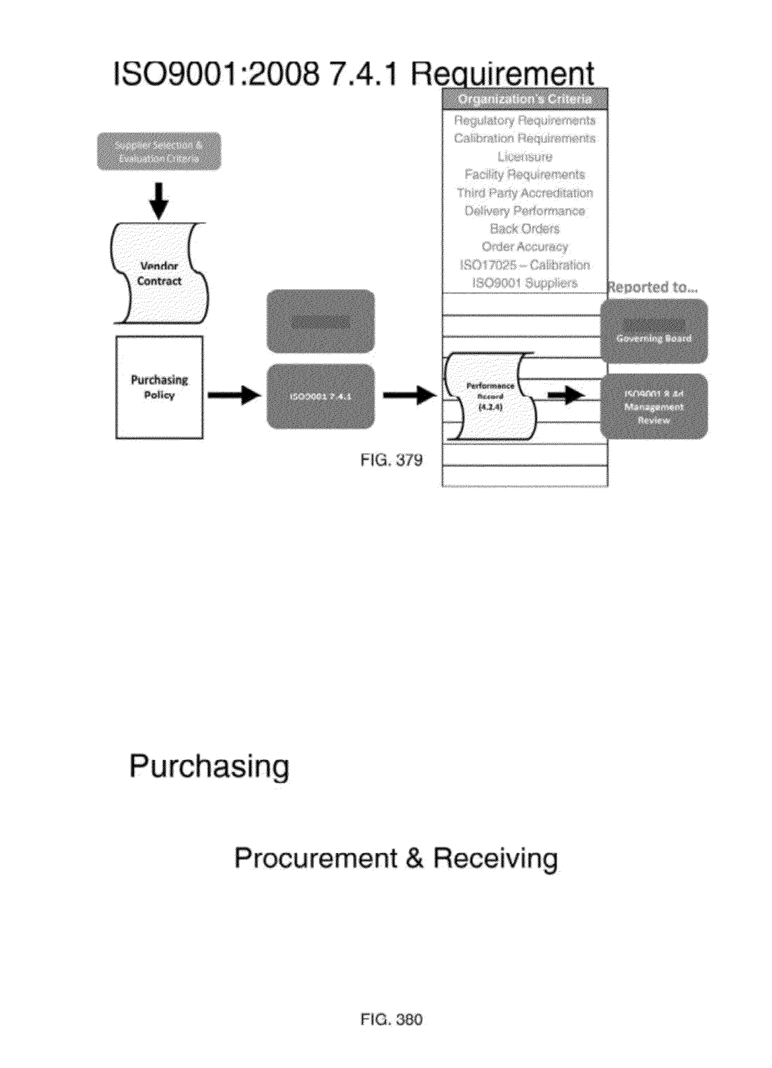

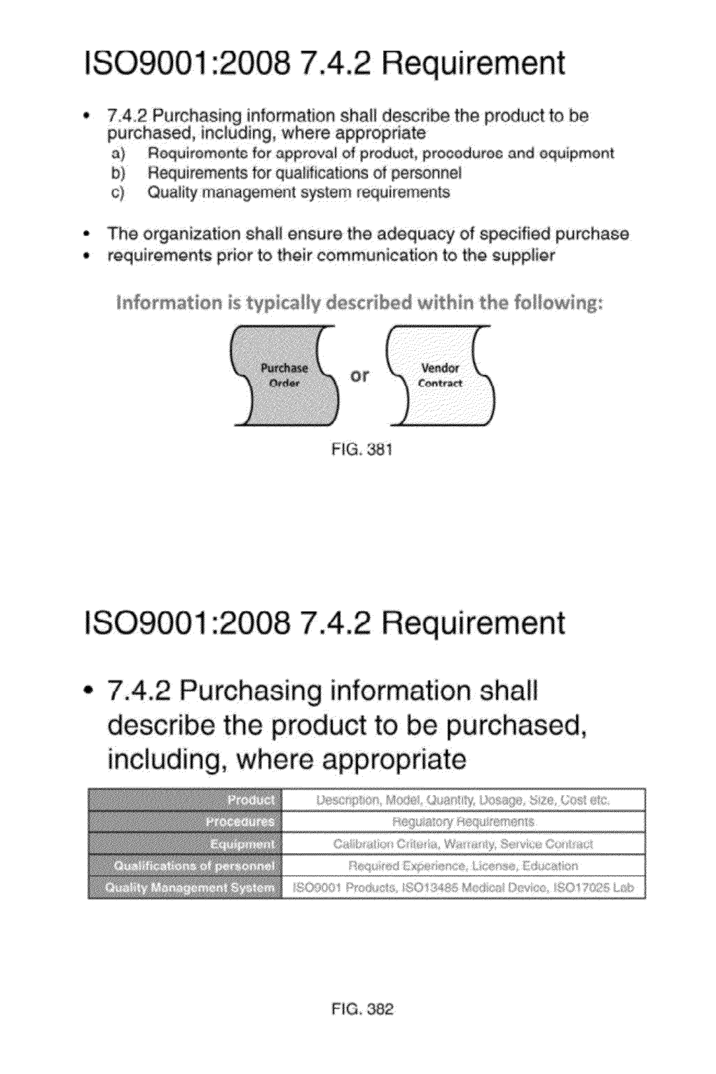

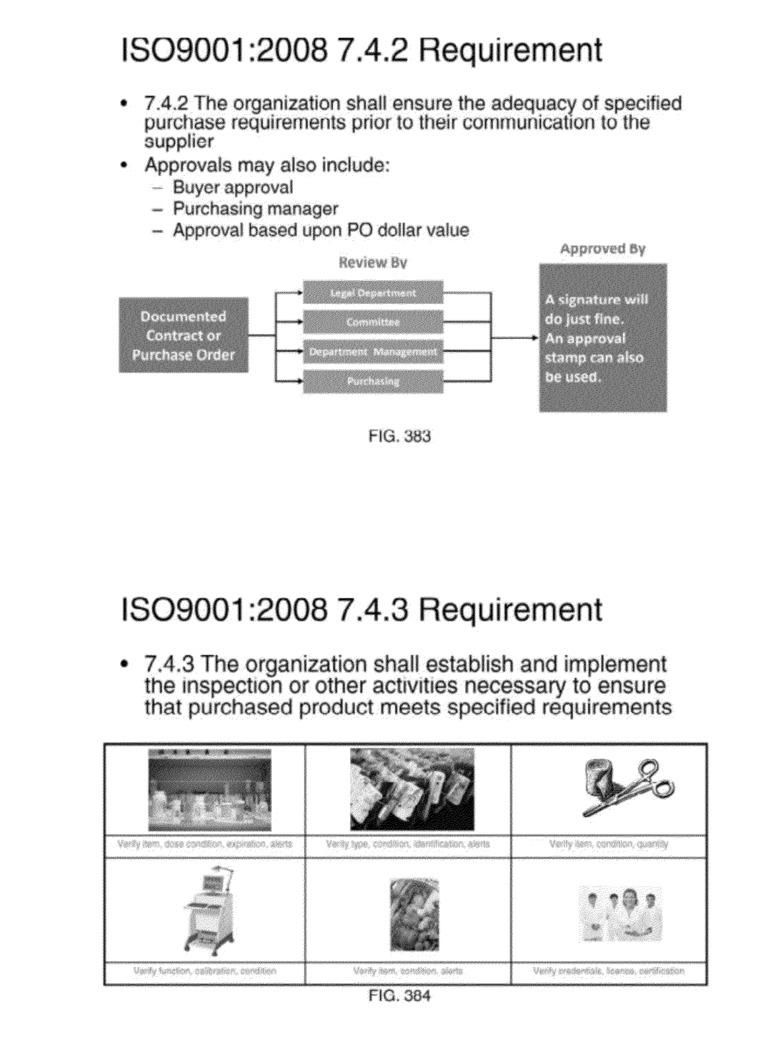

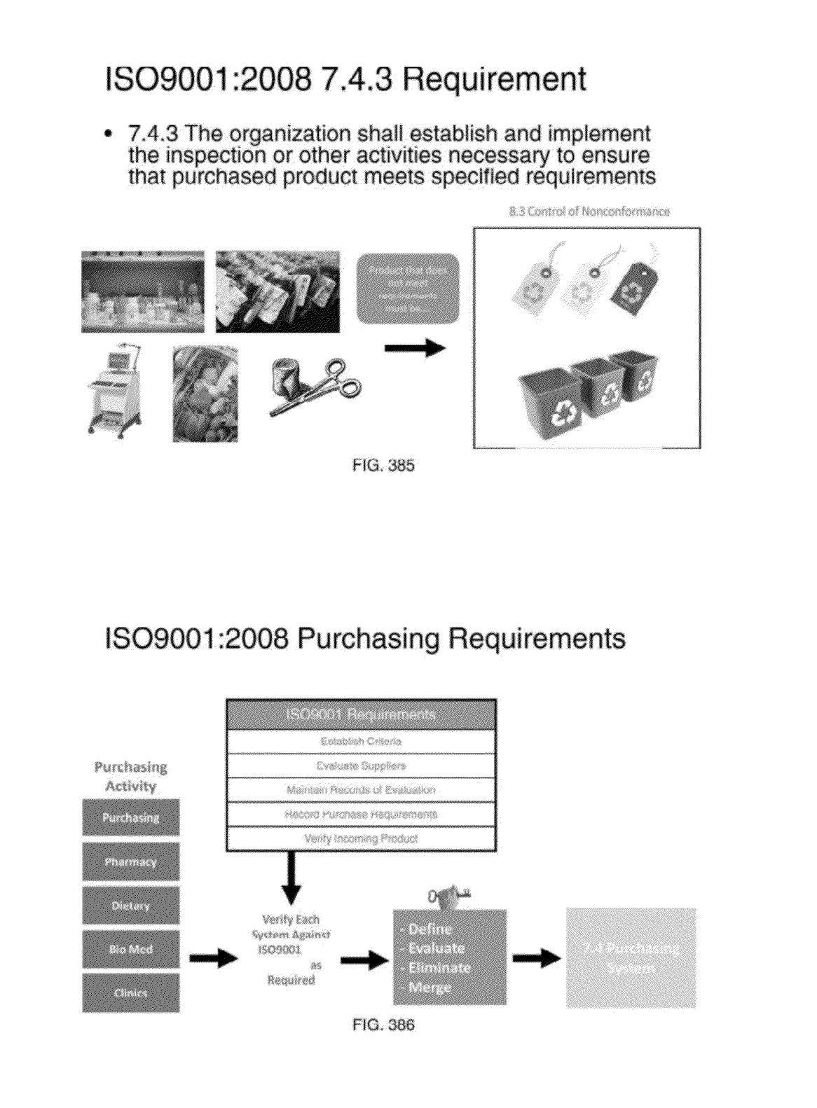

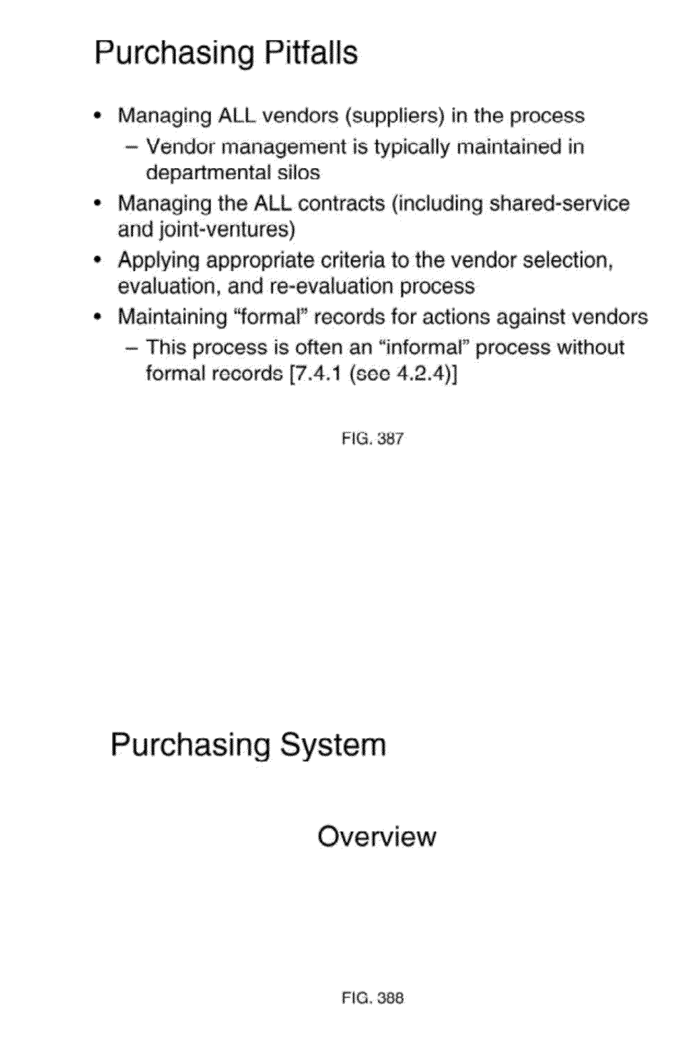

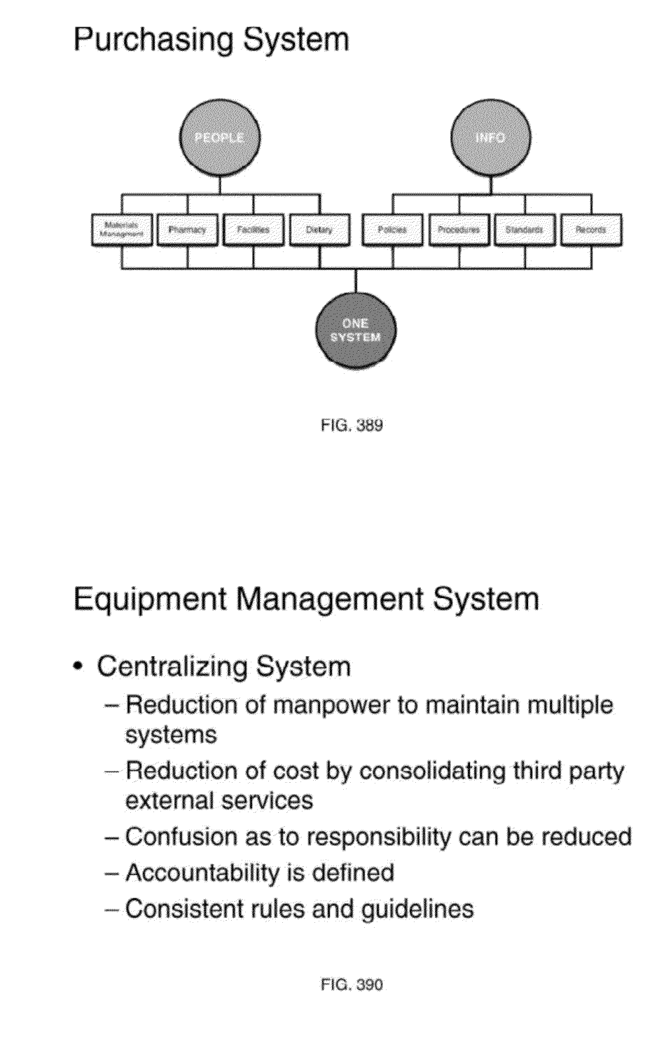

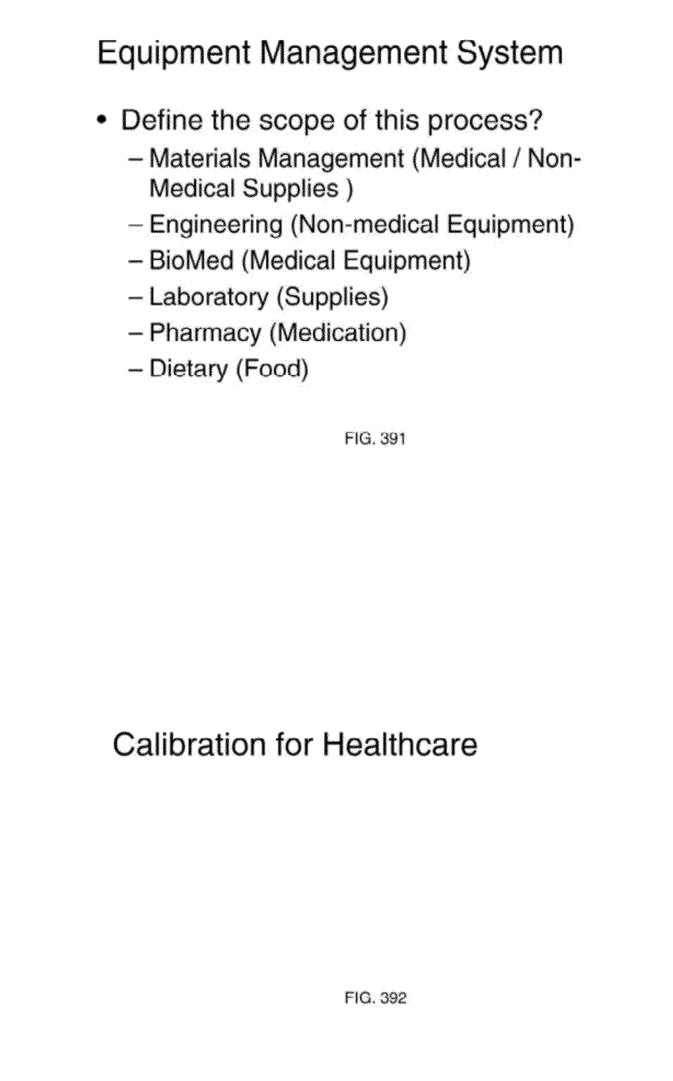

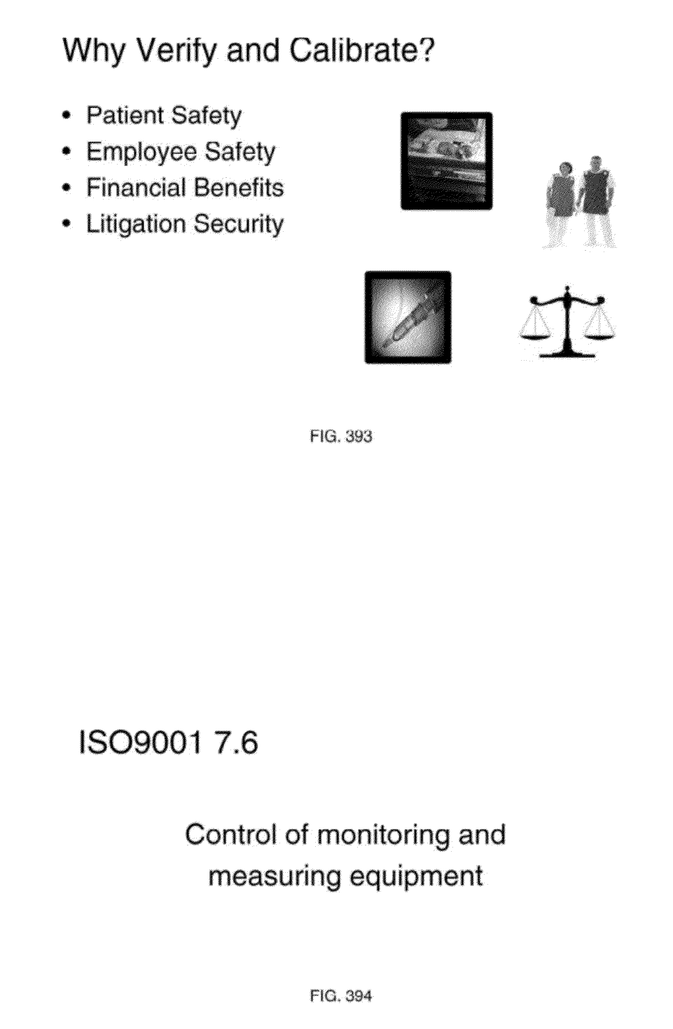

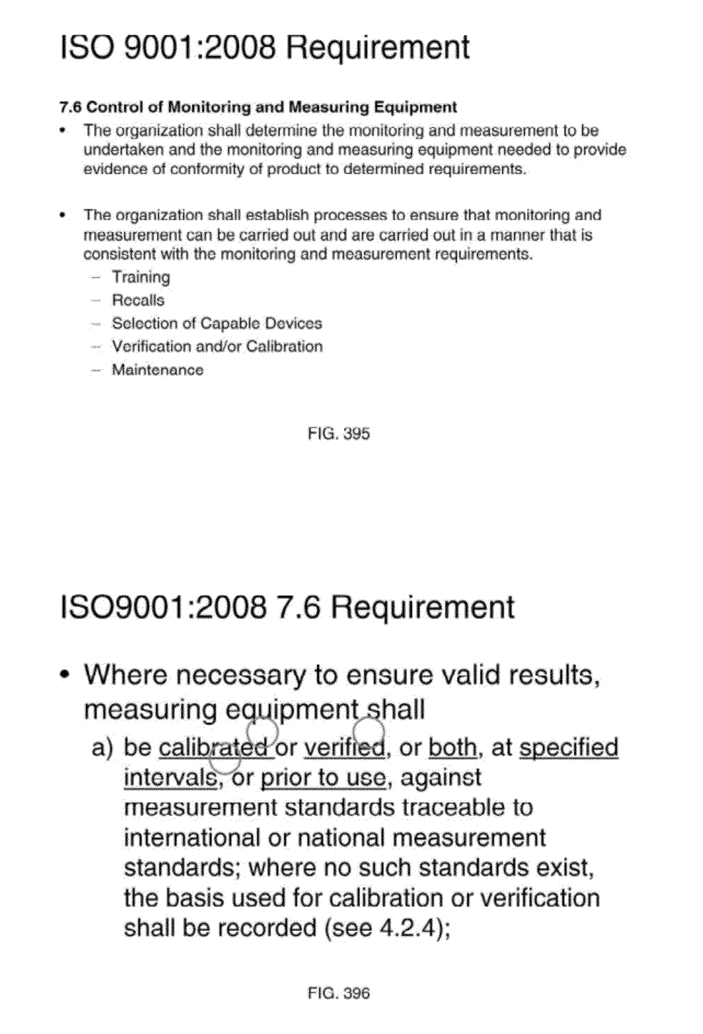

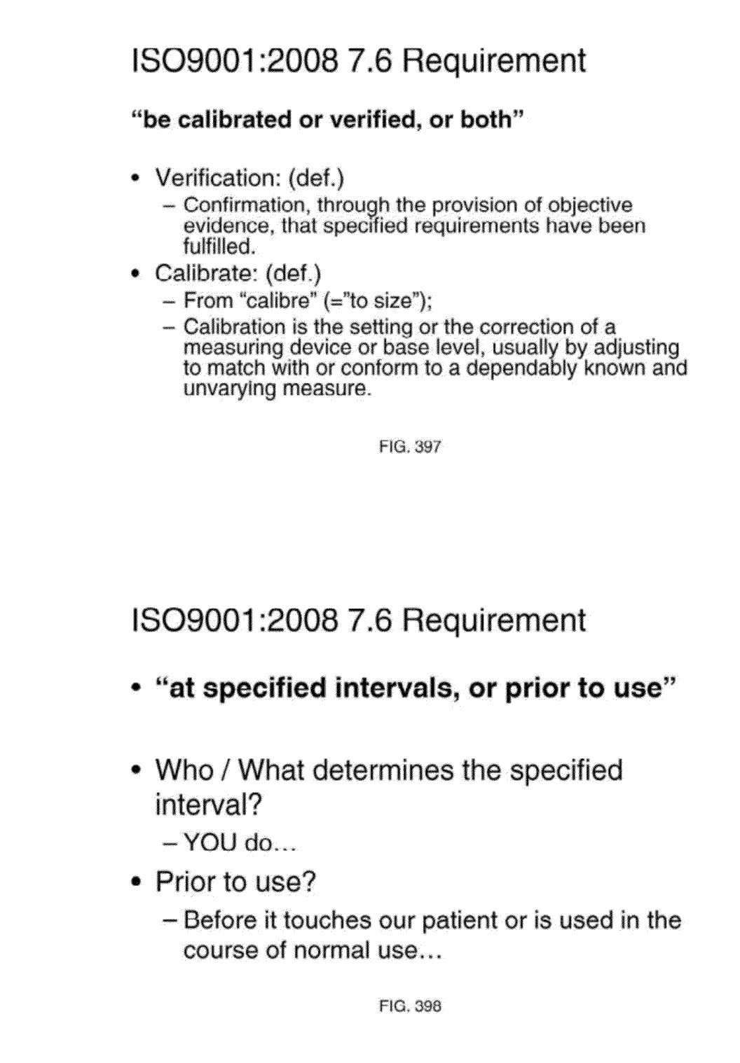

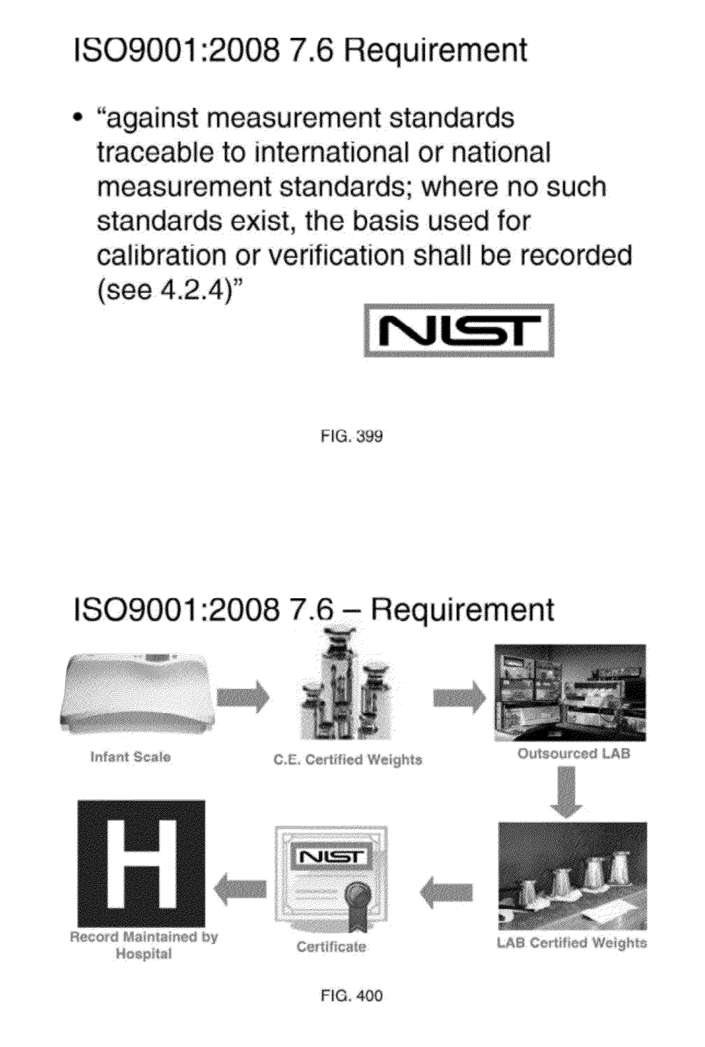

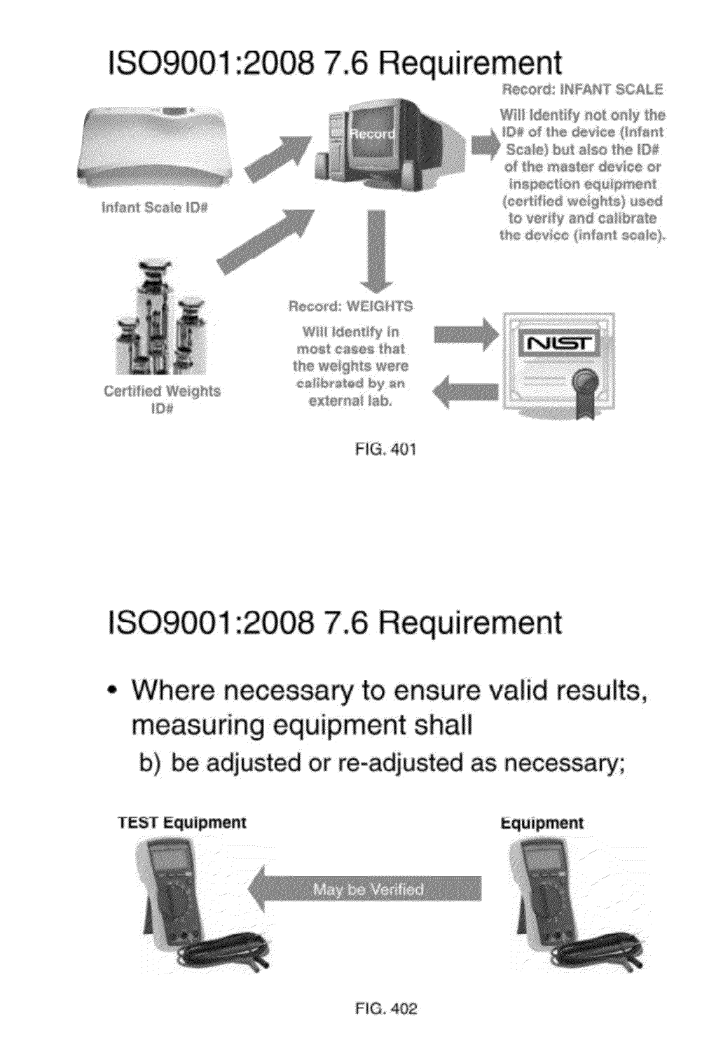

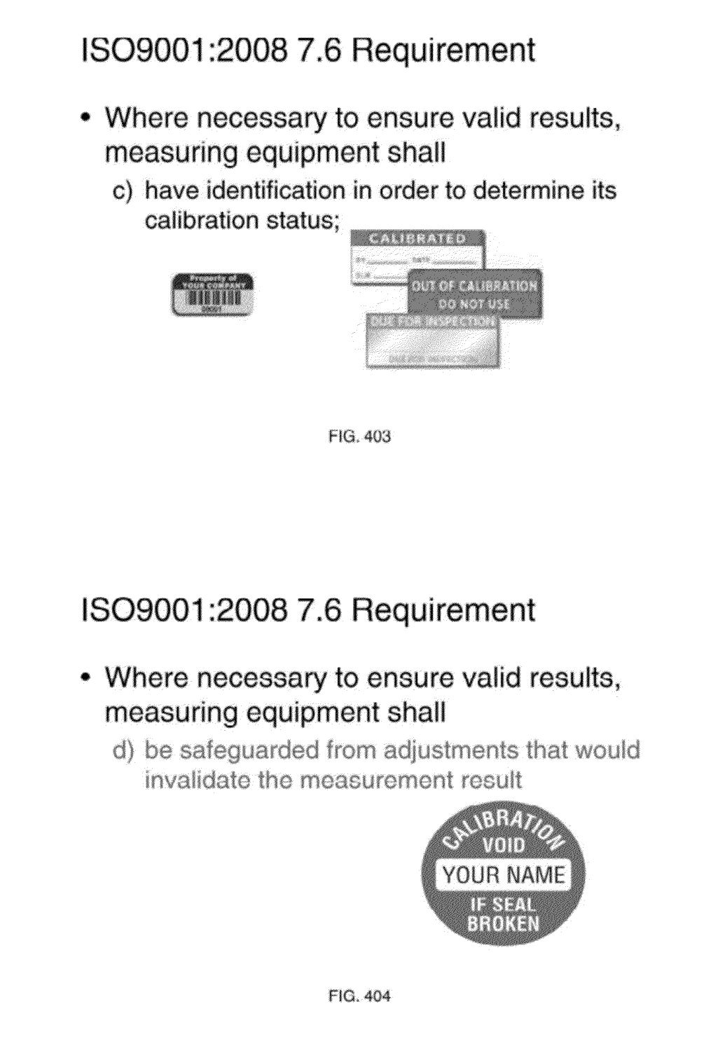

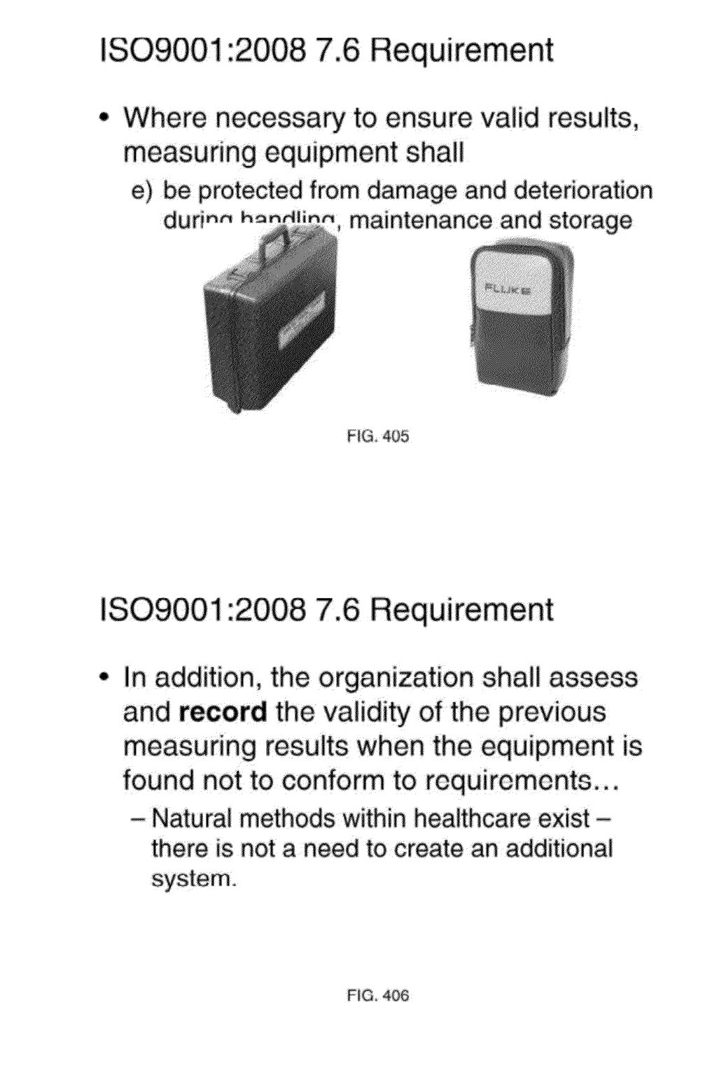

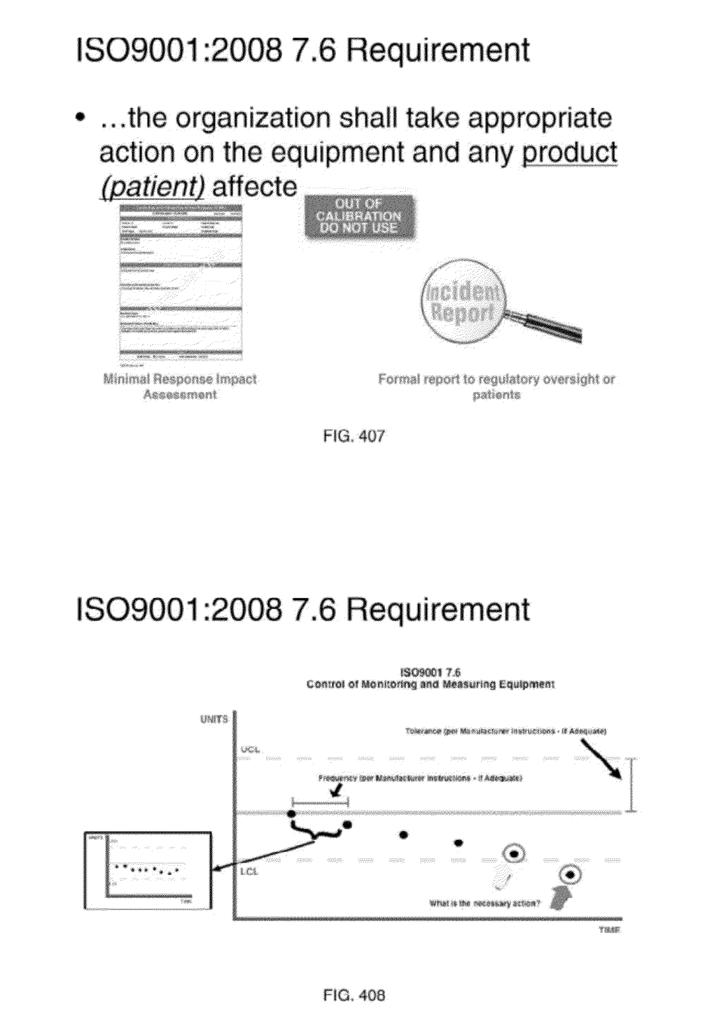

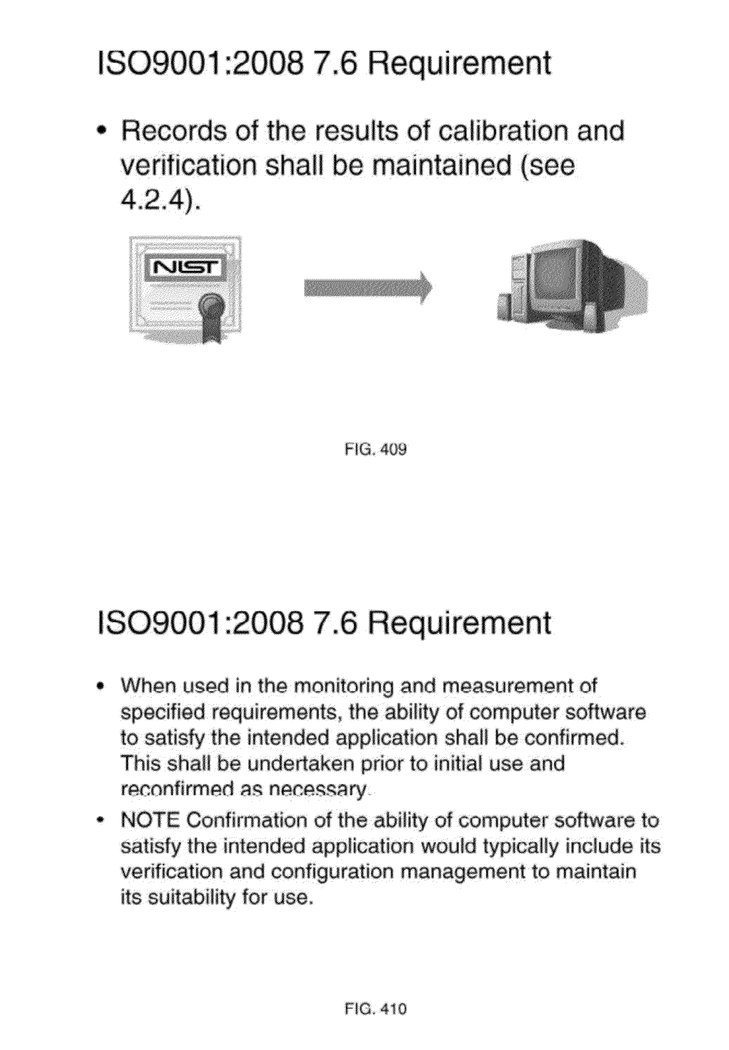

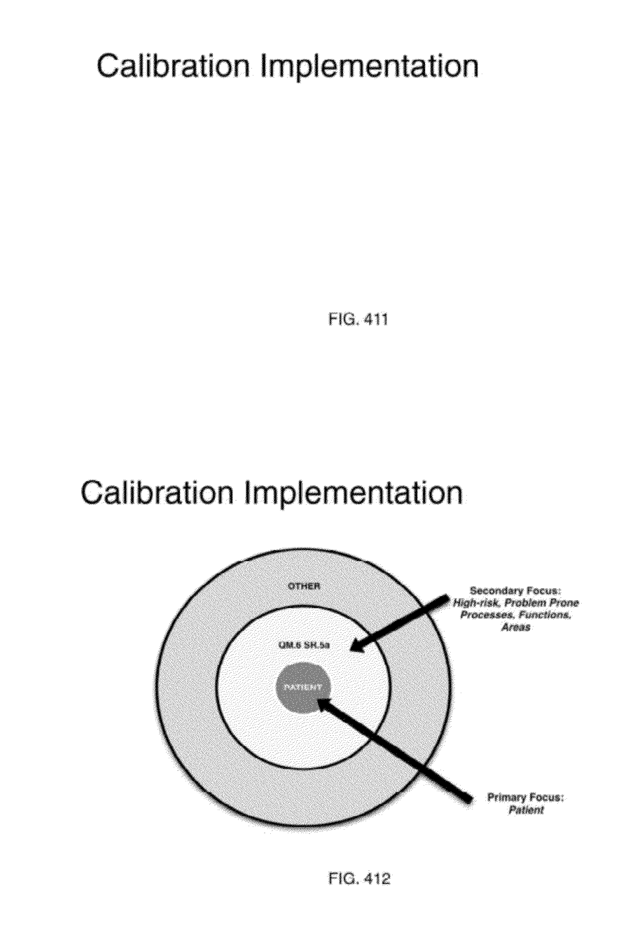

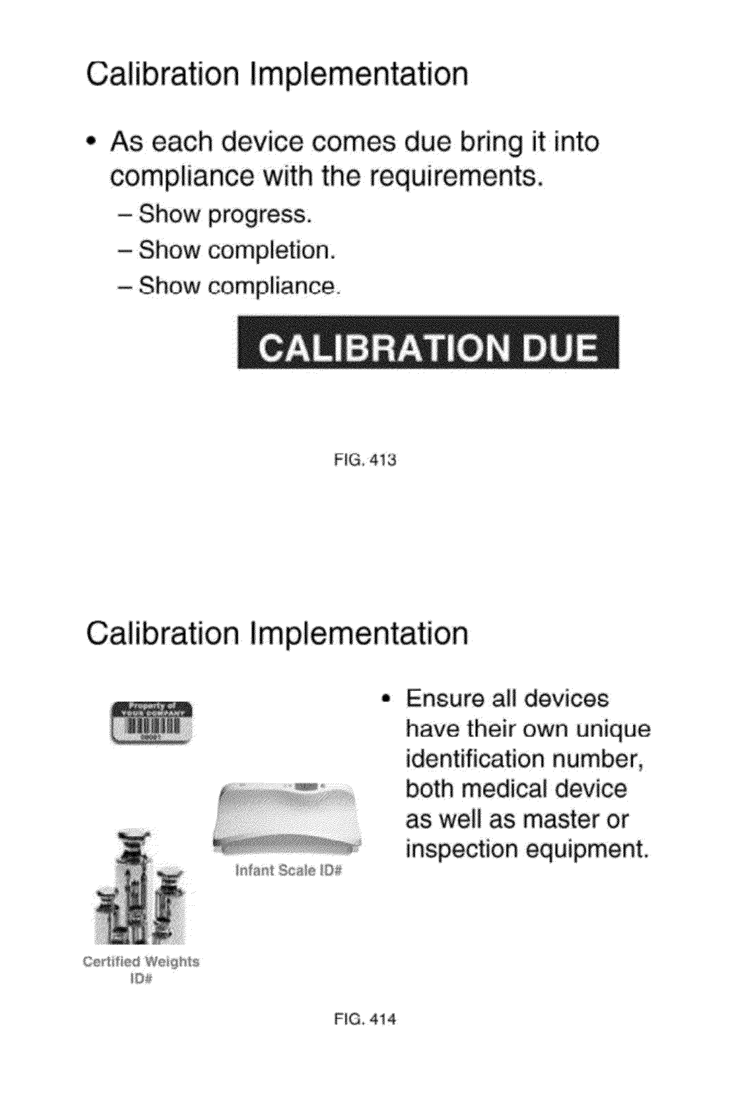

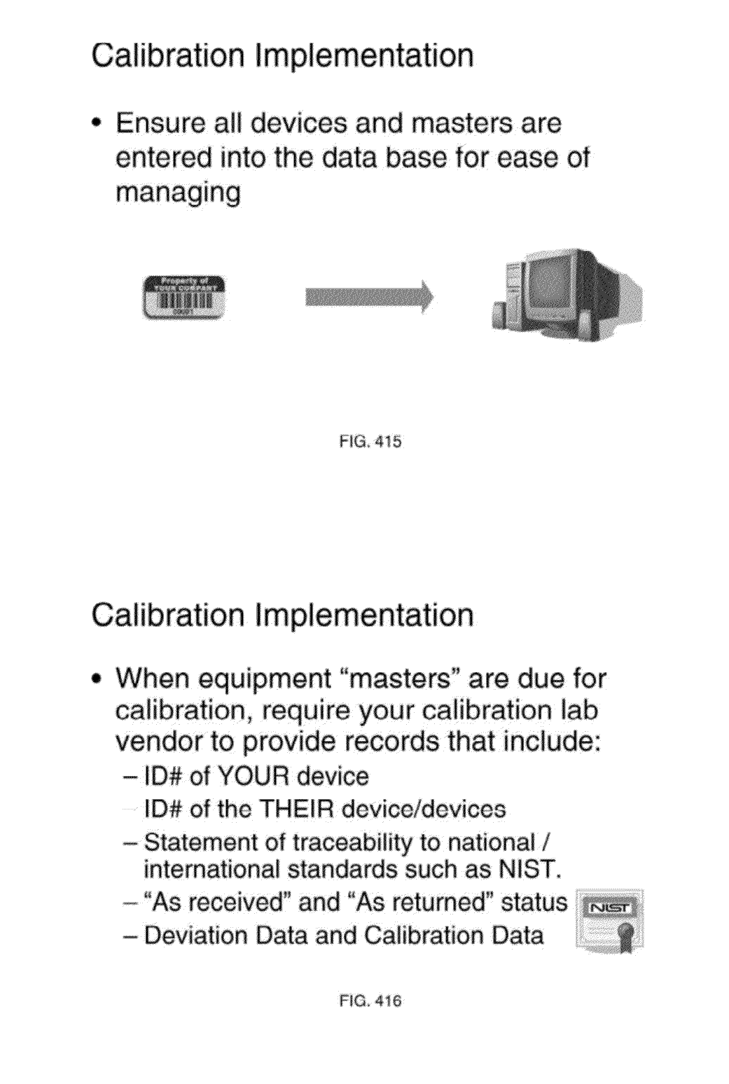

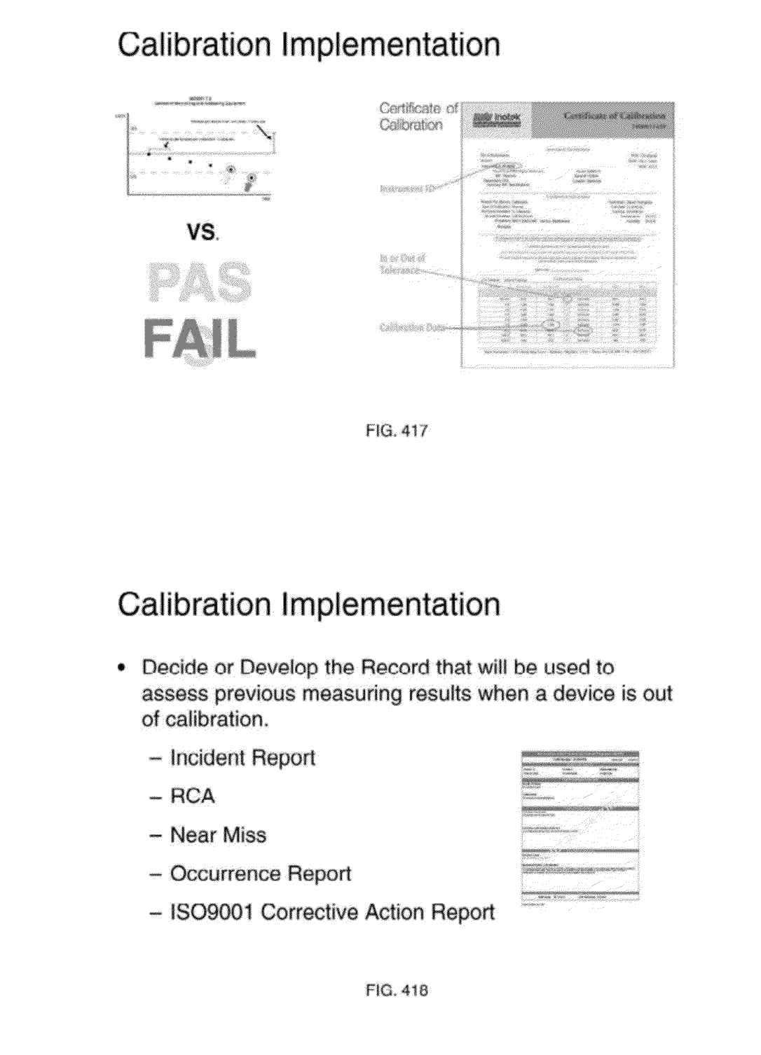

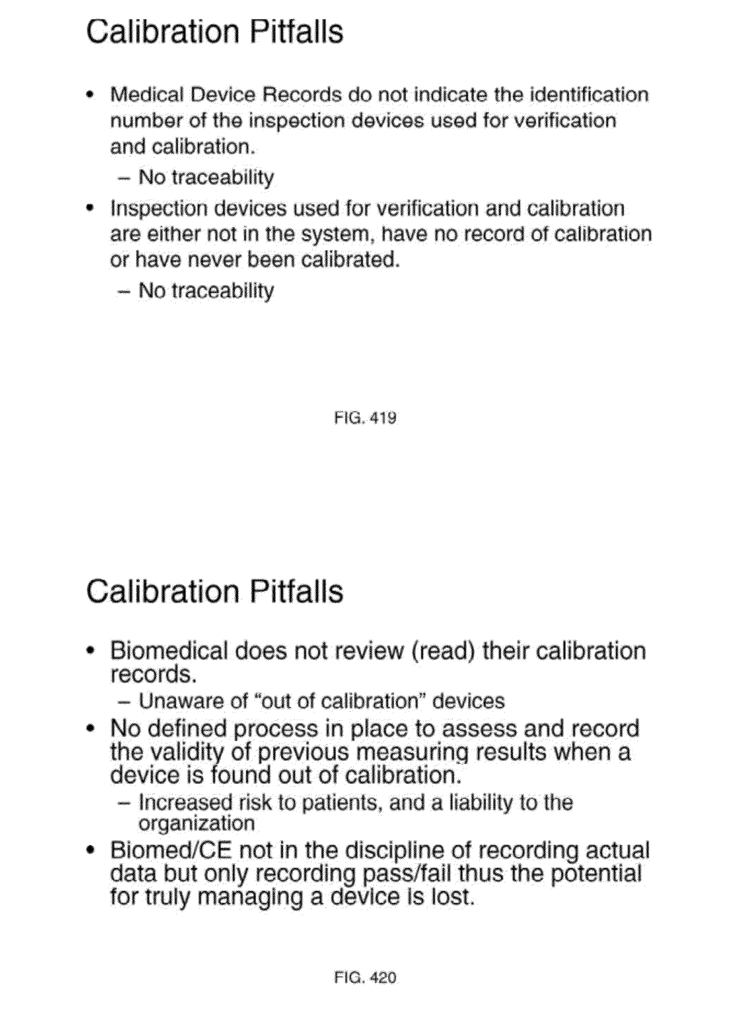

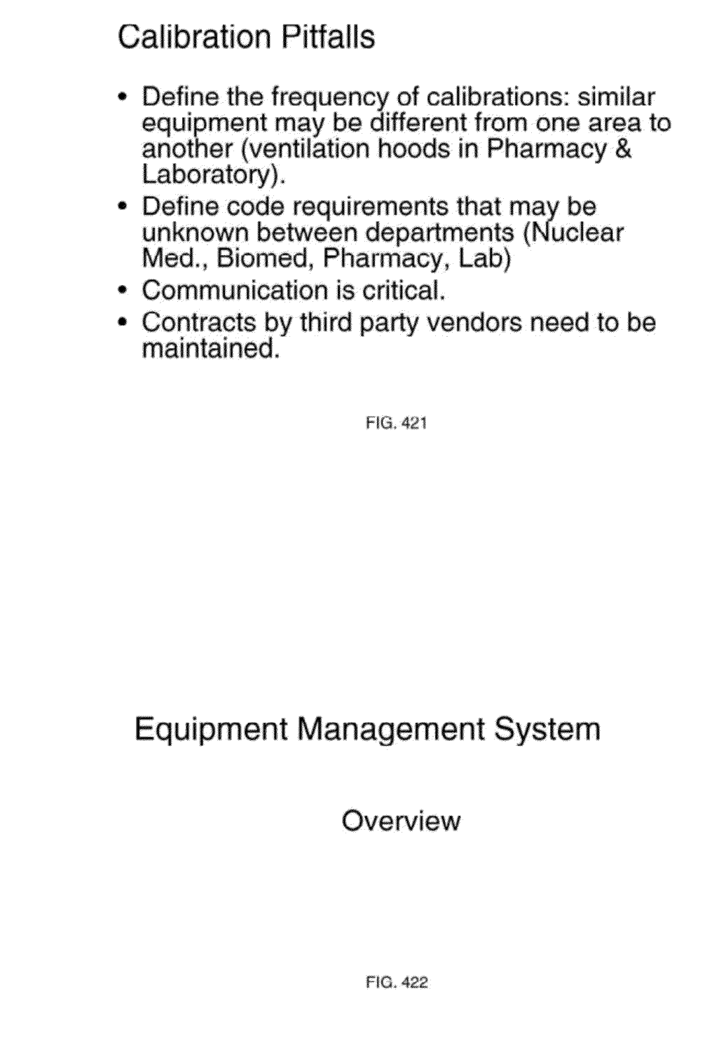

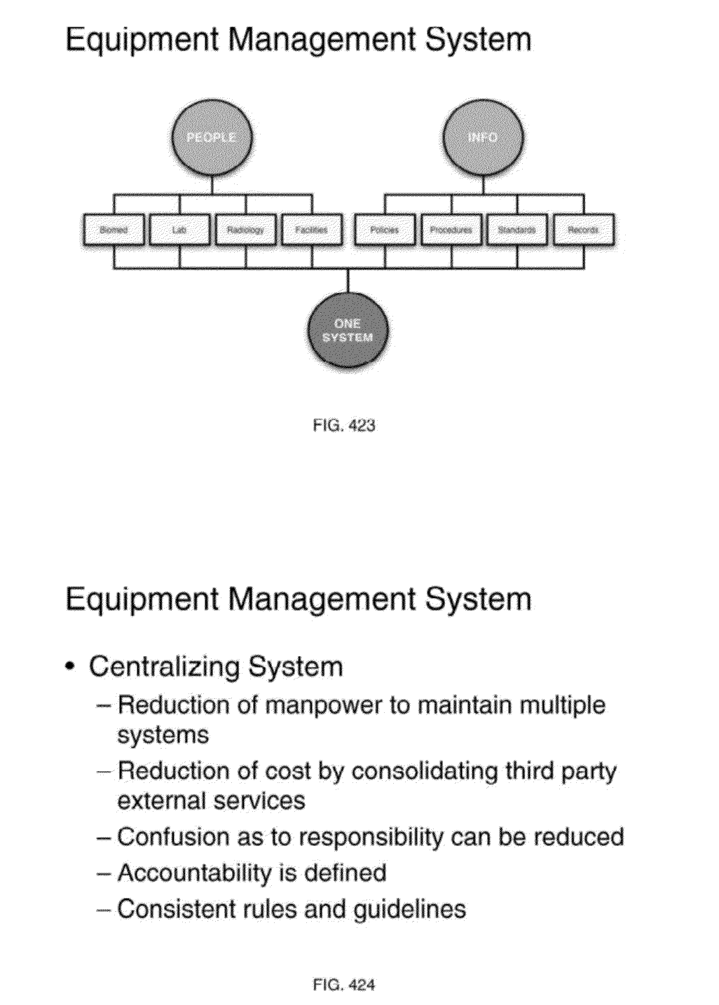

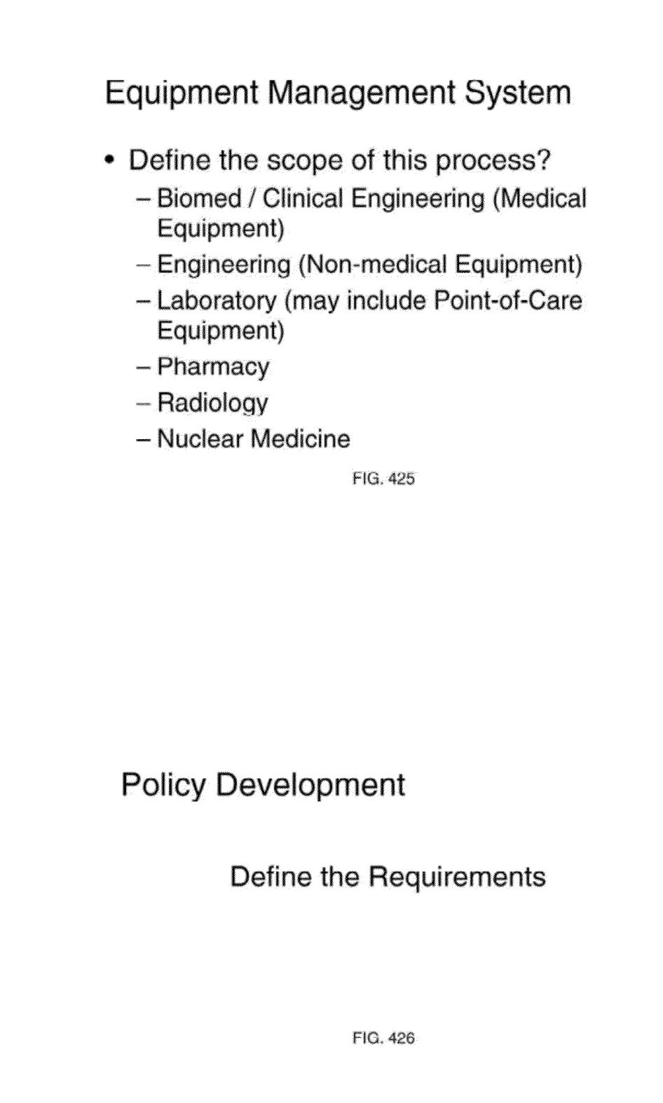

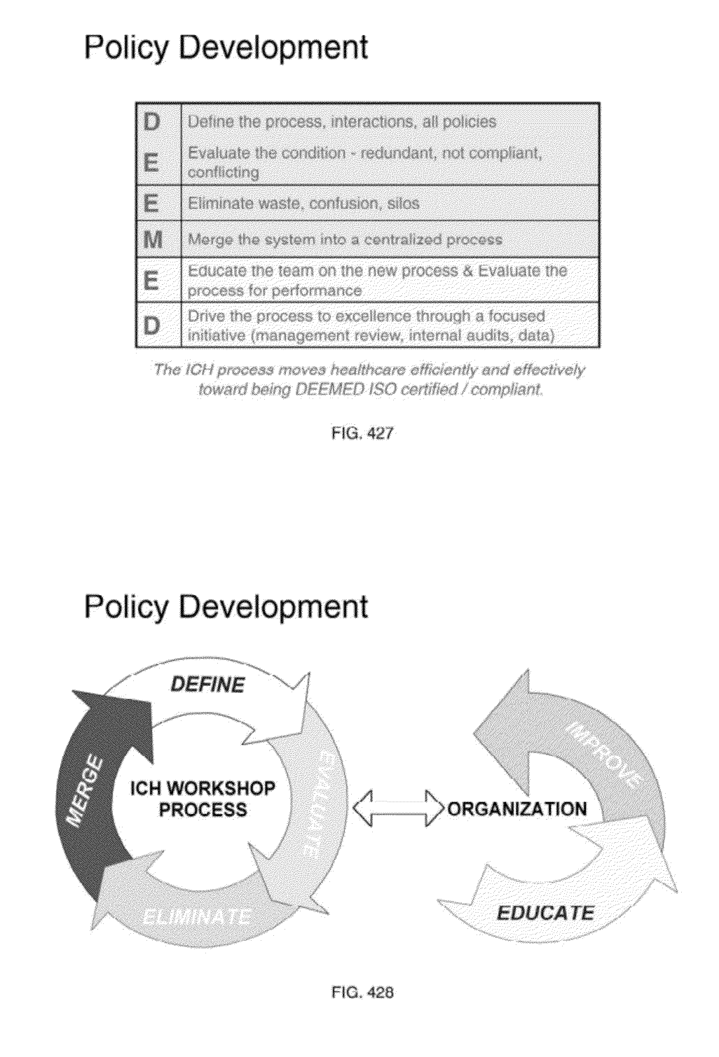

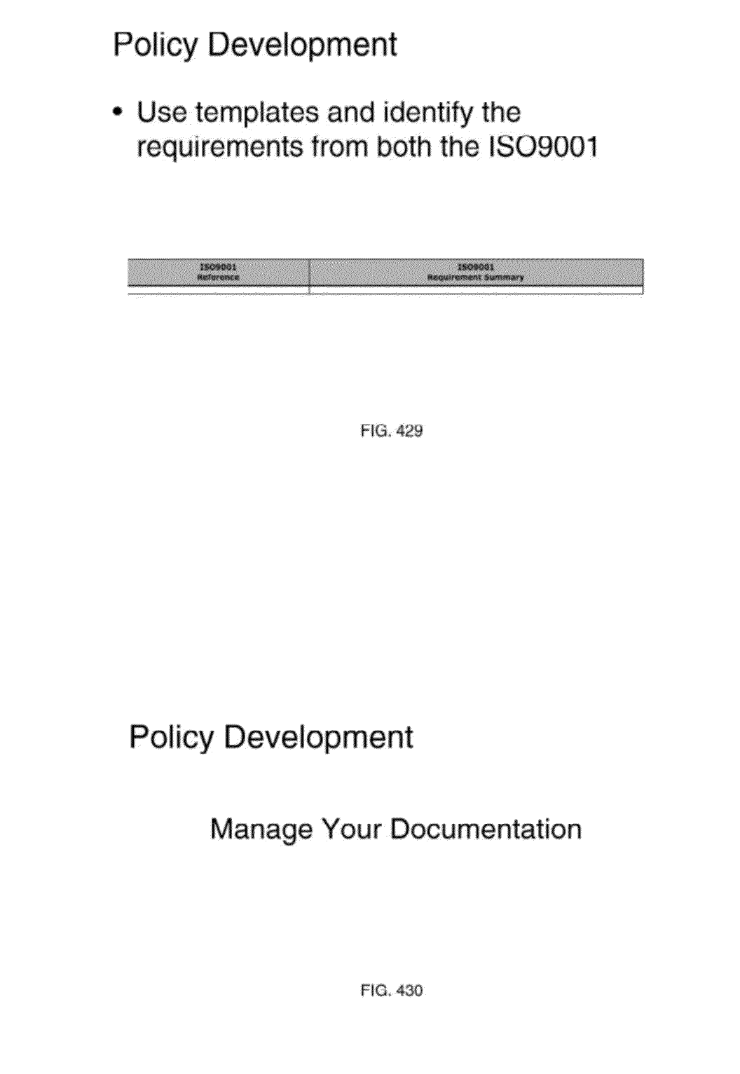

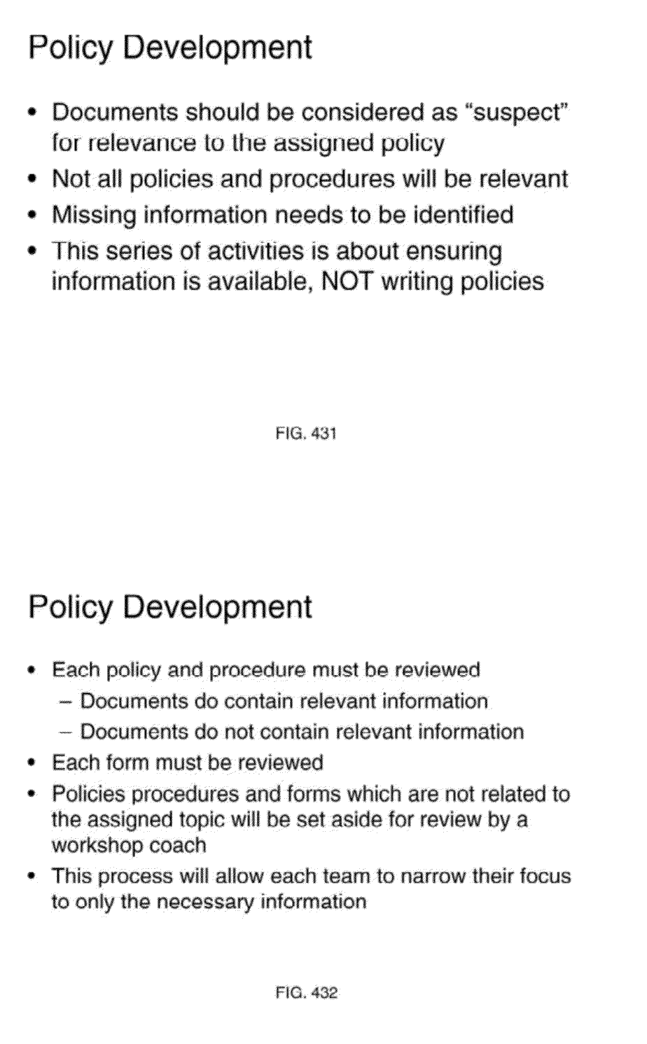

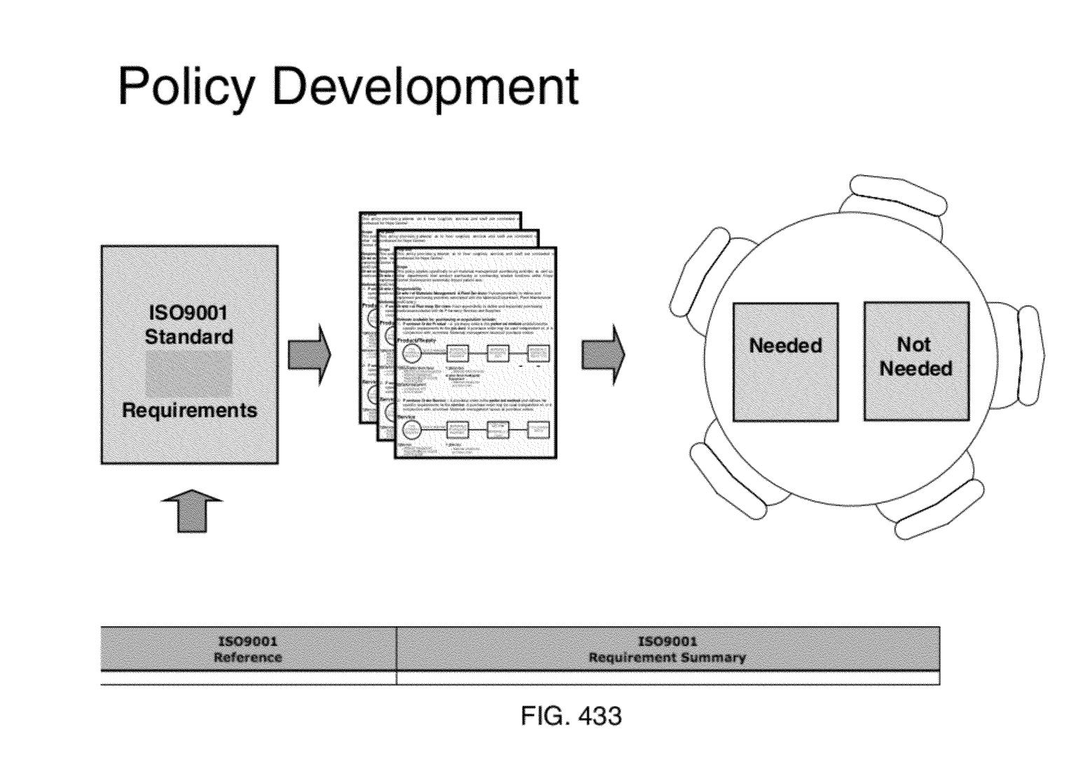

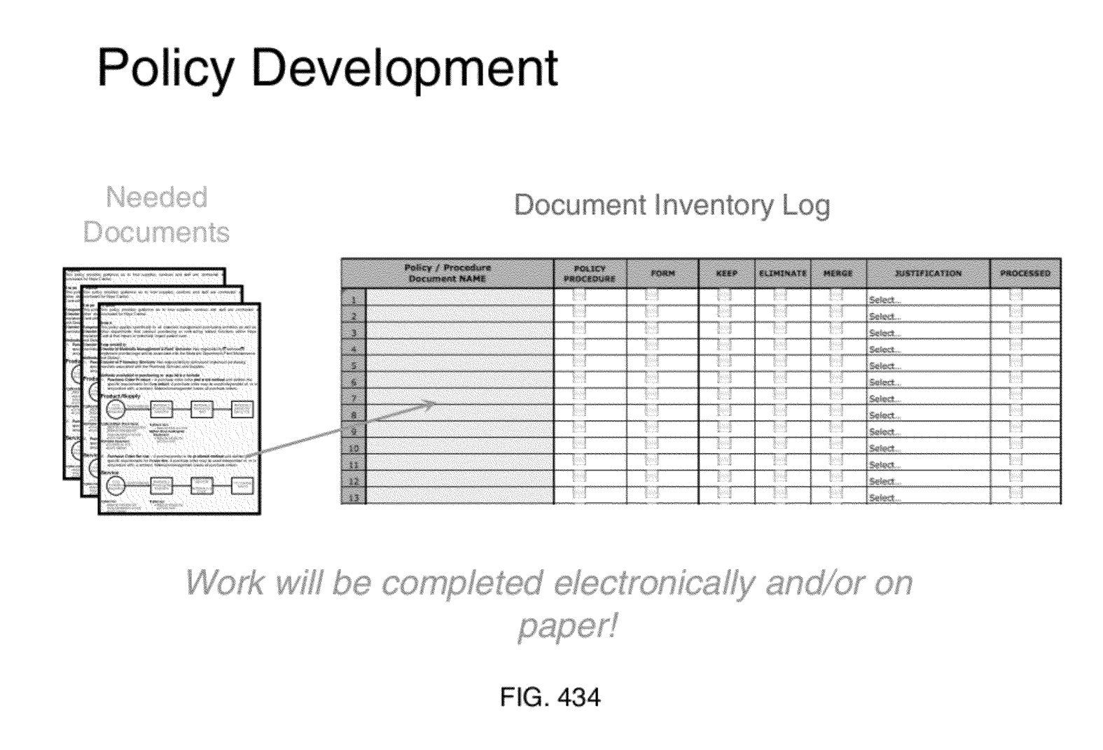

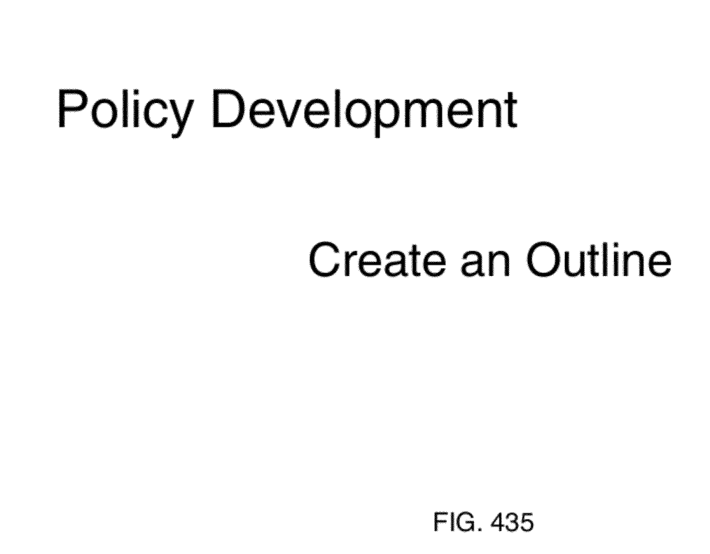

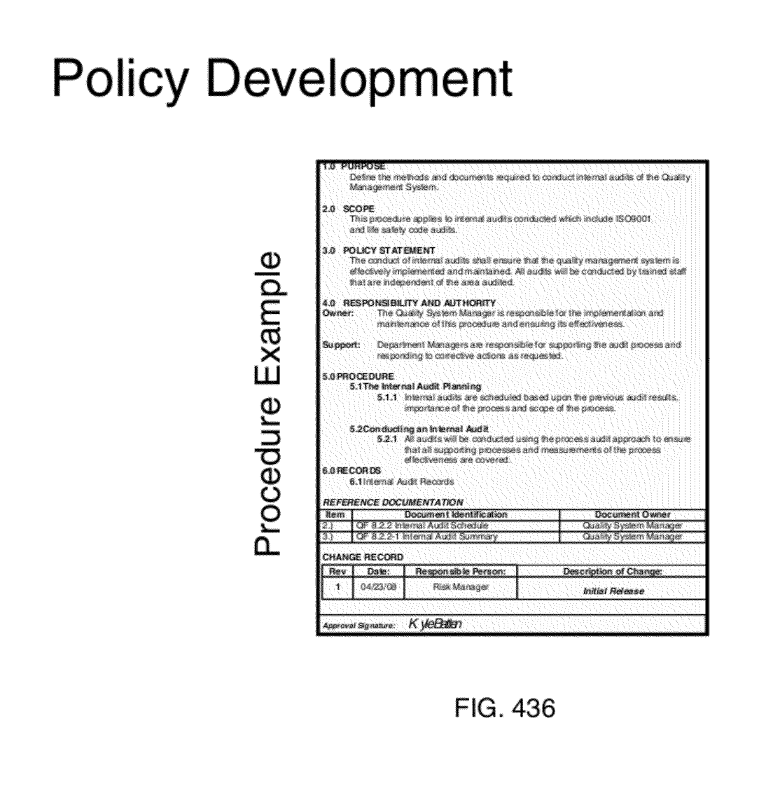

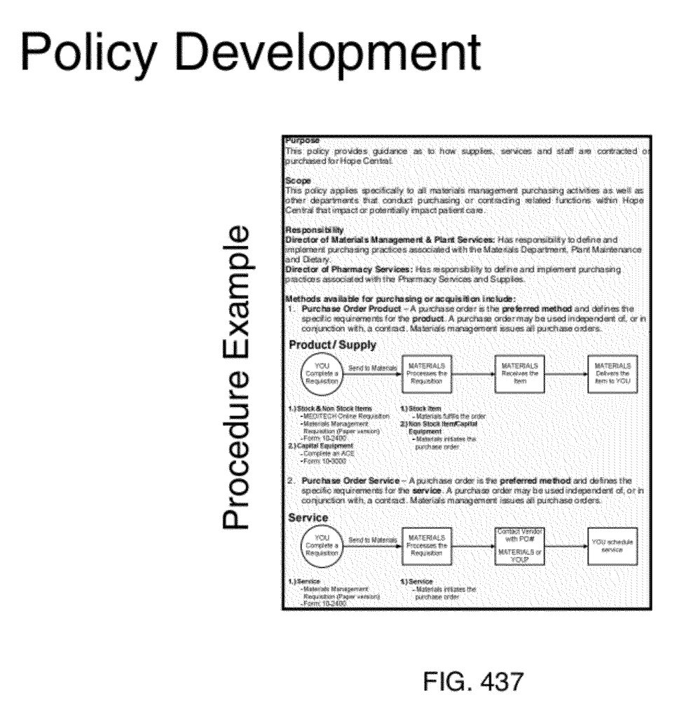

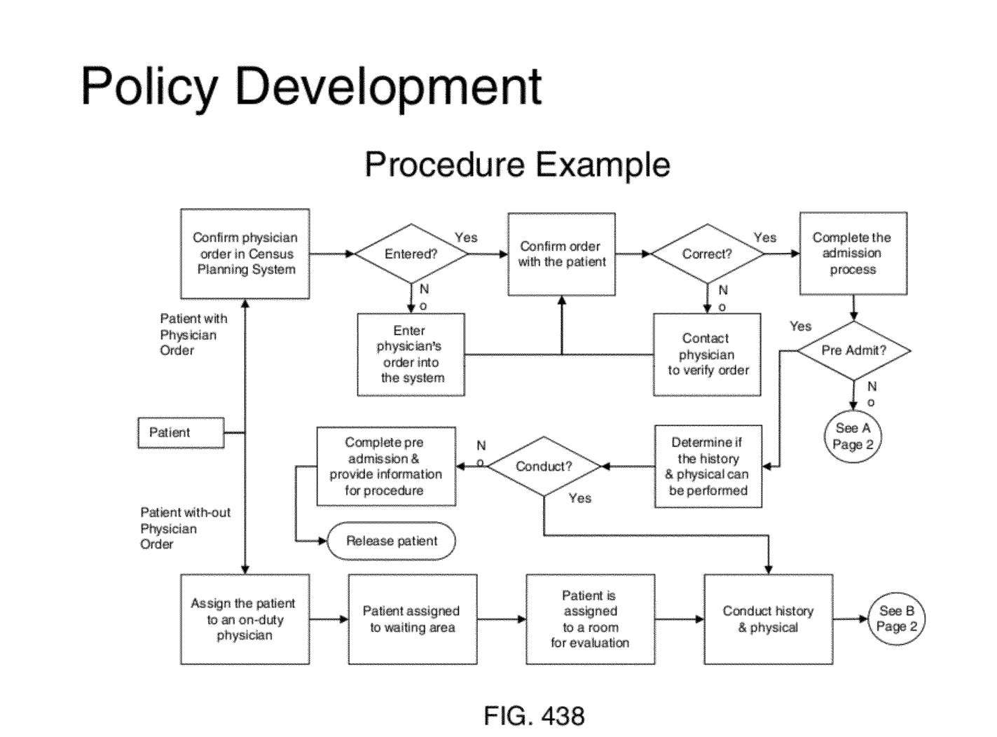

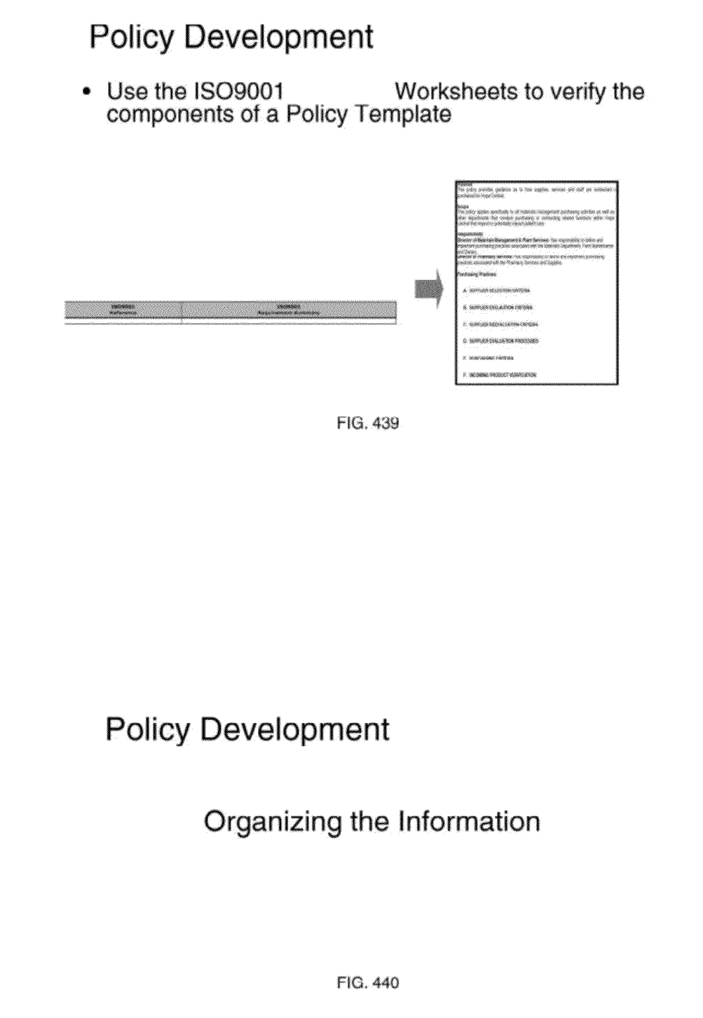

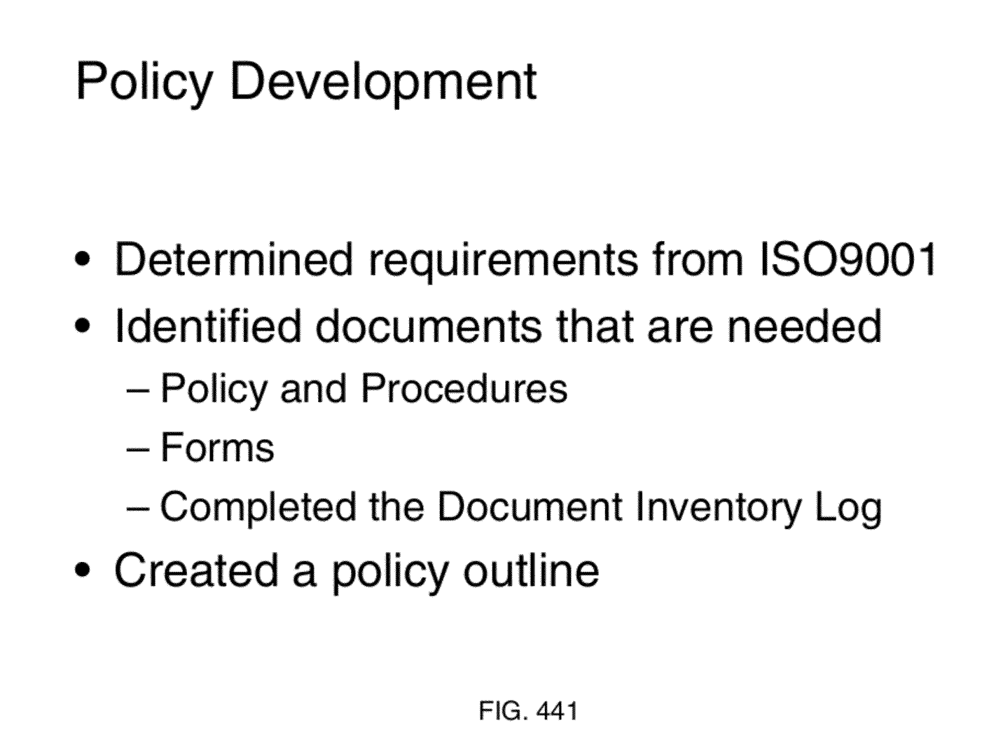

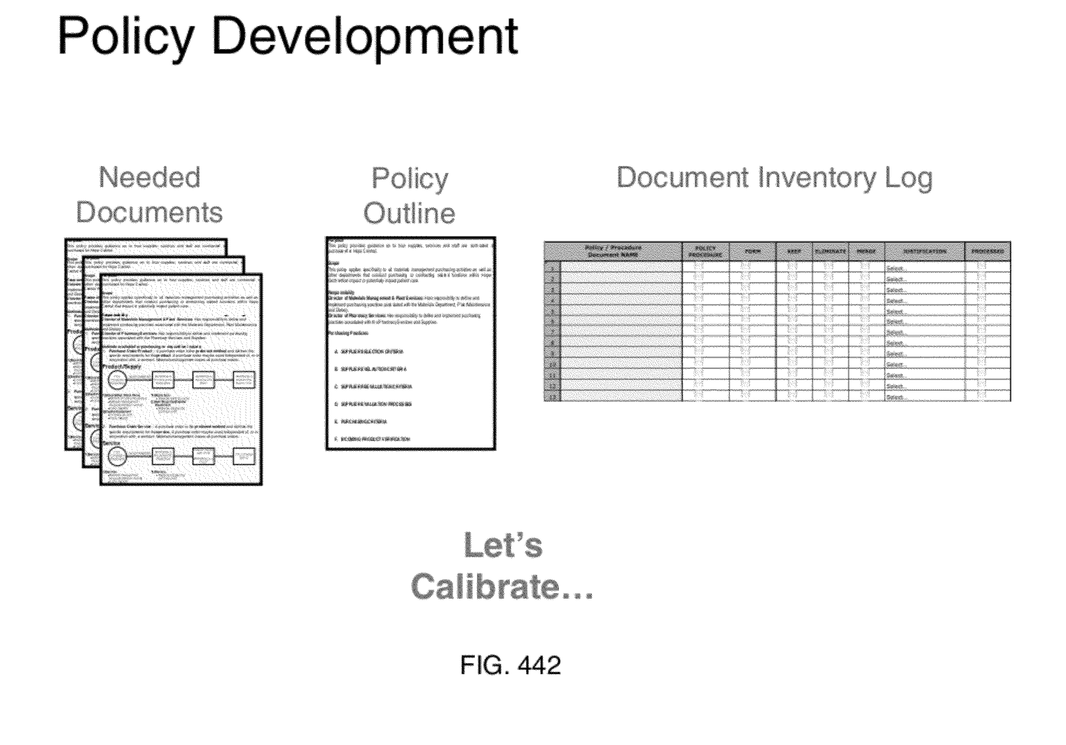

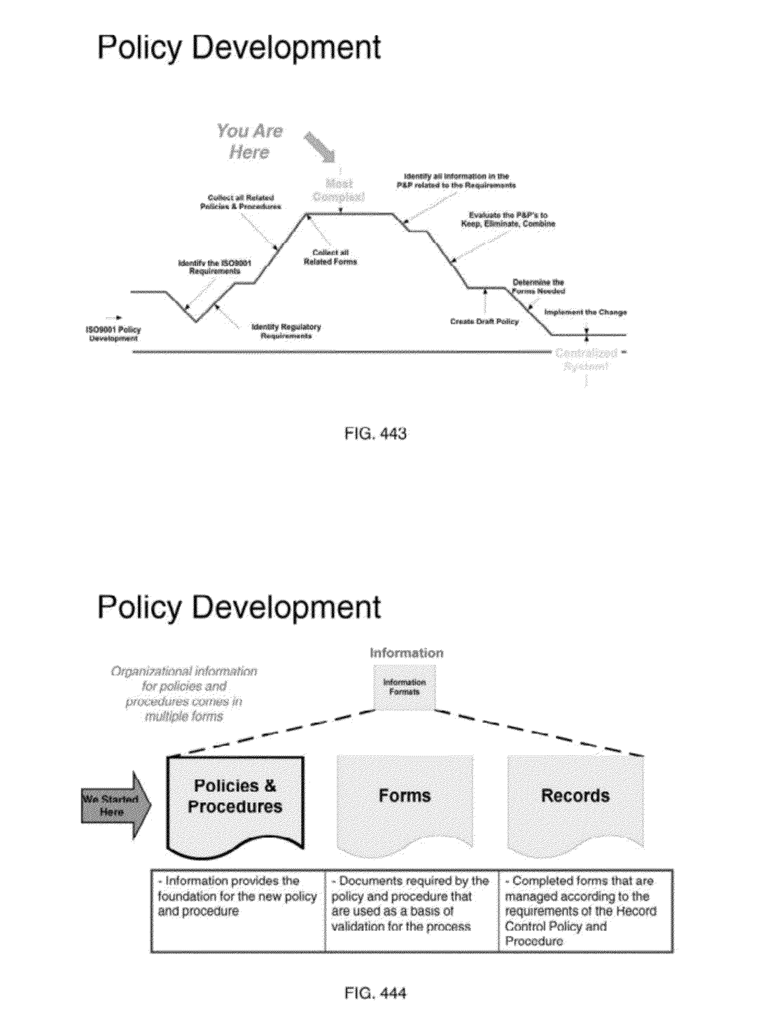

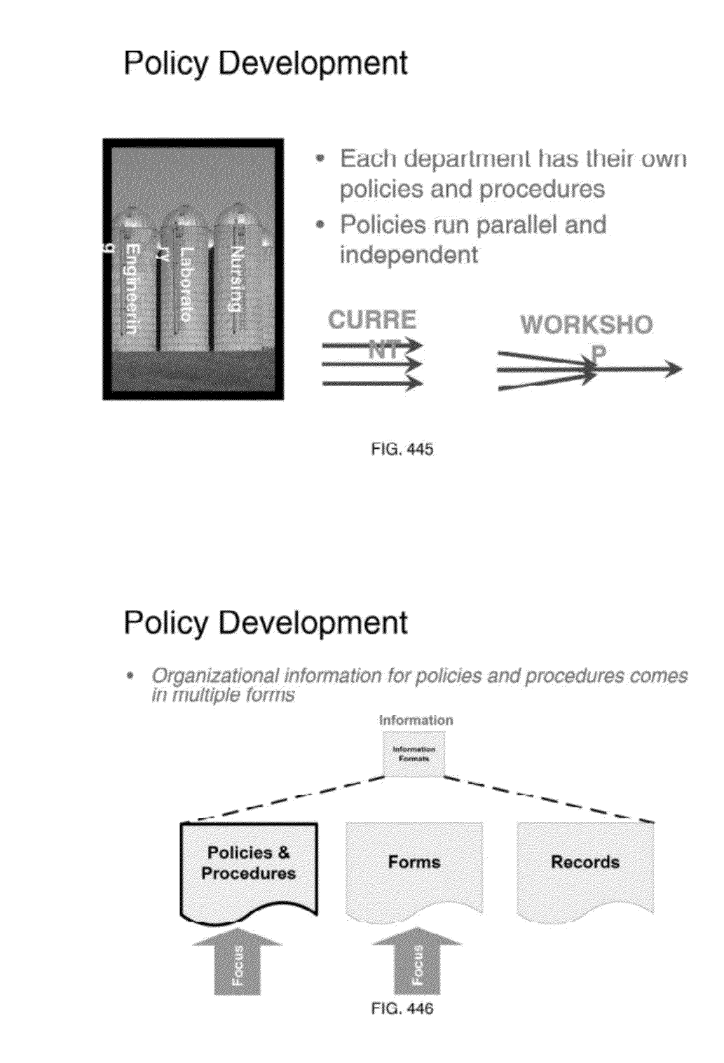

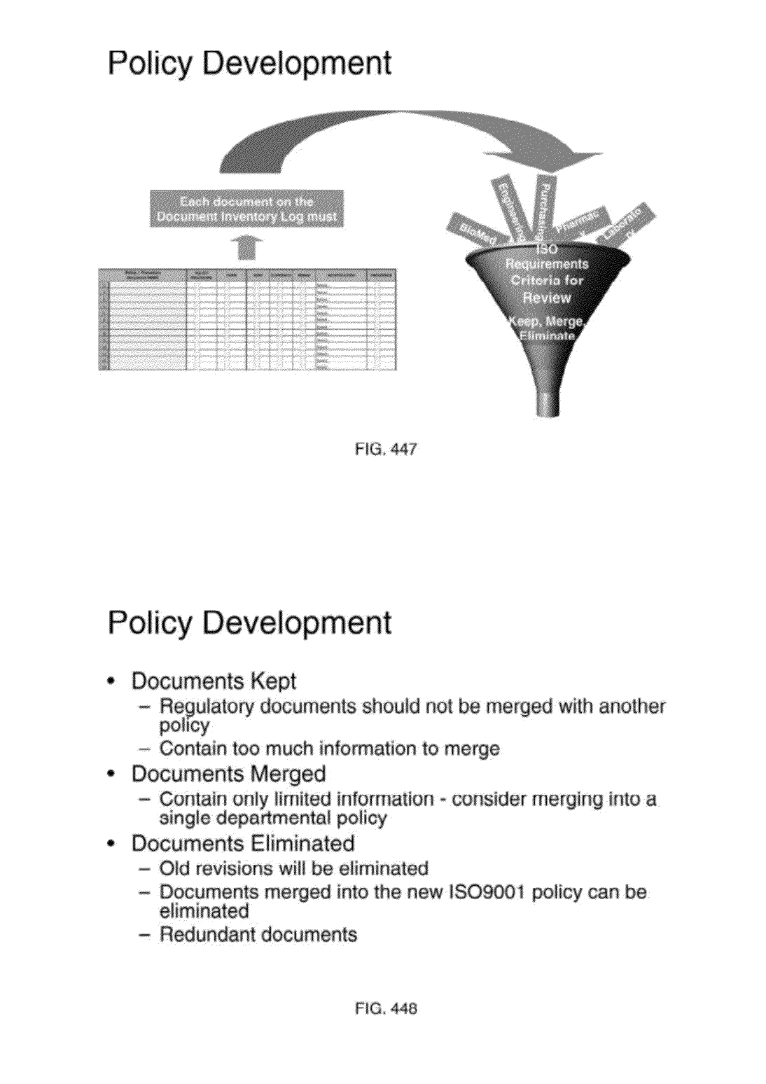

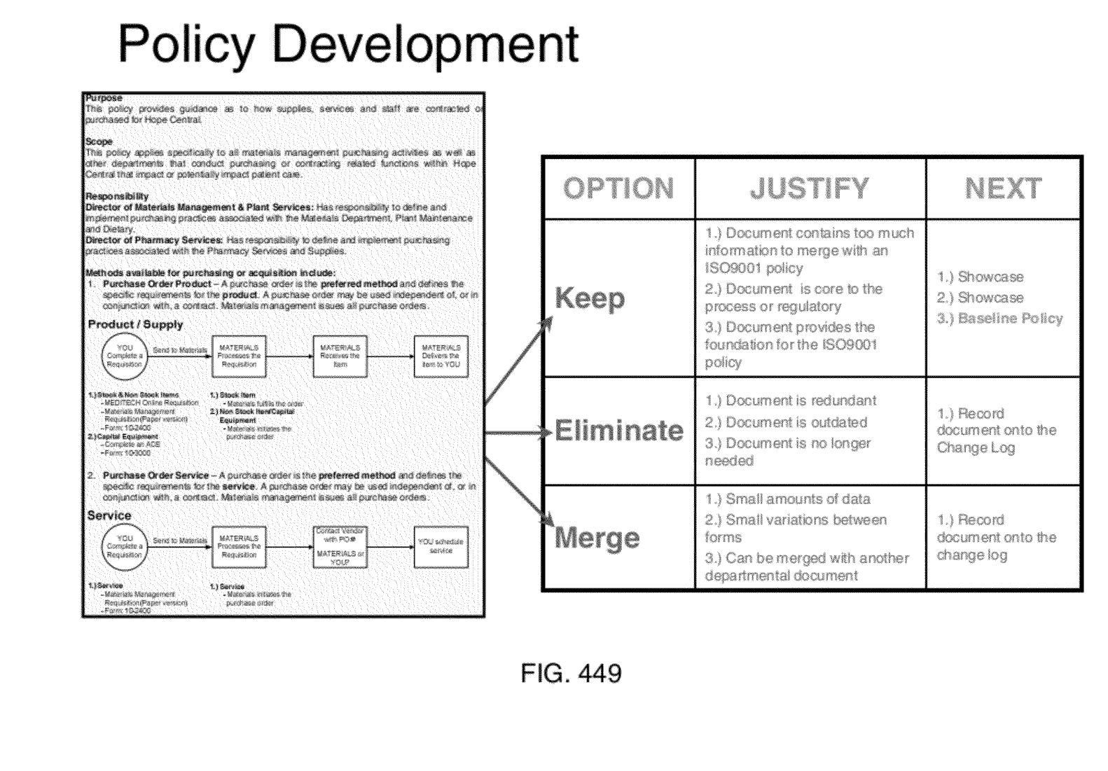

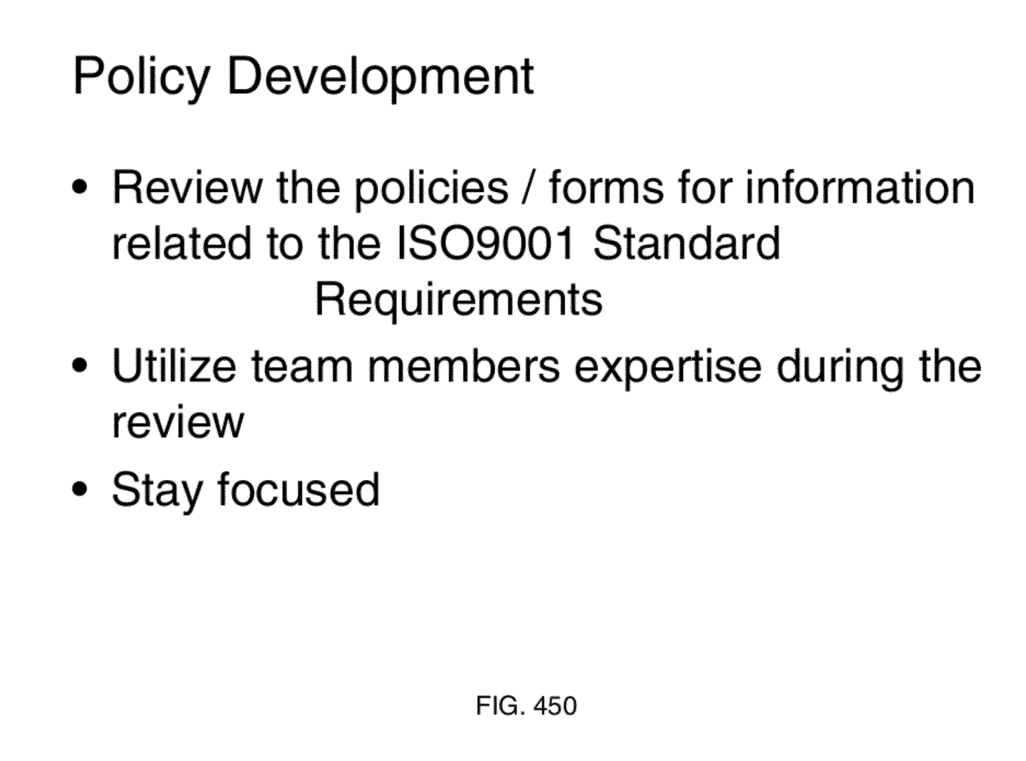

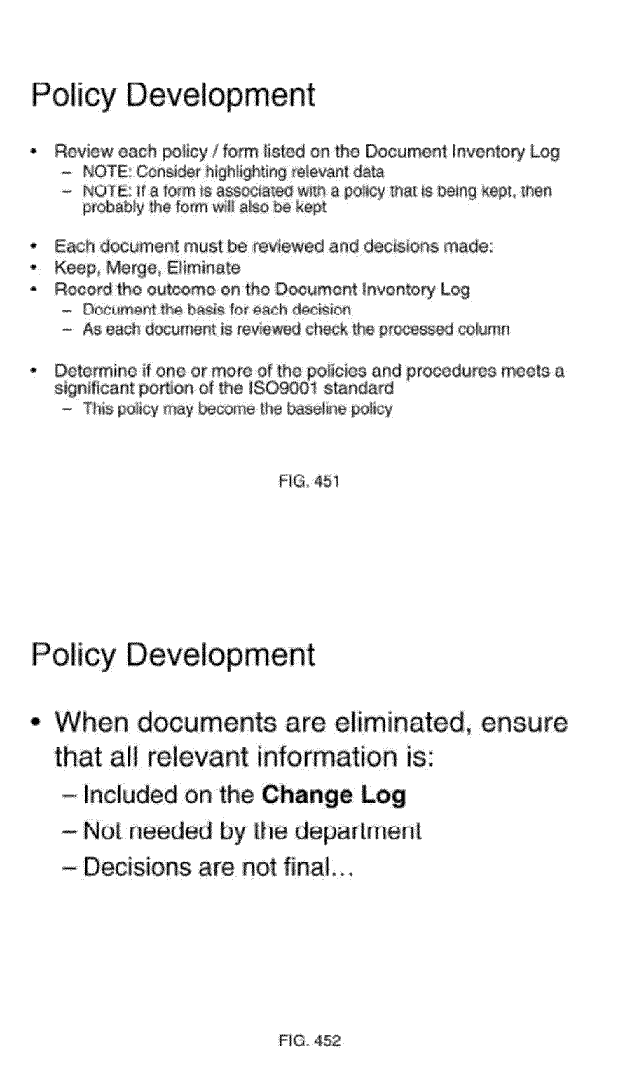

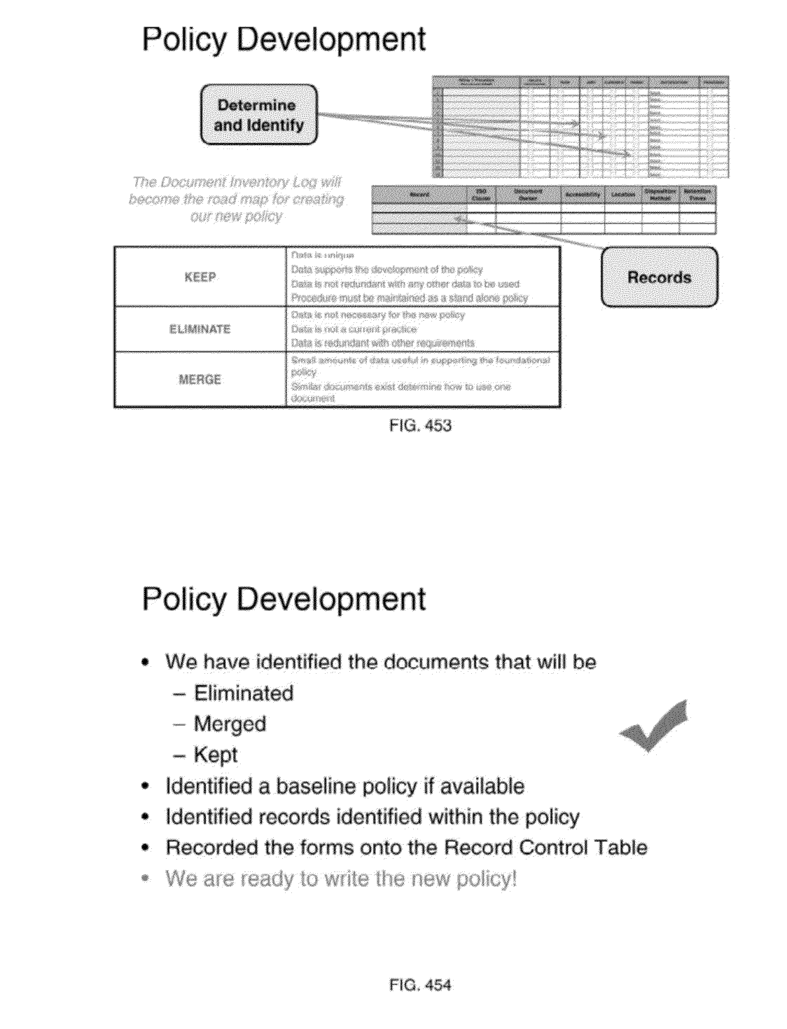

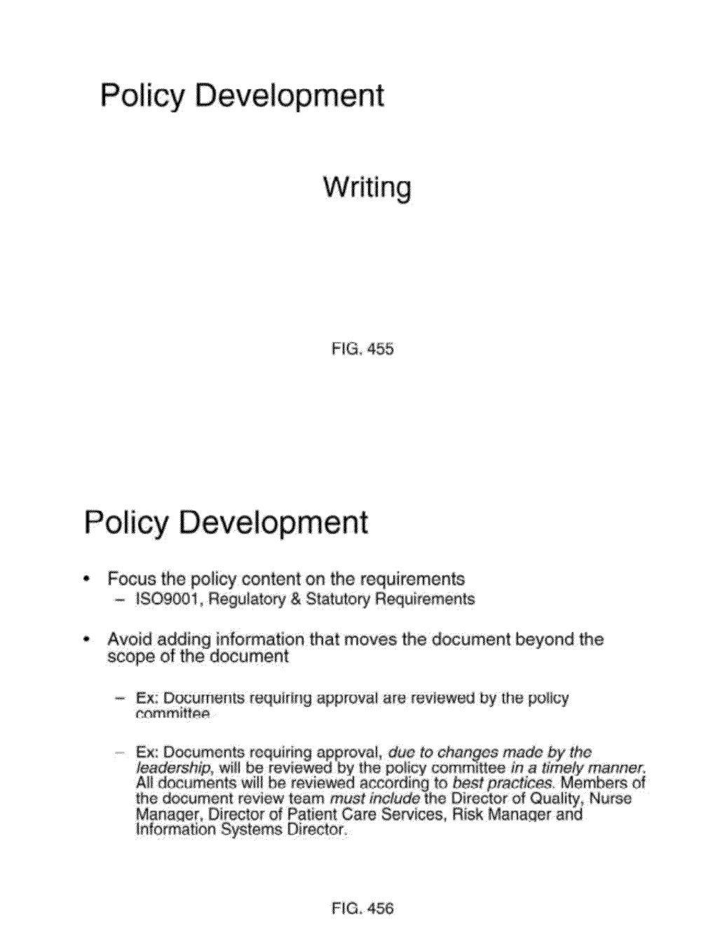

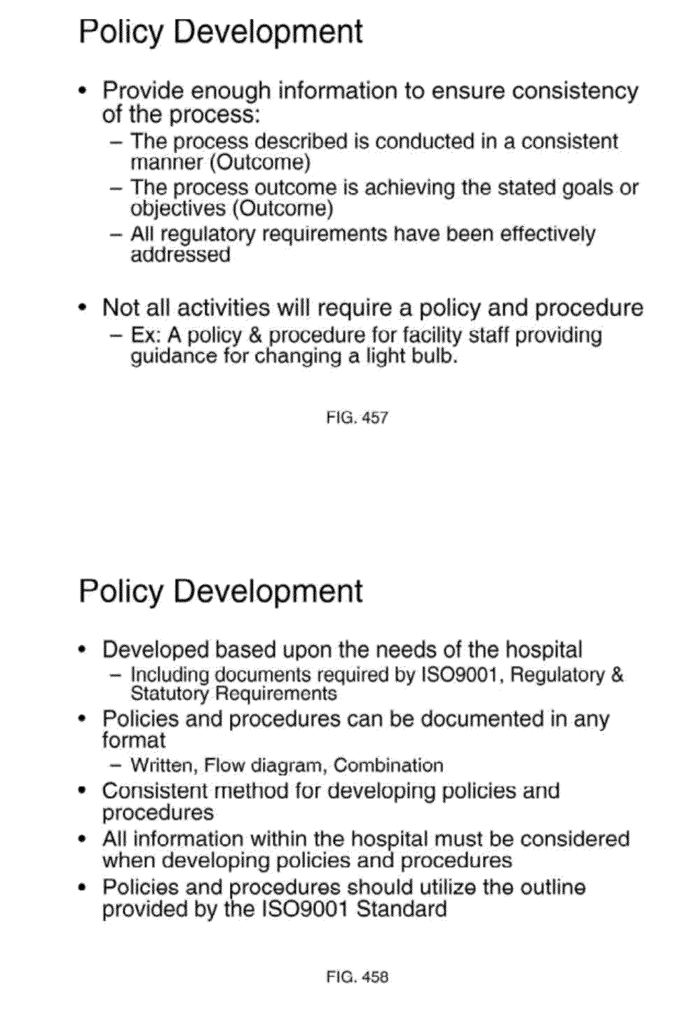

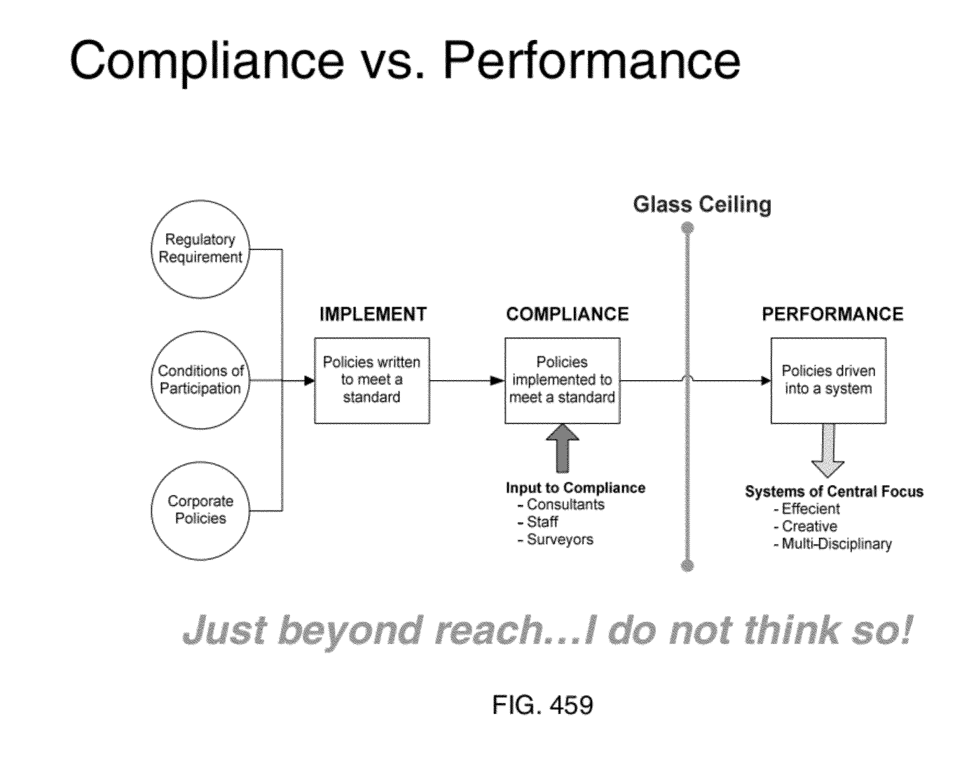

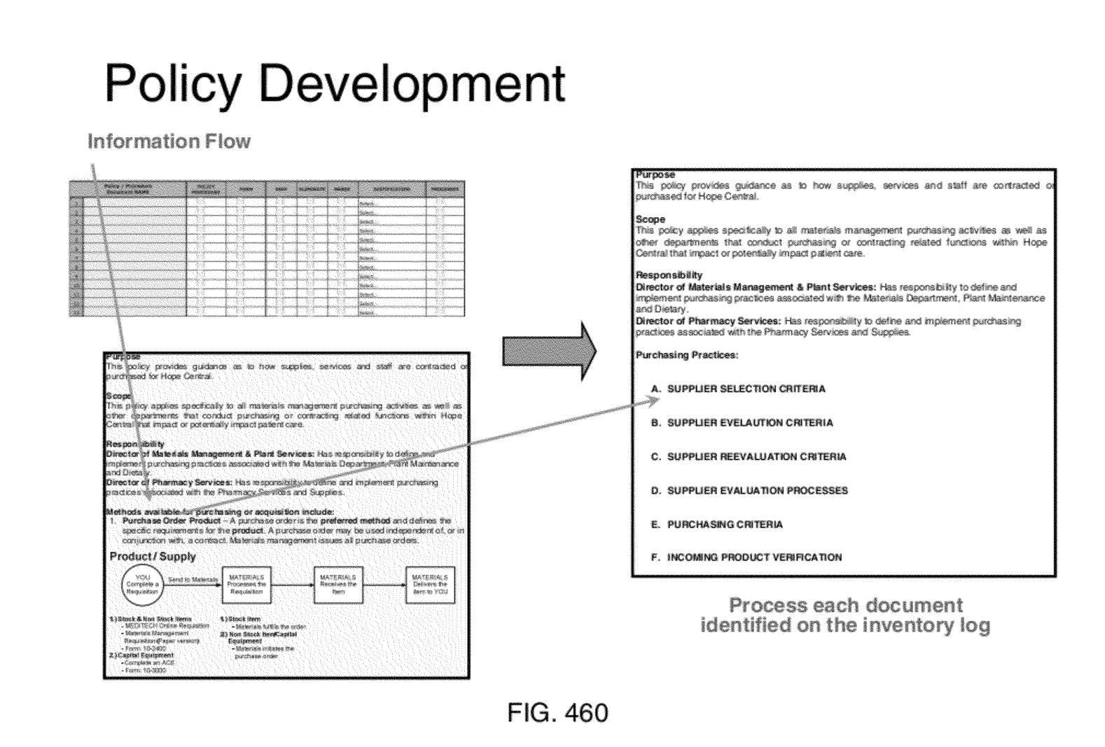

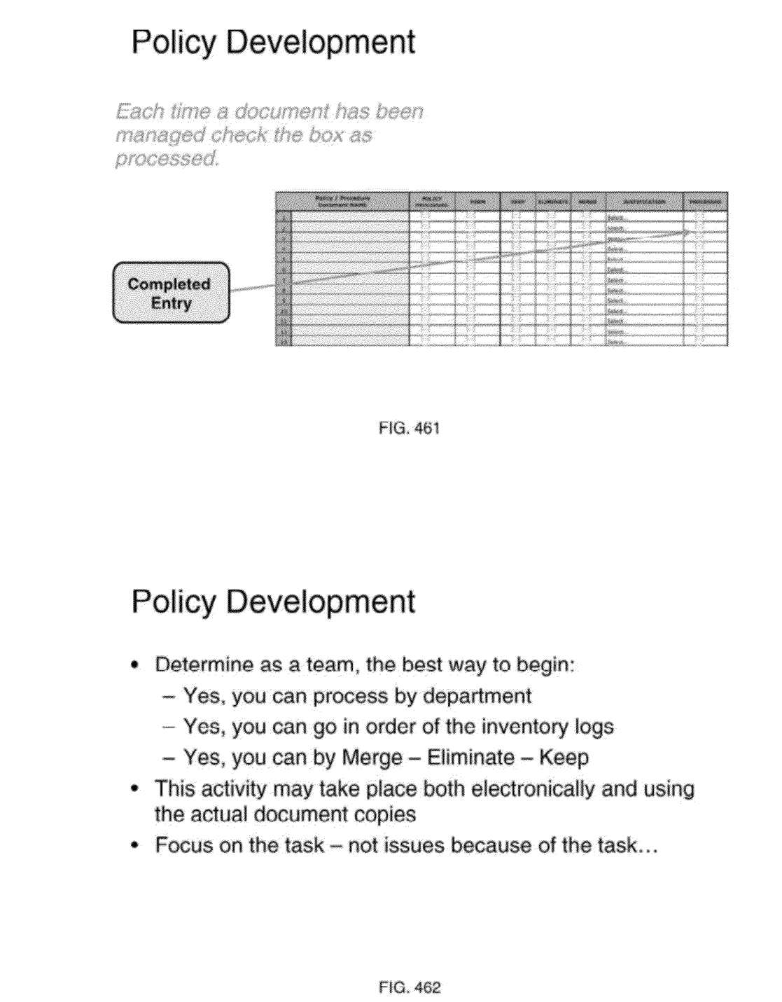

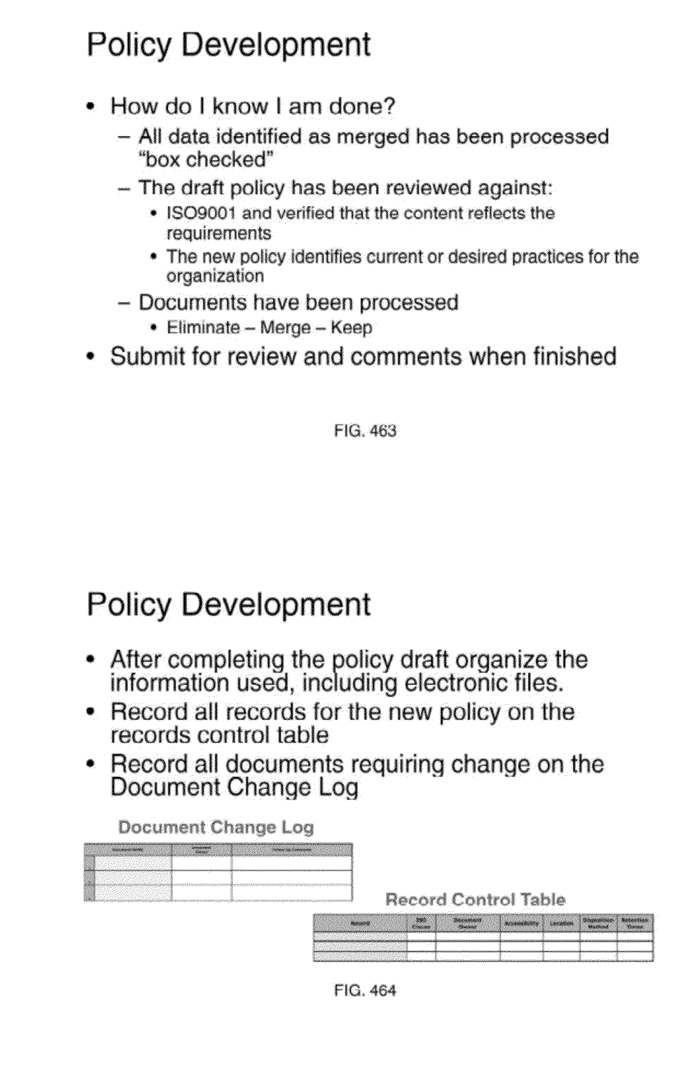

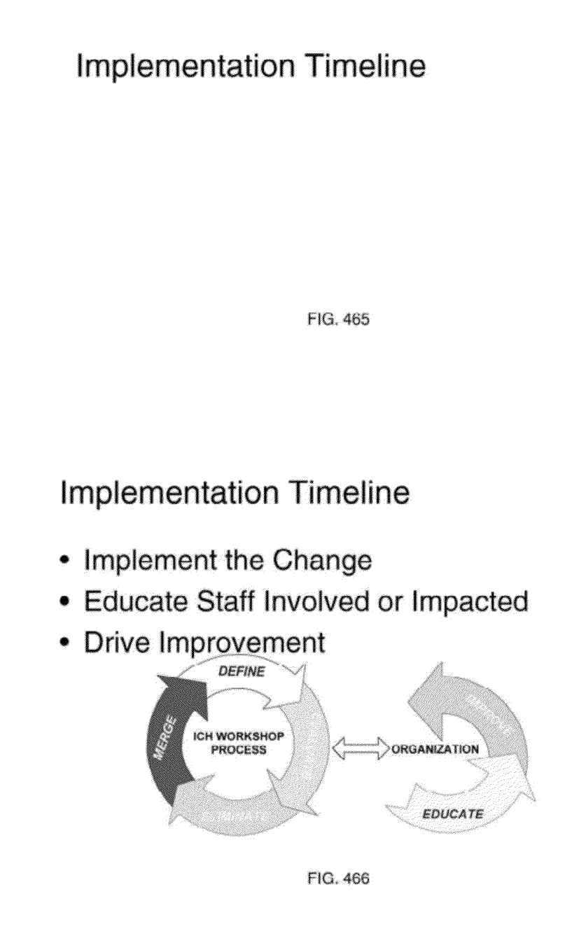

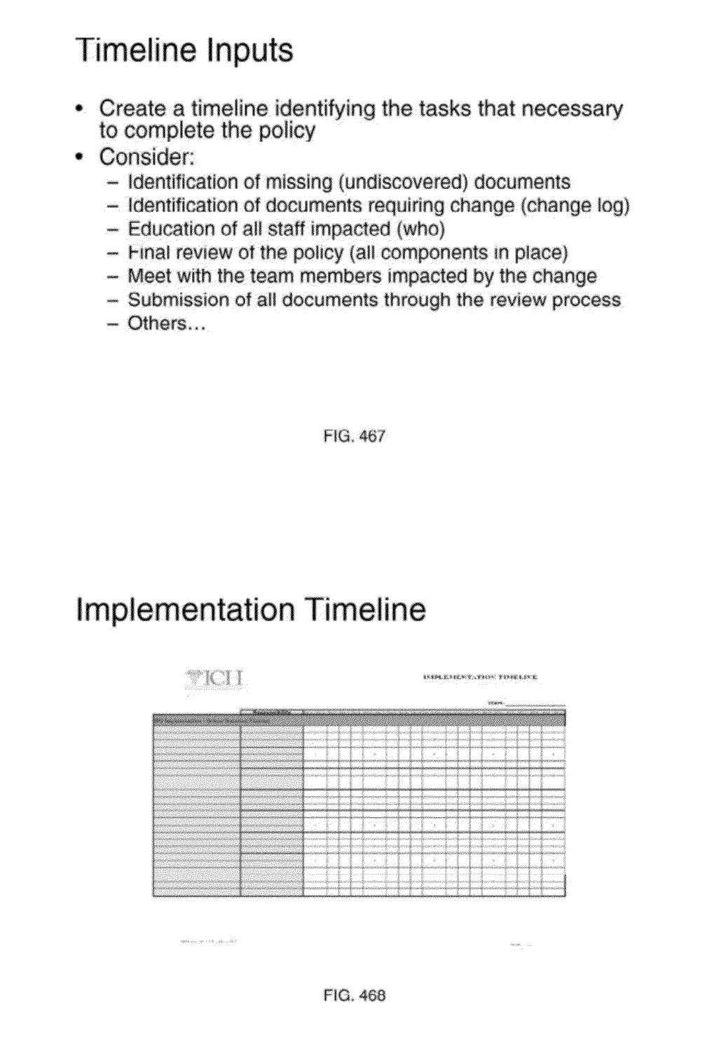

### DETAILED DESCRIPTION

The present disclosure relates to an ISO9001 implementation workshop. The course combines ISO9001 implementation instruction with a hands-on workshop. The course provides the history and foundation of ISO9001, a complete overview of the ISO9001 standard and review of the key steps to consider for all hospitals with regard to implementing ISO9001 within their organization. Through the focused workshops support is given to hospitals in their implementation efforts by guiding them through development of the quality manual, the six required procedures, leadership development, clinical engineering, and materials management. The ISO9001 implementation workshop suite is the key first step for all healthcare organizations seeking DNVHC (Det Norske Veritas Healthcare) accreditation and promotes an easier transition into the ISO9001 requirements.

The course includes: on-site instruction at a preferred location or site; a two to four day course with full access to a highly trained, knowledgeable ISO accredited consultant; an additional fully trained facilitator to help support the participants during the workshop portion of the course; and, utilizing the healthcare organizations own documentation, coupled with health care's best practices, the actual development of the key documents required for the ISO implementation.

The course may be broken out into three phases that cover all aspects of ISO9001 implementation. The outcome of Phase One of the course includes onsite consultation support, the development of the Quality Manual draft, the development of the six required ISO9001 Procedure drafts, and the provision of specific steps for continued implementation strategy for the Quality Manual and six required Procedures. The outcome of the Phase Two Leadership Alignment Workshop of the course includes offsite consultation preparation, onsite consultation support, enhancement of the Quality Manual or Performance Improvement Plan, development of the committee Scope of Service, standardization of the committee minute format, development of baseline rules for data review and analysis, and determination of the method for data review and accountability. The outcome of the Phase Three Workshop of the course includes offsite consultation preparation, onsite consultation support, alignment of purchasing across the organization, alignment of clinical engineering services through the organization, creation of a defined policy for both materials management and clinical engineering, and creation of a timeline to align related departments.

In one embodiment, topics and key objectives obtained during a three day ISO9001 Phase One implementation workshop include:

ISO9001 IMPLEMENTATION WORKSHOP - 3 Day

| | Topics | Key Objectives |
|---|---|---|
| Day One | Overview of management | Complete the ISO9001 system analysis |
| | systems in healthcare | form to recognize activity of the hospital |
| | Components of an ISO9001 | that fulfills ISO9001 requirements |
| | system | Identify the common requirements for |
| | Team development of the quality | implementation of ISO9001 in hospitals |
| | manual | |
| Day Two | ISO9001 Phase One | Review the exclusive ICH system for |
| | Quality Manual | policy development |
| | Document Control | Develop the six policies required by the |
| | Record Control | ISO9001 standard |
| | Internal Audits | Draft quality manual |
| | Control of Nonconformance | |
| | Corrective Action | |
| | Preventive Action | |
| Day Three | Team development of the six | Draft level documents for the ISO9001 |
| | required procedures | system |
| | Implementation strategies | Specific action plans to complete the |
| | Review of policies by coaches | implementation process for phase one |
| | Create implementation timeline | Develop key objectives and steps for |
| | | ISO9001 implementation |

In another embodiment, topics and key objectives obtained during a four day ISO9001 Phase One implementation workshop include:

ISO9001 IMPLEMENTATION WORKSHOP - 4 Day

| | Topics | Key Objectives |
|---|---|---|
| Day One | Overview of ISO9001 History | Develop the business application of |
| | Foundation of ISO9001 | ISO9001 |
| | Differences between | Identify the required documents of an |
| | Management Systems as it | ISO9001 system |
| | relates to Healthcare | Identify the application of clauses 1.0-6.4 |
| | ISO9001 Clauses 1-6 | to healthcare |
| | Exercise Clauses 4-6 | |
| | ISO9001 Clauses 7-8 (Begin) | |
| Day Two | ISO9001 Clauses 7-8 (Complete) | Identify the application of clauses 7-8 to |
| | Exercise Clauses 7-8 | healthcare |
| | Overview of management | Complete the ISO9001 system analysis |
| | systems in healthcare | form to recognize activity of the hospital |
| | Components of an ISO9001 | that fulfills ISO9001 requirements |
| | system | Identify the common requirements for |
| | ISO9001 Phase One | implementation of ISO9001 in hospitals |
| | Quality Manual | Create components for the quality |
| | | manual |
| Day Three & Four | ISO9001 Phase One | Draft quality manual |
| | Document Control | Draft level documents for the ISO9001 |
| | Record Control | system |
| | Internal Audits | Specific action plans to complete the |
| | Control of Nonconformance | implementation process for phase one |
| | Corrective Action | Develop key objectives and steps for |
| | Preventive Action | ISO9001 implementation |
| | Team development of the | |
| | quality manual | |
| | Team development of the six | |
| | required procedures | |
| | Implementation strategies | |
| | Review of policies by coaches | |
| | Create implementation timeline | |

In another embodiment, topics and key objectives obtained during a two day ISO9001 Leadership Alignment implementation workshop include:

ISO9001 LEADERSHIP ALIGNMENT WORKSHOP - 2 Day

| | Topics | Key Objectives |
|---|---|---|
| Offsite | Review requirements for | Build a foundation for the |
| Preparation | leadership workshop | leadership workshop |
| | Review information provided | |
| | by the hospital | |
| | Prepare materials for Day One | |
| | leadership session | |
| Day One | Components of an ISO9001 | Identify the key |
| | system related to leadership | requirements of ISO9001 as |
| | and performance | applied to leadership |
| | Hospital presentation of the | Alignment of metrics with |
| | leadership system | committees or departments |
| | Metrics required by the | |
| | hospital | |
| | Committee structure review | |
| | Regulatory requirements | |
| | Approval of meeting minute | |
| | format | |
| | Develop map of alignment for | |
| | the metrics | |
| Day Two | Develop scorecard/metrics | Committee minute format |
| | response system | Committee structure |
| | Develop the annual quality | alignment |
| | plan(Quality Manual) | Management oversight |
| | Develop scopes of service | agenda |
| | Prepare meeting for | Updated performance |
| | management oversight | improvement plan |
| | Create a timeline for | Timeline for continued |
| | implementation | implementation |

In another embodiment, topics and key objectives obtained during a two day ISO9001 Phase Three implementation workshop include:

ISO9001 PHASE THREE WORKSHOP - 2 Day

| | Topics | Key Objectives |
|---|---|---|
| Offsite | Review requirements for | Build a foundation for the |
| Preparation | Phase Three workshop | phase three workshop |
| | Review information provided | |
| | by the hospital | |
| | Prepare materials for Day One | |
| | workshop session | |
| Day One | Components of an ISO9001 | Identify the key |
| | system related to materials | requirements of ISO9001 |
| | management and clinical | as applied to leadership |
| | engineering | Alignment of materials |
| | Review current practices of | management |
| | materials management | services |
| | Departments | Alignment of clinical |
| | Data review and submission | engineering services |
| | to a committee | |
| | Review current practices of | |
| | clinical engineering | |
| | Departments | |
| | Data review and submission | |
| | to a committee | |
| | Determine the alignment of | |
| | services related to materials | |
| | management and clinical | |
| | engineering | |
| Day Two | Create a hospital wide policy | Define the scope of |
| | for materials management | materials management |
| | | and clinical engineering |
| | Create a hospital wide policy | Create a draft policy for |
| | for clinical engineering | materials management as it |
| | | applies to the organization |
| | Create a timeline for | Create a draft policy for |
| | implementation | clinical engineering as it |
| | | applies to the organization |

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An ISO9001 implementation workshop as shown and described herein.

2. An ISO9001 implementation workshop comprising one or more of the novel features described herein.
